(19) United States
(12) Patent Application Publication
(10) Pub. No.: US 2007/0226795 A1
(43) Pub. Date: Sep. 27, 2007

(54) VIRTUAL CORES AND HARDWARE-SUPPORTED HYPERVISOR INTEGRATED CIRCUITS, SYSTEMS, METHODS AND PROCESSES OF MANUFACTURE

(75) Inventors: Gregory R. Conti, Saint Paul (FR); Levon Petrosian, Plano, TX (US); Atif Hussain, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/671,752

(22) Filed: Feb. 6, 2007

Related U.S. Application Data
(60) Provisional application No. 60/771,737, filed on Feb. 9, 2006.
(60) Provisional application No. 60/869,986, filed on Dec. 14, 2006.

(51) Int. Cl. G06F 12/14

(52) U.S. Cl. 726/22

(57) ABSTRACT

An electronic system (1400) includes a processor (1422, 2610) having a pipeline, a bus (2655) coupled to the pipeline, a storage (1435, 1440, 2650) coupled to the bus (2655), the storage (1435, 2650) having a real time operating system (RTOS) and a real-time application, a non-real-time operating system (HLOS), a secure environment kernel (SE), and a software monitor (2310); and protective circuitry (2460) coupled to the processor and operable to establish a first signal (VP1_Active) and a second signal (NS) each having states and together having combinations of the states representing a first category (2430) for the real-time operating system and the real-time application, a second category (2420) for the non-real-time operating system, and a third category (2450) for the secure environment kernel.

### CROSS-REFERENCE TO RELATED APPLICATIONS

This application is related to provisional U.S. Patent Application No. 60/771,737, (TI-61985PS) filed Feb. 9, 2006, titled “CPU Virtual Cores and Hardware Hypervisor Model,” and to provisional U.S. Patent Application No. 60/869,986, (TI-61985PS1) filed Dec. 14, 2006, titled “Multi-Processor Architecture with Hardware-Supported Hypervisor,” Priority under 35 U.S.C. 119(e)(1) is hereby claimed for both said provisional U.S. Patent Applications.

U.S. non-provisional patent application TI-39616 “Method And System For Preventing Unauthorized Processor Mode Switches” U.S. Ser. No. 11/343,061 filed Jan. 30, 2006, for which priority under 35 U.S.C. 120 is hereby claimed to such extent as may be applicable and said patent application TI-39616 is also hereby incorporated herein by reference.

U.S. non-provisional patent application TI-39615 “Methods And System To Restrict Usage Of a DMA Channel” U.S. Ser. No. 11/557,298 filed Nov. 7, 2006, for which priority under 35 U.S.C. 120 is hereby claimed to such extent as may be applicable and said patent application TI-39615 is also hereby incorporated herein by reference.

U.S. non-provisional patent application TI-39613 “Method And System For Preventing Unsecure Memory Accesses” U.S. Ser. No. 11/343,072, filed Jan. 30, 2006, for which priority under 35 U.S.C. 120 is hereby claimed to such extent as may be applicable and said patent application TI-39613 is also hereby incorporated herein by reference.

U.S. non-provisional patent application TI-38804 “Method And System For A Multi-Sharing Security Firewall” U.S. Ser. No. 11/272,532, filed Nov. 10, 2005, for which priority under 35 U.S.C. 120 is hereby claimed to such extent as may be applicable and said patent application TI-38804 is also hereby incorporated herein by reference.

U.S. non-provisional patent application TI-38802 “Method And System For Detection And Neutralization Of Buffer Overflow Attacks” U.S. Ser. No. 11/199,427, filed Aug. 8, 2005, for which priority under 35 U.S.C. 120 is hereby claimed to such extent as may be applicable and said patent application TI-38802 is also hereby incorporated herein by reference.

U.S. non-provisional patent application TI-38800 “System And Method For Checking The Integrity Of Computer Program Code” U.S. Ser. No. 11/463,426, filed Aug. 9, 2006, for which priority under 35 U.S.C. 120 is hereby claimed to such extent as may be applicable and said patent application TI-38800 is also hereby incorporated herein by reference.

U.S. non-provisional patent application TI-38213 “Methods, Apparatus, and Systems for Secure Demand Paging and Other Paging Operations for Processor Devices” U.S. Ser. No. 11/426,597 filed Jun. 27, 2006, is hereby incorporated herein by reference.

U.S. non-provisional patent application TI-39617 “Page Processing Circuits, Devices, Methods And Systems For Secure Demand Paging And Other Operations” U.S. Ser. No. 11/426,598 filed Jun. 27, 2006, is hereby incorporated herein by reference.

U.S. non-provisional patent application TI-38206 “Less-Secure Processors, Integrated Circuits, Wireless Communications Apparatus, Methods And Processes Of Making” U.S. Ser. No. 10/915,830 filed Aug. 10, 2004, is hereby incorporated herein by reference.

U.S. non-provisional patent application TI-37338 “System and Method of Identifying and Preventing Security Violations Within a Computing System” U.S. Ser. No. 10/961,344, filed Oct. 8, 2004, is hereby incorporated herein by reference.

U.S. non-provisional patent application TI-61407 “Monitor Mode Integrity Verification” U.S. Ser. No. 11/617,411 filed Dec. 28, 2006, for which priority under 35 U.S.C. 120 is hereby claimed to such extent as may be applicable and said patent application TI-61407 is also hereby incorporated herein by reference.

### STATEMENT REGARDING FEDERALLY SPONSORED RESEARCH OR DEVELOPMENT

Not applicable.

### COPYRIGHT NOTIFICATION

Portions of this patent application contain materials that are subject to copyright protection. The copyright owner has no objection to the facsimile reproduction by anyone of the patent document, or the patent disclosure, as it appears in the United States Patent and Trademark Office, but otherwise reserves all copyright rights whatsoever.

### BACKGROUND OF THE INVENTION

This invention is in the field of electronic computing hardware and software and communications, and is more specifically directed to improved processes, circuits, devices, and systems for information and communication processing purposes, and processes of making them. Without limitation, the background is further described in connection with communications processing.

Wireline and wireless communications, of many types, have gained increasing popularity in recent years. The personal computer with a wireline modem such as DSL (digital subscriber line) modem or cable modem communicates with other computers over networks. The mobile wireless (or “cellular”) telephone has become ubiquitous around the world. Mobile telephony has recently begun to communicate video and digital data, and voice over packet (VoP or VoIP), in addition to cellular voice. Wireless modems, for communicating computer data over a wide area network, using mobile wireless telephone channels and techniques are also available.

Wireless data communications in wireless local area networks (WLAN), such as that operating according to the well-known IEEE 802.11 standard, has become popular in a wide range of installations, ranging from home networks to commercial establishments. Short-range wireless data communication according to the “Bluetooth” technology permits computer peripherals to communicate with a personal computer or workstation within the same room. Numerous other wireless technologies exist and are emerging.

Security techniques are used to improve the security of retail and other business commercial transactions in electronic commerce and to improve the security of communications wherever personal and/or commercial privacy is desirable. Security is important in both wireline and wireless communications.

For security reasons, at least some processors provide two levels of operating privilege: a first level of privilege for user programs; and a higher level of privilege for use by the operating system. However, the higher level of privilege may or may not provide adequate security for m-commerce and e-commerce, given that this higher level relies on proper operation of operating systems. In order to address security concerns, some mobile equipment manufacturers implement yet another third level of privilege, or secure mode, that places less reliance on operating system programs, and more reliance on hardware-based monitoring and control of the secure mode.

As computer and communications applications with security become larger and more complex, a need has arisen for technology to inexpensively handle large amounts of software program code and the data for highly disparate applications and run them more or less concurrently in a secure manner.

Processors of various types, including DSP (digital signal processing) chips, RISC (reduced instruction set computing) and/or other integrated circuit devices are important to these systems and applications. Constraining or reducing the cost of manufacture and providing a variety of circuit and system products with performance features for different market segments are important goals in DSPs, integrated circuits generally and system-on-a-chip (SOC) design.

Further alternative and advantageous solutions would, accordingly, be desirable in the art.

### SUMMARY OF THE INVENTION

Generally and in one form of the invention, an electronic device includes a processor including a pipeline operable to execute instructions in a real-time category or a non-real-time category, the processor operable in a secure or non-secure mode and in a monitor or a non-monitor mode and further operable to generate mode signals on a secure mode line and a monitor mode line; a bus coupled to the pipeline for accesses; and protective circuitry coupled to the processor, the protective circuitry having a register field operable to couple first and second qualifiers to the bus wherein the first qualifier is responsive to the secure mode line and the second qualifier represents whether the processor is in the real-time category or not for a given access, and the protective circuitry further responsive to the monitor mode line to permit alteration of the register field by the processor when the processor is in the monitor mode and to prevent alteration of at least part of the register field when the processor is in a non-monitor mode.

Generally and in another form of the invention, an integrated circuit includes a processor including a pipeline, a bus coupled to the pipeline, a storage coupled to the bus, the storage having a real time operating system, a non-real-time operating system, and a software monitor; and a security circuit coupled to the bus and operable to generate at least one security violation signal unless a transition between the real time operating system and the non-real-time operating system includes the software monitor.

Generally and in a further form of the invention, an electronic system includes a processor having a pipeline, a bus coupled to the pipeline, a storage coupled to the bus, the storage having a real time operating system and a real-time application, a non-real-time operating system, a secure environment kernel, and a software monitor; and protective circuitry coupled to the processor and operable to establish a first signal and a second signal each having states and together having combinations of the states representing a first category for the real-time operating system and the real-time application, a second category for the non-real-time operating system, and a third category for the secure environment kernel.

Generally, and in still another form of the invention, a security circuit is for use with a processor having modes and address signals. The security circuit includes a security violation handler, a first checker circuit having a first checker output coupled to the security violation handler and the first checker circuit having input lines for receiving mode signals indicative of at least some of the modes and the first checker circuit having logic circuitry coupled to the input lines to detect mode transitions between the modes and activate the first checker output upon detection of a mode transition contrary to a permitted transition policy for the logic circuitry; and a second checker circuit having a second checker output coupled to the security violation handler, the second checker circuit having second input lines for receiving mode signals indicative of at least some of the modes, the second checker circuit further having third input lines for receiving the address signals, and the second checker circuit having second logic circuitry responsive to the mode signals and to the address signals to identify attempted transactions of different modes and activate the second checker output upon detection of an attempted transaction including an address and a mode contrary to a permitted transaction policy for the second logic circuitry.

Other forms of the invention involving processes of manufacture, processes of operation, circuits, devices, telecommunications products, wireless handsets and systems are disclosed and claimed.

### BRIEF DESCRIPTION OF THE DRAWINGS

FIG. 1 is a pictorial diagram of a communications system including system blocks, for example a cellular base station, a WLAN AP (wireless local area network access point), a WLAN gateway, a personal computer, a set top box and television unit, and two cellular telephone handsets, any one, some or all of the foregoing improved according to the invention.

FIG. 2 is a block diagram of inventive integrated circuit chips for use in the blocks of the communications system of FIG. 1.

FIG. 3 is a diagram of inventive operational layers and structures for compartmentalizing real-time operations from certain public and secure operations.

FIG. 4 is a diagram of an inventive compartmentalized process to support the layers and structures of FIG. 3.

FIG. 5 a diagram of an inventive process of a hypervisor monitor mode mediating transitions between various modes.

FIG. 6 is a diagram of the inventive compartmentalized process from a different perspective from that of FIG. 4 and governed by a hypervisor monitor mode.

FIG. 7 is diagram of address spaces controlled by a Public MMU and a Secure MMU in an inventive system.

FIG. 8 is a block diagram of an inventive combination of a microprocessor unit (MPU) and target hardware together with and protected by inventive security hardware (SSM) and inventive target firewall circuits.

FIGS. 9A and 9B are two halves of a block diagram showing a detail of inventive security hardware (SSM), and other inventive blocks in FIG. 8 in further detail.

FIGS. 10A and 10B are two halves of a flow diagram of an inventive CPSR Mode Checker and NS Bit Enforcement circuit of FIG. 9.

FIG. 11 is a block diagram related to FIGS. 8 and 9 and highlighting an inventive SSM Physical Checker circuit and related registers.

FIG. 12 is a flow diagram of an inventive process and structure for generating an MreqSystem qualifier for differentiating modes to be compartmentalized.

FIG. 13 is a flow diagram of an inventive process and structure for checking bus physical addresses by the Physical Checker circuit of FIG. 11.

FIG. 14 is a flow diagram of an inventive process and structure for checking instruction bus physical addresses in FIG. 13.

FIG. 15 is a flow diagram of an inventive process and structure for checking read data bus and write data bus physical addresses in FIG. 13 relative to various contexts.

FIG. 16 is a block diagram related to FIGS. 8 and 9 and highlighting an inventive SSM Virtual Checker circuit and related registers.

FIG. 17 is a flow diagram of an inventive process and structure for checking virtual addresses by the Virtual Checker circuit of FIG. 16.

FIG. 18 is a block diagram of an inventive combination of MPU and target hardware protected by an inventive security hardware (SSM) of FIGS. 8 and 9 and inventive target firewall circuits.

FIG. 19 is a block diagram related to FIG. 9 and highlighting an inventive Interrupt Handler and inventive Secure FIQ Pre-emptive Masking Handler with related registers.

FIG. 20 is a block diagram of an inventive DMA Access Properties Firewall for use in the system of FIG. 18.

FIG. 21 is a partially block, partially hierarchical, diagram for showing an inventive structure and process of the DMA Access Properties Firewall of FIG. 20.

FIG. 22 is a flow diagram for showing an inventive process and structure of the DMA Access Properties Firewall of FIG. 20 and for other firewalls in FIGS. 9 and 18.

FIG. 23 is a schematic diagram of inventive circuitry for address checking, use of classifier signals and issuing security violation signals such as for firewalls in FIGS. 9, 18 and 20.

FIG. 24 is a block diagram of an inventive Secure Privilege Stack Firewall and an inventive Monitor Stack Firewall with related registers for use in the circuitry of FIG. 9.

FIGS. 25A and 25B are two halves of a block diagram of an inventive Instruction Bus Firewall and an inventive Monitor Mode Data Firewall with related registers for use in the circuitry of FIG. 9.

FIG. 26 is a block diagram of an inventive security zone static configuration enforcement block and related fields in a Firewall Controller register for use in the circuitry of FIG. 9.

FIG. 27 is a block diagram of an inventive Platform events and configuration handler with related registers for use in the circuitry of FIG. 9.

FIGS. 28A and 28B are two halves of a block diagram of an inventive Security Violation handler with related registers for use in the circuitry of FIG. 9.

FIG. 29 is a partially block, partially flow diagram an inventive process of Monitor code, vectors and transitions and related to FIG. 5.

FIG. 30 is a block diagram of an inventive Debug section with related registers and in-circuit emulator for use in the circuitry of FIG. 9.

FIGS. 31A and 31B are two halves of a block diagram of an inventive Trace instruction bus firewall and inventive Trace data bus firewall and related registers and a Trace block and related to FIG. 9.

FIG. 32 is a block diagram of inventive dual-CPU hardware and software for dual core operation.

FIG. 33 is a block diagram of inventive four-CPU hardware and software for four-core operation.

FIGS. 34A and 34B are upper and lower halves of a more detailed block diagram of inventive four-CPU hardware and associated inventive hardware-support for an inventive hypervisor process for the inventive four-core system.

FIG. 35 is a timing diagram of an inventive process of digital signal transitions of an inventive system including master counter, and of four CPUs in an inventive four-CPU system such as in FIGS. 34A/34B and 38A/38B, and showing interspersed interrupt signal transitions for various CPUs and types of operating systems for them.

FIG. 36 is an interrupt priority diagram for an inventive Generalized Interrupt Handler (GIC) and its inventive process of operation.

FIG. 37 is a partially-block, partially process diagram of inventive secure monitoring hardware (SSM) and inventive Monitor Mode processing.

FIGS. 38A-38F are six portions of a composite block diagram of inventive four-CPU hardware and associated inventive hardware-support for an inventive hypervisor process for the inventive four-core system.

FIG. 39 is a flow diagram of an inventive process of manufacturing one or more integrated circuits, devices and systems of the foregoing Figures.

Corresponding numerals indicate corresponding parts throughout the Figures of drawing, except where the context indicates otherwise. If a signal name or register field designation is expressed in all caps, title case, or lower case in different places in the drawing and description, the same signal or register field is signified unless the context indicates otherwise.

### DETAILED DESCRIPTION OF EMBODIMENTS

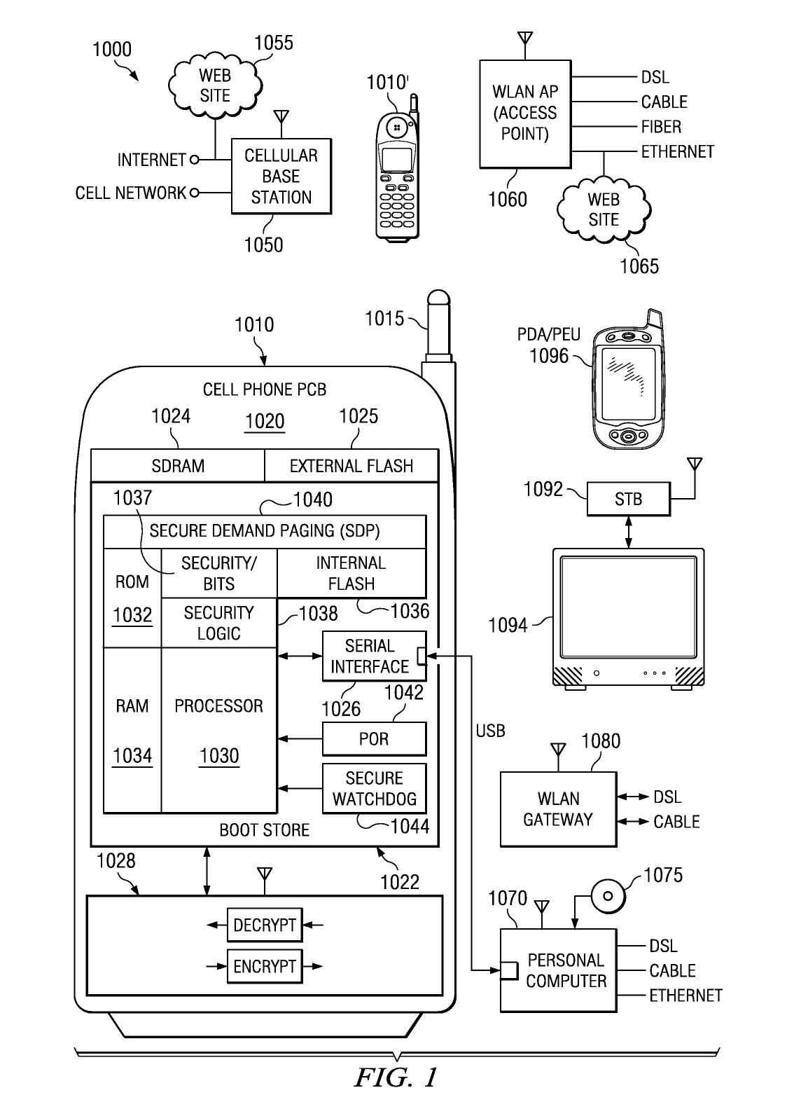

In FIG. 1, an improved communications system 1000 has system blocks as described next. Any or all of the system blocks, such as cellular mobile telephone and data handsets 1010 and 1010′, a cellular (telephony and data) base station 1050, a WLAN AP (wireless local area network access point, IEEE 802.11 or otherwise) 1060, a Voice WLAN gateway 1080 with user voice over packet telephone 1085 (not shown), and a voice enabled personal computer (PC) 1070 with another user voice over packet telephone (not shown), communicate with each other in communications system 1000. Each of the system blocks 1010, 1010′, 1050, 1060, 1070, 1080 are provided with one or more PHY physical layer blocks and interfaces as selected by the skilled worker in various products, for DSL (digital subscriber line broadband over twisted pair copper infrastructure), cable (DOCSIS and other forms of coaxial cable broadband communications), premises power wiring, fiber (fiber optic cable to premises), and Ethernet wideband network. Cellular base station 1050 two-way communicates with the handsets 1010, 1010′, with the Internet, with cellular communications networks and with PSTN (public switched telephone network).

In this way, advanced networking capability for services, software, and content, such as cellular telephony and data, audio, music, voice, video, e-mail, gaming, security, e-commerce, file transfer and other data services, internet, world wide web browsing, TCP/IP (transmission control protocol/Internet protocol), voice over packet and voice over Internet protocol (VoP/VoIP), and other services accommodates and provides security for secure utilization and entertainment appropriate to the just-listed and other particular applications.

The embodiments, applications and system blocks disclosed herein are suitably implemented in fixed, portable, mobile, automotive, seaborne, and airborne, communications, control, set top box 1090, television 1044 (receiver or two-way TV), and other apparatus. The personal computer (PC) 1070 is suitably implemented in any form factor such as desktop, laptop, palmtop, organizer, mobile phone handset, PDA personal digital assistant 1096, internet appliance, wearable computer, content player, personal area network, or other type.

For example, handset 1010 is improved for selectively determinable security and economy when manufactured. Handset 1010 remains interoperable and able to communicate with all other similarly improved and unimproved system blocks of communications system 1000. On a cell phone printed circuit board (PCB) 1020 in handset 1010, there is provided a higher-security processor integrated circuit 1022, an external flash memory 1025 and SDRAM 1024, and a serial interface 1026. Serial interface 1026 is suitably a wireline interface, such as a USB interface connected by a USB line to the personal computer 1070 and magnetic and/or optical media 1075 when the user desires and for reception of software intercommunication and updating of information between the personal computer 1070 (or other originating sources external to the handset 1010) and the handset 1010. Such intercommunication and updating also occur via a processor in the cell phone 1010 itself such as for cellular modem, WLAN, Bluetooth from a website 1055 or 1065, or other wireless or wireline modem processor and physical layer (PHY) circuitry 1028.

Processor integrated circuit 1022 includes at least one processor (or central processing unit CPU) block 1030 coupled to an internal (on-chip read-only memory) ROM 1032, an internal (on-chip random access memory) RAM 1034, and an internal (on-chip) flash memory 1036. A security logic circuit 1038 is coupled to secure-or-general-purpose-identification value (Security/GPI) bits 1037 of a non-volatile one-time alterable Production ID register or array of electronic fuses (E-Fuses). Depending on the Security/GPI bits, boot code residing in ROM 1032 responds differently to a Power-On Reset (POR) circuit 1042 and to a secure watchdog circuit 1044 coupled to processor 1030. A device-unique security key is suitably also provided in the E-fuses or downloaded to other non-volatile, difficult-to-alter parts of the cell phone unit 1010.

The words “internal” and “external” as applied to a circuit or chip respectively refer to being on-chip or off-chip of the applications processor chip 1022. All items are assumed to be internal to an apparatus (such as a handset, base station, access point, gateway, PC, or other apparatus) except where the words “external to” are used with the name of the apparatus, such as “external to the handset.”

ROM 1032 provides a boot storage having boot code that is executable in at least one type of boot sequence. One or more of RAM 1034, internal flash 1036, and external flash 1024 are also suitably used to supplement ROM 1032 for boot storage purposes.

Secure Demand Paging SDP circuitry 1040 effectively multiplies the memory space that secure applications can occupy. Processor 1030 is an example of circuitry coupled to the Secure Demand Paging block 1040 to execute a process defined by securely stored code and data from a Secure RAM 1034 as if the secure RAM were much larger by using SDRAM 1024. As described further herein SDP Circuitry 1040 includes circuitry for determining which secure RAM memory page to wipe, or make available for a new page of code and/or data for a secure application.

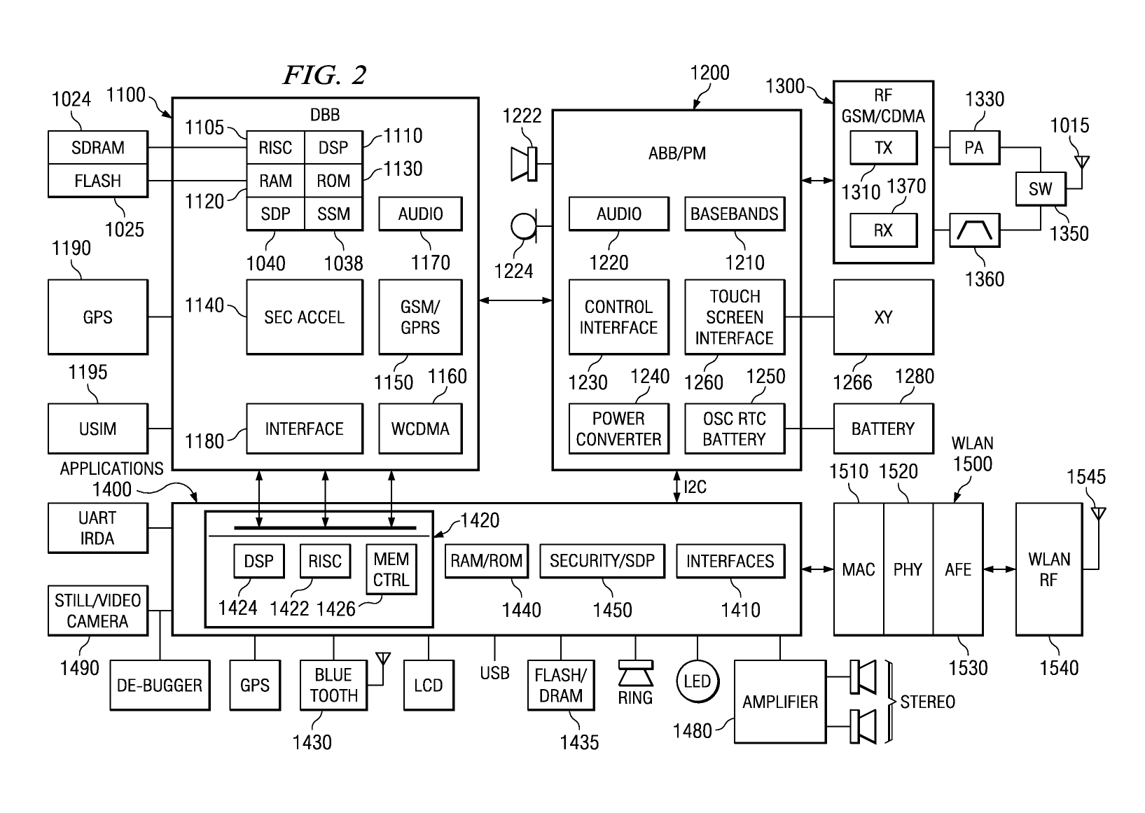

FIG. 2 illustrates inventive integrated circuit chips including chips 1100, 1200, 1300, 1400, 1500 for use in the blocks of the communications system 1000 of FIG. 1. The skilled worker uses and adapts the integrated circuits to the particular parts of the communications system 1000 as appropriate to the functions intended. For conciseness of description, the integrated circuits are described with particular reference to use of all of them in the cellular telephone handsets 1010 and 1010′ by way of example.

It is contemplated that the skilled worker uses each of the integrated circuits shown in FIG. 2, or such selection from the complement of blocks therein provided into appropriate other integrated circuit chips, or provided into one single integrated circuit chip, in a manner optimally combined or partitioned between the chips, to the extent needed by any of the applications supported by the cellular telephone base station 1050, personal computer(s) 1070 equipped with WLAN, WLAN access point 1060 and Voice WLAN gateway 1080, as well as cellular telephones, radios and televisions, Internet audio/video content players, fixed and portable entertainment units, routers, pagers, personal digital assistants (PDA), organizers, scanners, faxes, copiers, household appliances, office appliances, microcontrollers coupled to controlled mechanisms for fixed, mobile, personal, robotic and/or automotive use, combinations thereof, and other application products now known or hereafter devised in which there is desired increased, partitioned or selectively determinable advantages next described.

In FIG. 2, an integrated circuit 1100 includes a digital baseband (DBB) block 1110 that has a RISC processor 1105 (such as MIPS core(s), ARM core(s), or other suitable processor) and a digital signal processor 1110 such as from the TMS320C55x™ DSP generation from Texas Instruments Incorporated or other digital signal processor (or DSP core) 1110, communications software and security software for any such processor or core, security accelerators 1140, and a memory controller. Security accelerators block 1140 provide additional computing power such as for hashing and encryption that are accessible, for instance, when the integrated circuit 1100 is operated in a security level enabling the security accelerators block 1140 and affording types of access to the security accelerators depending on the security level and/or security mode. The memory controller interfaces the RISC core 1105 and the DSP core 1110 to Flash memory 1025 and SDRAM 1024 (synchronous dynamic random access memory). On chip RAM 1120 and on-chip ROM 1130 also are accessible to the processors 1110 for providing sequences of software instructions and data thereto. A security logic circuit 1038 of FIGS. 1 and 2 has a secure state machine (SSM) to provide hardware monitoring of any tampering with security features. Secure Demand Paging (SDP) circuit 1040 of FIGS. 1 and 2 is provided.

Digital circuitry 1150 on integrated circuit 1100 supports and provides wireless interfaces for any one or more of GSM, GPRS, EDGE, UMTS, and OFDMA/MIMO (Global System for Mobile communications, General Packet Radio Service, Enhanced Data Rates for Global Evolution, Universal Mobile Telecommunications System, Orthogonal Frequency Division Multiple Access and Multiple Input Multiple Output Antennas) wireless, with or without high speed digital data service, via an analog baseband chip 1200 and GSM/CDMA transmit/receive chip 1300. Digital circuitry 1150 includes a ciphering processor CRYPT for GSM ciphering and/or other encryption/decryption purposes. Blocks TPU (Time Processing Unit real-time sequencer), TSP (Time Serial Port), GEA (GPRS Encryption Algorithm block for ciphering at LLC logical link layer), RIF (Radio Interface), and SPI (Serial Port Interface) are included in digital circuitry 1150.

Digital circuitry 1160 provides codec for CDMA (Code Division Multiple Access), CDMA2000, and/or WCDMA (wideband CDMA or UMTS) wireless suitably with HSDPA/HSUPA (High Speed Downlink Packet Access, High Speed Uplink Packet Access) (or 1×EV-DV, 1×EV-DO or 3×EV-DV) data feature via the analog baseband chip 1200 and RF GSM/CDMA chip 1300. Digital circuitry 1160 includes blocks MRC (maximal ratio combiner for multipath symbol combining), ENC (encryption/decryption), RX (downlink receive channel decoding, de-interleaving, viterbi decoding and turbo decoding) and TX (uplink transmit convolutional encoding, turbo encoding, interleaving and channelizing.). Block ENC has blocks for uplink and downlink processes of WCDMA.

Audio/voice block 1170 supports audio and voice functions and interfacing. Speech/voice codec(s) are suitably provided in memory space in audio/voice block 1170 for processing by processor(s) 1110. An applications interface block 1180 couples the digital baseband chip 1100 to an applications processor 1400. Also, a serial interface in block 1180 interfaces from parallel digital busses on chip 1100 to USB (Universal Serial Bus) of PC (personal computer) 1070. The serial interface includes UARTs (universal asynchronous receiver/transmitter circuit) for performing the conversion of data between parallel and serial lines. Chip 1100 is coupled to location-determining circuitry 1190 for GPS (Global Positioning System). Chip 1100 is also coupled to a USIM (UMTS Subscriber Identity Module) 1195 or other SIM for user insertion of an identifying plastic card, or other storage element, or for sensing biometric information to identify the user and activate features.

In FIG. 2, a mixed-signal integrated circuit 1200 includes an analog baseband (ABB) block 1210 for GSM/GPRS/EDGE/UMTS/HSDPA/HSUPA which includes SPI (Serial Port Interface), digital-to-analog/analog-to-digital conversion DAC/ADC block, and RF (radio frequency) Control pertaining to GSM/GPRS/EDGE/UMTS/HSDPA/HSUPA and coupled to RF (GSM etc.) chip 1300. Block 1210 suitably provides an analogous ABB for CDMA wireless and any associated 1×EV-DV, 1×EV-DO or 3×EV-DV data and/or voice with its respective SPI (Serial Port Interface), digital-to-analog conversion DAC/ADC block, and RF Control pertaining to CDMA and coupled to RF (CDMA) chip 1300.

An audio block 1220 has audio I/O (input/output) circuits to a speaker 1222, a microphone 1224, and headphones (not shown). Audio block 1220 has an analog-to-digital converter (ADC) coupled to the voice codec and a stereo DAC (digital to analog converter) for a signal path to the baseband block 1210 including audio/voice block 1170, and with suitable encryption/decryption activated.

A control interface 1230 has a primary host interface (I/F) and a secondary host interface to DBB-related integrated circuit 1100 of FIG. 2 for the respective GSM and CDMA paths. The integrated circuit 1200 is also interfaced to an I2C port of applications processor chip 1400 of FIG. 2. Control interface 1230 is also coupled via circuitry to the interfaces in circuits 1250 and the baseband 1210.

A power conversion block 1240 includes buck voltage conversion circuitry for DC-to-DC conversion, and low-dropout (LDO) voltage regulators for power management/sleep mode of respective parts of the chip regulated by the LDOs. Power conversion block 1240 provides information to and is responsive to a power control state machine between the power conversion block 1240 and circuits 1250.

Circuits 1250 provide oscillator circuitry for clocking chip 1200. The oscillators have frequencies determined by one or more crystals. Circuits 1250 include a RTC real time clock (time/date functions), general purpose I/O, a vibrator drive (supplement to cell phone ringing features), and a USB On-The-Go (OTG) transceiver. A touch screen interface 1260 is coupled to a touch screen XY 1266 off-chip.

Batteries such as a lithium-ion battery 1280 and backup battery provide power to the system and battery data to circuit 1250 on suitably provided separate lines from the battery pack. When needed, the battery 1280 also receives charging current from a Charge Controller in analog circuit 1250 which includes MADC (Monitoring ADC and analog input multiplexer such as for on-chip charging voltage and current, and battery voltage lines, and off-chip battery voltage, current, temperature) under control of the power control state machine.

In FIG. 2 an RF integrated circuit 1300 includes a GSM/GPRS/EDGE/UMTS/CDMA RF transmitter block 1310 supported by oscillator circuitry with off-chip crystal (not shown). Transmitter block 1310 is fed by baseband block 1210 of chip 1200. Transmitter block 1310 drives a dual band RF power amplifier (PA) 1330. On-chip voltage regulators maintain appropriate voltage under conditions of varying power usage. Off-chip switchplexer 1350 couples wireless antenna and switch circuitry to both the transmit portion 1310, 1330 and the receive portion next described. Switchplexer 1350 is coupled via band-pass filters 1360 to receiving LNAs (low noise amplifiers) for 850/900 MHz, 1800 MHz, 1900 MHz and other frequency bands as appropriate. Depending on the band in use, the output of LNAs couples to GSM/GPRS/EDGE/UMTS/CDMA demodulator 1370 to produce the I/Q or other outputs thereof (in-phase, quadrature) to the GSM/GPRS/EDGE/UMTS/CDMA baseband block 1210.

Further in FIG. 2, an integrated circuit chip or core 1400 is provided for applications processing and more off-chip peripherals. Chip (or core) 1400 has interface circuit 1410 including a high-speed WLAN 802.11a/b/g interface coupled to a WLAN chip 1500. Further provided on chip 1400 is an applications processing section 1420 which includes a RISC processor 1422 (such as MIPS core(s), ARM core(s), or other suitable processor), a digital signal processor (DSP) 1424 such as from the TMS320C55x™ DSP generation from Texas Instruments Incorporated or other digital signal processor, and a shared memory controller MEM CTRL 1426 with DMA (direct memory access), and a 2D (two-dimensional display) graphic accelerator. Speech/voice codec functionality is suitably processed in chip 1400, in chip 1100, or both chips 1400 and 1100.

The RISC processor 1420 and the DSP 1424 in section 1420 have access via an on-chip extended memory interface (EMIF/CF) to off-chip memory resources 1435 including as appropriate, mobile DDR (double data rate) DRAM, and flash memory of any of NAND Flash, NOR Flash, and Compact Flash. On chip 1400, the shared memory controller 1426 in circuitry 1420 interfaces the RISC processor 1420 and the DSP 1424 via an on-chip bus to on-chip memory 1440 with RAM and ROM. A 2D graphic accelerator is coupled to frame buffer internal SRAM (static random access memory) in block 1440. A security block 1450 in security logic 1038 of FIG. 1 includes an SSM analogous to SSM 1038, and includes secure hardware accelerators having security features and provided for secure demand paging 1040 as further described herein and for accelerating encryption and decryption. A random number generator RNG is provided in security block 1450. Among the Hash approaches are SHA-1 (Secured Hashing Algorithm), MD2 and MD5 (Message Digest version #). Among the symmetric approaches are DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard). Among the asymmetric approaches are RSA, DSA, DH, NTRU, and ECC (elliptic curve cryptography). The security features contemplated include any of the foregoing hardware and processes and/or any other known or yet to be devised security and/or hardware and encryption/decryption processes implemented in hardware or software.

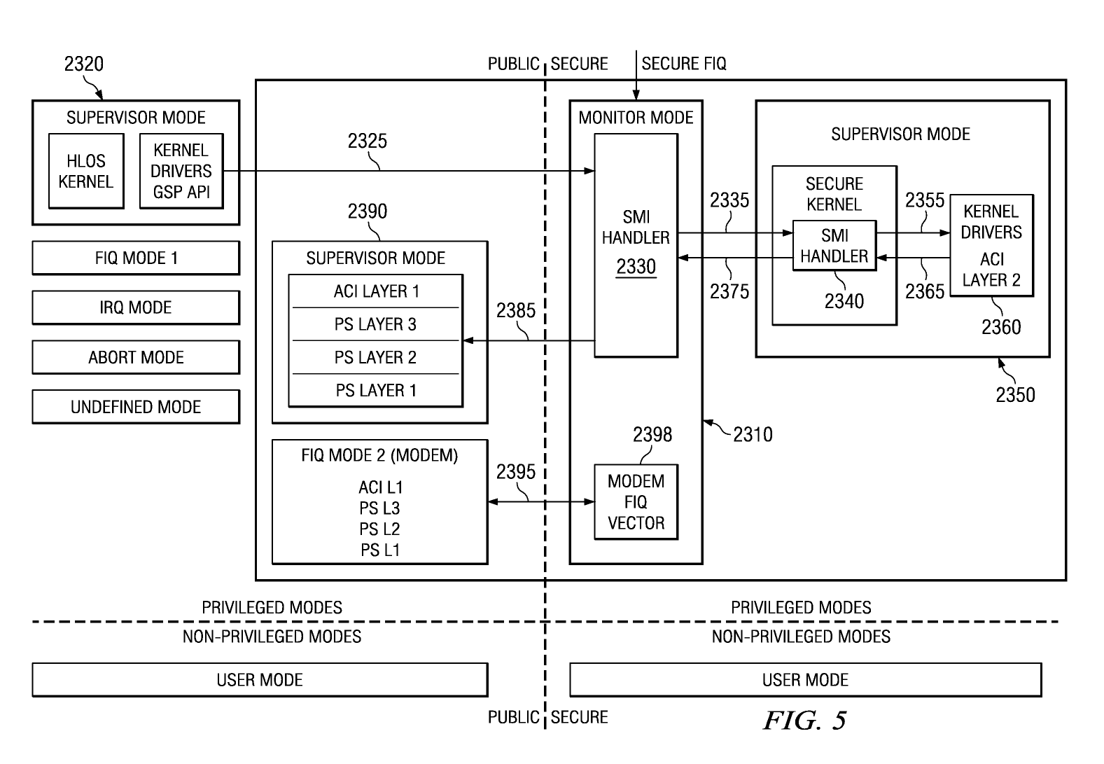

Security logic 1038 of FIG. 1 and FIG. 2 (1038, 1450) includes hardware-based protection circuitry, also called security monitoring logic or a secure state machine 2460 of FIG. 5, 6-9. Security logic 1038, (1450) is coupled to and monitors busses and other parts of the chip for security violations and protects and isolates the protected areas. Security logic 1038 (1450) makes secure ROM space inaccessible, makes secure RAM and register space inaccessible and establishes any other appropriate protections to additionally foster security. In one embodiment such a software jump from Flash memory 1025 (1435) to secure ROM, for instance, causes a security violation wherein, for example, the security logic 1038 (1450) produces an automatic immediate reset of the chip. In another embodiment, such a jump causes the security monitoring logic 1038, (1450) to produce an error message and a re-vectoring of the jump away from secure ROM. Other security violations would include attempted access to secure register or RAM space.

On-chip peripherals and additional interfaces 1410 include UART data interface and MCSI (Multi-Channel Serial Interface) voice wireless interface for an off-chip IEEE 802.15 (“Bluetooth” and low and high rate piconet and personal network communications) wireless circuit 1430. Debug messaging and serial interfacing are also available through the UART. A JTAG emulation interface couples to an off-chip emulator Debugger for test and debug. Further in peripherals 1410 are an 12C interface to analog baseband ABB chip 1200, and an interface to applications interface 1180 of integrated circuit chip 1100 having digital baseband DBB.

Interface 1410 includes a MCSI voice interface, a UART interface for controls, and a multi-channel buffered serial port (McBSP) for data. Timers, interrupt controller, and RTC (real time clock) circuitry are provided in chip 1400. Further in peripherals 1410 are a MicroWire (u-wire 4 channel serial port) and multi-channel buffered serial port (McBSP) to Audio codec, a touch-screen controller, and audio amplifier 1480 to stereo speakers. External audio content and touch screen (in/out) and LCD (liquid crystal display) and DLP™ (digital light processor) display are suitably provided. Additionally, an on-chip USB OTG interface couples to off-chip Host and Client devices. These USB communications are suitably directed outside handset 1010 such as to PC 1070 (personal computer) and/or from PC 1070 to update the handset 1010.

An on-chip UART/IrDA (infrared data) interface in interfaces 1410 couples to off-chip GPS (global positioning system block cooperating with or instead of GPS 1190) and Fast IrDA infrared wireless communications device. An interface provides EMT9 and Camera interfacing to one or more off-chip still cameras or video cameras 1490, and/or to a CMOS sensor of radiant energy. Such cameras and other apparatus all have additional processing performed with greater speed and efficiency in the cameras and apparatus and in mobile devices coupled to them with improvements as described herein. Further in FIG. 2, an on-chip LCD controller or DLP™ controller and associated PWL (Pulse-Width Light) block in interfaces 1410 are coupled to a color LCD display or DLP™ display and its LCD light controller off-chip and/or DLP™ digital light processor display.

Further, on-chip interfaces 1410 are respectively provided for off-chip keypad and GPIO (general purpose input/output). On-chip LPG (LED Pulse Generator) and PWT (Pulse-Width Tone) interfaces are respectively provided for off-chip LED and buzzer peripherals. On-chip MMC/SD multimedia and flash interfaces are provided for off-chip MMC Flash card, SD flash card and SDIO peripherals.

In FIG. 2, a WLAN integrated circuit 1500 includes MAC (media access controller) 1510, PHY (physical layer) 1520 and AFE (analog front end) 1530 for use in various WLAN and UMA (Unlicensed Mobile Access) modem applications. PHY 1520 includes blocks for Barker coding, CCK, and OFDM. PHY 1520 receives PHY Clocks from a clock generation block supplied with suitable off-chip host clock, such as at 13, 16.8, 19.2, 26, or 38.4 MHz. These clocks are compatible with cell phone systems and the host application is suitably a cell phone or any other end-application. AFE 1530 is coupled by receive (Rx), transmit (Tx) and CONTROL lines to WLAN RF circuitry 1540. WLAN RF 1540 includes a 2.4 GHz (and/or 5 GHz) direct conversion transceiver, or otherwise, and power amplifier and has low noise amplifier LNA in the receive path. Bandpass filtering couples WLAN RF 1540 to a WLAN antenna. In MAC 1510, Security circuitry supports any one or more of various encryption/decryption processes such as WEP (Wired Equivalent Privacy), RC4, TKIP, CKIP, WPA, AES (advanced encryption standard), 802.11i and others. Further in WLAN 1500, a processor comprised of an embedded CPU (central processing unit) is connected to internal RAM and ROM and coupled to provide QoS (Quality of Service) IEEE 802.11e operations WME, WSM, and PCF (packet control function). A security block in WLAN 1500 has busing for data in, data out, and controls interconnected with the CPU. Interface hardware and internal RAM in WLAN 1500 couples the CPU with interface 1410 of applications processor integrated circuit 1400 thereby providing an additional wireless interface for the system of FIG. 2. Still other additional wireless interfaces such as for wideband wireless such as IEEE 802.16 “WiMAX” mesh networking and other standards are suitably provided and coupled to the applications processor integrated circuit 1400 and other processors in the system.

Further described next are improved secure circuits, structures and processes and improved systems and devices for use in and with the systems of FIGS. 1 and 2 and all other systems to which their structures and processes commend their use.

In a type of embodiment, a hypervisor is established and copies virtually and non-virtually (normal) both the non-secure and secure worlds. The monitor mode is given hardware structural support called checker circuits or checkers to enable operation as a hypervisor. Security is protected from the public world side because the SSM (secure state machine) and the checkers are used together to establish one or more classifiers or classifier control signals. For example a classifier signal MreqSystem uniquely specifies virtual mode and non-virtual mode, and another classifier signal MreqSecure specifies secure mode and non-secure mode. Classifier signals are used collectively to specify combinations of virtual/non-virtual, secure/non-secure, and other modes. The hardware checker checks transactions and interrupts, and different access types. The Monitor mode operates as software on top of the checker hardware.

The hypervisor monitors which secure mode is being used and detects when a switch is happening from virtual mode to normal mode and insures the integrity of the architecture. Jumping between modes is mediated by the hypervisor instead of being permitted directly. Each time operations are to enter virtual mode or to leave virtual mode, the transition is arranged and structured to go through the Monitor mode as hypervisor under a specific process that is controlled by the SSM or is defined by SSM.

Added to that, the system has debug capability and trace controlled through SSM, so that blocks and functions that do not exist in the secure zone are put in the SSM outside the processor core. The SSM establishes the function of a secure zone to provide a minimum level of support for a variety of chips.

Some embodiments create virtual processors using an SSM-secured monitor mode acting as a hypervisor. Such architecture allows running in each of these virtual processors a complete operating system that is completely independent and isolated from any other operating system running in a different normal or virtual processor.

For example, in some embodiments a 3^{rd}/4^{th} generation (3G/4G) wireless modem Protocol Stack runs under a real time operating system (RTOS) and is desirably isolated from the application operating system. Application processor devices desirably execute on the same processor core (MPU) a real time 3G/4G Modem Protocol Stack (PS) and a Secure Kernel, as well as a High Level Operating System (HLOS) for handling applications. The HLOS need not be a real time operating system.

Establishing an RTOS and modem protocol stack (PS) under a hypervisor and independent of an application operating system like an HLOS, then enhances security and real time operational reliability and stability, and confers tamper-resistance against updating an IMEI number by some other application running under the HLOS.

Application operating systems are often not architected to be real time. Thus, a real-time modem protocol stack running independently of a non-real time operating system prevents and obviates latencies and possible crash scenarios. The modem protocol stack memories are given enhanced stability because the modem protocol stack is independent of the application operating system.

The modem protocol stack is made HLOS-agnostic thanks to the monitor mode hypervisor and improved secure state machine (SSM) and checkers while providing strong timing accuracy for a protocol stack interrupt model and providing a hardware-ensured high priority fast interrupt request FIQ. Protocol stack activity benefits from complete hardware isolation from HLOS, for improved security and stability of the protocol stack. The improved interrupt model is agnostic to HLOS behavior and is timing accurate and predictable. High portability with other HLOS means that the same hardware design can be used with different HLOS, thereby reducing costs of designing products.

An example of a hardware mechanism includes a physical to virtual memory space checker. Some background information is described in incorporated patent application TI-61407. The checker is added and used according to the teachings herein to detect when the processor core is developing and evolving the virtual cores memory space. The hardware mechanism checks different MPU core current status program register (CPSR) mode transitions to determine if the current processor state is allowed to be entered in order to detect any processor mode hijacking. Some background information is described in incorporated patent application TI-39616. In addition the proposed solution checks the current MMU configuration in order to detect any malformed or corrupted MMU configuration. Some background information is described in incorporated patent application TI-39613.

The improved secure state machine hardware issues bits or information signals to structure the environment for the software hypervisor and checkers. The hypervisor determines each particular type of processor core (normal or virtual; secure or public) it operates or determines shall operate.

When the processor MPU is detected to be evolving in a virtual core, a qualifier MreqSystem together with hardware security infrastructure differentiates processor core transactions belonging to the non-virtual processor or virtual processor through different hardware firewall stages. Some background information is described in incorporated patent application TI-38804.

Secure fast interrupts (Secure FIQ) pre-emptive masking technology is combined herein with the MreqSystem hardware security infrastructure and hypervisor to give real time properties to each virtual processor core, if needed. The Secure FIQ identifies the source of each interrupt by classifier states, e.g., normal or virtual processor core, and by other classifiers or qualifiers.

A DMA (direct memory access) component supports and is used by one or more of the operating systems. The MreqSystem classifier is added and provided as a qualifier for a DMA transaction issued when the MPU is evolving a virtual processor core in the secure mode. Some background is described in incorporated patent application TI-39615.

Some hardware-based embodiments offer simplicity, a high level of security, resistance to software attacks and real time properties through FIQ to the modem protocol stack. Processor core caches and MMU are used efficiently while promoting very fast processing on each virtual and normal processor core context switch. As many virtual processor cores as needed are implemented in various embodiments. Two or more operating systems suitably co-exist on a given platform.

The Monitor Mode operation is hardware-checked, and Monitor Mode integrity is structured and preserved by physical address checking and virtual address checking coupled with execution status integrity checking and one or more hardware firewalls. Resistance to and prevention of buffer overflow attacks is provided and enhanced. Integrity of the security zone run-time configuration including MMU mapping and exception base vectors is protected. A dynamic hardware firewall protects Secure Privilege modes against buffer overflow attacks. Secure Privilege mode and User mode can fetch in a protectively regulated and structured manner from Secure RAM, Secure ROM and Secure Stacked SDRAM. Various modes are protected against fetching instructions in disallowed memory. Secure RAM and Secure ROM are hardware-protected from disallowed accesses. Secure Stacked SDRAM programmably establishes secure regions for virtual processors.

Inconsistency in MMU configuration is detected by monitoring for an attempt to fetch non-secure code in spaces reserved for secure mode access. Secure Privilege Debug Mode is protected against the Secure User Debug Mode. Virtual Processor modes are created, resource-isolated and MMU mapped. Attempted access by one virtual processor into the stack of another virtual processor is monitored and restricted or prevented.

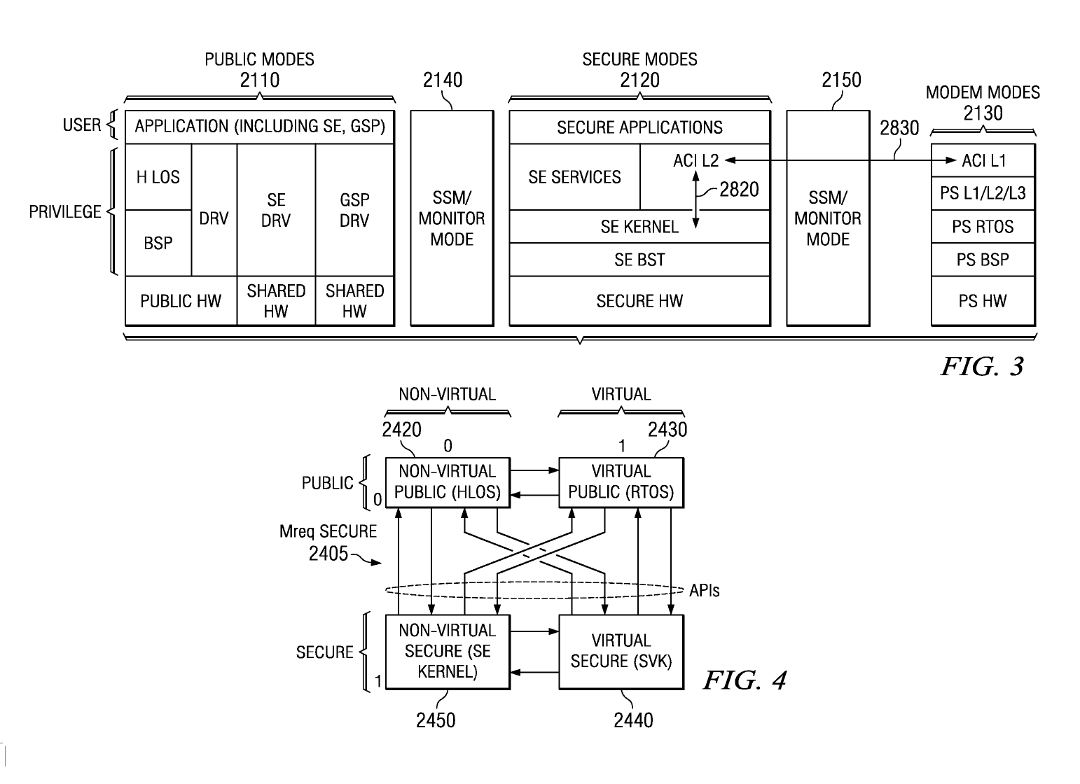

In FIG. 3, an example of hardware-supported hypervisor provides three virtual processors or resources: Public 2110, Secure 2120, and Modem 2130. Switching between each processor is made through a low latency SSM-supported monitor mode structured to act as a hypervisor and shown as two protective processing structures 2140 and 2150. Switching between Public resources 2110 and modem resources 2130 is done through the secure processor 2120 exclusively in this example. The Modem processor 2130 and Secure virtual processor 2120 preempt any public activity (IRQ/FIQ) inconsistent with their hardware security requirements, thereby guaranteeing integrity of the RTOS (real time operating system) and modem hardware properties.

In FIG. 3, from left to right, the worlds of the three processors 2110, 2120, 2130 are separated and protected by Monitor Mode structures 2140 and 2150. The Public, non-virtual processor 2110 has applications APP accessible in a non-privileged User mode in the upper layer. These applications are accessible even if they include calls to a secure environment (SE) and/or a modem process GSP. Privilege modes are occupied by a Public HLOS (high level operating system), by a board support package (BSP), and by a secure environment driver, a GSP driver or modem driver and other drivers DRV. Public hardware (HW) and shared Public/secure hardware are accessible in non-secure (public) mode. Public modes such as User mode, as well as Privileged modes can access resources 2110. Supervisor, IRQ, FIQ, Undef Undefined Exception, and Abort mode can access resources 2110.

In the secure resources 2120 of FIG. 3, reside Secure Applications, Secure Environment (SE) Services, SE Kernel, modem commands called AT Command Interface (ACI) Layer 2 (L2) coupled to SE Kernel, SE BSP, and Secure Hardware such as encryption/decryption accelerators and random number generator RNG. Only Secure modes are permitted to access resources 2120. Supervisor/System, FIQ, Undef, Abort, and secure User mode can access resources 2120.

The resources 2130 of FIG. 3 have real-time operations, also called modem modes in a telecommunications context herein. Protocol stack (PS) layers there include modules or entities which are running as OS tasks. These OS tasks communicate using messages via queues. The modem GSP API is used to support and provide the messaging services to the PS and a modem AT Command Interface (ACI) and to abstract from different operating systems the PS can run on. Communication with the application layer is performed in a manner depending on the hardware and operation system arrangements, such as one OS for Apps and PS, or different OS for Apps and PS, and using single processor hardware core or plural processor hardware cores. A secure driver for the PS is used to access IMEI (International Mobile Extended Identification) data and SIMlock (Subscriber Identification Module) data.

The real-time resources 2130 has layers including ACI L1, PS L1/L2/L3, PS RTOS, PS BSP. PS hardware (HW) supports the layers of resources of resources 2130. Modem command interface ACI L1 is coupled via the Monitor Mode protective interface process 2150 to ACI L2. In the example of FIG. 3, access to the real-time modes is provided for processor modes called Supervisor, FIQ, and Abort.

By contrast with the real-time RTOS and modem, for instance, the non-real-time HLOS and its applications do not expect to be scheduled real-time-accurately, and can wait their turn to execute. The non-real-time HLOS and its applications are therefore expected to be negligibly affected or unaffected by introduction of the embodiments taught herein. On the other hand, in a modem if server sync is not done in time, then a server at a wireless base station or a wireline central site can issue a time-out signal and break the communications protocol activity (phone call for example). Then a restart of the communication becomes introduced. At least some of the embodiments herein confront or ameliorate or prevent scenarios wherein the phone user might experience a bad transmission followed by a call interruption or unexpected crash. These undesirable event scenarios might happen if HLOS over-schedules multiple applications (display+file system+MMU allocation) at the wrong moment with IRQ and FIQ unmasked and misses a modem L1 Protocol Stack interrupt IRQ. Another undesirable situation might involve some non-synchronized timers or non-synchronized peripherals firing concurrently and creating many pending interrupts, and in some interrupt mode of HLOS IRQ/FIQ, the modem interrupts might be masked so that a call interruption does not occur or is not taken in time.

In some embodiments, multiple virtual processors reside inside the same category or world. By context-switching fully the MMU and processor registers, such embodiment places or accommodates as many different HLOS as desired. The MreqSystem qualifier is generated when operating in a virtual category in order for system interconnect firewalls to protect memories from other categories. Consequently for a complete and robust security scheme, some embodiments generate qualifiers to identify as many virtual processors as needed (MreqSystem1, MreqSystem2 . . . ). Some other embodiments provide HLOSes in a given single world (i.e., Virtual Public) that have exactly the same level of security where one HLOS cannot impact or is prevented from having any impact security-wise on any other HLOS.

In some other embodiments, the Monitor software code that acts as an hypervisor can configure the interconnect hardware firewalls to deny all accesses to one HLOS physical space while providing full access to other HLOSes when running in the same virtual world (other contexts described previously). The Monitor software code also configures the SSM hardware that supports the Monitor code as hypervisor to define new boundaries in accordance with this real-time resources protection configuration as well as the full MMU setting.

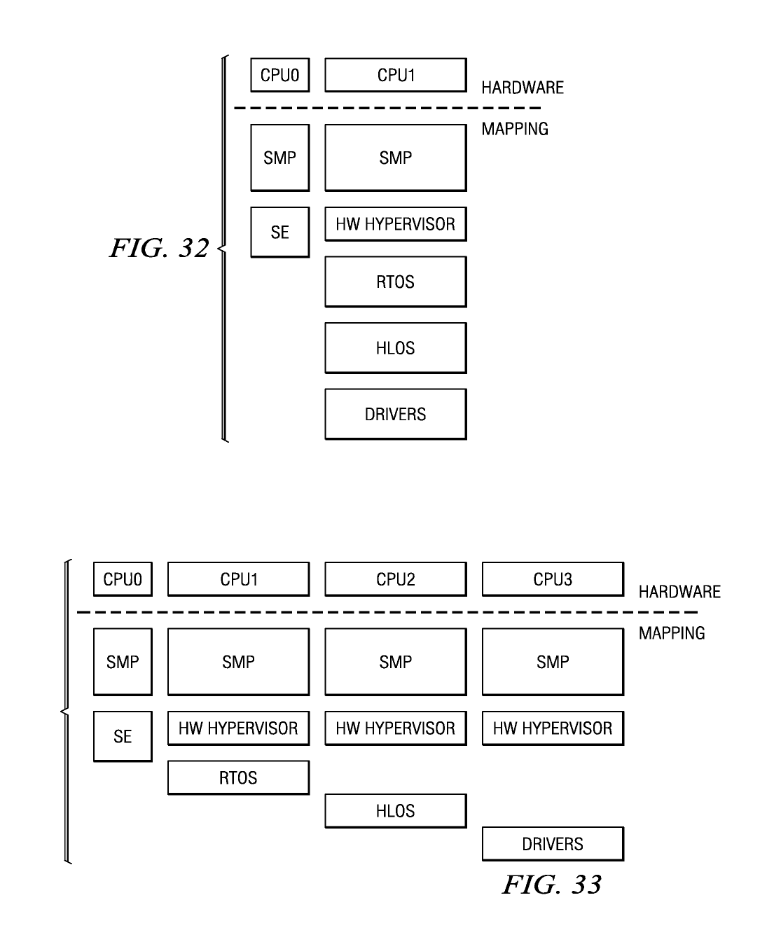

Multiple non-virtual processors suitably are made to reside inside the same Non-virtual world, e.g. Non-virtual Secure. Corresponding strategy is suitably used for the Non-virtual case as for a virtual category described just above herein. The virtual mode is created with the MreqSystem qualifier to provide strong security isolation between HLOS, RTOS and secure mode at system level. The Secure Virtual category is created or established by symmetry or analogously. There is no limit on how many virtual categories that are implemented (1 MreqSystem=>4 worlds as in FIG. 4; two (2) MreqSystem=>8 worlds , three (3) MreqSystem=>16 worlds (8 public, 8 secure)). In multi-core embodiments, see e.g. FIGS. 32-38F, these numbers apply to each CPU core and provide an extensive flexibility in establishing and organizing system embodiments herein.

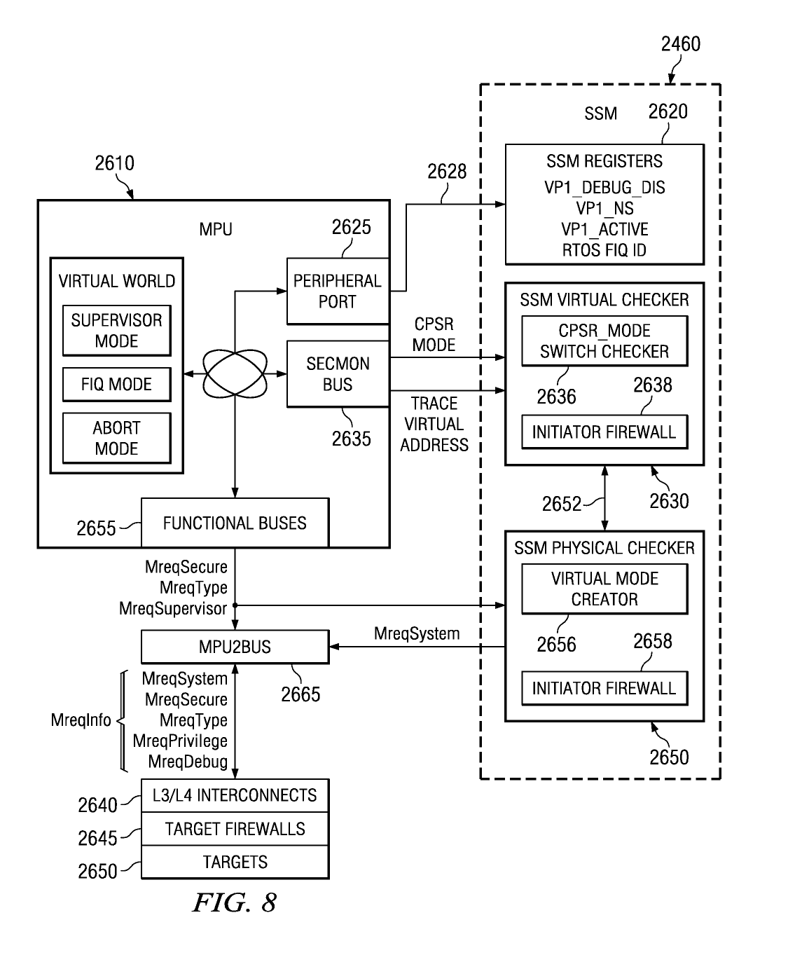

Refer briefly to FIG. 8. When in the secure mode, the processor MPU generates a bit CP15_NS=0 for an example on an ARM™ core. The SSM herein maintains an SSM register bit designated VP1_NS corresponding to CP15_NS. Any MMU page programming or any transfer retained in cache is marked with an NS qualifier equal to or responsive to CP15_NS. The NS qualifier bit is used thereafter to generate a protection signal HPROT[ ] on a line of a system bus. The MPU2BUS interface 2665 creates the actual signal designated MreqSecure=NOT(HPROT[ ]). In other words, the MreqSecure qualifier is the logical complement of the logically equal signals HPROT[ ], NS_qualifier, and CP15_NS.

The SSM 2460 provides bit fields VP1_NS and VP1_Active. The VP1_Active bit field defines whether operations are transitioning from Monitor mode to a Non-virtual or Virtual category (VP1_Active), and the VP1_NS bit field defines whether the transition is going to Secure or Public category. The SSM 2460 is provided with protective circuitry coupled to MPU 2610. The protective circuitry is operable to couple a first qualifier MreqSecure to a system bus via interface 2665. MreqSecure is responsive to a line from MPU 2610 signaling Secure mode. The field VP1_Active is an example of a register field in the protective circuitry that is coupled as a second qualifier MreqSystem to the bus. For instance, in the case of virtual processor VP1 in some embodiments represents whether the processor is in a particular category (e.g., Public Virtual assigned to a real-time virtual processor such as a modem) or not for a given access. The protective circuitry is responsive to a line from MPU 2610 indicating that Monitor Mode is active. The protective circuitry permits alteration of the SSM register field by MPU 2610 in the Monitor Mode or Secure Supervisor mode and prevents at least some such alteration when MPU 2610 is in some other mode. In some embodiments Monitor Mode or Secure Supervisor mode access is required for all such alteration and firewalls are programmed in Monitor Mode or Secure Supervisor mode as well therein.

A Virtual Core or Virtual Processor (VP1) here is compared with a Virtual Machine Context (VMC) in Secure Demand Paging SDP (see description elsewhere herein and background in incorporated application TI-38213). The virtual machine (VMC of SDP) virtualizes HLOS tasks such as applications in User mode, and this virtualization is applied, if desired, to some kernel services in Supervisor mode. But, in an example, the VMC of SDP in some embodiments virtualizes the SDP kernel itself, and in other embodiments does not virtualize SDP nor IRQ/FIQ/ABORT/UNDEF vector and code, nor the MMU mapping, nor the MPU 2610 complete core configuration (e.g., debug and all other properties). By contrast, some information about a virtualized core is or may be ported to establish a Virtual Processor (e.g., VP1 for modem) on MPU 2610.

In FIG. 4, the Hypervisor differentiates categories of operation using MreqSystem qualifiers to identify in which world operations are running and thereby protect data and code in any category of FIG. 4 from other categories using interconnect firewalls. The Hypervisor effectively controls MreqSystem through register field VP1_Active and provides a virtualization of a real-time DSP application applied to the MPU 2610 itself. This keeps track of DSP-level functions in the system and/or achieves a higher level of virtualization that extends to the core or processor level, as the teachings herein make possible.

Qualifiers MreqModem and MreqSystem mean the same thing at DMA level and interconnect level, but have somewhat distinctive meanings in some different embodiments. Let a first embodiment have a DSP (digital signal processor) separate from the MPU 2610 operating as a modem engine. The SSM hardware and interface 2665 then generate a signal MreqModem active to accompany attempted accesses by this modem engine DSP core. In a second embodiment, suppose the DSP core is absent and the modem engine is established as software on the MPU 2610 which in some embodiments is a RISC processor core and not a DSP core. For expressiveness of signal designations, the SSM hardware and interface 2665 then generate a signal designated MreqSystem active to accompany attempted accesses by this virtual modem engine running on the MPU 2610. The significance of MreqModem and MreqSystem are both the same farther out in the system in that a process (e.g., modem) is attempting an access.

A first embodiment has an application engine including a RISC core, system DMA, and dedicated peripherals. Coupled to the application engine is a Modem engine including a DSP plus modem DMA plus dedicated peripherals. Shared memory such as SDRAM and Flash memory and shared peripherals such as USB serial bus are coupled to both the application engine and the modem engine.

A second embodiment is similar to the first embodiment except that the modem engine is virtualized onto the RISC core and uses the same system DMA, but has modem-dedicated peripherals. The second embodiment has the modem engine run on the same core MPU 2610 with a modem RTOS using the same system DMA and co-existing with a Public HLOS. To deal with the constraints of the second embodiment, recreation of the two distinct engines (application and modem) is accomplished by effectively virtualizing the distinct engines onto the RISC core and system DMA. They are transformed into categories in FIG. 4.

The signal MreqModem is generated and used in the first embodiment (RISC plus DSP) so that both the Application engine and Modem engine (subsystems in general) have access to a large number of DMA channels and as much DMA as is desirable for each engine (in effect a combination of the system DMA and modem DMA. Using the MreqSystem (or MreqModem) differentiates the application engine from the modem engine for accessing or preventing access to peripherals reserved for the application engine or reserved for the modem engine, for instance. In the first embodiment, the DSP is dedicated to modem engine and the DSP is operated or provided with circuitry to assert MreqModem active to differentiate each DMA channel programmed by the modem engine (DSP) from each DMA channel programmed by the application engine (MPU 2610 core). In the second embodiment MreqSystem is similarly used, from an interconnect/DMA point of view, and this provides economical design of different system products with complementing advantages using a very similar methodology or architectural scheme as described herein.

In the first embodiment, MreqModem (MreqSystem) goes active when the Modem DSP attempts access to a peripheral instead of MPU 2610 and inactive when MPU 2610 attempts access. In the second embodiment, the real-time process represented by the DSP code is suitably modified and ported to be compiled and run as a virtualized modem engine, for example, on MPU 2610 such as a RISC processor. MreqSystem goes active when the virtualized real-time process (e.g., modem) thus ported to MPU 2610 attempts access to a peripheral, and inactive when the application engine attempts access.

The field VP1_Active when active in SSM registers 2620 signifies that MPU 2610 is in a Virtual category indicative of the modem for instance, so that the circuitry knows that it is in a Virtual world. The SSM register bit field VP1_NS is set equal to the Non-Secure/Secure bit CP15_NS described hereinabove. Bit field VP1_NS services an intermediate configuration state while in Monitor mode. For example, suppose CP15_NS=1 (context switching Public MMU) but operations are to go to a Secure category. VP1_NS provides a flag for Monitor Mode software. The Monitor code software structure sets, triggers and resets the bits CP15_NS and VP1_NS at different stages and times. An example architecture uses a Virtual Public category and an empty Virtual Secure category and consequently suitably provides only one set of banked registers for Virtual mode. These triggers are used also to select in the SSM address boundary checker register bank.

Logic circuitry of SSM responds to the bit field VP1_Active to generate the qualifier MreqSystem. The qualifier MreqSystem is a signal that accompanies or is attached to each transaction the MPU 2610 creates in the second embodiment (without physical DSP), and is the signal that accompanies or is attached to each transaction the DSP creates in the first embodiment that has DSP. Interconnect firewalls respond to qualifier MreqSystem to protect memories from accesses that are inconsistent with a currently operative category of operation.

In one group of embodiments a DSP with RTOS and real-time application(s) is virtualized onto a RISC processor that also runs non-real-time HLOS and non-real-time applications. In another group of embodiments a RISC processor with real-time application(s) is virtualized onto a DSP that also runs non-real-time HLOS and non-real-time applications. In still another group of embodiments, a RISC processor with a non-real-time HLOS and non-real-time applications(s) is virtualized onto a DSP that runs an RTOS and real-time application(s). In yet another group of embodiments, a DSP with non-real-time HLOS and non-real-time applications is virtualized onto a RISC processor that runs an RTOS and real-time application(s). In still other groups of embodiments, a first processor runs both an RTOS and HLOS and their applications is virtualized as a distinct virtual processor for system purposes onto a physical core MPU that runs both an RTOS and HLOS and their applications as a second virtualized processor maintained distinct from the RTOS, HLOS and applications of the first virtualized processor. Further groups of embodiments have the processors be physical (non-virtual) but provide MreqSystem qualifier(s) to indicate and identify to the system and to protective SSM hardware which physical processor is making an attempted access. Yet other groups of embodiments virtualize multiple distinct processors, as respective clusters of contexts identified to a virtual core, onto a physical core. Still other groups of embodiments include clusters of physical processors as in FIGS. 32-38B.

When one processor, e.g. real-time, is virtualized onto another processor (e.g., non-real-time, a single qualifier (e.g., MreqSystem) is suitably provided and has two states to respectively signify which of two virtualized processors are active. Thus, the inactive state of MreqSystem can indicate a virtualized processor distinct from the virtualized processor signified by the active state of MreqSystem. When more than one processor is virtualized onto another processor(s), then an MreqSystem qualifier is provided as a single field with more than two states to keep the virtual processors distinctly identified for hypervisor and system firewall purposes. Alternatively, multiple MreqSystem qualifiers are provided and represented by multiple fields or bits so that more than two states are analogously available to distinctly identify the virtual processors for hypervisor and system firewall purposes.

“GSP” herein is used as a software platform designator to refer collectively to a Modem, BSP with RTOS, ACI, Debug, Emulator, and Trace all together.

In FIG. 4, some categories of operation are defined as combinations of different modes Public and Secure and independently selectable modes Non-virtual and Virtual. A classifier signal MreqSecure determines whether a mode is Public or Secure. An additional classifier signal MreqSystem determines whether a mode is Non-virtual or Virtual. In this way a first category (00) is Non-virtual Public, a second category (01) is a Non-virtual Secure, a third category (10) is Virtual Public, and a fourth category (11) is Virtual Secure. Application port interfaces (APIs) in each category respond to a respective OS or kernel in each category to initiate transitions to another category.

In FIG. 4, the transitions are mediated and controlled by an SMI handler in the hypervisor or a Secure FIQ trap in the hypervisor. FIG. 4 is also conceived as a view downward by the hypervisor onto four exemplary categories, modes, or worlds of operation of the system.

In FIG. 5, modes are divided into four quadrants indicated by a vertical dotted line and a horizontal dotted line. A classifier MreqSecure divides Public modes on left from Secure modes on the right. An additional classifier MreqPrivilege divides Privileged modes from Non-privileged mode(s) such as User Mode lower in FIG. 5. In the operation of the Privileged modes, various transitions can occur in a structured manner as taught herein and shown as examples by arrows in FIG. 5. A software monitor interrupt SMI instruction makes a transition from a given mode to the Monitor Mode.

In FIG. 5, one transition example goes from Supervisor Public mode 2320 wherein the HLOS kernel activates the GSP API. See also area 2110 of FIG. 3. It should be understood that this particular example is but one of many examples that could be given for transitions between any pair of categories based on one or another API. In this particular example, suppose the user wants to place a cell phone call, which involves activating the modem. The GSP API asserts SMI and arrow 2325 represents transition to Monitor Mode 2310 in Secure environment and activation of an SMI handler 2330 process therein. Compare with section 2140 of FIG. 3. A transition 2335 in the Secure Environment of FIG. 5 now occurs from the SMI handler 2330 process in Monitor Mode 2310 to an SMI handler 2340 process in a Secure Supervisor mode 2350. The SMI handler 2340 process further transitions via arrow 2355 to a block 2360 for Kernel drivers and for a modem command ACI Layer 2, which is an AT command interface in area 2120 of FIG. 3 and enforced by a 3G network hardware firewall.

In FIG. 5, the transition 2355 activates modem command interface ACI L2, and operation of ACI L2 is completed in due course and then transitions by an arrow 2365 back to the SMI handler 2340 process. Operations of SMI handler 2340 further transition from Secure Supervisor mode via an arrow 2375 to the SMI handler 2330 process of Monitor Mode in the Secure environment. Compare with section 2150 of FIG. 3. The SMI handler 2330 process, in its turn, transitions via an arrow 2385 from Monitor Mode in the Secure environment to a Public Supervisor mode 2390. In some embodiments, the Public System mode is used for mode 2390. Thus, plural mode choices are usable, and optimization exist to minimize context switch latency if we atrophy and steal System mode from the Public HLOS world. Also, various embodiments use varying amounts or none of the RTOS kernel in mode 2390.

In Public Supervisor mode 2390 of FIG. 5, ACI Layer 1 is initiated and modem protocol stack PS Layers L3, L2, L1 are activated. Compare with section 2130 of FIG. 3. Modem operation occurs on a real-time basis and generates a fast interrupt request FIQ mode 2 (modem) related to ACI L1, or PS L3, L2, L1. Note that Modem FIQ is always trapped in this example into the Monitor Mode by action of Secure FIQ as further described elsewhere herein. A bi-directional arrow 2395 shows transitions each way between the Supervisor mode 2390 FIQ Mode 2 (modem) and Monitor mode 2310. A Modem FIQ vector 2398 delivers and provides FIQ Mode 2 dynamic creation in Monitor Mode. Compare with section 2150 and arrow 2830 of FIG. 3.

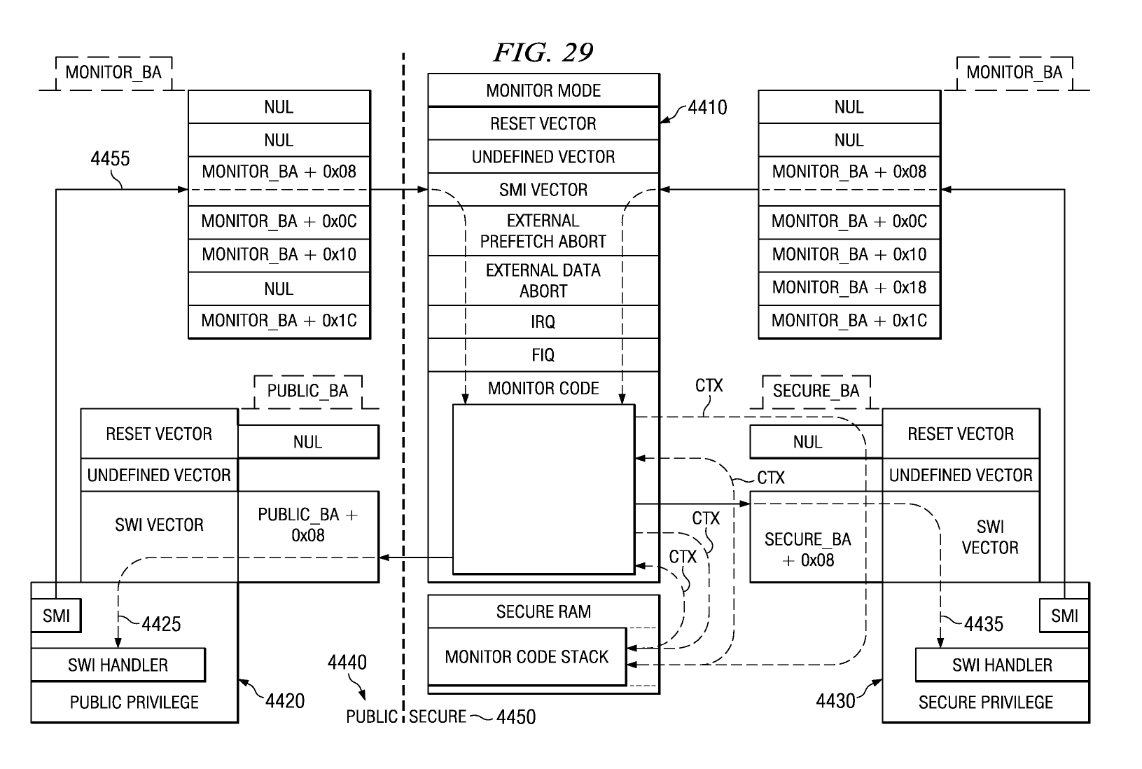

Examples of operation based on FIG. 5 in Public, Privileged modes are also indicated for a fast interrupt request FIQ Mode 1, an interrupt request IRQ mode, an Abort mode, and an Undefined (Undef) mode. Other process and structure embodiments such as those of FIG. 29 and TABLE 29 and TABLE 42 and description elsewhere herein can be compared with FIG. 5 and with each other.

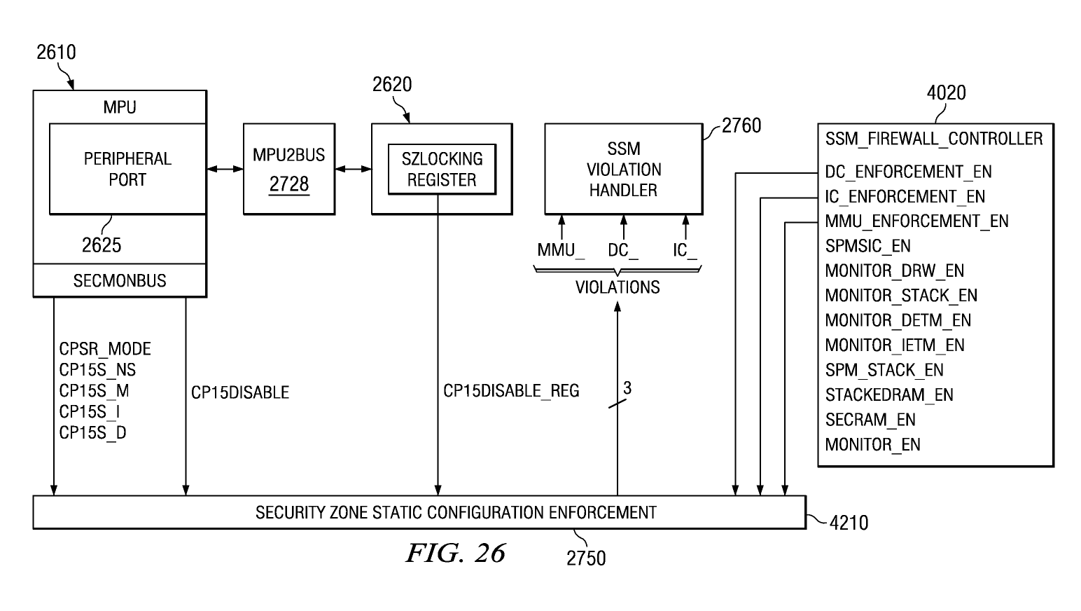

In some embodiments, the Virtual Public category 2430 (e.g., modem) generates one or more Secure FIQ even though secure environment SE Kernel generate Secure FIQ as well (but at other times). The SE Kernel is arranged non-interferingly so that the SE Kernel and its FIQ routine disables the FIQ masking (e.g. F bit) very rarely for only few clock cycles. And each time operations are in Monitor Mode before entering the Virtual Public category 2430, the Monitor code gives category 2430 (modem) the capability to disable the FIQ masking. FIQ masking capability is withheld from the Public Non-virtual category 2420 (for Public HLOS) because of the configuration of the security zone register (e.g., CP15S) and hardware enforcement thereof in FIG. 26. In other words, SE Kernel may have the capability to mask modem_FIQ but is coded so SE Kernel does not do such masking. Moreover, code in Virtual Public category 2430 (modem) can mask all FIQ when processing critical sections of modem code. Public HLOS cannot mask the Secure FIQ of either category 2430 nor 2450 (Modem or SE). In this way the modem runs in real time without interference. Some other embodiments provide dedicated modem FIQ and have the secure environment SE mask only public FIQ and secure FIQ but not the modem FIQ. In either type of embodiments, the modem virtual processor runs freely in real-time without interference from Secure FIQs from the SE Kernel in single core and multi-core examples as taught herein.

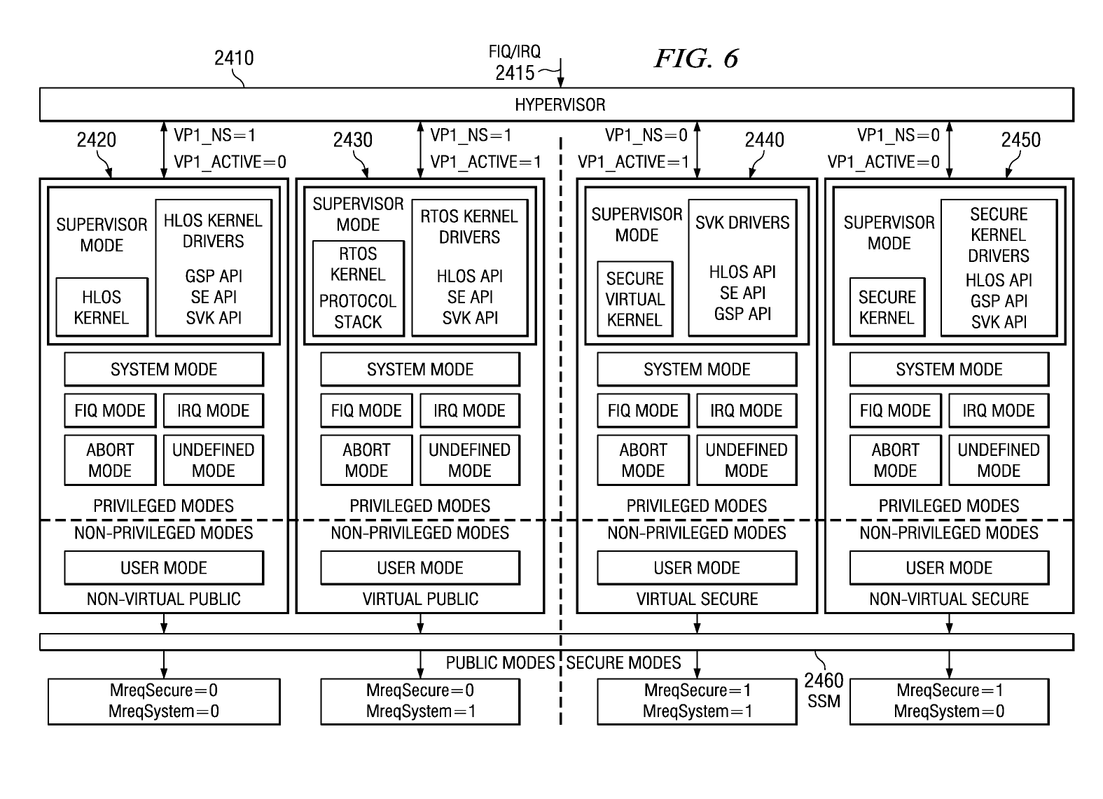

In FIG. 6, a SSM-supported processor core virtualization architecture switches between the different categories of FIG. 4 through the Monitor Mode which acts as an hypervisor 2410. FIG. 6 is conceived as a profile view of the categories of FIG. 4 viewed along a viewing direction 2405 and with the categories spread out from FIG. 4 into FIG. 6. The hypervisor is depicted above the categories. A viewing direction 2415 of FIG. 6 shows the direction of view for going from FIG. 6 to FIG. 4.

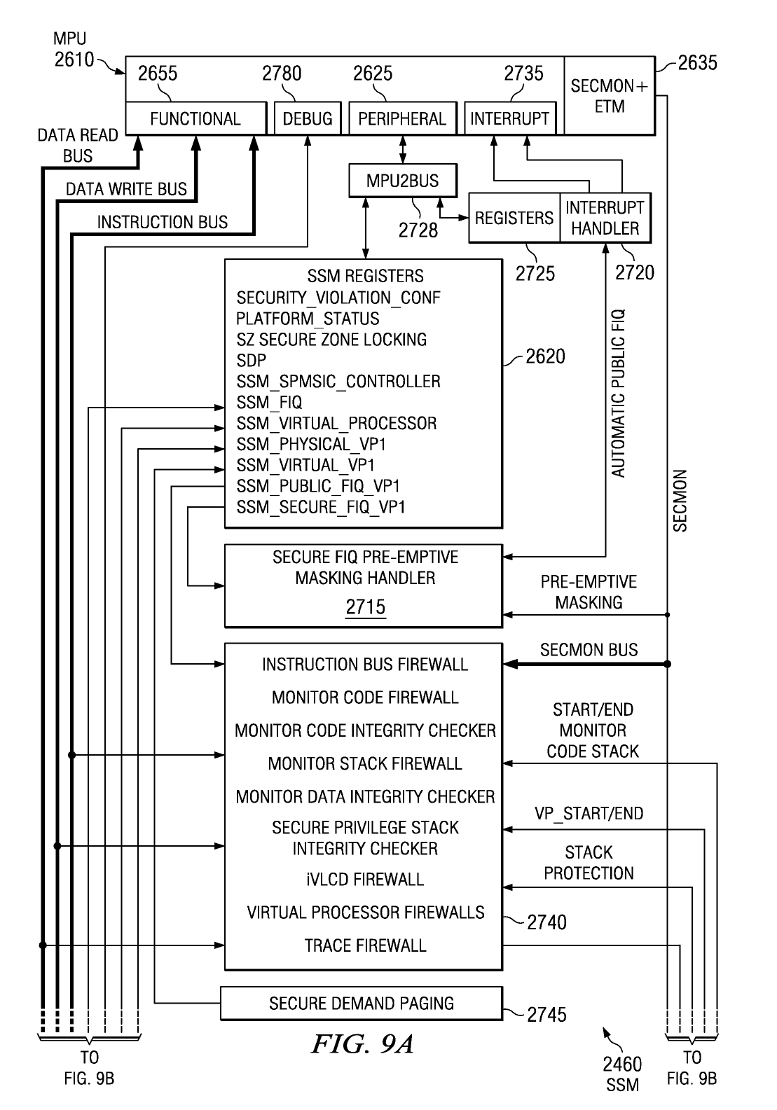

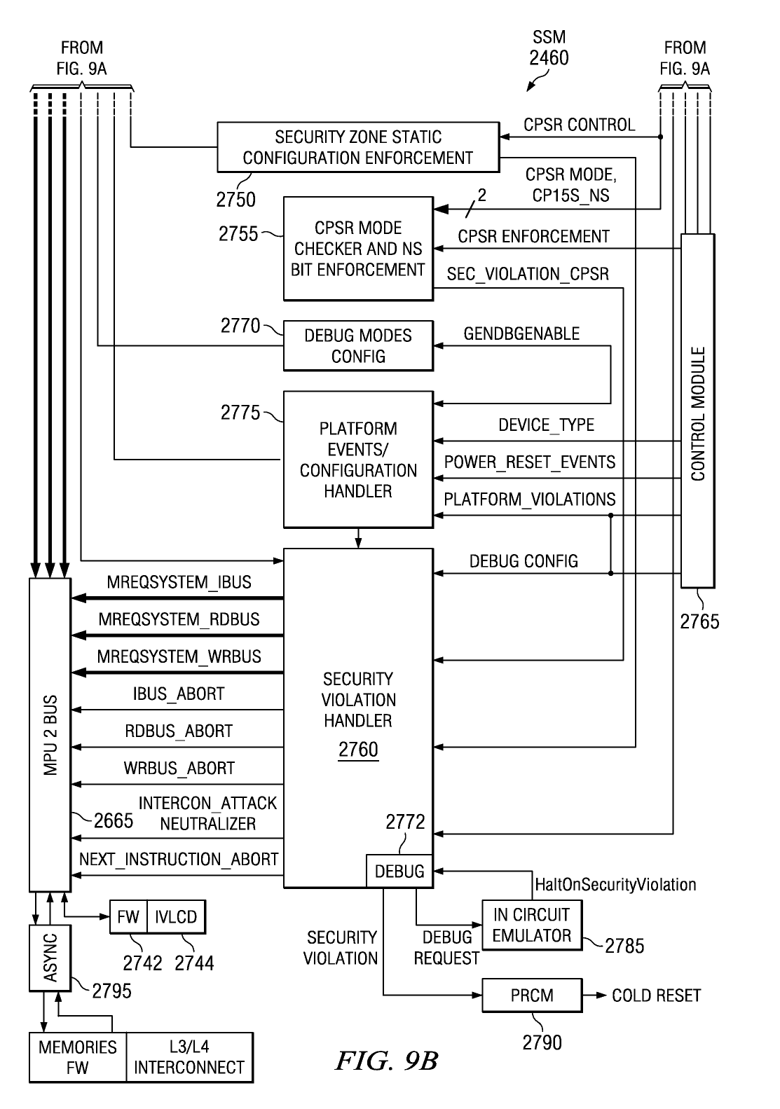

In this embodiment, switches between the categories are prevented except through Monitor Mode. Notice that the hypervisor 2410 controls or is structured by certain register bits. A CP15_NS bit or SCR bit is active or not to indicate and distinguish the Non-secure (Public) condition from the Secure condition. The SSM 2460 has a VP1_NS bit or field in a SSM_Virtual_Processor register (see FIG. 9) that mirrors the CP15_NS bit to also distinguish Non-secure (Public) from Secure condition for SSM hardware monitoring purposes.

Further in FIG. 6, the SSM 2460 has a VP1_Active bit or field provided elsewhere in the SSM_Virtual_Processor register. This bit or field indicates and distinguishes the Virtual condition from a Non-virtual (Normal) condition. The SSM issues the classifier signal MreqSystem as a function (e.g., same or complement) of the VP1_Active bit or field. Note that even in embodiments where Virtual/Non-virtual is simply two states that are represented by one bit, either or both of VP1_Active and MreqSystem are suitably one-bit or plural bits to avoid one-hot conditions where radiation error-resistance or otherwise highly reliable operation is required. The various categories established by a plurality of classifiers or qualifiers are in some embodiments suitably encoded, expanded, decoded or otherwise transformed and delivered as signals in the hardware and software of various embodiments as a further security feature.

In FIG. 6, the hypervisor 2410 sets the bits or fields VP1_NS and VP1_Active to establish the different categories of resources of FIG. 4 and otherwise. Accordingly, the hypervisor is shown as an expansive mantle over four columns of hypervisor-controlled categories 2420, 2430, 2440, 2450 as indicated or driven by states of the bits or fields. All the categories have, or can have a Supervisor Mode, a System mode, an FIQ mode, IRQ mode, Abort mode, Undef mode, and User mode. Fast interrupt requests FIQ are trapped by the Monitor Mode. Interrupt IRQ is trapped by the Monitor Mode for Virtual categories and Secure categories. An External Abort EA need not be trapped into the Monitor Mode in this example. As discussed in FIG. 5, SMI Handler in Monitor Mode handles transitions between categories where a software monitor interrupt SMI instruction is used to initiate the transition out of a particular category.

Each category 2420, 2430, 2440, 2450 has drivers to interface the kernel that operates in or controls each application in that category with each application in that category. Each category has APIs to interface the kernel to the other categories. These APIs make transitions that are trapped and mediated by hypervisor 2410.

For example, in FIG. 6, category 2420 is Non-virtual Public and has an HLOS kernel which is the operating system for category 2420. HLOS Kernel Drivers interface HLOS with each application in category 2420. GSP API, SVK API, and SE API respectively interface HLOS of category 2420 with the corresponding RTOS Kernel of category 2430, Secure Virtual Kernel (SVK) of category 2440, and the Secure Environment (SE) kernel of category 2450. Each of these—GSP API, SVK API, SE API, makes an inter-category transition relative to category 2420 that is SMI-handled and mediated by hypervisor 2410. FIG. 5 illustrates a transition process as described hereinabove.

In FIGS. 6 and 4, category 2430 is Virtual Public and in this example has an RTOS kernel which is the real time operating system for category 2430, Modem Protocol Stack PS layers, and RTOS Kernel Drivers to interface RTOS with the PS layers. Compare with section 2130 of FIG. 3 and areas 2390 and PS layers of FIG. 5. In some embodiments this category 2430 is used for one or more other real time processes instead of or in addition to a modem. In category 2430, HLOS API, SVK API, and SE API provide respective interfaces between RTOS kernel of category 2430 and the corresponding HLOS kernel of category 2420, SVK of category 2440, and the SE kernel of category 2450. Each of the HLOS API, SVK API, and SE API, makes an inter-category transition relative to category 2430 that is trapped and mediated by hypervisor 2410.

Category 2440 is Virtual Secure and in this example has a Secure Virtual Kernel (SVK), and Secure Virtual kernel drivers and APIs. An example of an SVK is a secure OS for a content player, gaming box, and/or still imaging or camera system which is provided in category 2440. The SVK in category 2440 is used either by itself or in addition to a category 2430 wireline modem RTOS or wireless modem RTOS according to the type of system desired. In category 2440, HLOS API, GSP API, and SE API provide respective interfaces between the SVK kernel of category 2440 and the corresponding HLOS kernel of category 2420, RTOS kernel of category 2430, and the SE kernel of category 2450. Each of the HLOS API, GSP API, and SE API makes an inter-category transition relative to category 2440 that is trapped and mediated by hypervisor 2410.

Category 2450 is Non-virtual Secure and in this example has a Secure Kernel, and Secure Kernel drivers to interface the Secure Kernel with secure applications or protected applications in category 2450. In category 2450, an HLOS API, GSP API, and SVK API provide respective interfaces between Secure Kernel of category 2450 and the corresponding HLOS kernel of category 2420, RTOS kernel of category 2430, and SVK of category 2440. Each of the HLOS API, GSP API, and SVK API, makes an inter-category transition relative to category 2450 that is trapped and mediated by hypervisor 2410.

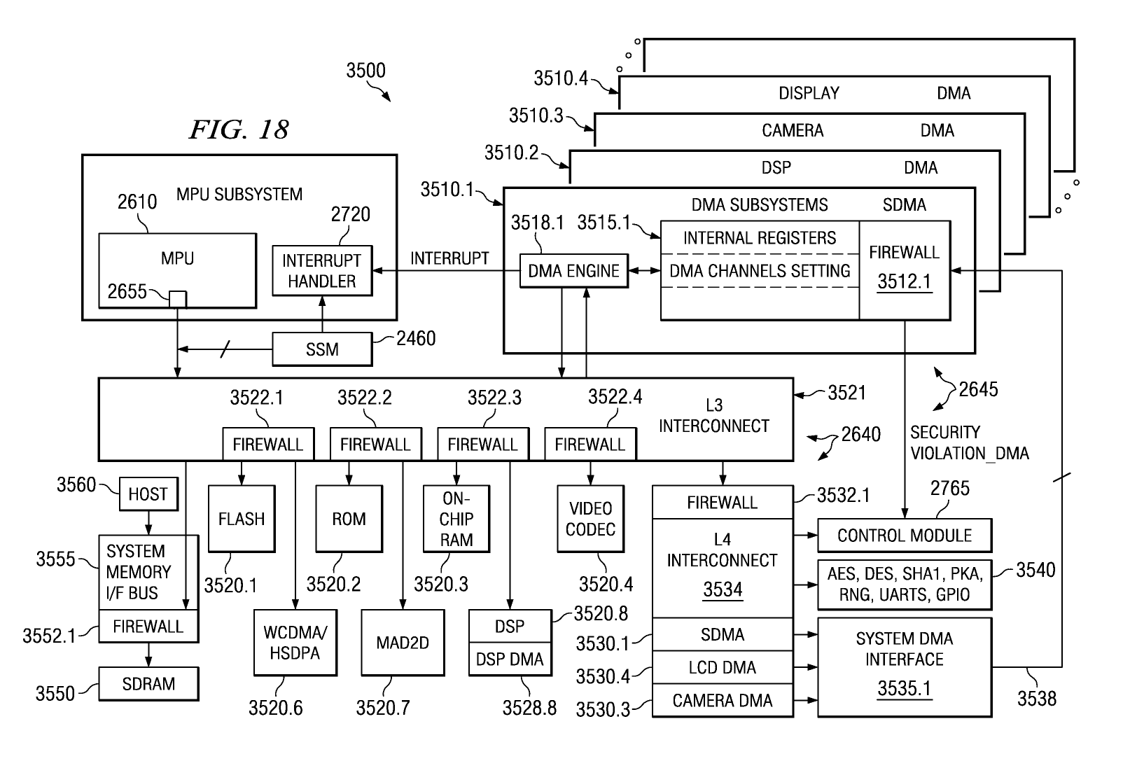

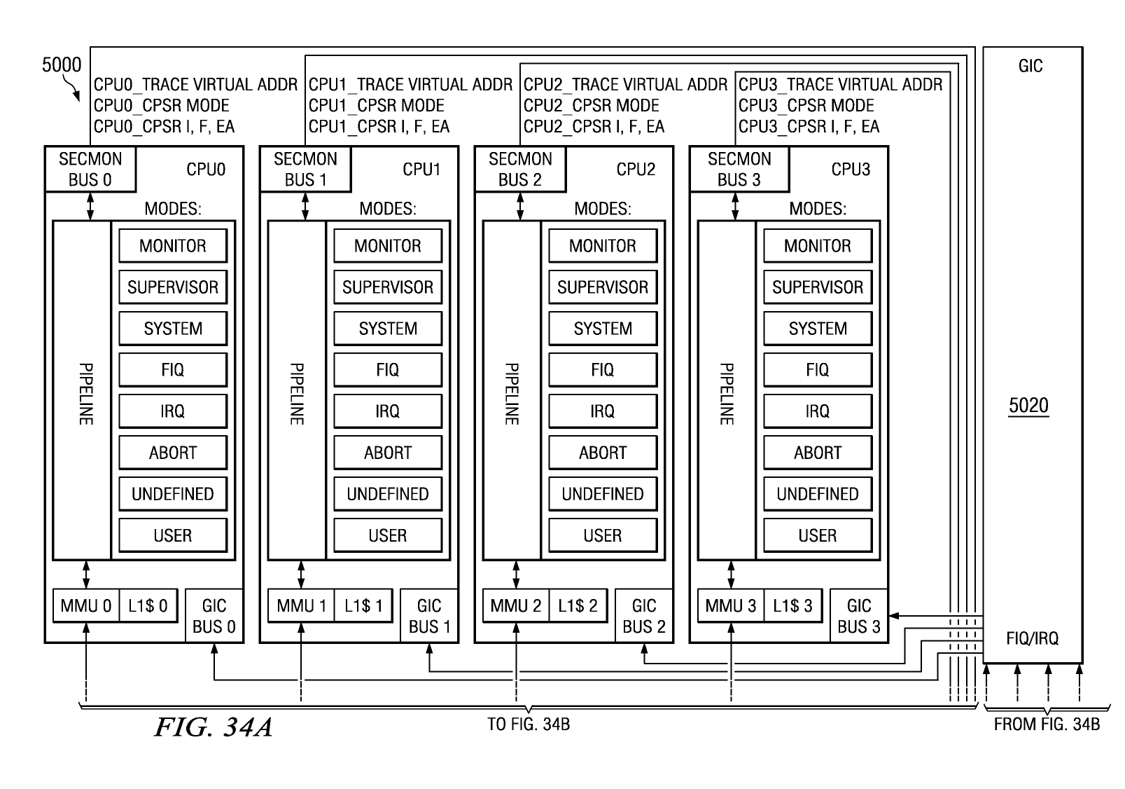

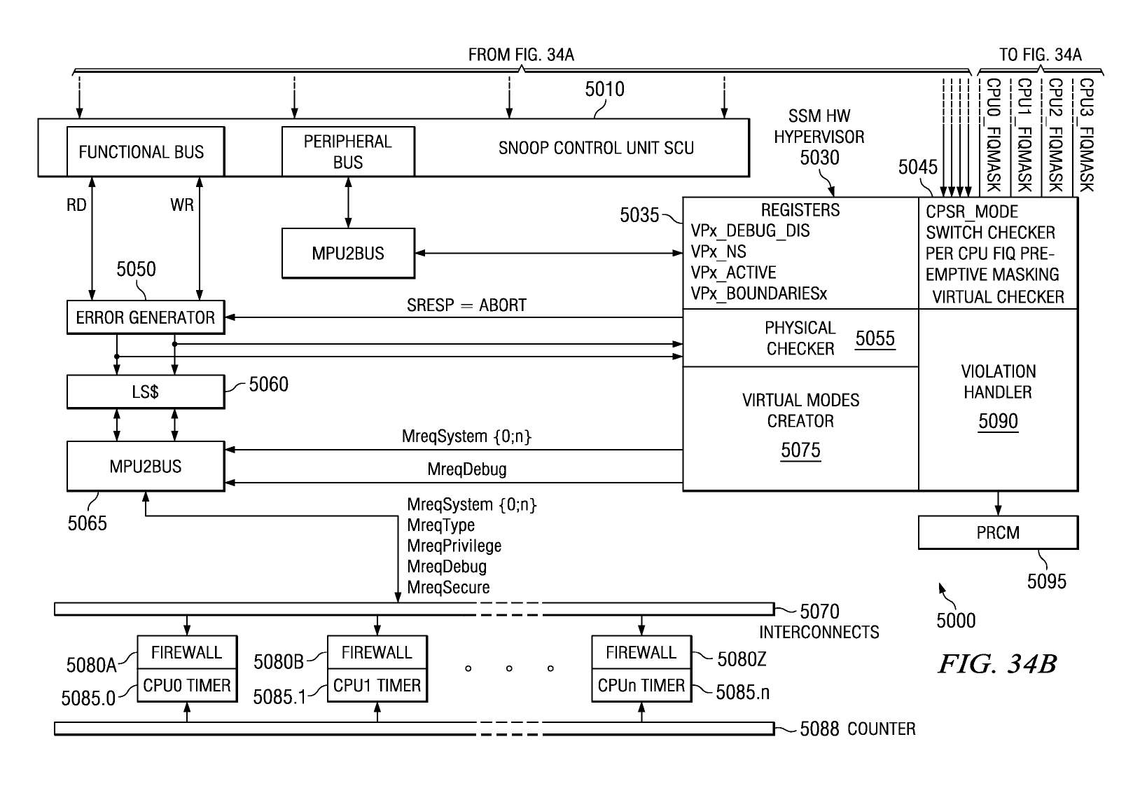

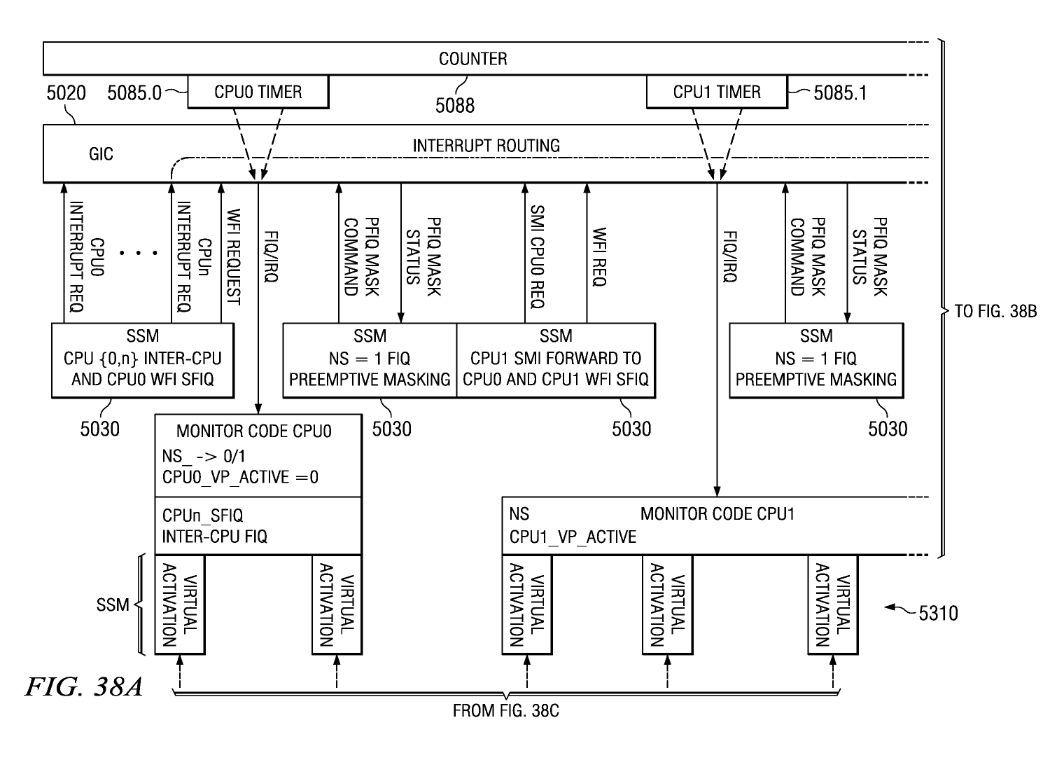

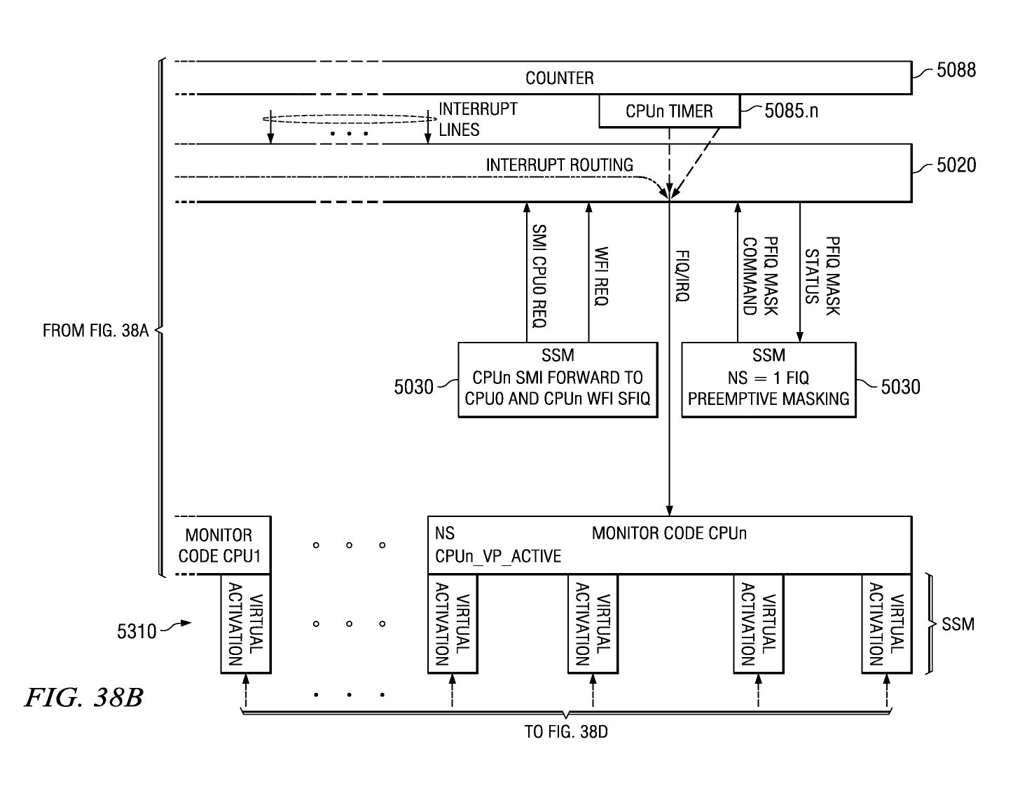

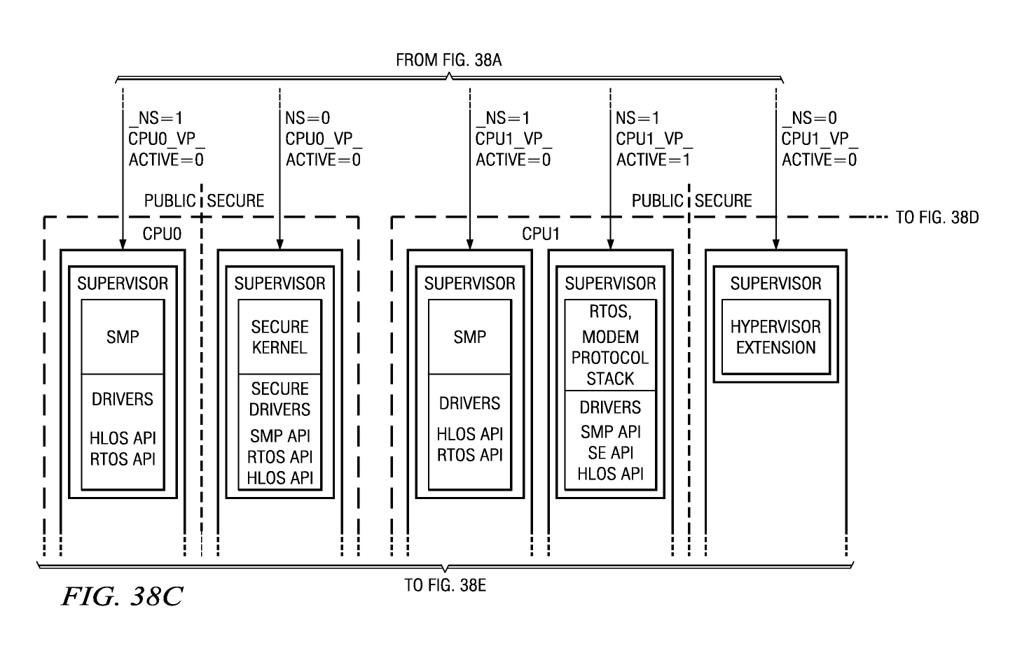

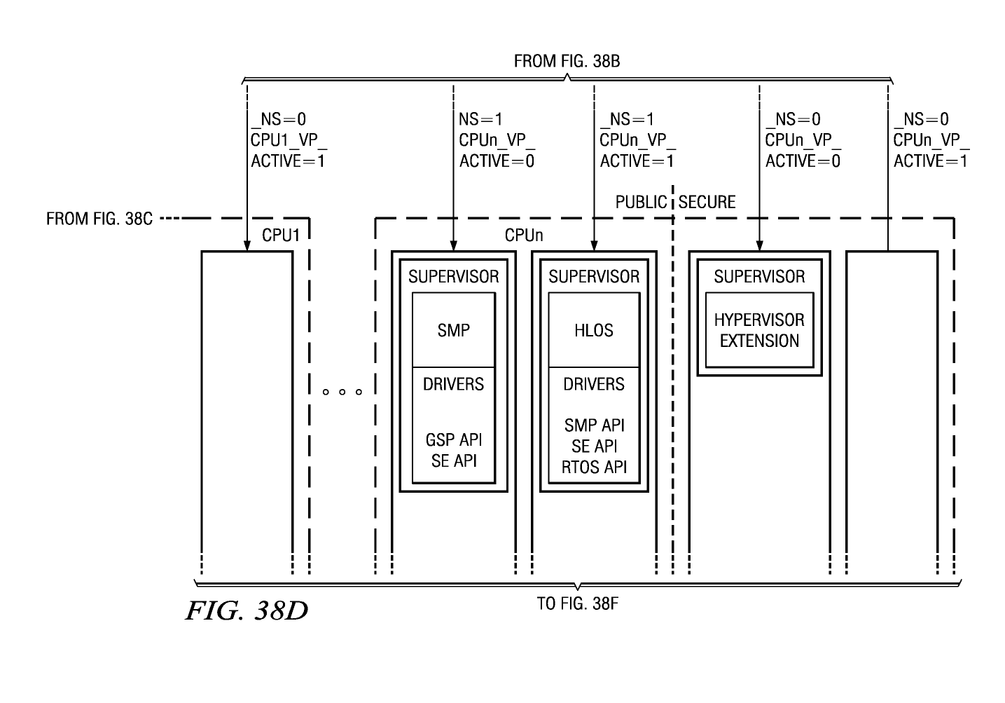

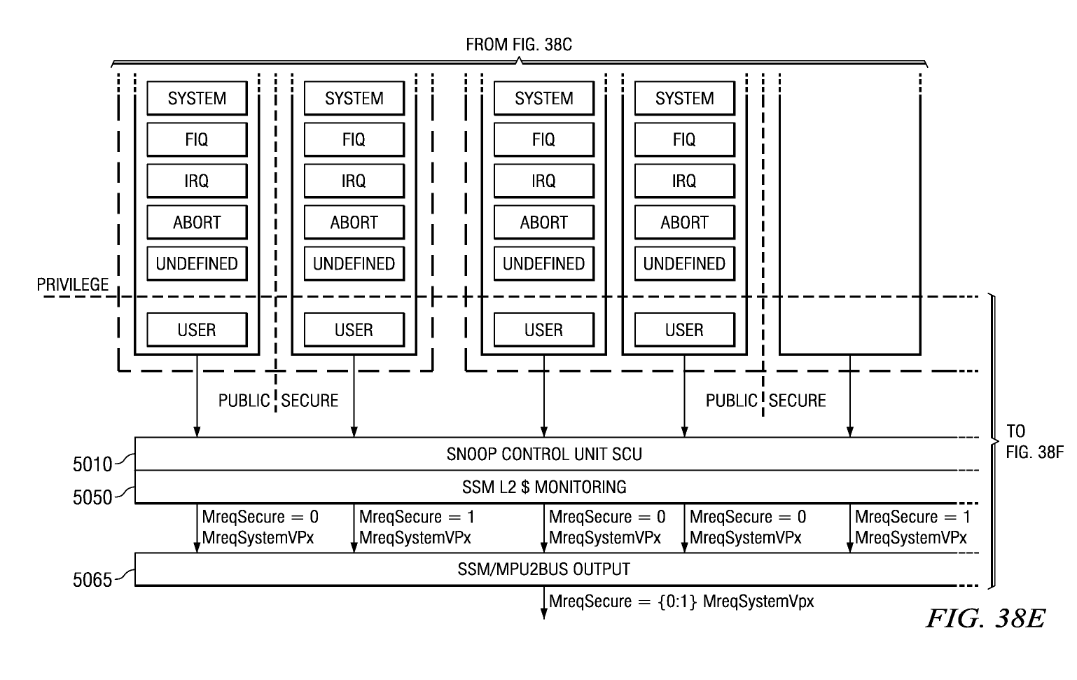

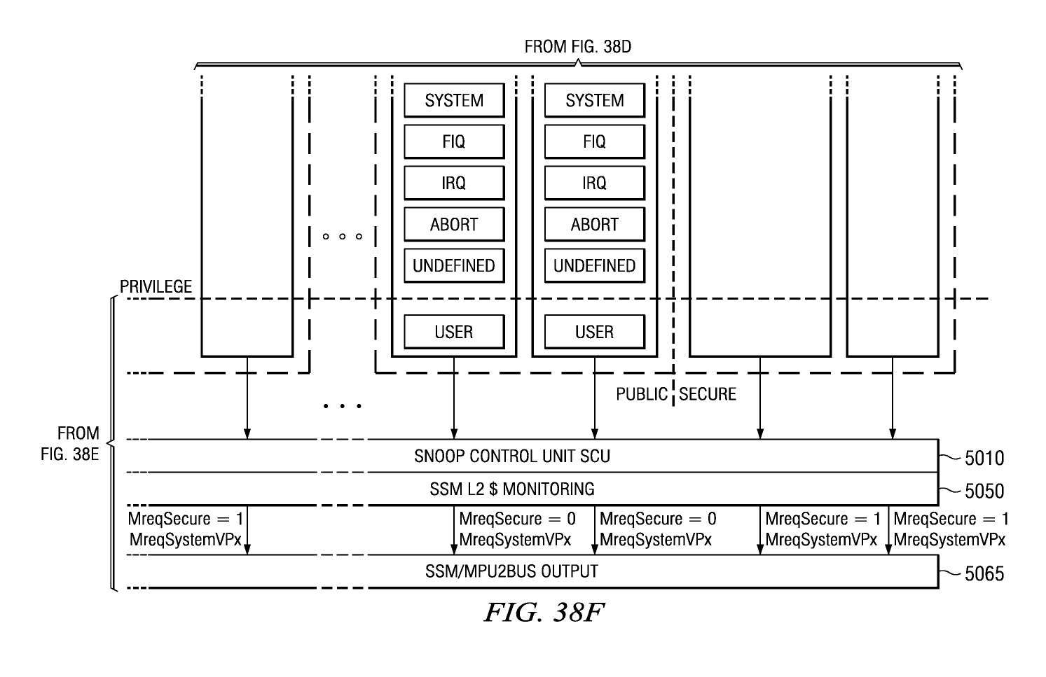

The arrangement is flexible so that one or more of the categories 2420, 2430, 2440, 2450 is or can be populated or empty. When a category is empty, the APIs in the other categories for interfacing to the empty category are suitably also omitted unless retained for upgrade purposes. Additional categories are suitably further established according to the teachings herein, and then additional APIs in the categories are added to interface to each additional category. SSM 2460 provides hardware monitoring and enforcement and issues classifier bits or fields MreqSystem, MreqPrivilege, MreqSecure, and other classifiers according to the teachings herein to regulate access to system peripherals of FIGS. 2 and 18, for instance. FIG. 6 can also be compared with multi-processor embodiments shown in FIGS. 34A/34B and FIGS. 38A/38B and description elsewhere herein.

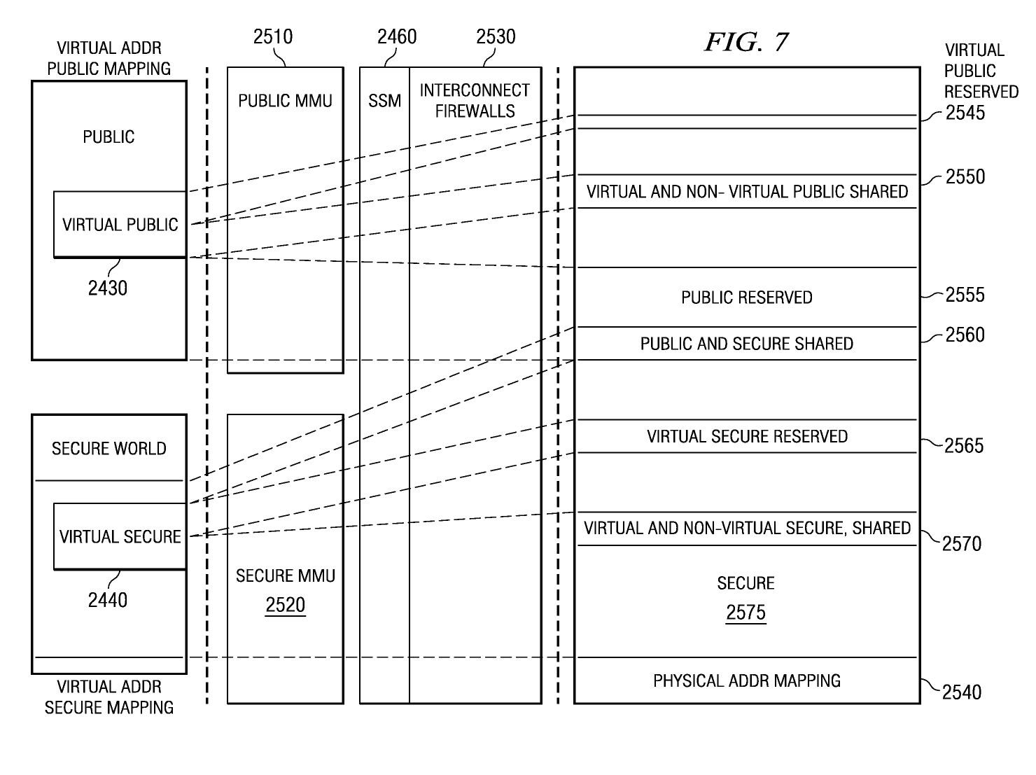

FIG. 7 shows an SSM MPU core virtualization MMU overview. An example system provides two (2) MMU components: a Public MMU 2510 and a Secure MMU 2520. Each MMU 2510 and 2520 has its own virtual memory space that can access the physical memory space according to a mapping. At MMU level, differentiation need not be applied as between the virtual processor and the Non-virtual processor of each category of resources 2410, 2420, 2430, 2440 of FIGS. 4 and 6. Categories 2430 and 2440 are shown for example in FIG. 7. The SSM 2460 of FIG. 6 creates for each memory space in FIG. 7 defined for a virtual processor the MreqSystem qualifier to distinguish transactions belonging to Virtual or Non-virtual modes. Concurrently, the MreqSecure qualifier distinguishes the Secure resources from the Public resources.

An interconnect firewall 2530 is enabled to reserve or isolate or enforce memory space allocated to a particular virtual processor or non-virtual processor. Shared memory space is provided as between various combinations of the four categories of resources of FIG. 4: Non-Virtual Public, Virtual Public, Non-Virtual Secure, and Virtual Secure. For example, a memory space 2540 has reserved spaces 2545, 2555, 2565, 2575 for Virtual Public, Public, Virtual Secure, and Secure respectively. Shared spaces 2550, 2560, and 2570 for instance are provided for respective sharing between Virtual and Non-virtual Public, Public and Secure, and Virtual and Non-virtual Secure as illustrated in FIG. 7.

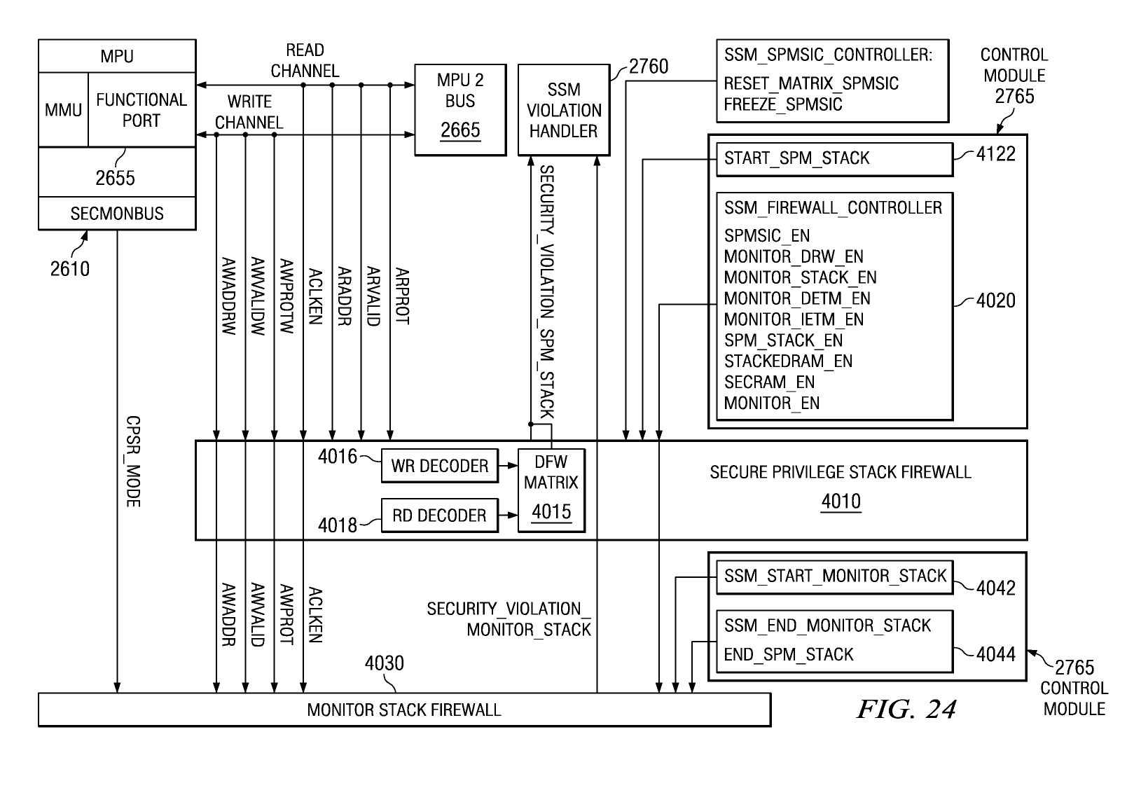

In FIG. 7, hardware monitoring of the Monitor Mode software code range of addresses for security violations is enabled by writing in a Monitor_EN field of a SSM_Firewall_Controller register of FIGS. 24-26 and of TABLE 19. The SSM_Firewall_Controller register is situated in a circuit called a Control Module as in FIG. 9, for example.

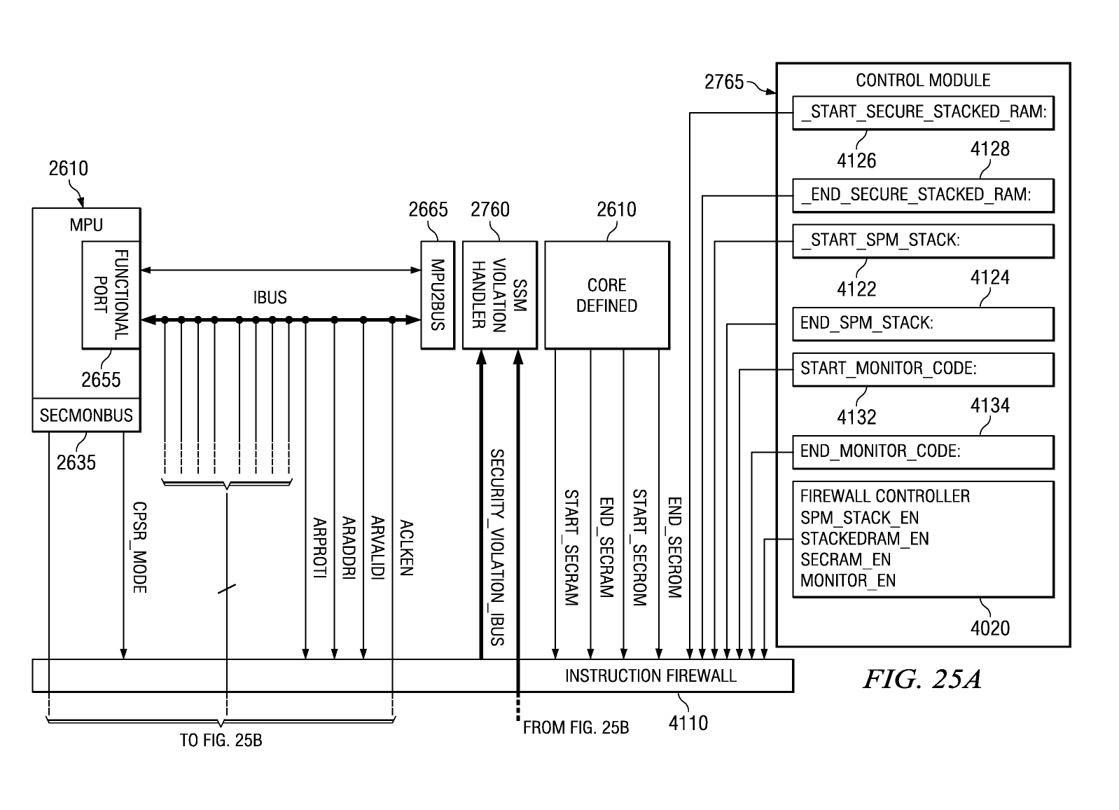

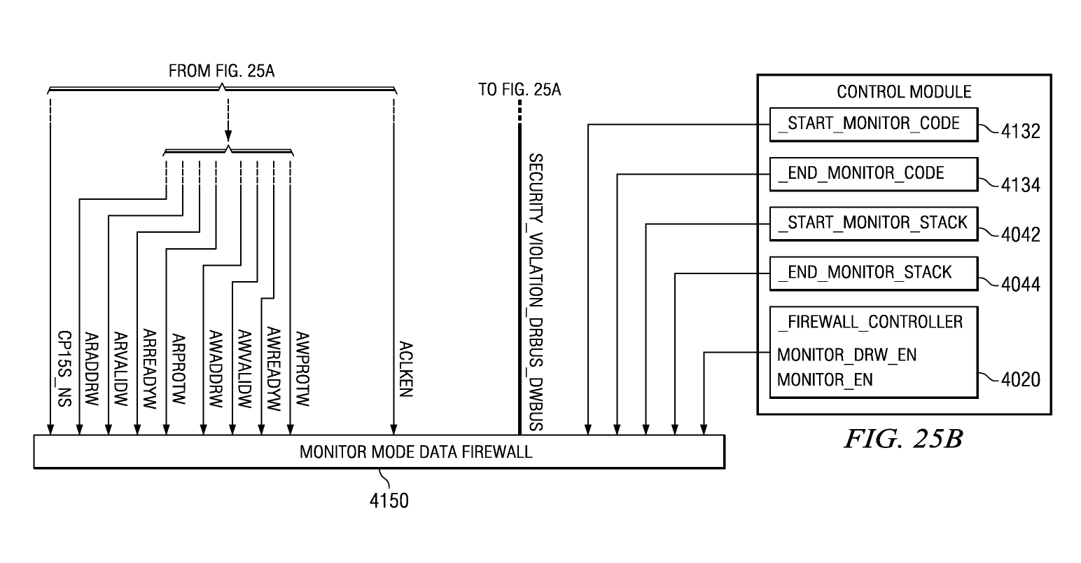

In FIGS. 7 and 25, when Monitor_EN is active, the SSM 2460 checks that the Monitor Mode software code only fetches instructions in an allowed memory range and only reads data from an allowed memory range. When Monitor_EN is active, the Start_Monitor_Code and End_Monitor_Code start address and end address registers are locked. If the Monitor Mode attempts to access an address outside the permitted address range(s) while the Monitor_EN field is active, a security violation signal is generated. This security violation hardware monitoring process is active when the MPU 2610 of FIG. 8 is physically in Monitor Mode (CPSR_Mode=Monitor). In this way, the SSM 2460 operation just described contributes, structures, or enforces addresses ranges for Monitor Mode so that hypervisor operation effectively occurs.

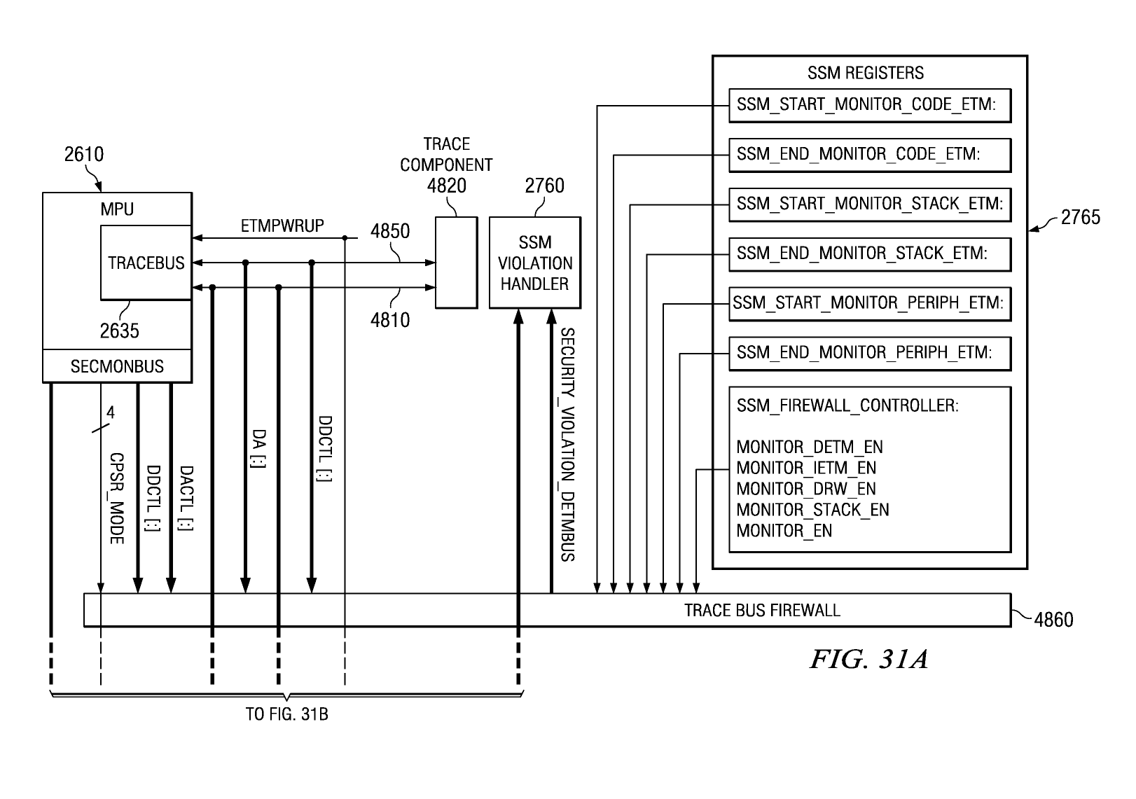

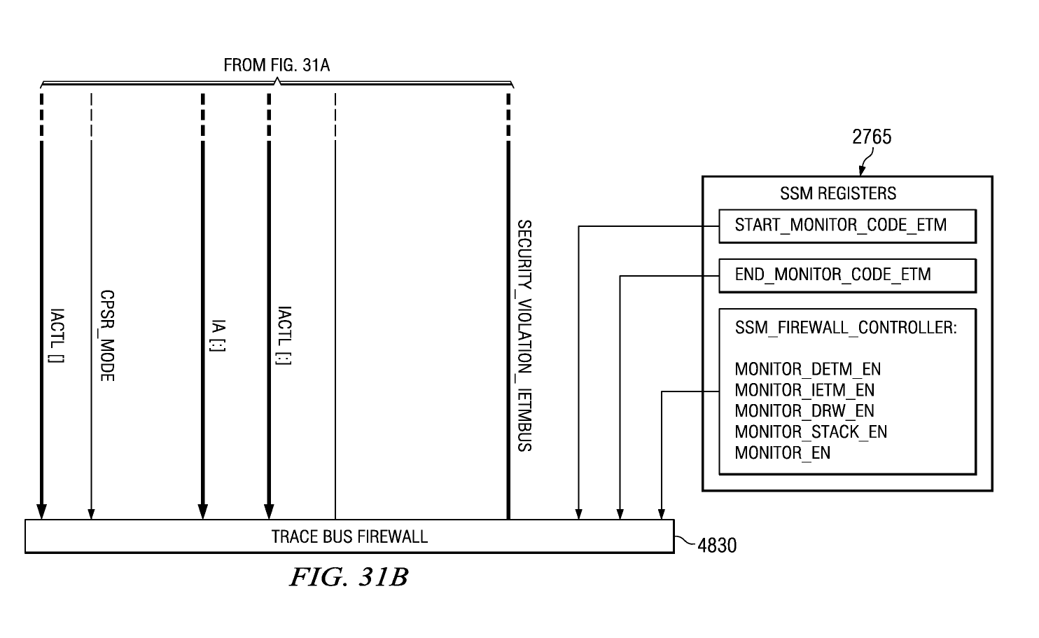

When the MPU is physically in Monitor Mode and the hardware monitoring mechanism is activated (Monitor_EN field active), the SSM hardware monitoring mechanism is configured to restrict the physical instruction fetch of the Monitor code to a ROM only location, for example. In that case, the Monitor mode RAM stacks are excluded. Execution in the monitor mode stacks is prevented because the stacks are not included in the ROM address range defined as permitted by the Start_Monitor_Code and End_Monitor_Code start address and end address registers. Moreover, the trace-related circuitry as described in FIG. 31A/31B allows detection of abnormal instruction flow activity. This prevention effectively impedes and resists basic buffer overflow attack. The Monitor Mode software code by this construction does not expose any API (FIGS. 4, 5, 6) to the external world.

Also, in some embodiments, the hypervisor code in Monitor Mode, context switches the MMU completely each time a switch is made from a Non-virtual category to a Virtual category. This provides a large system address space (e.g., 4 Gb or other large space size) for each category or world, physically differentiated with the classifier MreqSystem. An embodiment that hypervises two HLOSes suitably puts one HLOS in a Non-virtual category and the other HLOS in a Virtual category. Along with the circuitry and processes of FIGS. 5-8, a complete MMU context switch is added to accommodate such additional HLOS. Thus, alternative structure and process embodiments are provided depending on the target HLOS and/or target RTOS established in the architecture to run in a Virtual category.

In FIG. 7, the virtual section 2440 that is shown included respectively into public and secure mappings 2560, 2565, 2570 are quite suitable for a modem implementation that features desirably-high instruction rate (MIPS) and as little context switching as possible. In other embodiments, the MMU is completely devoted or 100% allocated to one category at a time while in Monitor, such as to have a 4 gigabyte address space for each category of FIG. 3. Accordingly, FIG. 7 is thoroughly revised for such other embodiments in respect of shared space.

FIG. 8 shows an embodiment of virtualization hardware architecture that includes a processor core MPU 2610 and the secure state machine SSM 2460. MPU 2610, for example, has an ARM™ core, MIPS™ core, or other processor core such as for core 1105 and/or 1422 of FIG. 2. MPU 2610 is coupled to SSM registers 2620 via a peripheral port 2625 and peripheral bus 2628. MPU 2610 has a virtual world with a Supervisor Mode, an FIQ mode, and an Abort mode in the virtual world. The SSM registers 2620 include a VP1_Debug_Dis debug disable for virtual processor 1 (VP1), a Non-secure/Secure qualifier VP1_NS, and a VP1_Active field for indicating a Virtual or Non-virtual category. An RTOS container FIQ ID interrupt identification for the RTOS is included in the SSM register 2620 area.

In FIG. 8, the processor core 2610 is coupled to an SSM Virtual Checker 2630 through a secure monitor bus SECMON 2635, which provides a signal and line CPSR Mode, and address lines to provide a Virtual Address for Virtual check 2630 and for a TRACE unit, (not shown). The Virtual Checker 2630 checks that the virtual modes execute properly in their own virtual address space. The Virtual Checker 2630 also includes a CPSR Mode switch checker 2636 and further includes an Initiator Firewall 2638.

An initiator firewall like Initiator Firewall 2638 is provided in each initiator in the system. An initiator is a circuit that initiates transfers of information. Each initiator firewall detects whether its associated initiator has been corrupted and can enforce specific security mechanisms, such as a buffer overflow checker or other checker. When an initiator is performing a transaction, in-transaction classifiers or qualifiers are generated. These in-transaction classifiers are, for example, any one or more of the following: MCMD for Read/Write qualification, and MreqInfo qualifiers such as MreqSystem, MreqSecure, MreqDebug, MreqType, MreqPrivilege and other suitable qualifiers. These qualifiers reflect the system state of the initiator at the time of the transaction, and the qualifiers are propagated to interconnect 2640. The interconnect 2640 generates a parameter designated ConnID to identify exactly which initiator made the transaction.

Each of several configurable Target Firewalls 2645 (e.g., each L4 interconnect firewall, system memory, and each L3 interconnect firewall) respectively dedicates a memory or a peripheral in the Targets 2650 to each initiator and isolates each such target among Targets 2650 from any other initiator so that corruption or attack from any other initiator is prevented. A firewall is configurable to share initiators, if desired. Either or both of an Initiator Firewall 2638 and a Target Firewall 2645 generate a Security Violation signal when an attempted bus-access by an initiator is inconsistent with permissions configured into a firewall.

A reset or power management transition may clear or erase a firewall configuration. The processor core 2610 boots in Secure Supervisor mode and reconfigures the firewalls 2645 to their default run-time configurations. Accordingly, upon reset, any memory or target 2650 that can be used for security is restricted to use by the processor core 2610 in Secure Privileged mode.

In FIG. 8, an SSM Physical Checker 2650 checks that the Virtual modes execute properly in their own physical address spaces. The SSM Physical Checker 2650 is bi-directionally coupled to the SSM Virtual Checker 2630 by an arrow 2652, representing defined Virtual and Physical memory space container boundaries from register 2620 and/or a Control Module 2765 of FIG. 9. The SSM Physical Checker 2650 is also coupled to Functional buses 2655. Physical Checker 2650 receives lines MreqSecure, MreqType, and MreqPrivilege (MreqSupervisor). The SSM Physical Checker 2650 has a Virtual Mode Creator block 2656 that creates the MreqSystem qualifier and supplies that signal MreqSystem to a bus interface 2665 designated MPU2BUS. Interface 2665 couples a bus protocol suitably used by MPU 2610 (e.g. AXI protocol) to a peripheral bus using another suitable bus protocol (e.g., OCP Open Core Protocol). MPU2BUS 2665 is bi-directionally coupled to Interconnects 2640 and Target Firewalls 2645 for various peripherals. Classifier signals such as MreqSystem, MreqSecure, MreqType, MreqPrivilege and MreqDebug are provided to the Interconnects 2640.

In FIG. 8, the SSM Physical Checker 2650 defines each virtual container physical memory space. The SSM Physical Checker 2650 also checks that when the processor MPU 2610 is executing in these containers and ranges there no fetch or data read outside each established boundary. In some embodiments, the SSM Physical Checker 2650 also uses classifier MreqType to check that each memory boundary defined as Data Only is not executed or accessed as if it were an instruction. This enhances buffer overflow attacks detection, for instance.

In FIGS. 5 and 8, the processor core 2610 is operated to execute in a virtual processor category (e.g., as a modem) in privileged mode. The SSM Physical Checker 2650 ensures that no unauthorized intruding User mode (MreqPrivilege=Non-privileged) accesses happen. The classifier MreqPrivilege facilitates checking by the Target Firewalls 2640 to intercept any non-privileged access to a peripheral or address space that is reserved for a virtual processor in FIG. 7.

The SSM Physical Checker 2650 is also coupled to the Write Data bus. Note that Physical Checker 2650 does not need to check for violation on the Write Data base in a case wherein the Data Cache and Write Buffer might not have been drained before entering the monitor mode in path to enter the virtual container. In such case, a possible writeback could result during this Monitor code and cause an unnecessary violation signal when no meaningful security violation has actually occurred. The Monitor Mode software code ensures the system coherency by executing the appropriate memory barriers before activating the VPx_Active to ensure that no undesired write takes place after entering the virtual container.

When leaving a virtual container to switch to the Monitor Mode, the Monitor Mode 2310 of FIG. 5 and 2410 of FIG. 6 executes a Data Memory Synchronization/Write Barrier (DMB_DSB/DWB) to ensure that all pending items in Data Cache belonging to the Virtual Processor are written to a physical address. See also FIG. 29 and TABLE 42. This reason is that when the virtual container is deactivated (VP1_ACTIVE=0) then a write access belonging to the virtual container is no longer marked as Virtual by the MreqSystem qualifier being active. The implementer also defines or configures the virtual container or category to have a granularity such as page size and a permitted total memory space such as some substantial fraction of DRAM space.

In FIG. 8, an SSM Virtual Checker 2630 defines the virtual container virtual memory space. Also, the SSM Virtual Checker 2630 checks that when the processor core 2610 is executing in the virtual container there no fetch or data transfer outside the memory boundary. Memory boundaries defined as Data Only by classifier MreqType are not executed, which enhances buffer overflow attacks detection. By means of L1 cache physical to virtual indexing, the SSM Virtual Checker 2630 also ensures that the memory has not been corrupted by the non-virtual world to which it belongs. The SSM virtual checker also ensures that branch phantom instructions (see glossary TABLE 36) and executed instructions do not generate an exception. This facilitates detection of corrupted code in some attack scenarios.

In FIG. 9A, processor core 2610 is coupled via a peripheral port 2625 and bus interface 2728 to Registers 2620 in the SSM 2460. SSM 2460 also includes a Secure FIQ preemptive masking handler 2715 coupled to an Interrupt Handler 2720. The Interrupt Handler 2720 has various numbered inputs to which various interrupt sources in the system are assigned. Examples of interrupt sources are SSM (secure state machine) 2460, System DMA (SDMA), Display DMA, Camera DMA, Core, Emulation, and Peripheral.

Interrupt Handler 2720 is coupled to registers 2725 including an Interrupt Status Register ISR and Interrupt Register ITR, and is coupled to the peripheral port 2625 via the bus interface 2728. Interrupt Handler 2720 has FIQ/IRQ output coupled to the processor core 2610 via an interrupt bus 2735. The Secure FIQ preemptive masking handler 2715 delivers automatic public FIQ pre-emptive masking signals to Interrupt Handler 2720. In SSM Registers 2620, a Public_FIQ VP1 register and a Secure_FIQ_VP1 register configure the Secure FIQ preemptive masking handler 2715.

A Firewalls and Checkers block 2740 includes an instruction firewall, monitor code firewall, monitor code integrity checker, monitor stack firewall, monitor data integrity checker, secure privilege stack integrity checker, variable length codec iVLCD firewall 2742, and virtual processor firewalls. Compare the SSM Virtual Checker 2630 and SSM Physical Checker 2650 of FIG. 8 with checker functions of the Firewalls and Checkers block 2740 of FIG. 9.

Further in FIG. 9, secure demand paging circuitry 2745 in effect expands secure memory space and has registers in SSM Registers 2620. Incorporated patent application TI-39617 describes some examples of secure demand paging technology that are suitably used in block 2745. A Security zone static configuration enforcement block 2750 is fed by CPSR control bits from the Security Monitor bus SECMON 2635. CPSR is monitored because CPSR determines modes and indicates transitions to and from Monitor Mode, for instance. A CPSR/NS block 2755 has a CPSR mode checker circuit and an NS bit Enforcement circuit. If a security violation event occurs, CPSR/NS block 2755 supplies a security violation output to a Security Violation Handler block 2760. The CPSR/NS block 2755 is fed with CPSR mode bits and MPU NS bit and is responsive to a signal designated CPSR Enforcement Mode supplied from a Control Module 2765. A Debug Modes Configuration block 2770 is activated by a general debug enable signal GenDbgEnable from a Platform Events and Configuration Handler block 2775. The Debug Modes Configuration block 2770 supplies a Debug Request to a Debug Port 2780 of the processor core 2610.

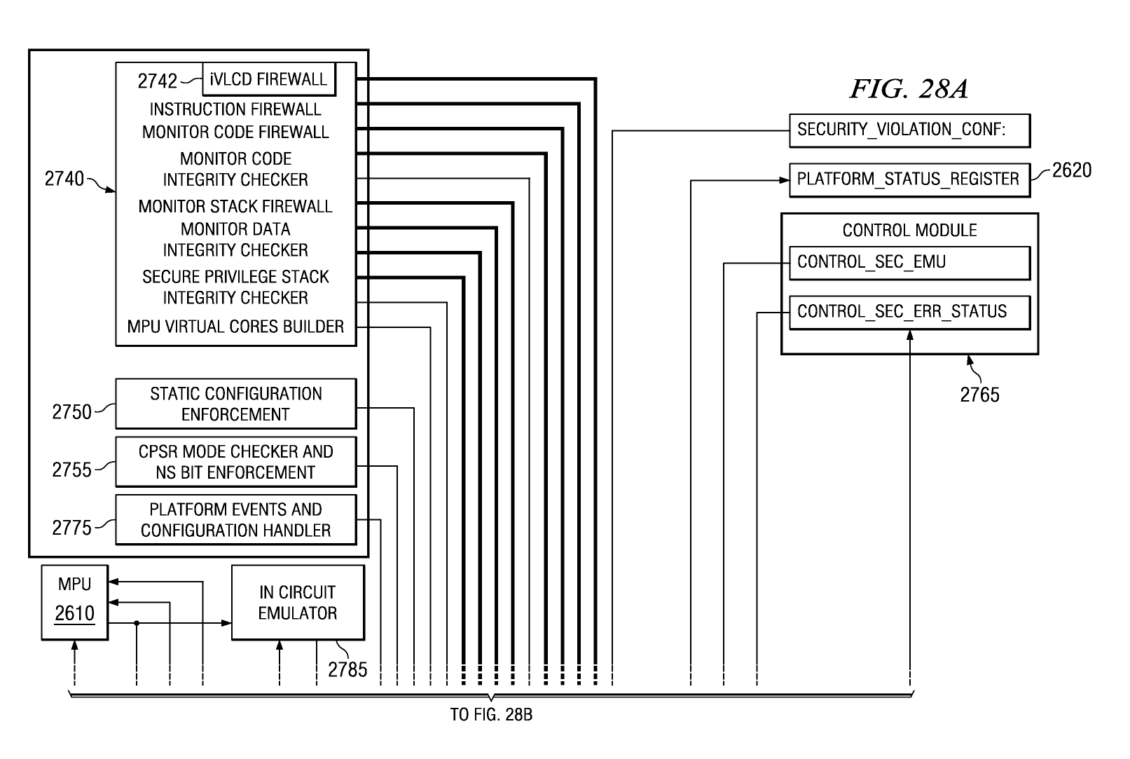

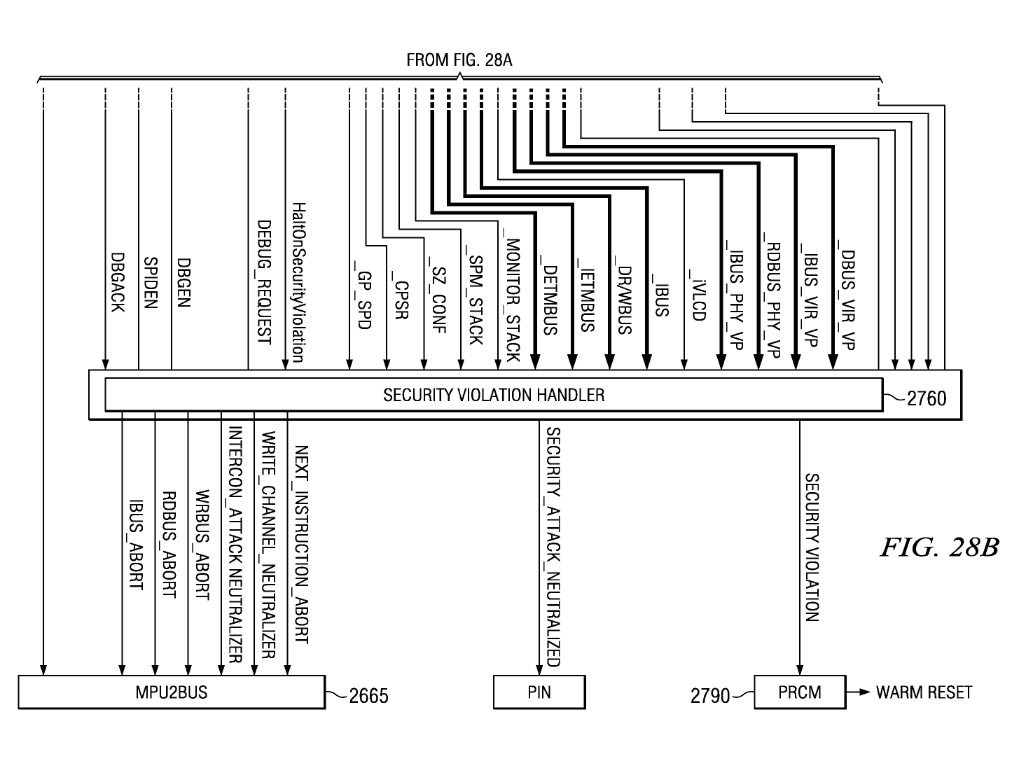

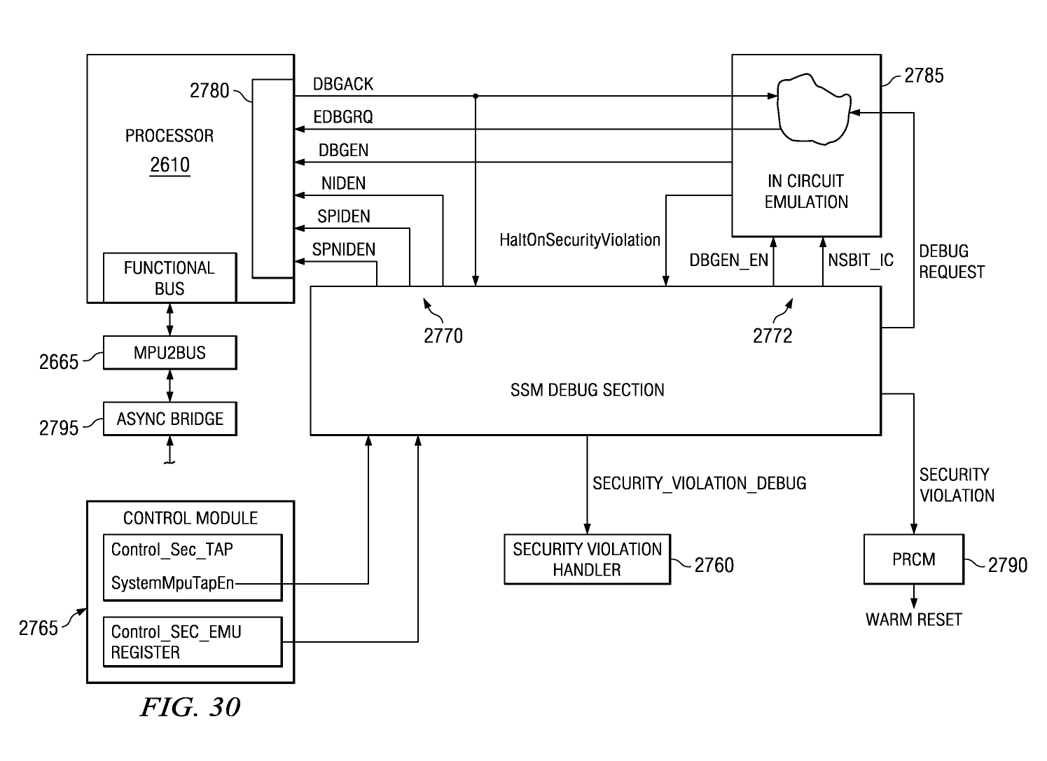

The Control Module 2765 supplies the Firewalls and Checkers block 2740 with information representing Start and End addresses of the monitor code and monitor stack, with the Start and End of the virtual processor resources, and with stacked memories protection and Secure privilege stack protection information. The Control Module 2765 supplies the CPSR/NS block 2755 with a CPSR Enforcement mode signal. Control Module 2765 supplies the Platform Events and Configuration Handler 2775 with signals along lines for a Device Type, for Platform Violations, and for Power Reset Events. Control Module 2765 supplies the Security Violation Handler 2760 with Platform Violations enables (compare with FIGS. 28A/28B) and supplies a debug section 2772 with information regarding Debug configuration (compare with FIG. 30).

Control Module 2765 in FIG. 9B has error log registers for access errors identified by various sources and firewalls in the system of FIG. 18, such as from SSM 2460, Secure Watchdog, Emulation Firewall, Peripherals Firewalls, DSP Firewall, MAD2D Firewall, SSM Firewall, Display DMA Firewall, Camera DMA Firewall, WCDMA Firewall, System Memory Functional Bus Firewall, Flash Firewall, On-Chip RAM Firewall, and On-Chip ROM Firewall. MAD2D means master asynchronous die to die, which is an electronic interface or optical-electronic interface or other communicative interface between stacked dice, wherein each die in the stack has an integrated circuit fabricated in that die. Each die in the stack is physically glued or otherwise affixed to any adjacent other die. Some embodiments have application processor 1400 (FIG. 2) and Modem processor 1100 on respective stacked dice, or application processor 1400 plus a graphic processor on each respective die, or plural application processors 1400 replicated on respective dice, and other embodiments provide other combinations of two or more stacked dice partitioning the electronic system of FIG. 2 and other systems. Separate error log registers of Control Module 2765 log errors in Debug mode for the various sources in the system of FIG. 2 and FIG. 18.

In FIG. 9B, Security Violation Handler 2760 is fed with violation information from Firewalls and Checkers block 2740, from Security zone static configuration enforcement block 2750, from CPSR/NS block 2755, and from Platform Events and Configuration Handler 2775. Security Violation Handler 2760 is bi-directionally coupled to the SSM Registers 2620.

In FIG. 9A, Functional Bus Interface MPU2BUS 2665 is coupled to the processor core 2610 by an Instruction Bus IBus, a Data Read Bus RDbus, and a Data Write Bus WRbus. In FIGS. 9B and 28B, Security Violation Handler 2760 supplies bus interface MPU2BUS 2665 with outputs MReqSystem_IBus, MReqSystem_RDbus, MReqSystem_WRbus, IBus_Abort, RDbus_Abort, WRbus_Abort, Intercon_Attack_Neutralizer, and Next_Instruction_Abort. The outputs named IBUS_Abort, RDBUS_Abort, WRBUS_Abort each go to interface MPU2BUS 2665 and cause the interface 2665 to destroy the current access transaction and send an error response ERR to MPU 2610. Some embodiments use outputs called Read Channel Abort and Write Channel Abort or Neutralizer where there is no separate IBUS.

Security Violation Handler 2760 generates an interconnect attack neutralization signal. This Intercon_Attack_Neutralizer signal is generated active when the SSM 2460 detects an attack attempt such as a stack buffer overflow. The attack neutralization is provided without damaging or impairing the memory functionality and the processor 2610 functionality. This Intercon_Attack_Neutralizer signal is also suitably delivered as a security attack indicator output of SSM 2460.

The output Intercon_Attack_Neutralizer goes to interface MPU2BUS 2665 and causes interface 2665 to generate a Prefetch Abort when a Data Abort is received. This operation kills an erroneous software application that is currently generating the Data Abort. By doing so, the erroneous software is wiped out from the MPU 2610 pipeline. Intercon_Attack_Neutralizer acts as a virus killer. The Interconnect_Attack_Neutralizer function generates a Prefetch Abort (on a valid instruction) each time any of the Interconnect firewalls (e.g., 3522.i or 3532.i of FIG. 18) generate a Data Abort to the interface 2665 and MPU 2610.

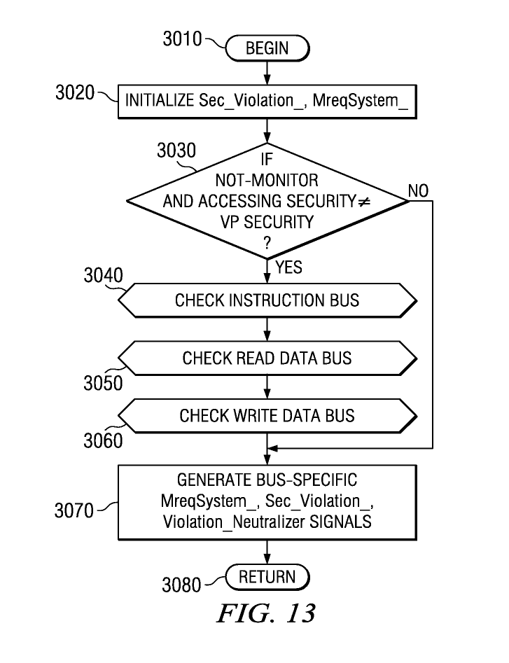

The Intercon_Attack_Neutralizer line and signal are fed to circuitry in interface 2665. Interface 2665, in turn, generates a Prefetch Abort to MPU 2610 when a system peripheral generates a Data Abort. Prefetch Abort is generated to trigger an Instruction memory barrier and thereby flush the MPU 2610 pipeline. The Prefetch Abort stops the prefetching of instructions of the currently-executing software. The reason for stopping the prefetching is because current software executing is quite probably responsible if a Data Abort has just happened. Since virus software may act in this faulty way, the Intercon_Attack_Neutralizer signal acts to stop virus software. Moreover, MPU instruction address register information is captured to enhance diagnostics and prevent a virus from concealing itself Undesirable propagation of either a Data Abort or Instruction Abort is also prevented. See further Neutralizer description in connection with FIG. 13.

The output Next_Instruction_Abort also goes to interface MPU2BUS 2665 and causes interface 2665 to generate a Prefetch Abort when a Data Abort is received. Next_Instruction_Abort is useful when MPU 2610 processing time to respond to the error response ERR might be too long (several clock cycles) to resist a buffer overflow attack for instance. In other words, in such scenario, Next_Instruction_Abort can be more effective than generating the outputs IBUS_Abort, RDBUS_Abort, or WRBUS_Abort to generate the error response ERR.

By contrast with Interconnect_Attack_Neutralizer, the Next_Instruction_Abort is generated by the Security Violation Handler 2760 in SSM 2460 when attacks are detected, such as a buffer overflow attack or boundary access violation. The generation of Next_Instruction_Abort may, but does not necessarily, imply that a Data Abort is generated to the MPU 2610. This is useful to resist a buffer overflow scenario in case a Data Abort is not generated.

In FIG. 9B, Security Violation Handler 2760 supplies a Debug request to an In-Circuit Emulation block 2785, which in turn delivers a HaltOnSecurityViolation signal to Security Violation Handler 2760. Security Violation Handler 2760 supplies a Security Violation signal to a Power, Resets, and Clocks Manager PRCM 2790 which outputs a Warm MPU Reset or a Cold Reset depending upon occurrence and nature of a Security Violation signal supplied to PRCM 2790. Either or both of Security Violation Handler 2760 and a Secure Watchdog Timer have security violation outputs coupled to PRCM 2790.

A security violation strategy is configurable in a Security Violation Configuration register Security_Violation_Conf in SSM Registers 2620. The Security_Violation_Conf register controls aborts depending on the configured abort type, and further determines whether or not a Warm CPU reset or a Cold Reset or no reset is generated for particular group of security violations. Configuring of this Security_Violation_Conf register by one or more write operations is suitably restricted and reserved to a predetermined mode such as Secure Privilege mode. Different security violations generated by the SSM 2460 are flagged in a Platform Status register in SSM Registers 2620. Security Violation flags are clearable by some restrictive mode of access such as Secure Privilege Mode access. A similar restrictive mode of access is suitably used for writing and reading the various SSM Registers 2620 and registers in Control Module 2765.

Among other things, SSM 2460 in FIG. 9 includes first and second checker circuits having first and second checker outputs coupled to Security Violation Handler 2760. The first checker circuit has input lines for receiving mode signals indicative of at least some of the processor modes. The first checker circuit has logic circuitry coupled to the input lines to detect mode transitions between the modes and activate the first checker output upon detection of a mode transition contrary to a permitted transition policy for the logic circuitry. For an example of a first checker circuit, see any corresponding portion of CPSR Mode Checker and NS Bit Enforcement circuit 2755. The second checker circuit has second input lines for receiving mode signals indicative of at least some of the modes, and further has third input lines for receiving address signals. The second checker circuit has second logic circuitry responsive to the mode signals and to the address signals to identify attempted transactions of different modes and activate the second checker output upon detection of an attempted transaction including an address and a mode contrary to a permitted transaction policy for the second logic circuitry. For an example of a second checker circuit, see any corresponding portion of the checkers in block 2740.

In FIGS. 9A/9B, Power Management circuitry is provided to establish and control different power domains in a single integrated circuit (IC) and/or in a multiple IC system. The power domains handle different levels of power hierarchy and facilitate proper switching from one power domain to another without losing already-configured parameters that are desired for use after the switching or upon return to operation of a given power domain. The power domains include an MPU Power Domain, a Wakeup Power Domain, a Core Power Domain, and a Peripheral Power Domain.

The MPU Power Domain includes the processor core 2610 and its ports and interfaces 2625, 2635, 2655, 2735, 2780, Functional Bus Interface 2665 and peripheral bus interface 2728, and SSM 2460 including blocks 2620, 2715, 2740, 2745, 2750, 2755, 2760, 2770, 2775, Interrupt Handler 2720 and its Interrupt Registers 2725, iVLCD 2744, 2742, and In-Circuit Emulation block 2785. SSM 2460 is suitably driven by a MPU core clock and a half-rate clock derived from the MPU core clock. The Wakeup Power Domain includes PRCM 2790. A Warm CPU reset and a Cold reset are provided. The Core Power Domain includes the Control Module 2765 and Memories. The Peripheral Power Domain includes various cryptographic accelerators and resources.

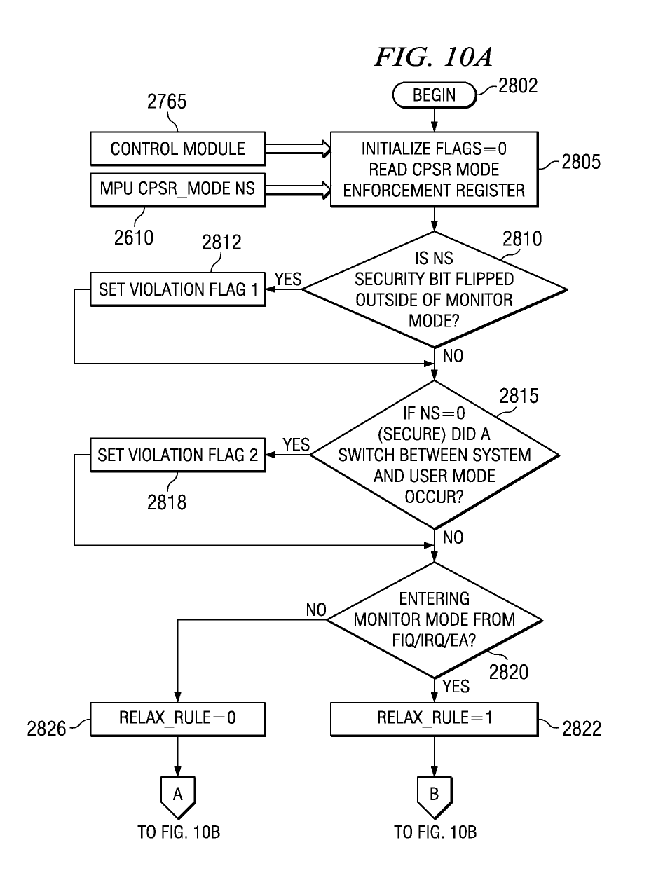

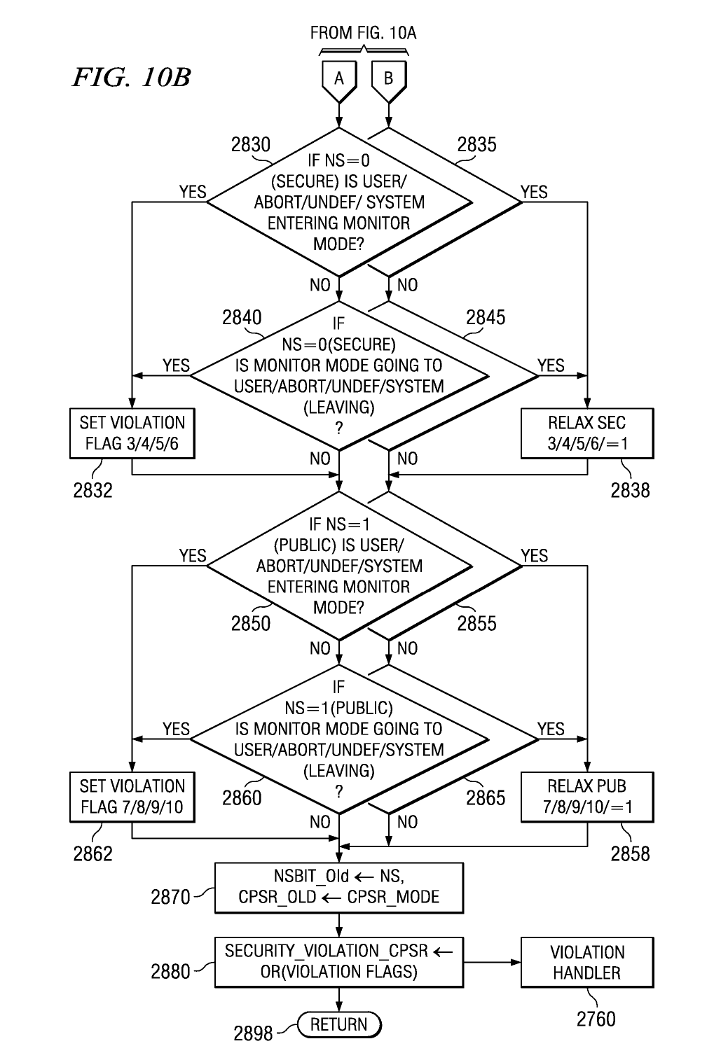

In FIGS. 9 and 10A/10B, SSM 2460 has the hardware CPSR mode enforcement block 2755. This block 2755 is configured by TABLE 8 fields in a SSM_CPSR_Mode_Enforcement register in the Control Module 2765. These register fields are also identified in the _Enforcement signal names in various IF conditionals in block 2755 design code of TABLE 1. At reset, some or all of the enforcement fields of TABLE 8 in that SSM_CPSR_Mode_Enforcement register are activated according to a non-volatile configuration for the product unit.

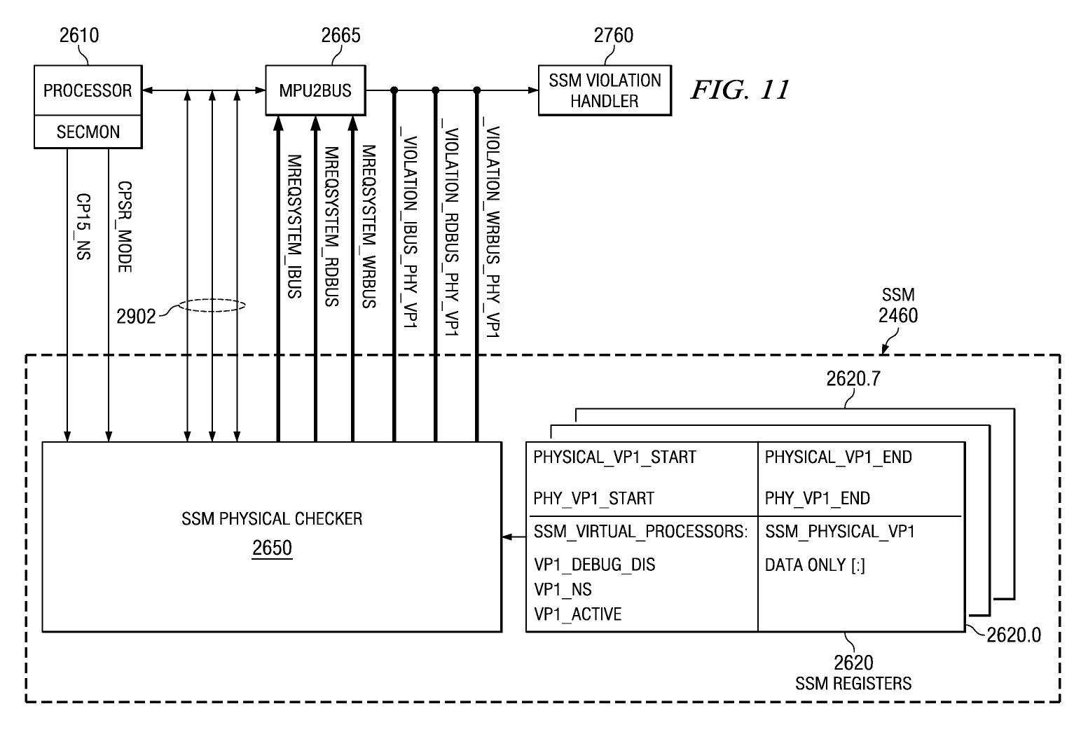

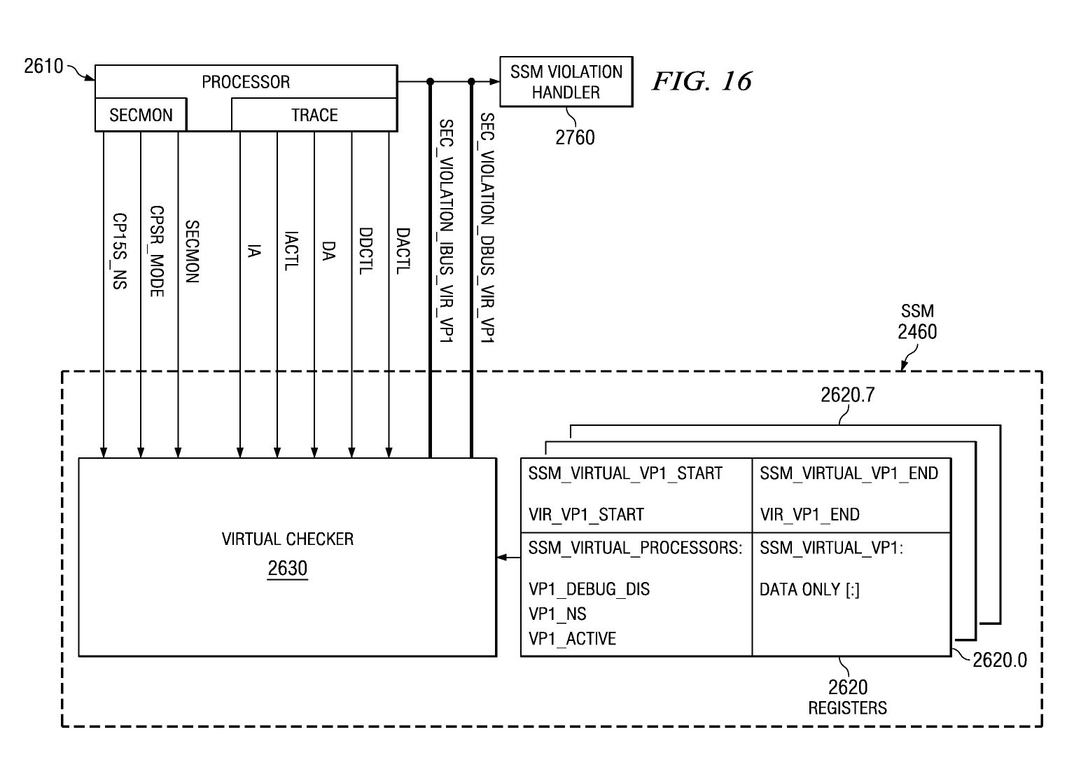

The CPSR Mode Checker and NS Bit Enforcement block 2755 contributes, specifies and structures the permitted transitions and non-permitted transitions so that the Monitor Mode operations can be and are effectively interposed in the architecture as shown in FIG. 3 areas 2140, 2150 and in FIG. 5. The CPSR mode enforcement block 2755 contributes and structures the permitted transitions and non-permitted transitions so that the Monitor Mode effectively provides a canopy or mantle of hypervisor control in FIG. 6. The various operational categories of FIG. 4 are established under hypervisor control by the Monitor Mode software and by the Physical Checker 2650 of FIG. 11 and Virtual Checker 2630 of FIG. 16 doing hardware control of address spaces, and by other blocks and firewalls in the system as described further elsewhere herein.

If a security zone mechanism associated with MPU 2610 has capability to change the NS (non-Security) bit in some or all Privilege modes, CPSR Mode Checker and NS Bit Enforcement 2755, in TABLE 1 and FIG. 10A, is arranged to restrict such capability to Monitor Mode in a step 2810. If the security zone has capability to switch from Monitor Mode to User mode (non-Privilege) by changing the CPSR mode bits, CPSR Mode Checker and NS Bit Enforcement 2755 is arranged at step 2815 of FIG. 10A to restrict such switching to Privilege mode instead. See further discussion of security zone mechanisms in FIG. 26.

In CPSR Mode Checker and NS Bit Enforcement 2755, hardware and process blocks in FIG. 10B are provided for detection of certain switches that are made impermissible by some embodiments herein. A block detects a switch from/to the Monitor Mode to/from Undefined mode, and hardware-provides a Security Violation in that case (MU bit). See TABLE 8 on CPSR Mode Enforcement Register in Control Module 2765. Detection of a switch from/to the Monitor Mode to/from the Abort mode triggers a hardware-provided Security Violation in that case (MA bit). Detection of a switch from/to the Monitor Mode to/from the System mode is provided for advanced layering capability in the Secure mode (MS bit). Detection of a switch from/to the System mode to/from the User mode is also provided for advanced layering capability in the Secure Mode (SU bit).

Three register bits or fields respectively designated FIQ_/IRQ_/EA_Trapped_in_Monitor are provided. When a respective FIQ/IRQ/EA_Trapped_in_Monitor bit is set, see step 2820 in FIG. 10A, all restrictions above are relaxed by setting Relax_Rule=1 if the nFIQ or nIRQ bit or EA bit is active at the MPU boundary. Monitor Mode is entered or exited in response to and as a consequence of an FIQ or IRQ or EA. For instance, the TABLE 8 FIQ_Trapped_In_Monitor field replicates part of the security zone mechanism static configuration to teach the CPSR Mode Checker and NS Bit Enforcement 2755 that a switch to Monitor Mode can appropriately happen when an FIQ occurs and thus no Security Violation should be generated. When this FIQ_Trapped_In_Monitor is activated, the Relax_Rule flag can be set, and block 2755 looks at Interrupt Handler 2720 output to MPU and detects when nFIQ signal is asserted/deaserted to MPU interrupt interface. In this way, hypervisor operation in Monitor Mode is further supported by hardware.

FIG. 9B and FIGS. 10A/10B and TABLE 1 show the CPSR Mode Checker and NS Bit Enforcement block 2755 and example circuitry represented by hardware design code. The CPSR_Mode signal signifies whether the hypervisor Monitor Mode is active or operations have switched to another mode. Note that in FIG. 10B and TABLE 1, the shorthand notation {User,Abort,Undef,System} acts as an index with four values and means that a variable or a block of design code is provided for User, and repeated analogously for Abort, and repeated analogously for Undef, and repeated analogously for System.

The variable CPSR_Old represents a next-previous value of the variable CPSR_Mode. CPSR_Old and CPSR_Mode are compared to determine whether the system is continuing in Monitor Mode, transitioning out of Monitor Mode, or transitioning into Monitor Mode, and to perform enforcements accordingly. The variable NSbit_Old represents a next-previous value of the MPU security signal CP15S_NS representing Non-secure or Secure.

In FIG. 10A, operations commence with a BEGIN 2802 and proceed to a step 2805 that initializes flags and variables (e.g., to zero). Step 2805 also inputs the information fields or bits from the CPSR Mode Enforcement Register in Control Module 2765 and also inputs from MPU 2610 the Non-secure/Secure signal NS and the CPSR Mode.

A decision step 2810 determines whether the NS bit has been flipped (state-changed) outside of Monitor Mode. If Yes, a security violation Flag1 is set at a step 2812. A succeeding decision step 2815 is executed after either step 2812 or after No at step 2810. Decision step 2815 determines whether NS=0 (Secure) and a switch either from System mode to User mode or from User mode to System mode occurred. If Yes, another security violation Flag2 is set at a step 2818.

A following decision step 2820 is executed after either step 2818 or after No at step 2815. Decision step 2820 determines whether operations are entering Monitor Mode from an occurrence of Fast interrupt FIQ, regular interrupt IRQ, or External Abort EA. If Yes, then a Relax_Rule flag is set (e.g. to one) at a step 2822, and if No, then the Relax_Rule flag is cleared (e.g. zero) at a step 2826.

For illustrative purposes in FIG. 10B, a series of paired decision steps represent the same decision but different outcomes in a particular pair. The pairs of decision steps are shown as pair 2830, 2835; pair 2840, 2845; pair 2850, 2855; and pair 2860, 2865. If Relax_Rule flag is clear (zero) in step 2826, then steps 2830, 2840, 2850, 2860 apply. If Relax_Rule flag is set (one) in step 2822, then steps 2835, 2845, 2855, 2865 apply. In TABLE 1, the flag values are handled by nested IF statements, and FIG. 10B shows a related alternative embodiment.

If step 2826 is reached and Relax_Rule=0 therein, operations proceed to decision step 2830 to determine whether NS=0 (Secure) and if Monitor Mode is being entered from User/Abort/Undef/System mode. If Yes, then operations branch to set security violation Flag3, Flag 4, Flag5, and/or Flag6 in a step 2832 depending from which mode the entrance to Monitor Mode is being attempted. If No in step 2830, then operations proceed to decision step 2840, to determine whether operations are conversely leaving Monitor Mode to any of User/Abort/Undef/System mode. If Yes in step 2840, then operations branch to set security violation Flag3, Flag 4, Flag5, and/or Flag6 in step 2832 depending on to which mode the transition from Monitor Mode is being attempted. In other embodiments, separate additional flags are provided.

After step 2832 or after No in step 2840, then operations proceed to decision step 2850, to determine whether NS=1 (Non-secure, Public) and if Monitor Mode is being entered from User/Abort/Undef/System mode. If Yes, then operations branch to set security violation Flag7, Flag 8, Flag9, and/or Flag10 in a step 2862 depending from which mode the entrance to Monitor Mode is being attempted. If No in step 2850, then operations proceed to decision step 2860, to determine whether operations are conversely leaving Monitor Mode to any of User/Abort/Undef/System mode. If Yes in step 2860, then operations branch to set security violation Flag7, Flag8, Flag9, and/or Flag10 in step 2862 depending on to which mode the transition from Monitor Mode is being attempted. In other embodiments, separate additional flags are provided.

In FIG. 10B, if Relax_Rule step 2822 is reached instead of step 2826, operations proceed to decision step 2835 instead of 2830 to make the same determination whether NS=0 (Secure) and if Monitor Mode is being entered from User/Abort/Undef/System mode. If Yes at step 2835, then operations branch to a step 2838 to set a particular flag Relax_Rule_SEC_User/Abort/Undef/System (e.g. to one, and not indicative of a security violation) and proceed to a step 2855. If No at step 2835, operations go to step 2845, make the same determination as step 2840 and go to step 2838 if Yes at step 2845 and step 2855 if No at step 2845. At step 2855 the same determination as step 2850 determines whether NS=1 (Public) and if Monitor Mode is being entered from User/Abort/Undef/System mode. If Yes, then operations instead branch to a step 2858 to set a particular flag Relax_Rule_PUB_User/Abort/Undef/System (e.g. to one, and not indicative of a security violation) and proceed to a step 2870. If No at step 2855, operations go to step 2865, make the same determination as step 2860 and go to step 2858 if Yes at step 2865 and step 2870 if No at step 2865.

Following any of steps 2860 (No), 2862, 2865 (No), or 2858, a step 2870 prepares for a subsequent cycle of transition monitoring. Step 2870 updates NSBIT_Old with the value of NS, and NS is updated on a subsequent cycle. Step 2870 also updates CPSR_Old with the value of CPSR_Mode, and CPSR_Mode is updated on a subsequent cycle. After step 2870, a composite security violation flag SECURITY_VIOLATION_CPSR is updated with a logic function such as an OR of all the diagnostic security violation flags Flag1, Flag2, . . . Flag10 described above in connection with steps 2812, 2818, 2832, 2862. The Security_Violation_CPSR flag is fed to Security Violation Handler 2760 of FIGS. 9 and 28A/28B. Then a RETURN 2898 is reached and hardware operations go back to BEGIN 2802 for a subsequent cycle of monitoring various transitions so as to structure and protect Monitor Mode to effectively act as a hypervisor.

To protect a security zone, the SSM CPSR Mode Checker and NS Bit Enforcement block 2755 ensures that no CPSR_Mode switch can occur from User mode directly to Monitor Mode while bypassing the Secure kernel or bypassing Supervisor mode contrary to the operation of FIG. 5. This protection is provided because such a switch-bypass is likely to be associated with a compromise of security.

In FIG. 10A, the Relax_Rule flag in one example of the circuitry provides a signal for SSM 2460 showing the security zone configuration in embodiments wherein the MPU 2610 might not provide all MPU2610 CP15 register bits as hardware signals on the SECMON bus. Other embodiments provide auto-detection hardware of the MPU 2610 CP15 configuration as well as for MMU and caches.

The flag Relax_Rule is set to ‘1’ when FIQ or IRQ are detected (fired to the MPU hardware inputs) and IRQ/FIQ_traps in Monitor Mode are configured to ‘1’. If there is a transition User mode to Monitor Mode and Relax_Rule=0, meaning that the more-permissive case of Relax_Rule=1 is absent, then the SSM hardware generates a Security Violation if Monitor_vs_User register field of TABLE 8 in the SSM_CPSR_Mode_Enforcement register in Control Module 2765 is set active. Otherwise if the Monitor_vs_User bit is inactive, no violation is taken. In this way, the hardware uses or takes the Monitor_vs_User register bit to make an implicit decoding of whether or not to generate a Security Violation.

If Relax_Rule=1, a flag is set or kept that represents that a jump back is expected and not a security violation. When the jump back occurs, no FIQ/IRQ is asserted to the MPU 2610. The condition of Relax_Rule=1 facilitates switching back and forth between modes starting from Public User mode, such as for example, Public User to Monitor Mode and back to Public User mode. Suppose an interrupt FIQ fires during a software application. The improved SSM 2460 traps FIQ/IRQ/EA into Monitor Mode, and the system hardware is established (static configuration, architecture defined, for instance) to create a CPSR_Mode switch from User mode to Monitor Mode. Respective signals designated {FIQ/IRQ/EA}_Trap_in_Monitor allows control over mode switches between User and Monitor Mode by detecting that these events have happened, and ensure that a switch that could be associated with a security attack is prevented. From a software viewpoint FIQ trapping directly into Monitor Mode further enables the hardware to structure and establish Monitor Mode code as a hypervisor.

A further embodiment of the hypervisor prevents and detects inter-virtual mode switches, such as from Non-virtual Public User mode to Virtual Public Monitor Mode. Another embodiment implements eight categories instead of the four shown in FIG. 4.

The hardware design code of TABLE 1 has IF conditions involving each of the enforcement fields of TABLE 8 in the SSM_CPSR_Mode_Enforcement register and generally follows the flow of FIGS. 10A/10B. The various Flags 1-10 of FIGS. 10A/10B are given respective mnemonic names prefixed by CPSR_Switch_in TABLE 1. Some embodiments leave the enforcement fields out of the IF condition and instead load the respective Flag with the pertinent field in the THEN portion of the operations, which accomplishes a similar result. Note that more or fewer flags are suitably used in various embodiments depending on the amount of diagnostic detail desired in case a security violation occurs.

TABLE 1
CPSR MODE ENFORCEMENT HARDWARE DESIGN CODE EXAMPLE

```
CPSR_Switch_NSbit <= ‘0’;;
CPSR_{—} Switch_SEC_SYSUSER <= ‘0’;
CPSR_{—} Switch_SEC_{User,Abort,Undef,System} <= ‘0’;
Relax_Rule_SEC_{User,Abort,Undef,System} <= ‘0’;
CPSR_Switch_PUB_{ User,Abort,Undef,System} <= ‘0’;
Relax_Rule_PUB_{User,Abort,Undef,System} <= ‘0’;
IF (CPSR_Enforcement_EN = ‘1’) THEN
  IF (SECZONE_NS_BIT_{—} Enforcement = ‘1’ AND NSBIT_Old != CP15S_NS) -
MONITOR MODE ONLY ALLOWED TO FLIP NS BIT--
    THEN
      IF (CPSR_Mode = Monitor & CPSR_Old = Monitor)
      THEN CPSR_Switch_NSBIT <= ‘0’;
      ELSE CPSR_Switch_NSBIT <= ‘1’;
      ENDIF;
  ENDIF;
IF (System_vs_User_{—} Enforcement = ‘1’ AND CP15S_NS = ‘0’)
    - IN THE SECURE WORLD: SYSTEM vs USER ENFORCEMENT
  THEN
        IF (CPSR_Old = System & CPSR_Mode = User)
          THEN CPSR_Switch_SEC_SYSUSR <= ‘1’;
        ELSIF (CPSR_Old = User & CPSR_Mode = System)
          THEN CPSR_Switch_{—} SEC_SYSUSR <= ‘1’;
          ELSE CPSR_Switch_SEC_SYSUSR <= ‘0’;
        ENDIF;
ENDIF;
IF  (FIQ_Trapped_In_Monitor = ‘1’ & nFIQ = ‘0’)
  OR (IRQ_Trapped_In_Monitor = ‘1’ & nIRQ = ‘0’)
  OR (EA_Trapped_In_Monitor = ‘1’)
      - ENTERING MONITOR MODE IN RESPONSE TO FIQ/IRQ/EA--
    THEN Relax_Rule<= ‘1’;
    ELSE Relax_Rule<= ‘0’;
ENDIF;
IF (Monitor_vs_{User,Abort,Undef,System}_Enforcement = ‘1’ & CP15S_NS = ‘0’)
  - SECURE --
  THEN
      IF (CPSR_Old = {User,Abort,Undef,System}& CPSR_MODE = Monitor)
      --ENTERING MONITOR MODE--
      THEN
        IF Relax_Rule= ‘0’
            THEN CPSR_Switch_SEC_{User,Abort,Undef,System} <= ‘1’;
          ELSE Relax_Rule_SEC_{User,Abort,Undef,System} <= ’1’;
          ENDIF;
    ELSIF ((CPSR_Old = Monitor) & (CPSR_Mode = {User,Abort,Undef,System}))
      --LEAVING MONITOR MODE--
      THEN
          IF Relax_Rule_SEC_{User,Abort,Undef,System} = ‘0’
            THEN CPSR_Switch_SEC_{User,Abort,Undef,System} <= ‘1’;
          ELSE Relax_Rule_SEC_{User,Abort,Undef,System} <= ’0’;
          ENDIF;
        ELSE CPSR_Switch_SEC_{User,Abort,Undef,System} <= ‘0’;
    ENDIF;
ENDIF;
IF (Monitor_vs_{User,Abort,Undef,System}_{—} Enforcement = ‘1’ & CP15S_NS = ‘1’)
  - PUBLIC--
  THEN
    IF (CPSR_Old ={User,Abort,Undef,System}& CPSR_Mode = Monitor)
      --ENTERING MONITOR MODE--
    THEN
        IF Relax_Rule= ‘0’
          THEN CPSR_Switch_PUB_{User,Abort,Undef,System} <= ‘1’;
        ELSE Relax_Rule_PUB_{User,Abort,Undef,System} <= ’1’;
        ENDIF;
    ELSIF (CPSR_Old = Monitor & CPSR_Mode ={User,Abort,Undef,System}
      --LEAVING MONITOR MODE--
      THEN
        IF Relax_Rule_PUB_{User,Abort,Undef,System} = ‘0’
          THEN CPSR_Switch_PUB_{User,Abort,Undef,System} <= ‘1’;
        ELSE Relax_Rule_PUB_{User,Abort,Undef,System} <= ’0’;
      ENDIF;
    ELSE CPSR_Switch_PUB_{User,Abort,Undef,System} <= ‘0’;
  ENDIF;
ENDIF;
NSBIT_Old <= CP15S_NS;
CPSR_Old <= CPSR_Mode;
SECURITY_VIOLATION_CPSR <=
```

| | | | |
|---|---|---|---|
| CPSR_Switch_NSBIT | OR | CPSR_Switch_SEC_SYSUSR | OR |
| CPSR_Switch_SEC_User | OR | CPSR_Switch _PUB_User | OR |
| CPSR_Switch_SEC_Abort | OR | CPSR_Switch_PUB_Abort | OR |
| CPSR_Switch_SEC_Undef | OR | CPSR_Switch_PUB_Undef | OR |
| CPSR_Switch_SEC_System | OR | CPSR_Switch_PUB_System; | |

In FIG. 11, an integrated circuit has processor core 2610 coupled via the MPU2BUS block 2665 to the SSM Violation Handler 2760. The processor core 2610 is coupled via various functional bus lines 2902 to the SSM Physical Checker 2650. Bus lines 2902 in an example are Clock as well as Protection, Address, and Valid lines for each of an Instruction bus, Data Read bus, and a Data Write Bus. The SSM Physical Checker 2650 of FIG. 11 is a hardware block, such as established by design code of TABLE 2 or TABLE 3 or otherwise to perform physical checking. Physical Checker 2650 determines whether any physical address is in the Modem physical address range. The FIG. 11 example has eight ranges Start/End defined by registers 2620.0-.7 “Modem” is used in the TABLE 2 and TABLE 3 discussion without limitation for a system block controlled by an RTOS in Virtual Public category 2430.

In the example of TABLE 2, hardware Firewalls FW permit Data accesses by Modem or by Secure mode, and this is called multi-share herein. For multi-sharing, CPSR_Mode information from the SECMON bus is used with a suitable Data Memory Barrier established in Monitor Mode. SSM Physical Checker 2650 generates the MreqSystem classifier. Physical Checker 2650 performs MreqType checking of Data versus Instruction and checks the MMU coherency, and issues the Security Violation signal if these checks detect a problem.

In FIG. 11, a secure access (NS=0, MreqSecure=‘1’) to a location in Modem physical address space is seen as a permitted secure access even if the access is not originated by the Modem. Such normal secure access is permitted, with firewall and run-time integrity checks.

TABLE 2 is useful for describing concepts applicable to different embodiments with different bussing structures. For example, some embodiments have a single bus for instructions and data, and other embodiments have an instruction bus and a separate data bus for data. Yet other embodiments have the data bus separated into a data read bus and a data write bus. Still other embodiments have multiple width bus structures and other bus structures for increasing bandwidth and parallelism and for other purposes.

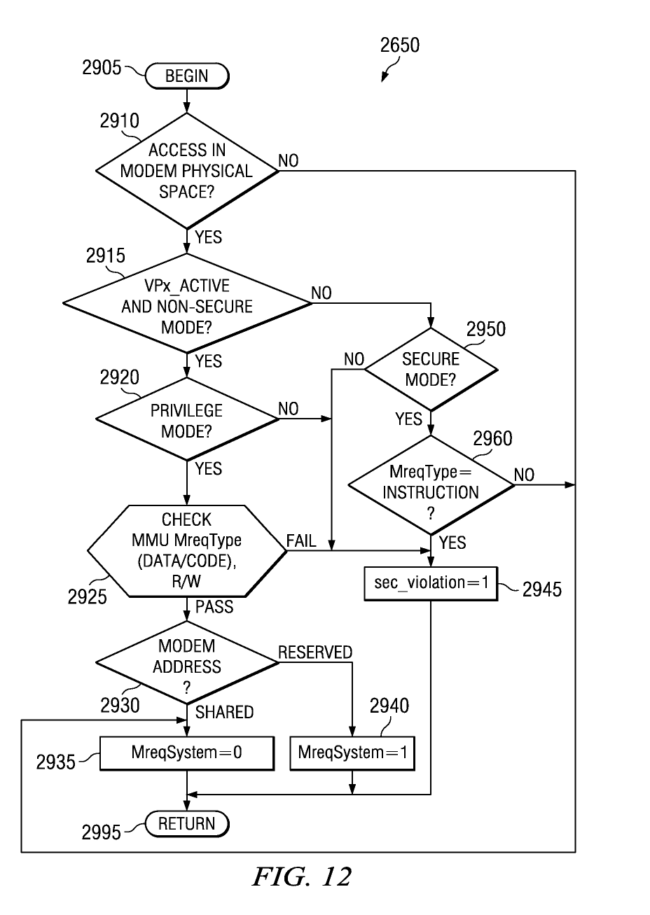

FIG. 12 depicts operations of the hardware defined in TABLE 2. Operations commence at a begin 2905 and proceed to a decision step 2910 to check one or busses to determine whether an access in Modem physical space has occurred. If so, then operations proceed to a decision step 2915 to determine whether the mode is a Public (non-secure) mode and the virtual processor field VP1_Active (VPx_Active in general) is active concurrently. In the modem virtual processor example, passing step 2915 (Yes) means that the modem so far appears to be attempting an access in modem physical address space. If so, then operations proceed to a further decision step 2920 to determine whether the mode is a Privilege mode. If so, then operations proceed to a checking step 2925 to check the MMU based on whether a Data or Instruction access is involved and whether the access is a read or write access.

If the checking at step 2925 passes, then the MMU passes and operations go to a decision step 2930 to determine whether the Modem address to which access is attempted is a Shared address or a Reserved address. If Shared address, then operations go to a step 2935 to set the classifier MreqSystem to a predetermined inactive value (e.g., zero). If a Reserved address in step 2935, then operations go instead to a step 2940 to set the classifier MreqSystem to an active value (e.g., one). If the checking at step 2925 fails, then the MMU is incoherent and operations instead branch from step 2925 to a step 2945 to set a Security Violation SEC_VIOLATION flag active (e.g., one) for the applicable bus in FIG. 11.

In FIG. 12, if the mode is not a Privilege mode in step 2920, then operations branch to step 2945 to set the Security Violation SEC_VIOLATION flag active. If in step 2915 the mode is not both VPx_Active and Public (non-secure), then operations branch to a step 2950 to determine whether the mode is a Secure mode. If not, then operations go to step 2945 and set the Security Violation SEC_VIOLATION flag active, since a non-secure, non-virtual-processor access is not permitted in modem space, for example. If the mode is a Secure mode at step 2950, it might be making a data access, but an instruction access is not permitted. If Secure mode at step 2950, then operations instead go to decision step 2960 to determine whether the type of access is for an instruction (MreqType=instruction). If not, then the access is a permitted access for Data and operations go from step 2960 to the step 2935 to set the classifier MreqSystem inactive (zero). If the access is for an instruction (Yes at step 2960), then the access is not a permitted access into Modem space, even though it is in Secure mode, and operations go from step 2960 to the step 2945 to set the Security Violation SEC_VIOLATION flag active. After completion of any of steps 2935, 2940 or 2945 to issue MreqSystem or set the Security Violation, then operations go to a RETURN 2995 and the hardware goes back to BEGIN 2905 to evaluate another access.

FIG. 11 and TABLE 3 show an example of a Physical Checker in an embodiment having a separate instruction bus, data read bus, and data write bus. Physical Checker 2650 supplies signals on MreqSystem lines for instruction bus, read bus, and write bus. SSM Physical Checker 2650 also is coupled by Security Violation lines for instruction bus, read bus and write bus to the SSM Violation Handler 2760. Security Monitoring bus SECMON delivers CP15S_NS and CPSR Mode signals to Physical Checker 2650. Physical Checker 2650 is coupled to SSM Registers 2620 that configure and control the operations of Physical Checker 2650. Physical Checker 2650 of FIG. 11 includes portions of block 2740 of FIG. 9 that support and perform physical checking.

Eight sets of SSM Registers .0-.7 each include physical start address PHY_VP1_START0, physical end address PHY_VP1_END0. The addresses are suffixed with an index x (e.g., 0, 1, . . . , 7). Index x represents any one of a predetermined number of different contexts (e.g., eight) permitted in the example, and the registers establish that number of physical address ranges specified by physical Start/End address boundaries and that same number of virtual address ranges specified by virtual Start/End address boundaries.

In this example, the Virtual Public category 2430 of FIGS. 4 and 6 has an address space which is the composite of eight physical address ranges defined by the eight pairs of Start and End registers. These physical start/end registers are useful for hardware-determining the Boolean designated Access_in_Modem_Physical_Space in TABLE 2 that goes active when an access is attempted into Modem physical address space. They are explicitly identified in the logic of TABLE 3.

In FIG. 11, the SSM Registers also include virtual processor registers SSM_VIRTUAL_PROCESSOR, and register SSM_PHYSICAL_VP1, and Virtual Processor (VP1) information VP1_DEBUG_DIS, VP1_NS, and VP1_ACTIVE. The register SSM_PHYSICAL_VP1 has eight (8) single-bit entries that when set high respectively indicate that a corresponding physical memory space 0, 1, . . . , 7 is data only. These entries are useful as in TABLE 2 because checking whether an access is permitted can depend on whether the access is for instructions or for data.

When VP1_DEBUG_DIS is high, enable lines designated DBGEN and NIDEN are activated before entering the VP1 CPSR modes and are reset to previous value before exiting. When VP1_NS is low in FIG. 11, the Virtual Secure category 2440 or Non-Virtual Secure category 2450 is active in FIGS. 4 and 6. When VP1_NS indicates Public and VP1_Active represents Virtual (active), the CPSR modes are active for Virtual Public category 2430. See also FIG. 30, TABLE 30 and TABLE 36.

SSM_VIRTUAL_PROCESSORS holds the Secure Demand Paging (SDP) Page Usage Level which relates to the priority of the page for demand paging purposes, see incorporated patent application TI-39617.

In FIG. 11, the Physical Checker 2650 maintains and detects violations of a definition of a Physical Modem space range that includes On-Chip RAM for modem, system peripheral space for Modem and Emulation, WCDMA modem, Flash memory section, SDRAM Reserved section and SDRAM Shared section, MMU TTB Shared section, and their related registers that are suitable for mapping into modem address space.

TABLE 2
SSM PHYSICAL CHECKER HARDWARE DESIGN PSEUDOCODE
1^{ST} EXAMPLE

```
IF (Access_in_Modem_Physical_Space= ‘1’)
  IF CPSR_MODE = “System” and MreqSecure =”0”) THEN
    IF (MreqPrivilege = “1”) THEN (MMU checker -> shadow registers)
      Check Data vs. Instruction section (MreqType) and R/W
            IF SUCCESS:
                If Modem_RESERVED_addr THEN
                MreqSystem <= ‘1’
                If Modem_SHARED_addr THEN
                MreqSystem <= ‘0’
            IF FAIL: SECURITY_VIOLATION = ‘1’
    ELSE SECURITY_VIOLATION = ‘1’ (MMU is not coherent.)
    ENDIF
  ELSIF (MreqSecure =’1’) THEN
        IF (MreqType = “Instruction”) then
        SECURITY_VIOLATION = ‘1’
          (Attempt to execute instructions from Modem resources is
          not permitted
              by this access even though in the Secure mode.)
        ELSE MreqSystem =’0’
          (Program in Secure mode can access data from Modem
          physical space.)
        ENDIF;
  ELSE SECURITY_VIOLATION = ‘1’ (Attack on Modem resources
  is detected.)
ELSE MreqSystem =’0’ (Normal access outside Modem physical space)
ENDIF;
```

In TABLE 3, the Physical Checker 2650 hardware checks both that the mode is not Monitor Mode and that the Virtual_processor mode is active. The hardware verifies that the Virtual processor VP1 is coherent, such as that CP15S_NS has the configured value for it.

The hardware 2650 also checks whether the current access at this clock cycle is occurring in one of the defined physical address ranges indexed x for an allowed context. If it is not in a permitted range, then the circuitry generates a security violation. When software is hijacked, it is like to be executing or attempting access outside the permitted physical address ranges. For example, the designated . . . PROT[2] line provides Data/Opcode type information for checking. If the checks pass, then the hardware generates the MreqSystem qualifiers. The MreqSystem qualifiers are propagated, along with the now-checked bus signals representing the access, to interconnect firewalls for system peripherals for further checking and isolation of any problems according to the firewall hardware scheme.

For write bus monitoring, notice that the hardware does not need to check whether the mode is not Monitor Mode. This latitude is mainly due to posted write that can occur anytime even in Monitor Mode. Some CPU cores can post Read and Write addresses before any accesses physically happen. Some embodiments of SSM herein respond to this posting capability, when present, to send back an External Prefetch/Data Abort (In_Band) signal SRESP response before any physical Data Read or Data Write takes place. The MPU2BUS interface 2665, either directly or via Monitor code, responds to that In-Band signal to neutralize an attack by intercepting the actual Read or Write transaction. A damage scenario is prevented because memory is not corrupted or one or more attacker instructions are not executed.

Consider a case wherein Secure FIQ happens, operations directly enter Monitor Mode, and posted writes are issued at that time. Security remains uncompromised nevertheless. The reason is that even if an attacker process running in Public mode attempts to exploit this case, the Public mode attacker process is unable to modify the VP1_Active bit. Physical Checker 2650 therefore does not tag the access with MreqSystem active, and the access is caught and prevented by the interconnect firewalls 3522 of FIG. 18, which are reserved for the Modem by requiring MreqSystem active. Before a process can set the VP1_Active bit to an active state (e.g., one), a flush write buffer (responsible for posted write) is established. In this way security robustness is enhanced.

If the checks regarding non-Monitor, security NS, and VP1_Active pass and then any of the eight address range checks (contexts indexed x) activate the corresponding MreqSystem_x classifier, then an OR-ing process in the TABLE 3 hardware 2650 generates MreqSystem active for the access. More specifically, the Physical Checker 2650 tags the current transaction with MreqSystem active on the applicable bus IBUS (instruction), RDBUS (read data), or WRBUS (Write data). This MreqSystem active signal or tag is encapsulated in the current bus transaction by the MPU2BUS interface 2665.

If a security violation is detected, SSM hardware of TABLE 3 generates a security violation flag for status flag recordkeeping. The security violation flag is used to trigger a Warm CPU reset/interrupt or other suitable security response.

In FIGS. 13, 9, and 28B, Intercon_Attack_Neutralizer in some embodiments has bus-specific circuitry. For instance, Violation_IBUS_Neutralizer hardware generates a Prefetch Abort directly to the MPU core 2610 to prevent any further execution and jump to the appropriate exception state for Prefetch Abort. Hardware for Violation_RDBUS_Neutralizer and Violation_WRBUS_Neutralizer generates a Data Abort directly to the MPU core 2610 to prevent any further execution and causes a jump to the appropriate exception state for Data Abort.

Violation_IBus_Neutralizer has a first mechanism that detects a violation on the IBUS instruction bus (non-allowed address, wrong MReqInfo values). The Physical Checker 2650 of FIG. 9 and TABLE 3 generates neutralizer signals for Security Violation Handler 2760. Security Violation Handler 2760 is coupled to interface MPU2BUS 2665 to neutralize the access and return a response (HRESP=ERR) to the MPU 2610. The error signal ERR response forces the MPU enter a Prefetch Abort exception state directly in the CPSR current program status register, for instance.

In FIGS. 13, 9, and 28B, the Neutralizer has a second mechanism that responds to reception of a Data abort on a read data bus RDBUS or a write data bus WRBUS, such as from Interconnect 3521 of FIG. 18. Security Violation Handler 2760 forces generation of a Prefetch Abort on the instruction bus IBUS_Abort, RDBUS_Abort, or WRBUS_Abort. Some embodiments use a single Next_Instruction_Abort signal for this purpose. The type of abort is chosen as one that is not maskable in the MPU 2610 when received. For example, when a Prefetch Abort exception occurs, it is non-maskable and the MPU 2610 pipeline is flushed, and the instruction that was executing is obliterated, destroyed, or wiped out.

Generally, the particular software application generating the data abort should be terminated and is the particular one currently in the pipeline.

Some embodiments provide and take two successive exceptions. First a data abort is taken. Second, the data abort is followed by a prefetch abort. The prefetch abort is adapted to obliterate, erase or kill the program link (relative address) register in the MPU 2610 register file for the particular software application. Consequently, from a system point of view, the particular software application that caused the violation does not exist anymore because no branch back is possible. No branch back is possible because the relative address needed by a branch back process is absent. The Neutralizer mechanism(s) thus provides a useful virus killer.

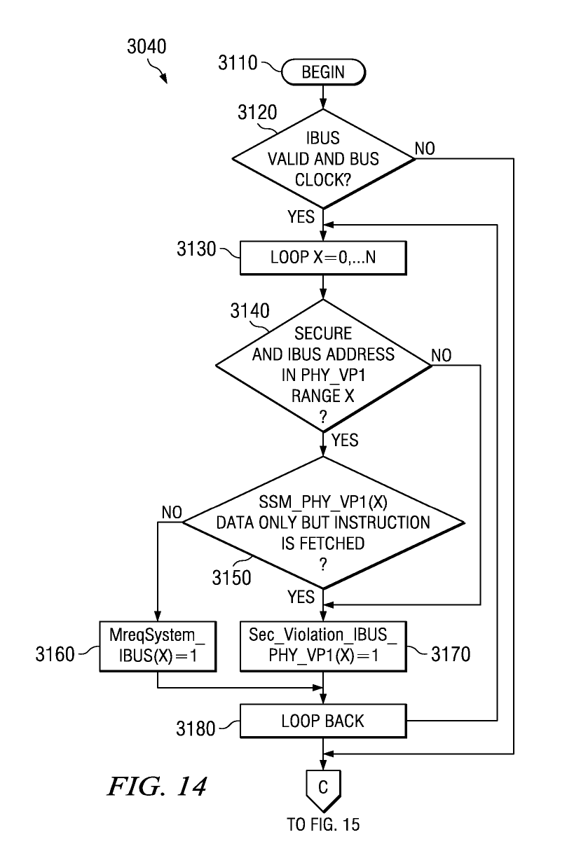

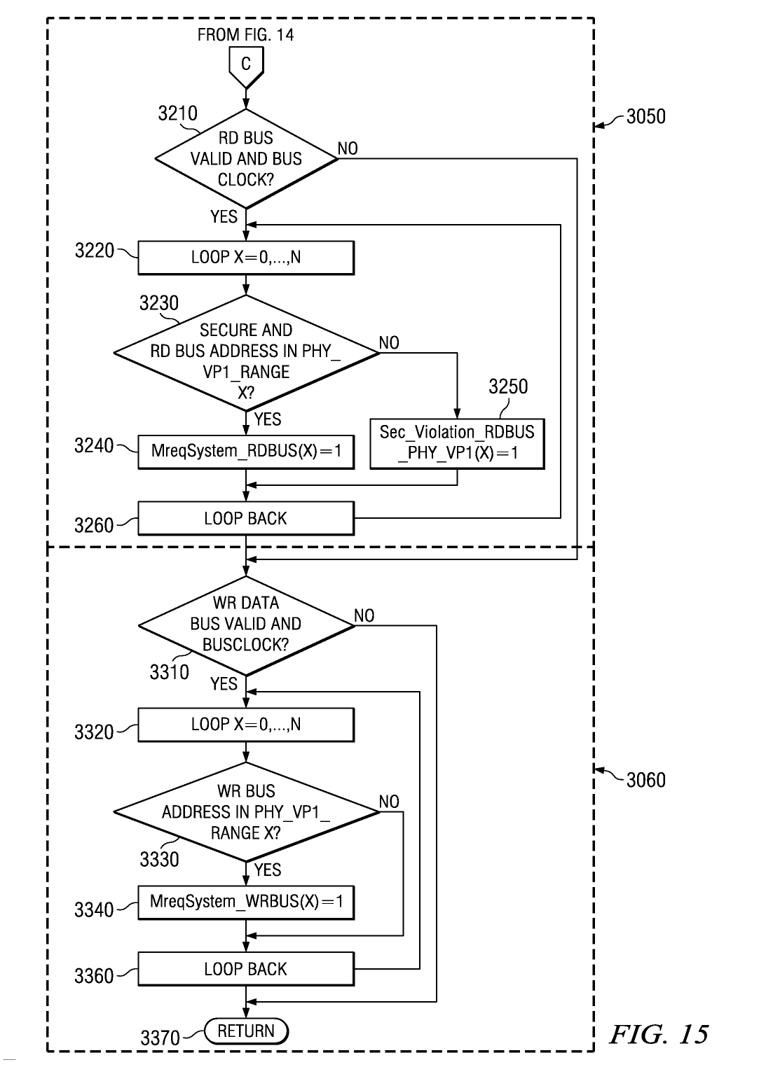

FIGS. 13, 14, 15 illustrate the operations of the hardware in TABLE 3. FIG. 13 provides an overview wherein operations commence at a BEGIN 3010 and proceed to a step 3020 to initialize various bus-specific fields inactive for bus-specific Security Violation SEC_VIOLATION_(bus), and bus-specific classifier MreqSystem(bus). Next a decision step 3030 determines whether the mode is both not the Monitor Mode, and the type of access security is the not the same as the security level of the virtual processor. For example, step 3030 suitably determines whether the access security is Secure mode from the Secure Environment SE when the Modem is Public (non-secure mode) Virtual. If Yes at step 3030, operations proceed to check an Instruction bus in step 3040 as detailed in FIG. 14. Upon completion of step 3040, operations proceed to step 3050 and then to step 3060 as detailed in FIG. 15 or all the operations 3040, 3050, 3060 are parallel in the hardware. In step 3050, an access on a Read Data Bus is checked. In step 3060, an access on a Write Data Bus is checked. In FIGS. 14 and 15, loops occur over indexed portions of physical address space assigned to the Modem. Index-specific MreqSystem flags and Security Violation flags are suitably set. Then operations proceed to a step 3070 to generate bus-specific signals for MreqSystem and Security Violation and Violation Neutralizer that involve OR-ing the corresponding index-specific flags.

If in step 3030, the mode is Monitor Mode or the access is from the Modem into its own space, or otherwise No in step 3030, then operations branch from step 3030 to step 3070 to set the bus-specific signals accordingly. After operations in step 3070, a RETURN 3080 is reached and the hardware goes back to BEGIN 3010 to evaluate the next access.

In FIG. 14, evaluation of an access on an Instruction bus IBUS commences at a BEGIN 3110 and proceeds to a decision step 3120 to a determine whether an IBUS access is occurring as indicated by a Valid line active and Bus Clock active. If so, operations proceed to a step 3130 to start a loop over index x for indexed portions of the physical address space assigned to the Modem. In the loop, a decision step 3140 determines whether both 1) the mode is a Secure mode and 2) the Instruction bus address is in a given range x of physical addresses between the Start and End register values inclusive for range x. If Yes at decision step 3140, then operations go to a step 3150 to determine whether SSM_PHY_VPI(x) register flags that this address range is for Data accesses only, and that an Instruction access is being attempted on the IBUS. If No at step 3150, then the IBUS access is permitted and a step 3160 sets an index-specific classifier MreqSystem_IBUS(x)=1 for that address range x. If Yes at step 3150, the IBUS access is not permitted, and operations go to a step 3170 to set an index-specific Security Violation SEC_VIOLATION_IBUS_PHY_VP1(x) active. After either step 3160 or step 3170 operations at a loop-back step 3180 loop back to step 3130 until the loop is completed for all the address ranges corresponding to the index x values 0, 1, . . . 7. After the loop is completed or if no IBUS access was detected (No at step 3120), then operations go to point C and on to FIG. 15.

In FIG. 15, evaluation of an access on a Data Read bus RDBUS has a decision step 3210 to a determine whether an RDBUS access is occurring as indicated by a RDBUS Valid line active and Bus Clock active. If so, operations proceed to a step 3220 to start a loop over index x for indexed portions of the physical address space assigned to the Modem. In the loop, a decision step 3230 determines whether both 1) the mode is a Secure mode and 2) the Data Read bus address is in a given range x of physical addresses between the Start and End register values inclusive for range x. If Yes at decision step 3230, the RDBUS access is a permitted access and operations go to a step 3240 to set an index-specific classifier MreqSystem_RDBUS(x)=1 for that address range x. If No at step 3230, the RDBUS access is not permitted, and operations go to a step 3250 to instead set an index-specific Security Violation SEC_VIOLATION_RDBUS_PHY_VP1(x) active. After either step 3240 or step 3250 operations at a loop-back step 3260 loop back to step 3220 until the loop is completed for all the address ranges corresponding to the index x values 0, 1, . . . 7. After the loop is completed or if no RDBUS access was detected (No at step 3210), then operations go on in FIG. 15 to a step 3310.

Further in FIG. 15, evaluation of an access on a Data Write bus WRBUS has a decision step 3310 to a determine whether an WRBUS Data Write access is occurring as indicated by a WRBUS Valid line active and Bus Clock active. If so, operations proceed to a step 3320 to start a loop over index x for indexed portions of the physical address space assigned to the Modem. In the loop, a decision step 3330 determines whether the Data Write bus address is in a given range x of physical addresses between the Start and End register values inclusive for range x. If Yes at decision step 3330, the WRBUS access is a permitted access and operations go to a step 3340 to set an index-specific classifier MreqSystem_WRBUS(x)=1 for that address range x. After step 3340, or if No at step 3330, operations at a loop-back step 3360 loop back to step 3320 until the loop is completed for all the address ranges corresponding to the index x values 0, 1, . . . 7. After the loop is completed or if no WRBUS access was detected (No at step 3310), then operations reach a RETURN 3370 in FIG. 15 and proceed to step 3070 of FIG. 13.

The hardware of TABLE 2 and TABLE 3 are helpfully compared with the system architecture of FIGS. 3 and 4. The location of the protocol stack (PS) software of FIG. 3 is situated in privileged mode because it is not used by the HLOS of Non-virtual Public category 2420 of FIG. 4. The protocol stack PS is not in Secure mode in this example and thus does not complicate particular security features that may be provided in Secure mode. The ACI upper layer(s) is ported to Secure mode and links with the SE kernel driver communication interface as indicated by FIG. 3 arrows 2820, 2830. Thus, the Modem protocol stack PS is made HLOS agnostic (independent of HLOS) while providing ACI security through a secure command interface.

Protocol stack PS is still in a Public Privilege mode, thus no software architecture changes are needed (direct porting on upgrade). Protocol stack PS is not in Secure mode and thus poses no threat to Secure mode under a security scenario of execution when protocol stack PS resides in Flash/SDRAM memory 1435 of FIG. 2. The protocol stack PS executes when resident in Flash/SDRAM without necessarily using Secure Demand Paging (SDP) 2745 of FIG. 9. HLOS access to protocol stack PS is done through ACI layer 2, which is established as an SE secure kernel service as shown in FIG. 5. If a currently-used HLOS is replaced with a new HLOS, the modem driver GSP is simply ported to the new HLOS.

Monitor Mode dynamically creates a second FIQ mode designated Modem FIQ mode of FIG. 5, which is not visible by HLOS. Any Modem-related interrupt is sent as a Secure FIQ and identified in the Monitor Mode. Each time a Modem FIQ occurs, the Monitor Mode changes the FIQ Mode base address to a predetermined address location of the Modem and Pushes/Pops the context. Such processing is referred to herein as the Secure FIQ served in Public mode.

The interrupt model is also HLOS agnostic. Modem FIQ interrupts are physically secure FIQ interrupts with high speed processing, and they are made to be higher priority than HLOS operation. See FIG. 36 also. Modem FIQ evolves in parallel with HLOS context. Modem FIQ takes priority over and coordinates with HLOS IRQ/FIQ. Secure FIQ thus provides atomic sectioning of the processing categories in FIGS. 3-6.

Hardware isolation architecture creates an MreqSystem qualifier and intelligently uses software and hardware security features. Using the MreqSystem qualifier, firewalls are improved to hardware-isolate any Modem resource dynamically. Monitor Mode is enforced, with acceptable impact on interconnect operation.

In regard to the pseudocode example of TABLE 2, the MMU mapping is enforced by the following measures. When in appropriate Privilege mode, the processor core 2610 evolves in a predefined Physical/Virtual memory space. Any change in the mapping is detected when in Privilege mode. The caches are physically indexed. The SSM 2460 architecture detects and responds to any non-permitted address overlap or MMU trashing. An example protocol stack PS is suitably executed in Virtual Public Privilege, and MMU is not be trashed in ordinary operation since MMU is setup by Monitor Mode and is not accessible by Public HLOS.

In order to preserve the integrity of the system operations, accesses to Modem reserved space 2545 of FIG. 7 are permitted only in a suitable mode such as Secure Privilege mode. A Read operation (L1/L2 cacheable) is permissible even if it originates from a Secure mode operation outside the Modem. A Write operation is permissible due to L1/L2 Cache line eviction in Others mode and Write Buffer drain. One example of the Modem reserved memory 2545 operates according to a L1/L2 cache write through policy. On privilege mode exit, a hardware enforced data memory barrier DMB is performed. On privilege mode exit to Modem FIQ mode, the Monitor Mode performs a DMB to resolve any conflict. A Modem shared section 2550 of address space in FIG. 7 is defined for an MMU page table walk. The MMU mapping is programmed by the HLOS Public Kernel or kernel drivers appropriately.

All Modem related FIQ is defined in privilege mode as Secure FIQ, and provides high speed, non-maskable, and HLOS-agnostic properties. The Monitor Mode is updated to encompass a list of the possible Modem FIQ interrupt number(s) (Modem reserved resources) and creates an additional FIQ mode (2nd Public FIQ mode).

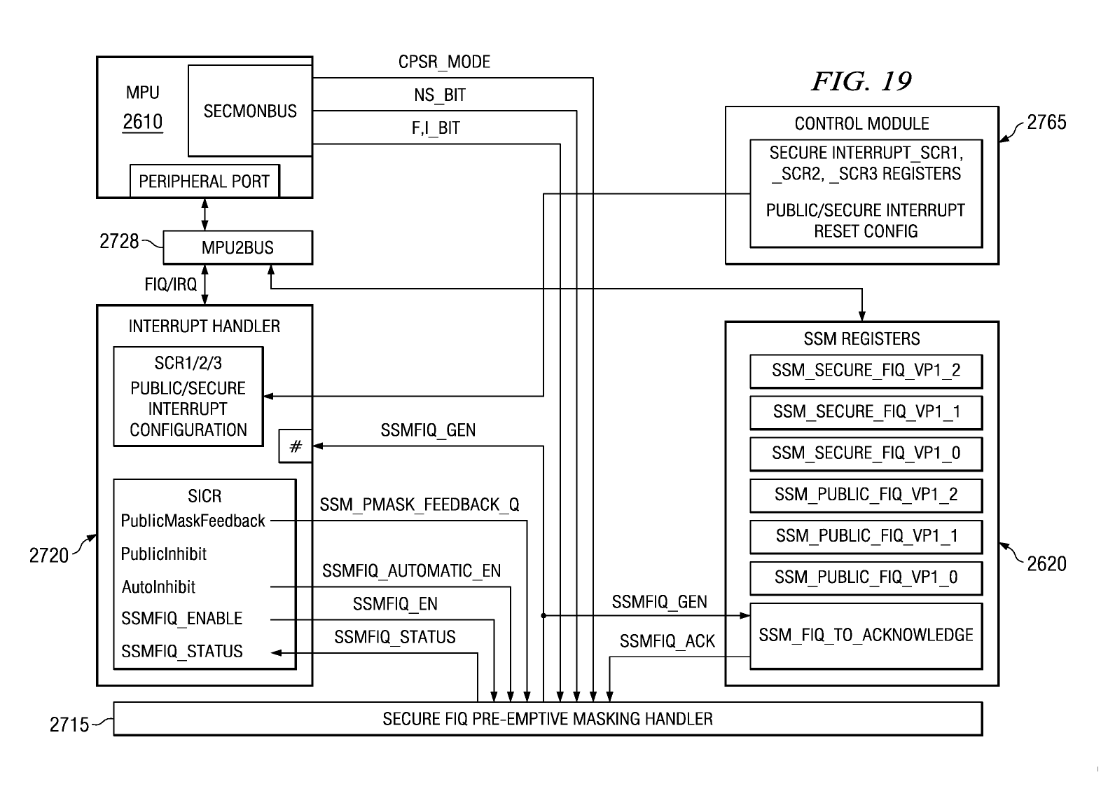

Another aspect creates in Interrupt Handler INTH 2720 of FIG. 9 a Modem interrupt identifier as for the Secure FIQ (three SCR registers), see FIG. 19. In one application processor example, any FIQ is trapped in Monitor mode under a security zone. The Monitor Mode decides to branch appropriately to Public FIQ mode or Secure FIQ mode.

In another aspect, the Monitor Mode creates a new Modem FIQ mode in the modem resource memory. That Modem FIQ is not correlated to other FIQ mode, and Modem FIQ physically evolves in Public FIQ mode. The secure interrupt is hardware controlled, and the CPSR F-bit public masking capability is re-allowed for this specific processing. Thus, the Modem software is fully isolated under Secure mode control. This method confers and ensures HLOS-agnostic properties when servicing Secure FIQ in Public mode.

TABLE 3
SSM PHYSICAL CHECKER 2650 HARDWARE DESIGN PSEUDOCODE 2^{ND} EXAMPLE
(&=AND. !=NOT.)

```
Sec_Violation_IBUS_PHY_VP1_x_{—} <= ‘0’;
Sec_Violation_RDBUS_PHY_VP1_x_{—} <= ‘0’;
MreqSystem_IBUS_{——}x_{—} <= ‘0’;
MreqSystem_RDBUS_{——}x_{—} <= ‘0’;
MreqSystem_WRBUS_{——}x_{—} <= ‘0’;
IF ((CPSR_Mode != Monitor_Mode & VP1_Active = ‘1’) & CP15_NS = ! (VP1_NS)) -
Secure/Public container--
  THEN
  IF (Instruction Bus Valid & Bus Clock)
    THEN -- LOOP_x--
      IF (ARPROTI [2] = ‘1’ & Instruction Data Bus Address in range defined by
        Start/End registers PHY_VP1_START_x_{—} , PHY_VP1_END_x_{—} )
      THEN
          IF (SSM_PHYSICAL_VP1 [_x_] = ‘1’ & ARPROTI [0] = ‘1’)
              -- Data only but Instruction is fetched-
          THEN Sec_Violation_IBUS_PHY_VP1_x_{—} <= ‘1’;
          ELSE MreqSystem_IBUS_x_{—} <= ‘1’;
          ENDIF;
      ELSE Sec_Violation_IBUS_PHY_VP1_x_{—} <= ‘1’
      ENDIF;
      End of LOOP_x
    ENDIF;
  IF (Read Data Bus Valid & Bus Clock)
      THEN -- LOOP_x--
        IF (ARPROTW [2] = ‘1’ (Secure) & Read Data Bus Address in range
          defined by Start/End registers PHY_VP1_START_x_{—} , PHY_VP1_END_x_{—} )
        THEN MreqSystem_RDBUS_x_{—} <= ‘1’;
          ELSE Sec_Violation_RDBUS_PHY_VP1_x_{—} <= ‘1’
          ENDIF;
          End of LOOP_x
    ENDIF;
    IF (Write Data Bus Valid & Bus Clock)
        THEN -- LOOP_x_{—} --
          IF (Write Data Bus Address in range defined by Start/End registers
                  PHY_VP1_START_x_{—} , PHY_VP1_END_x_{—} )
          THEN MreqSystem_WRBUS_x_{—} <= ‘1’;
          ENDIF;
          End of LOOP_x
    ENDIF;
ENDIF;
MreqSystem_IBUS <= MreqSystem_IBUS_0 OR. . .OR MreqSystem_IBUS_7;
MreqSystem_RDBUS <= MreqSystem_RDBUS_0 OR...OR MreqSystem_RDBUS_7;
MreqSystem_WRBUS <= MreqSystem_WRBUS_0 OR...OR MreqSystem_WRBUS_7;
Sec_Violation_IBUS_PHY_VP1 <=
  Sec_Violation_IBUS_PHY_VP1_0 OR...OR Sec_Violation_IBUS_PHY_VP1_7;
Sec_Violation_RDBUS_PHY_VP1 <=
  Sec_Violation_RDBUS_PHY_VP1_0 OR...OR Sec_Violation_RDBUS_PHY_VP1_7;
Sec_Violation_WRBUS_PHY_VP1 <=
  Sec_Violation_WRBUS_PHY_VP1_0 OR...OR Sec_Violation_WRBUS_PHY_VP1_7;
Violation_IBUS_Neutralizer<= Sec_Violation_IBUS_PHY_VP1;
Violation_RDBUS_Neutralizer <= Sec_Violation_RDBUS_PHY_VP1;
Violation_WRBUS_Neutralizer <= Sec_Violation_WRBUS_PHY_VP1;
```

In FIG. 16, the processor core 2610 is coupled to SSM Virtual Checker 2630 by SECMON bus lines CP15S_NS, and CPSR_MODE, and other SECMON bus lines. The processor core 2610 is further coupled to the SSM Virtual Checker 2630 by Trace Port lines Trace IA, TraceIACtl, TraceDA, TraceDDCtl, and TraceDACtl. These lines are tabulated in TABLE 4. The symbolism [ ] represents a bus line or bit, and the symbolism [:] represents multiple bus lines or bits. Some embodiments apply pipeline-specific trace to each pipeline of a superscalar processor (plural execute pipelines) as TraceIA0 and TraceIA1.

TABLE 4
SECURITY MONITOR SECMON BUS AND TRACE BUS LINES

| | |
|---|---|
| CPSR[ ] | A, I, F, and T bits and 4-bit CPSR_Mode from |
| | pipeline |
| | Writeback stage |
| CPSR | J bit |
| CP15S_NS | CP15 Secure Configuration Register bit |
| CP15S_M | CP15 Secure Control Register bit of current bank |
| CP15S_C | CP15 Secure Control Register bit of current bank |
| CP15S_I | CP15 Secure Control Register bit of current bank |
| IMB | Instruction memory barrier executing (flush prefetch |
| | buffer) |
| DMB_DWB | Data memory barrier or data write barrier executing |
| TraceIA0[ ] | Pipe 0 instruction address |
| TraceIA1[ ] | Pipe 1 instruction address |
| TraceL1DA[ ] | L1 data address |
| TraceICTL[ ] | Exception |
| TraceICTL[ ] | ICCFail1, ICCFail0, IAValid1, IAValid0 |
| TraceICTL bit | Exception Valid |
| TraceL1CTL bit | TRACE L1 Data Address Valid |

In FIG. 16, the SSM Virtual Checker 2630 is coupled by security violation lines for instruction bus and data bus to the SSM Violation Handler 2760. These lines are designated Sec_Violation_IBUS_VIR_VP1 and Sec_Violation_DBUS_VIR_VP1.

Analogous to FIG. 11, SSM Registers 2620.0-.7 for eight corresponding contexts in virtual space support the Virtual Checker 2630. Eight sets of SSM Registers 2620.0-.7 each include virtual start address SSM_VIRTUAL_VP1_START0, virtual end address SSM_VIRTUAL_VP1_END0, and virtual processor registers SSM_VIRTUAL_PROCESSOR, and SSM_VIRTUAL_VPI. For example, the register SSM_VIRTUAL_VP1 has eight (8) single-bit entries that when set high respectively indicate that a corresponding virtual memory space 0, 1, . . . , 7 is data only. The VP1 information VP1_DEBUG_DIS, VP1_NS, and VP1_Active are as discussed above in connection with FIG. 11.

The Virtual Checker 2630 maintains and detects violations of a definition of a Virtual Modem space range that includes on-chip RAM modem, Modem Peripherals and Emulation, WCDMA modem, Flash memory section, SDRAM Reserved section and SDRAM Shared section, MMU TTB Shared section, and related registers.

The SSM Virtual Checker 2630 is suitably established to accomplish its functions such as according to the hardware design pseudocode of TABLE 5 or hardware design code of TABLE 6 for two examples. NS_bit active means non-secure mode except Monitor Mode is secure.

TABLE 5
SSM VIRTUAL CHECKER HARDWARE DESIGN PSEUDOCODE
1^{ST} EXAMPLE

```
IF CPSR_MODE = “System” and NS_BIT =’1’ THEN
    Check any virtual address is in the MODEM virtual address range
    Check Data vs. Instruction section
    Check MMU mapping coherency
    IF FAIL: SECURITY_VIOLATION =’1’
ENDIF;
IF CPSR_MODE = “FIQ” and NS_BIT = ‘1’ AND
SSM_MODEM_FIQ = ‘1’ THEN
    Check any virtual address is in the MODEM virtual address range
IF Access_is_in_Modem_virtual_space= ‘1’ THEN
  IF SSM_MODEM_FIQ = ‘1’ (Monitor set SSM bit to
  create modemFIQ)
      Check Data vs. Instruction section
      Check R/W properties
      Check MMU mapping coherency
      IF FAIL: SECURITY_VIOLATION = ‘1’
    ELSE
      SECURITY_VIOLATION = ‘1’(NOT Allowed)
    ENDIF;
  ELSE
    SECURITY_VIOLATION = ‘0’
  ENDIF;
ENDIF;
IF (Switch between Public System MODE and
Monitor MODE) =’1’ THEN
      SECURITY_VIOLATION = ‘0’
ELSE
      SECURITY_VIOLATION = ‘1’(NOT Allowed)
ENDIF;
```

All other switches to System mode are enforced (e.g., Public Supervisor to Public System mode is forbidden).

TABLE 6
SSM VIRTUAL CHECKER HARDWARE DESIGN CODE
2^{ND} EXAMPLE

```
Out_of_IContainer_x <= ‘0’;
Out_of_DContainer_x <= ‘0’;
MPU_Inst_Not_Valid <= ‘0’;
Branch_Phantom_Not_Valid <= ‘0’;
Data_Inst_Not_Valid <= ‘0’;
Data_Slot_Abort <= ‘0’;
TracePwrUp <= ‘1’;
IF ((CPSR_Mode != Monitor_Mode & VP1_Active = ‘1’) &
CP15_NS = !(VP1_NS)) -
Secure/Public container --
  THEN
    IF (SECMONBUS [0] = ‘1’) - Instruction Executed out of Pipeline--
      THEN
        IF (TraceIACtl [1] = ‘1’) THEN
          IF TraceIACtl [5] = ‘0’
            THEN MPU_Inst_Not_Valid <= ‘0’;
            ELSE MPU_Inst_Not_Valid <= ‘1’;
          ENDIF
        ENDIF
        IF (TraceIACtl [2] = ‘1’) THEN
          IF TraceIACtl [6] = ‘0’
            THEN Branch_Phantom_Not_Valid <= ‘0’;
            ELSE Branch_Phantom_Not_Valid <= ‘1’;
          ENDIF
        ENDIF
        IF (TraceIACtl [9] = ‘1’) THEN
          IF TraceIACtl [10] = ‘0’
            THEN Data_Inst_Not_Valid <= ‘0’;
            ELSE Data_Inst_Not_Valid <= ‘1’;
            ENDIF
        ENDIF
    -- LOOP_x on Trace Instruction Address in Virtual Address
    Ranges--
      IF ((TraceIA in Staff/End Range of VIR_VP1_START_x,
      VIR_VP1_END_x) &
            SSM_Virtual_VP1_x = ‘0’)
        THEN Out_of_IContainer_x <= ‘0’;
        ELSE Out_of_IContainer_x <= ‘1’;
    ENDIF;
  ENDIF;
IF SECMONBUS [4:3] = “00” - Data Transferred (Read or Write)
out of Pipeline-
  THEN Data_Slot_Abort <= ‘0’;
  ELSE
    IF TraceDDCtl [3:2] = “00”
        THEN Data_Slot_Abort <= ‘0’;
        ELSE Data_Slot_Abort <= ‘1’;
    ENDIF;
  ENDIF;
IF (SECMONBUS [2:1] = “00” OR TraceDACtl [15] = ‘1’)
    THEN Out_of_DContainer_x <= ‘0’;
    ELSE
    -- LOOP_x on Trace Data Address in Virtual Address Ranges --
      IF (TraceDA in Start/End Range of VIR_VP1_START_x,
      VIR_VP1_END_x)
        THEN Out_of_DContainer_x <= ‘0’;
          ELSE Out_of_DContainer_x <= ‘1’;
      ENDIF;
    End of LOOP_x
  ENDIF;
ENDIF;
Security_Violation_IBUS_VIR_VP1 <= Out_of_IContainer_x OR
  MPU_Inst_Not_Valid OR Branch_Phantom_Not_Valid OR
  Data_Inst_Not_Valid;
Security_Violation_DBUS_VIR_VP1<= Out_of_DContainer_x OR
Data_Slot_Abort;
```

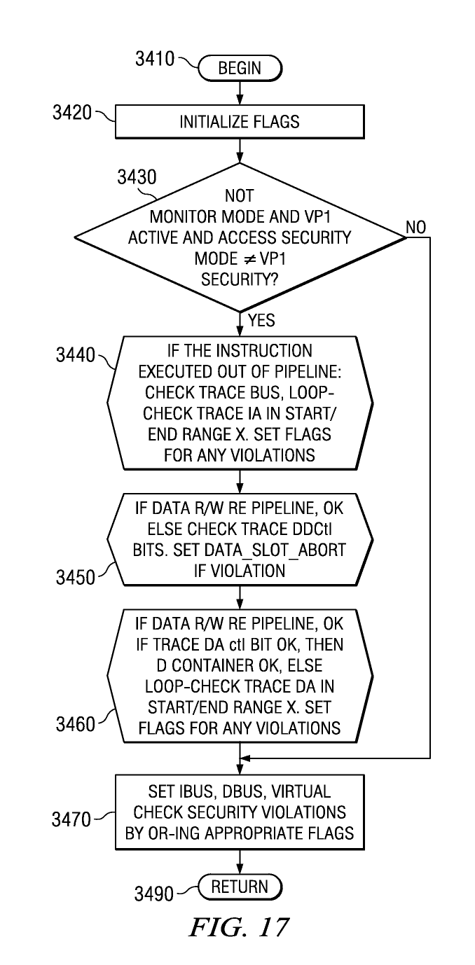

In FIG. 17, an embodiment of Virtual Checker 2630 is described by a flow of operations of the hardware of TABLE 6. Operations commence at a BEGIN 3410 and initialize flags in a step 3420. Then a decision step 3430 determines whether both 1) mode is not Monitor Mode, 2) the VP1_Active bit is set for virtual processor operation, and 3) mode of security of the bus access is not the same as the mode of security of the Modem (an example of virtual processor VP1 herein).

If Yes at step 3430, operations proceed to a checking step 3440 that operates if an instruction is involved and is executed out of the MPU 2610 pipeline. Checking step 3440 then checks various Trace bus (e.g., ETM bus) signals for any violations and sets corresponding flags as described in TABLE 6. These include MPU Instruction Not Valid, Branch Phantom Not Valid, and Data Instruction Not Valid in the example. Also, the Trace bus Instruction Address TraceIA is loop-checked for each of several Start/End virtual address ranges x allowed for contexts, and a respective Out of IContainer_x Flag x is set for any violation in a range x.

Further in FIG. 17, operations proceed to a checking step 3450 that checks for permitted Data read or write by the MPU 2610 pipeline. If the read/write operation is not out of the pipeline, the trace bus Trace Data Data Control bits are checked. If the Control bits are not as expected, then a Data_Slot_Abort violation flag is set.

A succeeding checking step 3460 checks for a permitted Data read or write address. If the Data read or write pertains to the MPU 2610 pipeline, it is permitted. If not, the trace bus Trace Data Address Control bit is checked and if not an expected value, then a loop on ranges x checks the Trace Data Address to make sure it lies within one of the permitted virtual address ranges permitted to the Virtual Processor VP1 category 2430 of FIG. 3 and FIG. 6. If not then an Out_of_DContainer_x flag is set.

Operations in FIG. 17 next go to a step 3470 to set Virtual Checker 2630 Security Violations for respective buses IBUS and DBUS by applying logic functions of the appropriate flags. Also, if the decision step 3430 yields No, wherein further virtual checking is unnecessary, then operations go to step 3470 (or Return 3490 in another embodiment).

In step 3470, Instruction related flags are high-active ORed for example. The Out_of_IContainer flags are ANDed (low-active ORed) together so that if the access is directed to a virtual address outside all of the permitted ranges x then the composite of those flags goes active high as output for generating a security violation. Analogously, the Data-related flags are high-active ORed in the example, and the Out_of_DContainer_x flags are ANDed (low-active ORed) together and then ORed with Data_Slot_Abort. When Security Violations step 3470 is completed, the hardware operations reach RETURN 3490 and go back to BEGIN 3410 to evaluate the next access.

In FIG. 18, a system 3500 has DMA subsystems 3510.i. DMA is integrated into the system 3500 in such a way that it can perform target accesses via target firewalls 2545 of FIG. 8 connected on the interconnects 2640. A target is a circuit block targeted or accessed by an initiator. In order to perform such accesses the DMA channels are programmed. Each DMA channel specifies the source location of the Data to be transferred and the destination location of the Data.

Data exchange between the peripheral subsystem and the memory subsystem and general system transactions from memory to memory are handled by the System SDMA. Data exchanges within a DSP subsystem 3520.8 are handled by the DSP DMA 3528.8 and/or by DSP DMA 3510.2. Data exchange to refresh a display is handled in display subsystem 3510.4 using a DISP DMA 3518.4 (numeral omitted). Data exchange to store camera capture is handled using a Camera DMA 3518.3 in camera subsystem 3510.3.

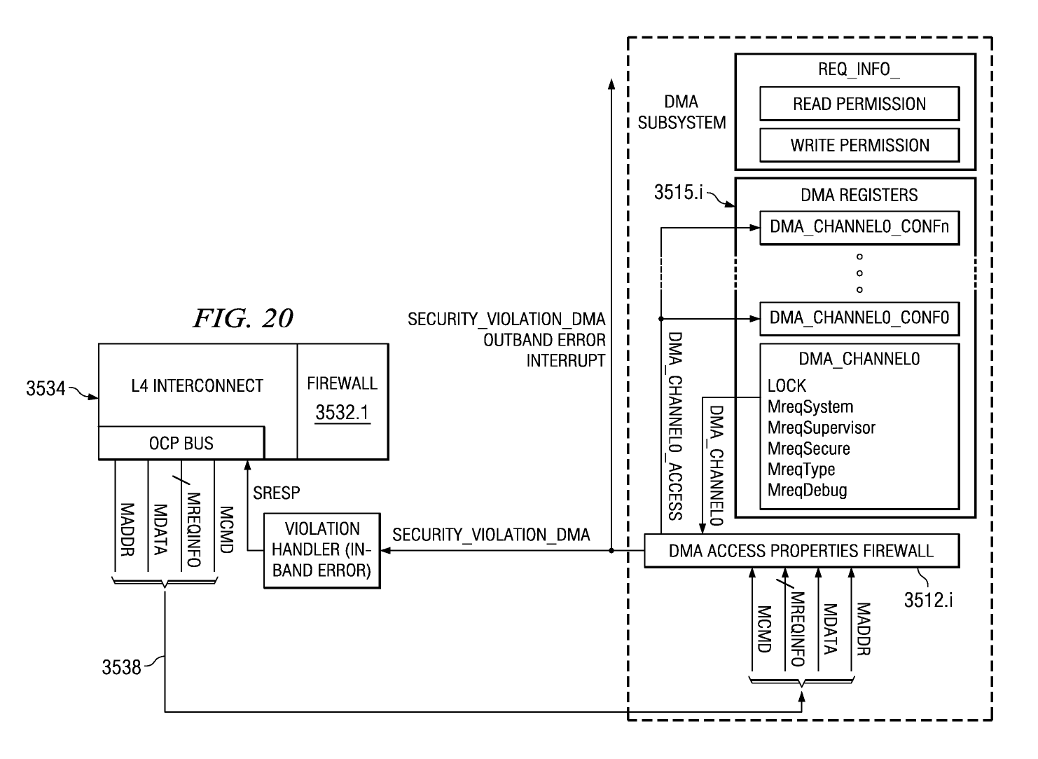

A hardware security architecture including SSM 2460 propagates qualifiers on the interconnect as shown in FIG. 18. The MPU 2610 issues bus transactions and sets some qualifiers on Interconnect 3521. SSM 2460 also provides the MreqSystem qualifier(s). The bus transactions propagate through the L4 Interconnect 3534 and then reach a DMA Access Properties Firewall 3512.1 of FIGS. 20-22. Transactions are coupled to a DMA engine 3518.i in each subsystem 3510.i which supplies a subsystem-specific interrupt to the Interrupt Handler 2720. Interrupt Handler 2720 is controlled by the SSM 2460 as shown in FIG. 19.

Firewall protection by firewalls 3522.i is provided for various system blocks 3520.i, such as Flash memory, ROM, on-chip RAM, Video Codec, WCDMA/HSDPA, MAD2D and DSP. Various initiators in the system are given 4-bit identifying codes designated ConnID. Some Initiators and their buses in one example are Processor Core MPU 2610 [RD, WR, INSTR Buses], digital signal processor direct memory access DSP DMA 3510 [RD, WR], system direct memory access SDMA 3510.1 [RD, WR], Universal Serial Bus USB HS, virtual processor PROC_VIRTUAL [RD, WR, INSTR], virtual system direct memory access SDMA_VIRTUAL [RD, WR], display 3510.4 such as LCD, memory management for digital signal processor DSP MMU, camera CAMERA 3510.3 [CAMERA, MMU], and a secure debug access port DAP (FIG. 30).

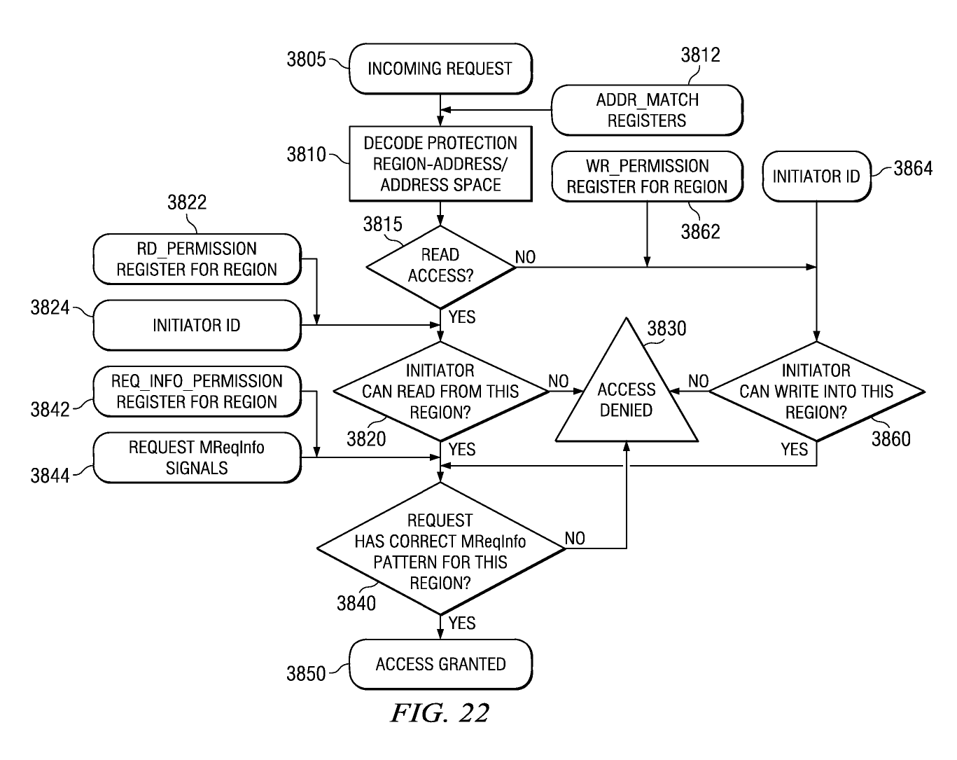

The DMA channels support interconnect qualifiers collectively designated MreqInfo, such as MreqSecure, MreqPrivilege, MreqSystem in order to regulate access to different protected memory spaces. The system of FIG. 22 configures and generates these different access qualifiers in a security robust way and delivers them to hardware firewalls 3512.1, 3512.2, etc. and 3522.1, 3522.2, etc. associated with some or all of the targets. The improved hardware firewalls protect the targets according to different access rights of initiators. Some background on hardware firewalls is provided in incorporated patent application TI-38804.

The DMA channels 3515.1, .2, etc. are configurable through the L4 Interconnect 3534 by the MPU 2610. A circuitry example provides a Firewall configuration on a DMA L4 Interconnect interface that restricts different DMA channels according to the configuration previously written to configuration register fields. This Firewall configuration implements hardware security architecture rules in place to allow and restrict usage of the DMA channel qualifiers used in attempted accesses to various targets.

When an attempt to configure access for DMA channels in a disallowed way is detected, in-band errors are sent back to the initiator that made the accesses and out-band errors are generated to the Control Module 2765 and converted into an MPU Interrupt. Some background on security attack detection and neutralization is described in the incorporated TI-37338 patent.

In FIG. 18, the MPU 2610, Others block, and System DMA (SDMA) 3530.1, 3535.1 each supply or have some or all of the MreqInfo signals MreqSystem, MreqSecure, MreqPrivilege, MreqDebug, MreqType, and other signals for various embodiments, with the signals as described in TABLE 7. L4 Interconnect 3534 supplies the MreqInfo signals to the DMA Firewall 3512.1 and other firewalls 3512.i. Interconnect 3534 is also coupled to Control Module 2765 and cryptographic accelerators and blocks 3540.

TABLE 7

| Firewall Qualifier | Definition |
|---|---|
| MReqSystem | 0 Non-virtual transaction |
| | 1 Virtual transaction |
| MReqPrivilege | 0 User mode access, non-privileged |
| (Or MreqSupervisor) | 1 Supervisor or other non-user mode privileged access |
| MReqSecure | 0 Public transaction |
| | 1 Secure transaction |
| MReqDebug | 0 Application access |
| | 1 Emulator access |
| MReqType | 0 Data access |
| | 1 Opcode fetch |

Additional Qualifiers for L3 Interconnect Firewalls 3522.i

| | |
|---|---|
| MReqCacheable | 0 Non-cacheable data |
| | 1 Data cacheable, CPU has access to cacheable memory location. |
| MReqElementSize | Natural data type of the access. |
| | 00 Byte |
| | 01 16-bit |
| | 10 32-bit |
| | 11 Unknown |
| MReqEndianness | Endian-ness assumption made re the target. |
| | 0 Big Endian |
| | 1 Little Endian |
| MReqEndianLock | 0 Endianness can be changed if target mismatch is detected. |
| | 1 Lock transaction endianness on the whole path to target. |
| MReqEndianConvResp | 0 No endian conversion needed on the response |
| | 1 Response data is endian-converted before return to initiator |

A signal ConnID is issued onto the various buses by each initiator in the system 3500. The signal ConnID is coded with the 4-bit identifying code pertaining to the initiator originating that ConnID signal. System Memory Interface 3555 in some embodiments also has an adjustment made to ConnID initiator code so that if incoming ConnID=MPU AND MreqSystem=‘1’, then ConnID=MPU_Virtual. If incoming ConnID=SDMA AND MreqSystem=‘1’, then ConnID=SDMA_Virtual. In this way the special signal MreqSystem identifies a virtual world for these initiators to protect their real time operation.

The System Memory Interface 3555 in some embodiments provides a HOST 3560 qualifier to represent a Host access (or non-Host modem access) in the System Memory Interface firewall 3552.1 to SRAM 3550. A new ConnID is suitably generated each time the processor core MPU 2610 or system SDMA 3530.1, 3535.1 perform an access in the case when the MreqSystem qualifier is one (1).

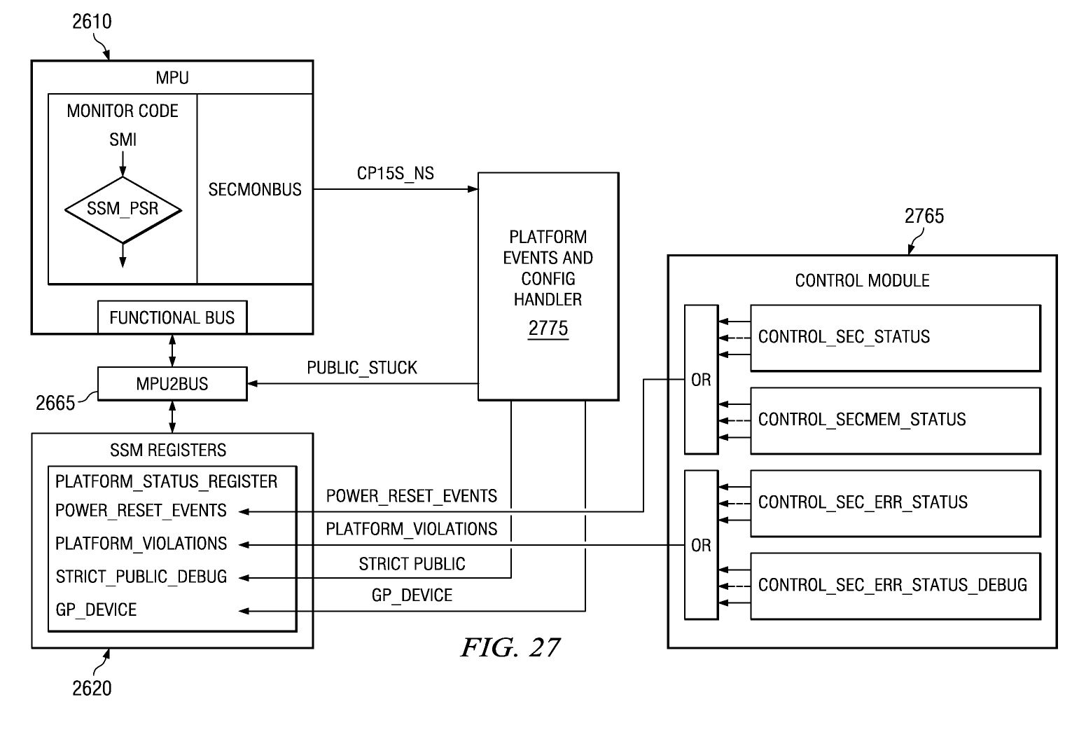

In FIGS. 18 and 9, Control Module 2765 between Interconnect 3534 and DMA Firewall 3512.1 receives the Security Violation signal from DMA Firewall 3512.1. In FIGS. 27 and 28, a Flag pertaining to the Security Violation is activated in Control_Sec_Err_Status register and is forwarded to SSM Platform_Status_Register of FIGS. 9 and 27. This flag is read on every Monitor Mode switch or otherwise frequently read, or interrupt handler 2720 generates an interrupt each time one of the Flag bits is updated or activated by the hardware.

FIG. 19 and examples in TABLE 9 depict an embodiment of a Secure Fast Interrupt Request (SFIQ) Preemptive Masking Handler 2715. When Preemptive Masking Handler 2715 is enabled, it operates to prevent Public FIQ from Public non-privileged and even privileged Public processes from contending, competing, or interfering with the operations of Monitor Mode and other Secure processes. Preemptive Masking Handler 2715 thus further provides hardware support so that Monitor code can operate as a hypervisor and so that the categories of FIG. 4 can be separated from each other in the manner shown in FIG. 3 and FIG. 5, for example.

Suppose an Interrupt request is sent by a target (e.g., 3510.i) to the Interrupt Handler 2720 of FIGS. 18 and 19. The Interrupt Handler 2720 has a global mask enable field in an internal register of Interrupt Handler 2720. If the global mask is not set to mask the particular target interrupt request, the Interrupt Handler 2720 after sorting its different inputs generates an IRQ or FIQ to the MPU 2610. If Interrupts are not masked inside the MPU (by I, F bits for IRQ, FIQ disable in current program status register CPSR), the MPU 2610 traps this interrupt. The trap is performed into a Public or Secure interrupt mode such as IRQ, FIQ or Monitor mode depending on whether the interrupt was received by the MPU 2610 when in Public or Secure mode and whether the IRQ or FIQ are configured to be trapped into the Monitor Mode by the FIQ/IRQ_Trapped_In_Monitor fields of TABLE 8.

Secure Configuration Register SCR1/2/3 registers of FIG. 19 also control the interrupt mapping and Secure/Public interrupt priorities configuration from Control Module 2765 in the Core Power Domain backing up and using and Interrupt Handler 2720 registers SCR1/2/3 in the MPU Power Domain. The applicable interrupt vector (FIG. 29) depends on the configuration and points to correspondingly applicable software code. The applicable software code is then executed.

TABLE 8
SSM CPSR MODE ENFORCEMENT REGISTER FIELDS

| EA_Trapped_In_Monitor | | Trap External Abort EA in Security Zone SCR. |
|---|---|---|
| FIQ_Trapped_In_Monitor | | Trap Fast Interrupt FIQ, ditto. |
| IRQ_Trapped_In_Monitor | | Trap Interrupt IRQ, ditto. |
| MASK_Pub_Secure | | Enable Interrupt Masking in Secure mode only |
| SYSTEM_VS_USER | (SU) | Enforce SYSTEM VS. USER Mode switch. |
| MONITOR_VS_SYSTEM | (MS) | Enforce MONITOR vs. SYSTEM Mode switch |
| MONITOR_VS_UNDEFINED | (MU) | Enforce MONITOR vs. UNDEF Mode switch |
| MONITOR_VS_ABORT | (MA) | Enforce MONITOR vs. ABORT Mode switch |
| MONITOR_VS_USER | (MT) | Enforce MONITOR vs. USER Mode switch |

| | |
|---|---|
| SECURITY_ZONE_CPSR | Ensure Security Zone default properties |
| SECURE_MODE_ENABLE | Set or unset the Secure mode |

IRQ Trapped In Monitor configures IRQ exception jump to Monitor Mode. When this IRQ trap bit is inactive and unless an IRQ is taken in Secure mode, all IRQ are treated as Public by default. Monitor Mode code performs an exit sequence. When this IRQ trap bit is set active, then each time an IRQ (Public or Secure) is taken, operations jump to Monitor Mode.

FIQ Trapped In Monitor configures FIQ exception jump to Monitor Mode. When this FIQ trap bit is inactive, FIQ are processed by MPU 2610 in FIQ mode. When this FIQ trap bit is set active, then each time an FIQ (Public or Secure) is taken, a jump to Monitor Mode occurs. Monitor Mode code performs an exit sequence.

MASK_Pub_Secure enables interrupt masking in the Public or Secure modes. When this masking configuration bit is inactive, masking of interrupts is made possible by the Public or Secure modes, i.e., that masking is permitted to be activated in either the Public or Secure modes. When this bit is set active, masking of interrupts is made possible only by the Secure modes.

In FIG. 19, upon occurrence of an interrupt request, an ITR register in Interrupt Handler 2720 is updated to indicate that an interrupt request has been received, even if the request is not served and whether or not the Interrupt Handler 2720 global mask is set. The MPU 2610 can be prevented from receiving these interrupts by any of a global mask in the Interrupt Handler 2720, interrupt disabling inside MPU 2610 using a core register (e.g. CPSR I, F bits), or disabling the interrupt generation function in a system component (e.g. 3510.i). In some embodiments, disabling of interrupts for FIG. 18 System DMA 3518.1, DSP DMA 3518.2, Camera DMA 3518.3 and Display DMA 3518.4 is accomplished by configuring their corresponding register 3515.1, .2, .3, .4 to not generate Interrupts that are otherwise coupled to Interrupt Handler 2720. Software of suitable security and privilege activates these functions when needed. The interrupt configuration for each of these system components is protected from unauthorized modification by firewalls 3512.i and/or Firewall 3532.1. Firewall out-band errors in FIG. 20 are routed as interrupts from each firewall to the Interrupt Handler 2720 of FIG. 19.

In some embodiments SSM 2640 distinguishes PFIQ generated by the Public Virtual (modem) category 2430 from PFIQ generated by Public Non-virtual category 2420 (using active state of VP1_Active and/or MreqSystem). This is because Modem FIQ are served in the Virtual mode when Modem RTOS is in the Modem FIQ mode (Virtual Public FIQ mode). Otherwise, masking all Public FIQ would undesirably mask Public FIQ from the VP1 modem in some embodiments too. In FIGS. 5 and 19, FIQ Mode 2 refers to hardware support by Preemptive Masking Handler 2715 separating PFIQ generated by Public Non-virtual world (FIQ Mode) from PFIQ generated by Public Virtual modem (FIQ Mode 2).

In some other embodiments, Modem FIQ are interrupt-mapped or tagged as Secure FIQ and not Public FIQ. In embodiments where in a given hardware architecture or policy makes Secure FIQ non-maskable by Public HLOS, then the second type of embodiments that interrupt-map or tag Modem FIQ as Secure FIQ have benefits of that policy.

In FIG. 19, the Control Module 2765 provides Secure Interrupt registers coupled to Interrupt Handler 2720 SCR configuration registers (3 registers because 96 interrupt lines). The Secure Interrupt registers SCR in FIG. 19 flag if any given interrupt is Virtual or not (e.g., Modem or not). In this way, Monitor Mode code acting as a hypervisor switches or transfers execution to any user-requested category or hypervisor-dictated category in FIG. 4, and interrupt servicing is correct. Thereupon, the correct and effective ISR (interrupt service routine) services the Public FIQ from Public HLOS category 2420, or services Modem_FIQ (Secure FIQ when MreqSystem is active to indicate modem operation in category 2430), or services Secure FIQ pertaining to Secure Environment SE 2450, or services FIQ from Virtual Secure category 2440. Compare Monitor Mode pseudo-code example of TABLE 42, which describes cases of hypervisor controlled transitions or switches to various cases of FIQ handling, such as from a mode with no hardware real-time FIQ support to exigent modem real-time hardware interrupt servicing capability.

Turning to Automatic/Manual control of Preemptive Masking Handler 2715, suppose Automatic_EN is high active, meaning Automatic method occurs when the signal is high. SSM_PMASK_FEEDBACK_Q is taken into account in Automatic mode.

When in Automatic method, Public Non-Virtual HLOS can mask only its own FIQ from the Public Non-Virtual category 2420, and HLOS is prevented from masking FIQs from the Secure Environment 2450. Also, Public HLOS is prevented from masking FIQs from the Public Virtual (e.g., modem) category 2430 nor Secure Virtual 2440. The Automatic method operates in a manner transparent to the system and thus no instruction cycles in MPU 2610 are occupied with the process.

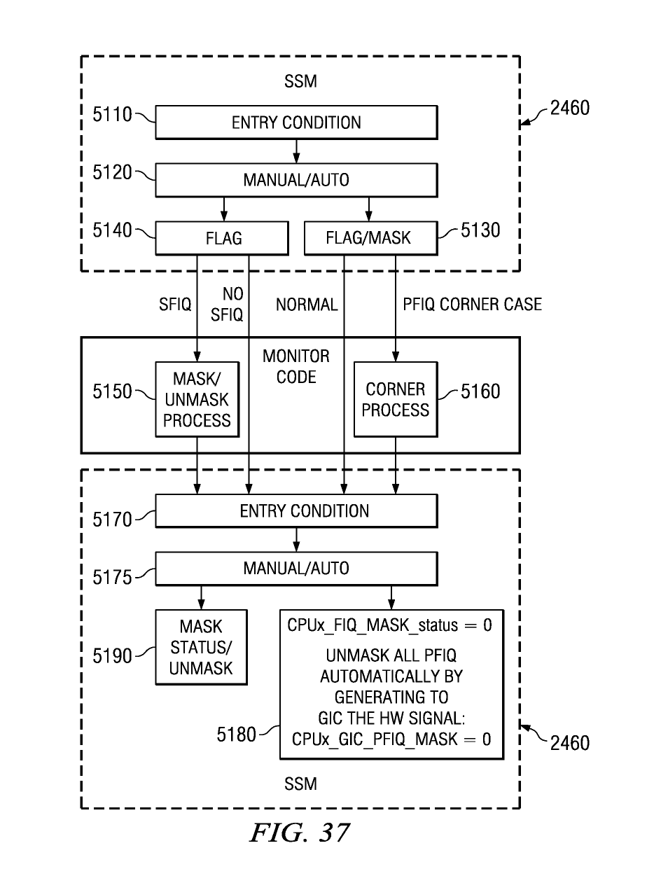

By contrast, the Monitor Mode method does occupy some instruction cycles in the MPU 2610. Assume IRQ_Trapped_In_Monitor is active and also that the virtual processor Modem is running. When in Monitor Mode method (also here called Manual mode), then when a Public HLOS FIQ occurs, the Monitor Mode is entered. Monitor Mode code responds to signal SSMFIQ_Status via Interrupt Handler 2720 of FIG. 19 so that only HLOS FIQ are masked (several lines of Monitor code as in FIG. 37). PublicInhibit in Secure Interrupt Control Register SICR is activated to mask any subsequent HLOS FIQ that might occur. Monitor code also generates a newFIQ agreement NEWFIQAGR in Interrupt Handler 2720 to release the current hardware signal (nFIQ) that just occurred. Monitor code thus acts to nullify the current Public FIQ event and avoids interrupt vectoring and avoids executing any interrupt code. Then Monitor code returns to the originally-interrupted software. The whole operation may occupy on the order of a hundred or more MPU clock cycles. In Manual mode, suppose Preemptive Masking Handler 2715 detects that Public HLOS is attempting to mask all FIQ. Then Preemptive Masking Handler 2715 (transparently to and independently of MPU 2610) sends the request signal SSMFIQ_Status to Interrupt Handler 2720. Interrupt Handler 2720 responds by masking only HLOS FIQ (Public Non-Virtual category FIQ), and no MPU clock cycles are occupied.

In Interrupt Handler 2720, an active high state of SSM_PMASK_FEEDBACK_Q represents a handshake or an acknowledgment to Preemptive Masking Handler 2715 that Public FIQ are indeed masked by Interrupt Handler 2720 in response to the earlier request SSMFIQ_Status. The signal SSM_PMASK_FEEDBACK_Q when inactive tells Preemptive Masking Handler 2715 information about the Interrupt Handler state too. A request to mask Public FIQ can go unfulfilled for a number of clock cycles (PublicInhibit active but SSM_PMASK_FEEDBACK_Q still inactive during sorting) when some interrupts are in the sorting machine of Interrupt Handler 2720.

If the CPSR_Mode is FIQ Mode, Public, then SSMFIQ_Status is set active by Preemptive Masking Handler 2715. In another case, if CPSR_Mode is Supervisor or System, and NS bit is Public and the IRQ mask I-bit CPSR_I is active, then SSMFIQ_Status is also set active as an enforcement mechanism to mask Public FIQ as well. If a security zone mechanism in MPU 2610 does not disable Public FIQ when in FIQ mode because the configuration of a security zone register (e.g., CP15S) is configured so that Public mode cannot mask FIQ, then Preemptive Masking Handler 2715 activates SSMFIQ_Status to enforce masking of the Public FIQ regardless. In yet another case, if MPU 2610 is in Monitor Mode or any Secure mode, and the SSMFIQ_Status_Global_REG is activated, then SSMFIQ_Status signal is activated or maintained activated if already activated. In this way, the Preemptive Masking Handler 2715 propagates a Public FIQ mask hardware state to Monitor Mode and Secure mode. Otherwise, Public FIQ might get unmasked upon an explicit Public HLOS request. Compare FIG. 5, FIG. 29 and TABLE 42.

In some typical HLOS, RTOS, and SE kernel software it appears that the IRQ mask and FIQ mask bits of MPU 2610 are toggled in the same way concurrently. A security attack might be underway if these mask bits were not toggled the same way concurrently. Accordingly, such concurrent toggling is enforced in some embodiments of the SSM herein. In other cases, HLOS may manipulate these bits without strategy in a system that might destabilize real-time processes (e.g., modem). SSM hardware linking the I-bit and F-bit hardware-supports the hypervisor by accommodating an RTOS (real-time operating system such as for Modem) and effectively have the MPU 2610 dedicated to RTOS with the assurance that all RTOS and modem interrupts will be real-time when RTOS is running. By hardware linking the I-bit and F-bit, then HLOS will not mask any FIQ, and hypervisor is protected and made safe from a scenario of interference by HLOS with a currently-running RTOS process that has been launched by hypervisor.

In FIG. 19, the Monitor code is coded to inactivate the IRQ_Trap_In_Monitor field in the SCR of Interrupt Handler 2720 of FIG. 19 to turn off the IRQ trap when Public HLOS is switching within the Public Non-virtual mode(s) for swift interrupt operation in category 2420 of FIGS. 4 and 6. Monitor Mode is coded to activate IRQ_Trap_In_Monitor when switching in the Secure world. In this way, the Interrupt Handler 2720 SCR and IRQ_Trap_In_Monitor of TABLE 8 are used to reserve different treatment for IRQ in the Public world relative to the Secure world. As a result, interrupts IRQ pertaining to Secure modes and both Secure FIQ and Public FIQ interrupts are trapped into Monitor Mode.

Boot software is coded to run in Secure Supervisor mode at Boot time to set an FIQ_Trap_In_Monitor bit or field of TABLE 8. SCR register circuitry of Interrupt Handler 2720 is also made so it is configurable to make any interrupt a Secure FIQ. A Secure FIQ means an interrupt that is handled only in a Secure mode. For the present example, one determines according to desired system architecture which interrupt(s) are to be Secure FIQ and boot-configures the SCR to make the thus-determined interrupts Secure FIQ.

The Interrupt Handler 2720 circuitry has interrupt masking circuitry as noted. Boot software is further coded in Secure Supervisor mode to clear MPU 2610 IRQ and FIQ masks to non-masked state for FIQ. Non-maskable Public FIQ means that a Public mode RTOS for a wireless or other modem, for instance, operates freely in real-time under the Monitor Mode hypervisor code. Some embodiments use MreqSystem to make Public FIQ non-maskable qualified by MreqSystem active. In this way, Public mode RTOS operates freely in real time in Public Virtual category 2430, and Public mode HLOS (Public Non-virtual 2420) can mask or unmask Public FIQs without interfering with interrupt operation of Public Virtual category 2430.

A Monitor Mode software handler is responsible to control the MPU 2610 IRQ mask (e.g. CP15S_I) and/or SICR PublicInhibit for masking and unmasking the Public FIQ when needed. The Monitor Mode software handler dispatches each pending FIQ to the Public world or Secure world according to the information provided by the Interrupt Handler 2720. The Monitor Mode software handler thus acts as an efficient intermediary for fast interrupts FIQ.

External Prefetch Abort and External Data Abort exceptions from interface 2665 to MPU 2610 are also trapped into Monitor Mode, such as by activating EA_Trapped_In_Monitor. Boot software operating in Secure Supervisor mode configures an External Abort trap active in MPU 2610 and this Abort trap is correspondingly configured in EA_Trapped_In_Monitor of TABLE 8. External Prefetch Abort and Data Abort are triggered for instructions and data respectively when a Security Violation signal SRESP is generated by an interconnect firewall 3522 (constructed analogous to firewall of FIGS. 20-23 and configured for its position in the system) or when a major memory component error occurs.

The Monitor Mode is configurable to be interruptible when not processing a trapped IRQ, FIQ or External Prefetch Abort/Data Abort. The Monitor Mode is coded to re-enable CPSR bits I, F, EA pertaining to mask/unmask IRQ, mask/unmask FIQ, and mask/unmask External Aborts upon a Software Monitor Interrupt SMI exception. Software code for the Monitor Mode is illustrated in FIG. 29 and discussed elsewhere herein.

In FIG. 19, secure interrupt architecture in one example provides hardware interrupt lines routed to MPU 2610 IRQ/FIQ/SFIQ under control of the Secure_Interrupt_SCR1, _SCR2, _SCR3 register of Control Module 2765 and Interrupt Handler 2720 for Public/Secure Interrupt configuration. When an interrupt line is configured as Secure in the Secure Control register SCR, the interrupt is automatically represented by configuration as a Secure FIQ, or SFIQ. An interrupt can be masked by an appropriate entry in a Maskable Interrupt Register (MIR) in Interrupt Handler 2720. However, when an interrupt line is configured as Secure in the SCR register, the MIR mask, if any, for that interrupt line is overridden and the interrupt is treated as if not masked. A Secure Privileged access can set or reset any bit in the SCR register.

The Secure FIQ Pre-Emptive Masking Handler 2715 of FIGS. 9 and 19 provides robust Secure FIQ hardware support. FIQ_Trapped_In_Monitor is configured active to trap FIQ into Monitor Mode. Virtual processor RTOS properties and FIQ mode support are facilitated and enhanced by trapping all FIQ into Monitor Mode. Secure FIQ Preemptive Masking Handler 2715 of FIG. 19 preemptively masks Public FIQ according to predetermined modes or conditions and protects that PFIQ mask from unauthorized unmasking. The virtual processor (e.g., modem real time operation) benefits as a consequence from high speed real-time FIQ that preempts FIQ from Non-virtual Public modes because masking of the latter PFIQ is ensured by Handler 2715. Non-virtual Public modes for Public FIQ preemptively masked by Handler 2715 include, for example, all Public modes User, Undef, FIQ, IRQ, Abort, System, and Supervisor as represented by CPSR_Mode signals.

In order to speed the FIQ sorting between the different containers or categories of FIG. 4, six 32-bit SSM registers are provided in some embodiments as in FIG. 19, to inform the Monitor Mode which FIQs are Secure FIQs and which are Public FIQs for virtual processor VP1 (e.g., modem). The six registers include three 32-bit registers SSM_PUBLIC_FIQ_VP1_0, _1, _2 that respectively hold Public FIQ identifications for virtual processor VP1, and three 32-bit registers SSM_SECURE_FIQ_VP1_0, _1, _2 that respectively hold Secure FIQ identifications for virtual processor VP1.

MASK_Pub_Secure of TABLE 8 is set to allow the FIQ to be maskable only by operations in the Secure modes. When the FIQ are not maskable by the Public modes, due to active register bit or field MASK_Pub_Secure in the Core Power Domain, MPU 2610 is prevented from performing a write to its F bit (FIQ masking) while in Public mode. Even when CPSR Public FIQ mode is entered, the Preemptive Masking Handler 2715 stops the entry from proceeding. This avoids, inhibits or impedes creation of dead loops. The SICR in Interrupt Handler 2720 in the MPU Power Domain correspondingly has a configurable PublicInhibit field that masks the Public FIQ when a switch occurs to CPSR mode that would ordinarily unmask Public FIQ by inactivating the F bit (FIQ masking) of MPU 2610. PublicInhibit masks or disables Public FIQ when a Public FIQ exception mode is entered.

In FIG. 19, configuration of Secure Interrupt Control Register SICR field SSMFIQ_ENABLE (e.g., at Boot time, and when Monitor code activates the virtual processor modem) activates the Preemptive Masking Handler 2715 via a line SSMFIQ_EN. In response, the Preemptive Masking Handler 2715 uses IF conditionals in TABLE 9 to detect when the Public FIQ needs to be masked and generates a SSMFIQ_Status signal to the Interrupt Handler 2720 that masks Public FIQ. If the Interrupt Handler 2720 does not mask the Public FIQ immediately (some clock latencies might be introduced) a not yet masked Public FIQ can fire and be trapped in the Monitor Mode. To handle the latencies, the Monitor Mode is coded to perform a NEWFIQAGR operation (see TABLE 40) and let the respective Interrupt Handler PublicMaskFeedback SICR bit become active and generate SSM_PMASK_FEEDBACK_Q before switching back to the interrupted code and thereby effectively nullify the Public FIQ occurrence.

Suppose the field IRQ_Trapped_In_Monitor is configured or set active. When a Public FIQ fires and is consequently trapped in the Monitor Mode, the Monitor code may determine that the Public FIQ masking signal SSMFIQ_Status should be activated. Consequently, the Monitor Mode is coded to set the PublicInhibit bit in the Interrupt Handler 2720 before generating the NEWFIQAGR in order to enter the Public FIQ mode with Public FIQ masked. Concurrently and protectively, when the Public FIQ mode is entered, the Preemptive Masking Handler 2715 automatically activates the SSMFIQ_Status signal. As long as the SSMFIQ_Status is activated, the Public FIQ are masked. When the Preemptive Masking Handler 2715 detects that Public FIQ are to be unmasked (Case 1: CPSR I bit reset so IRQ unmasked, or Case 2: CPSR_Mode not in FIQ mode any more), the SSMFIQ_Status is cleared and SICR PublicInhibit bit is automatically inactivated for software reset and hardware reset. The Public FIQ are then automatically unmasked. See TABLE 29 and Monitor code transitions.

Preemptive Masking Handler 2715 itself further supports Public FIQ masking by circuitry that generates an interrupt SSMFIQ_GEN. This SSMFIQ_GEN interrupt is distinct from the masking flag SSMFIQ_STATUS. The circuitry of Handler 2715 provides two different operational options or processes—a fully automated process (SICR AutoInhibit active) and a Monitor Mode method (AutoInhibit inactive). The process to use is selectable by establishing and setting or clearing the AutoInhibit field or bit in the Interrupt Handler SICR register such as at Boot time. The embodiment of FIG. 37 can also be compared to that of FIG. 19 and each may be used to supplement the other.

In FIG. 19 in an automated method process embodiment, AutoInhibit when active in the Interrupt Handler 2720 causes a signal SSMFIQ_Automatic_EN to be fed to the Secure FIQ Preemptive Masking Handler 2715 and control the interrupt SSMFIQ_GEN. See also TABLES 38, 41, 42 and description hereinabove and elsewhere herein.

A partially underlying process embodiment, designated the Monitor Mode method herein, is active in Preemptive Masking Handler 2715. Handler 2715 uses its IF-conditionals to detect when the Public FIQ should be masked and thereupon generates the SSMFIQ_Status signal. Then, if an FIQ occurs, the FIQ is trapped in the Monitor Mode. In the Monitor Mode method, the Monitor Mode code is also coded to read the Interrupt Handler SICR register SSMFIQ_Status field to determine that Public FIQ should be masked. If the SSMFIQ_Status is set, then the Monitor Mode is coded to respond to SSMFIQ_Status being active by disabling the Public FIQ by activating the SICR PublicInhibit and Monitor Mode also performing a NEWFIQAGR operation. This process automatically masks and clears all Public FIQ. The Monitor Mode switches or transitions back to the interrupted code if a PFIQ latency has occurred.

Suppose that the SSM detects that Public FIQ should be unmasked due to an inactivity of all the main IF-conditions in TABLE 9. Preemptive Masking Handler 2715 then clears or inactivates SSMFIQ_Status and generates its own Secure FIQ designated SSMFIQ_GEN at a predetermined Interrupt Handler 2720 input line or numbered input, to force entry to Monitor Mode. The Monitor Mode is coded to thereupon check that SSMFIQ_Status is cleared and thereupon inactivates or resets the Interrupt Handler SICR PublicInhibit to unmask all Public FIQ. The Monitor Mode then switches back to the code that was interrupted by SSMFIQ_GEN.

In FIG. 19, the SSMFIQ_GEN signal is acknowledged by an SSM register field SSMFIQ_ACK. The Security Violation Handler 2760 of FIGS. 28A/28B and the Platform_Violations register logic and flip-flops of the Platform Status Register in FIGS. 9 and 27 are under control of the Cold reset in order to avoid a racing loop with the Warm CPU reset generated by PRCM 2790 of FIG. 9 when a Security Violation is generated by Security Violation Handler 2760. The register field SSMFIQ_ACK is provided in order to not reset the mask signal SSMFIQ_GEN or SSMFIQ_Status in FIG. 19 when a Security Violation occurs.

The racing loop scenario for Cold Reset and Warm Reset is that when Security Violation Handler 2760 generates a violation, all paths might be asynchronous. Then the MPU 2610 subsystem could receive a glitch instead of a well-formed Warm Reset pulse signal in a circuitry wherein and because the SSM 2460 itself was reset asynchronously relative to the MPU 2610. In such asynchronous architecture, Security Violation Handler 2760 is further improved to avoid a racing loop by providing register with D-flip-flop (DFF) on Cold Reset in the violation logic. In that way, a stable Warm Reset generation is protectively provided.

Secure FIQ Pre-emptive Masking Handler 2715 conditions some operations on active state of a flag SSM_FIQ_Status_Global_Reg. This internal flag indicates that a Public FIQ masking SSMFIQ_Status has been generated active and supplied to the Interrupt Handler 2720. SSM_FIQ_Status_Global_Reg provides an indication that previous operations of Secure FIQ Pre-emptive Masking Handler 2715 turned on or turned off the state of the masking signal SSMFIQ_Status. An internal line and signal SSMFIQ_Status_Global_VAR indicates combinatorial logic behavior (output value is supplied immediately). By contrast, the SSMFIQ_Status_Global_REG indicates flip-flop behavior that is updated on next clock cycle.

When its IF-conditions are active (true), Secure FIQ Pre-emptive Masking Handler 2715 generates the SSMFIQ_GEN signal, which is directly connected to Interrupt Handler 2720 as an interrupt. This interrupt is raised when AutoInhibit is not-active and the Handler 2715 circuitry is in Manual mode (Monitor Mode method). When this SSMFIQ_GEN interrupt is generated, the Monitor Mode software de-asserts it by acknowledging the interrupt by clearing SSMFIQ_ACK in the SSM_FIQ register in registers 2620 in FIG. 19. In response to the cleared state of SSMFIQ_ACK, Secure FIQ Pre-emptive Masking Handler 2715 releases the SSMFIQ_GEN interrupt at Interrupt Handler 2720 and at the MPU 2610 boundary.

IF-conditioning the deeper-down operation of the Secure FIQ Pre-emptive Masking Handler 2715 Masking Handler on SSMFIQ_ACK, as shown in TABLE 9, releases the SSMFIQ_GEN interrupt so that it is not repeatedly and inadvertently trapped as an FIQ into Monitor Mode and thereby impede operation by frequently or continuously generating an interrupt exception.

In TABLE 9, the IF conditional involving SSM_PMASK_FEEDBACK_Q handles the situation that if SSMFIQ_Status transitions from one to zero and if masking of PFIQ was actually completed in Interrupt Handler 2720 ( . . . Feedback_Q=‘1’), then the circuit releases the interrupt or prevents generation of the interrupt SSMFIQ_GEN even without involvement of acknowledge SSMFIQ_ACK.

TABLE 9
SECURE FIQ PRE-EMPTIVE MASKING HANDLER 2715
HARDWARE DESIGN CODE EXAMPLE

IF SSMFIQ_EN = ‘1’ THEN --Preemptive Masking Handler Activated--

```
IF (CPSR_Mode = FIQ AND CP15S_NS = ‘1’) -FIQ Mode,
Public--
THEN SSMFIQ_Status_INT1 <= ‘1’; --Active--
ELSE SSMFIQ_Status_INT1 <= ‘0’; --Inactive--
ENDIF;
IF ((CPSR_{—} Mode = {Supervisor OR System}) &
CP15S_NS = ‘1’ &
CPSR_I = ‘1’)
THEN SSMFIQ_Status_INT2 <= ‘1’;
ELSE SSMFIQ_Status_INT2 <= ‘0’;
ENDIF
IF ((CPSR_{—} Mode = Monitor OR CP15S_NS = ‘0’)
        & SSMFIQ_Status_Global_REG=‘1’)
THEN SSMFIQ_Status_INT3 <= ‘1’;
ELSE SSMFIQ_Status_INT3 <= ‘0’;
ENDIF;
IF SSMFIQ_Automatic_EN = ‘0’
THEN
  IF (SSMFIQ_Status_Global_REG = ‘1’
    & SSMFIQ_Status_Global_VAR = ’0’
    & SSM_PMASK_FEEDBACK_Q = ‘1’)
  THEN SSMFIQ_GEN_INT<=‘1’;
  -- SSMFIQ_GEN_INT is active high--
      ELSE
        IF (SSMFIQ_ACK = ‘0’)
        THEN SSMFIQ_GEN_INT <= ‘0’;
        ELSE SSMFIQ_GEN_INT <= ‘1’; --Active--
        ENDIF
      ENDIF
  ELSE SSMFIQ_GEN_INT <= ‘0’; --Inactive--
  ENDIF
ELSE SSMFIQ_GEN_INT <= ’0”; --Inactive-- --Handler
2715 is disabled--
    SSMFIQ_Status_INT1 <= ‘0’; --Inactive--
    SSMFIQ_Status_INT2 <= ‘0’; --Inactive--
    SSMFIQ_Status_INT3 <= ‘0’; --Inactive--
ENDIF
SSMFIQ_GEN <= NOT (SSMFIQ_GEN_INT); -- Active low
SSMFIQ_GEN--
SSMFIQ_Status_Global_VAR
  <= SSMFIQ_Status_INT1 OR SSMFIQ_Status_INT2 OR
  SSMFIQ_Status_INT3;
SSMFIQ_Status_Global_REG <= SSMFIQ_Status_Global_VAR;
SSMFIQ_STATUS  <=
SSMFIQ_Status_Global_VAR; --Active high--
```

In FIG. 20, DMA access properties firewall 3512.i has configuration hardware security rules for example as follows.
1) A secure access is required to configure or program a DMA channel 3515.i as Secure, i.e., the access is restricted to be a secure access to make the configuration happen. This can effect a substantive change to the firewall configuration even if the firewall configuration is already set to Secure because configuring or programming the same mode in a given hardware security rule here can involve re-configuring another MreqInfo qualifier (such as MreqType) subject to compliance with the other configuration hardware security rules here. If a Public access attempts to program a DMA channel as Secure, the action is prevented and produces a security violation. Secure accesses are able to program a DMA channel 3515.i as Public or Secure subject to compliance with the other configuration hardware security rules.
2) Setting of any DMA channel 3515.i as Virtual is restricted to occur only when the access to program the DMA channel is made by accesses initiated by the MPU 2610 in Virtual mode. A Non-virtual access is allowed to configure DMA channel as Non-virtual, provided the other configuration hardware security rules are complied with. However, if a Non-virtual access attempts to program a DMA channel as Virtual, the action is prevented and a security violation is issued.
3) Setting of any DMA channel 3515.i as Public Privilege is restricted to occur only when the access to program the DMA channel is made by Public Privilege, Secure User or Secure Privilege accesses to an address of the channel register DMA_CHANNELi to be programmed. Setting of any DMA channel as Secure Privilege is also restricted to occur only when the access to program the DMA channel is made by Secure Privilege access. Analogously, a Public User access is allowed to configure DMA channel as Public User, subject to compliance with the other configuration hardware security rules. However, if a Public User access attempts to program a DMA channel as Public Privilege, the action is prevented and a security violation is issued. A Secure User access is allowed to configure a DMA channel as Secure User. However, if a Secure User access attempts to program a DMA channel as Secure Privilege, the action is prevented and a security violation is issued. On the other hand, Privilege accesses are able to program a DMA channel as User or Privilege without restriction in their own Public or Secure mode, subject to compliance with the other configuration hardware security rules.

Hardware security rules are applied as follows. When a channel rights configuration for DMA channel 3515.i is successfully made according to the configuration hardware security rules implemented in the hardware (e.g., see TABLE 10), the MreqInfo TABLE 7 qualifiers of the accesses that made that configuration are recorded or entered and thereby establish the channel rights in the channel rights register for regular (non-configuration) run-time accesses to DMA subsystem 3510.i (source, destination). Then operation of the DMA subsystem 3510.i is started and uses these MreqInfo qualifiers configured into the channel rights register DMA_CHANNELi 3515.i for firewall evaluation of a regular transaction issued on the interconnect.

In FIG. 20, the DMA registers 3515.i include eight registers DMA_CHANNELi_INT[ ] that temporarily or internally hold the DMA channel i attempted configuration. Index i is replaced by a digit 0, 1, . . . 7 in the register name for an eight-channel example. Also, a further eight registers DMA_CHANNELi hold the actual current DMA channel rights for the respective channel indexed i, where index i is replaced by a digit 0, 1, . . . 7 in the register name. Each DMA_CHANNELi register has bits/fields for Lock, MreqSystem, MreqPrivilege, MreqSecure, and any other MreqInfo bits/fields appropriate to administer the DMA channel indexed i.

The Lock bit, if set, locks the DMA_CHANNELi register to which it pertains. The various Mreq-prefixed bits MreqSystem, MreqPrivilege, MreqSecure, and so forth, in the DMA_CHANNELi register are issued to the DMA Access Properties Firewall 3512.i on occurrence of an attempted regular (non-configuration) DMA transaction via the corresponding DMA channel from Interconnect 3534. The attempted DMA transaction is represented by signals on lines in FIG. 20 for memory command MCMD for Read or Write (R/W), memory request information MReqInfo, memory data MDATA, and memory address MADDR. In FIG. 20, the interconnect 3534 has a bus that supplies those memory-related signals.

A security violation is recognized by the Firewall 3512.i upon an attempted configuration access wherein the MReqInfo supplied from Interconnect 3534 is non-compliant or inconsistent with the configuration hardware security rules hereinabove for a given attempted configuration access and implemented in the firewall 3512.i to which the attempted configuration access is made. Then the DMA Access Properties Firewall 3512.i issues an active signal on a line SECURITY_VIOLATION_DMA to a Violation Handler in FIG. 20 for in-band error that in turn supplies a Security System Response signal SRESP to the Interconnect 3534. In this way, the hardware protection by the firewall 3512.i over its own configuration is achieved for configuration accesses. If the attempted configuration access is compliant with the configuration hardware security rules hereinabove, then a grant signal called DMA_CHANNELi_ACCESS is activated in FIG. 20 and the configuration process is completed.

A security violation is recognized by the Firewall 3512.i upon an attempted regular access wherein the MReqInfo supplied from Interconnect 3534 is less than or is inconsistent with the channel rights configuration accorded by the hardware security rules to a given access, as reflected by MreqSystem, MreqPrivilege, MreqSecure and so forth stored in the DMA_CHANNELi register 3515.i for the DMA channel to which the attempted access is made. Then the DMA Access Properties Firewall 3512.i issues an active signal on a line SECURITY_VIOLATION_DMA to a Violation Handler in FIG. 20 for in-band error that in turn supplies a Security System Response signal SRESP to the Interconnect 3534. In this way the hardware protection by the firewall 3512.i over DMA block 3510.i is achieved for regular accesses.

Note also that the DMA registers are writeable provided that a respective channel rights signal complies with the hardware security rules for the access and thereupon an access permission signal is issued e.g., DMA_CHANNELn_ACCESS=MreqSystem&MreqPrivilege&MreqSecure.

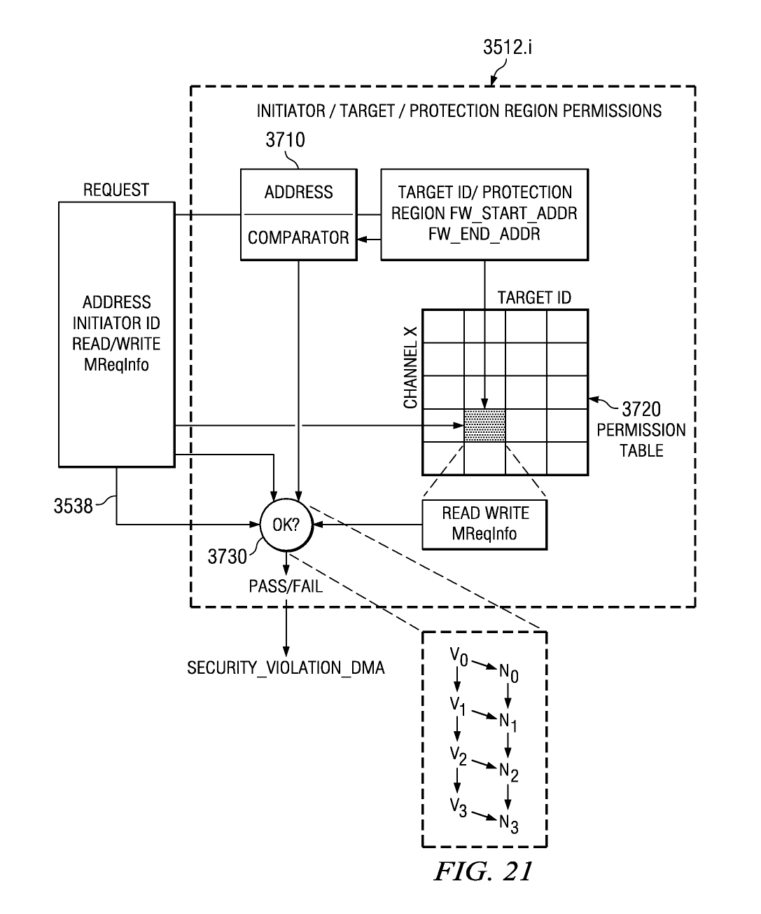

The hardware of the DMA Access Properties Firewall 3512.i is suitably established to achieve firewall configuration structures and operations. See circuitry of the firewall configuration hardware design code example of TABLE 10. Channel 0 is used as a placeholder for any particular channel i to which the Firewall 3512.i is adapted. MDATA is a new configuration request and new configuration data for the DMA_CHANNELi register. MreqSecure, MreqSystem, and MreqPrivilege are examples of qualifiers on the MreqInfo lines in FIG. 20 that describe the Initiator that is attempting the configuration access. DMA_Channel_INT[ ] is a temporary holding space for MDATA[ ] while the attempted configuration access is evaluated for clearance to proceed. (See FIGS. 21-23 for the further subject of firewall circuitry operating under an existing completed configuration to screen regular accesses after the firewall configuration is established.)

TABLE 10
DMA ACCESS PROPERTIES FIREWALL CONFIGURATION
HARDWARE DESIGN CODE EXAMPLE

```
--LOOP ON CHANNELi -
IF MADDR = DMA_CHANNELi_ADDR -Start/End Address
Match 3710--
THEN -Begin Comparison Block 3730--
  IF ((DMA_CHANNELi[ ]=’NotLocked’) & MDATA[ ]=‘1’ &
  MCMD=WR)
  THEN Security_Violation_LOCK <= ‘0’;
    -- SECURE --
    IF MreqSecure = “1”
    THEN DMA_CHANNELi_INT [ ] <= MDATA [0];
    ELSE DMA_CHANNELi_INT [ ] <= ’0’;
    ENDIF;
    -- SYSTEM --
    IF MreqSystem = “1” -Virtual processor, Modem--
    THEN DMA_CHANNELi_INT [ ] <= ‘1’;
    ELSE DMA_CHANNELi_INT [ ] <= ’0’;
    ENDIF;
    -- PRIVILEGE --
    IF (MreqPrivilege = ’1’)
    THEN DMA_CHANNELi_INT [ ] <= MDATA [ ];
      ELSIF (MreqPrivilege = ‘0’ & MreqSecure = ‘1’ & MDATA
      [0]=’0’)
      --Secure User, Non-Virtual or Virtual--
      THEN DMA_CHANNELi_INT [ ] <= MDATA [ ];
      ELSE DMA_CHANNELi_INT [ ] <= ’0’;
      ENDIF;
    DMA_CHANNELi_INT [ ] <= ‘1’; --LOCK Bit Activated--
  ELSE Security_Violation_{—} LOCK <= ‘1’; --Access attempt to a locked
  configuration--
  ENDIF;
  IF (MDATA != DMA_CHANNELi_INT[ ] OR
  Security_Violation_LOCK=’1’)
  THEN SECURITY_VIOLATION_DMA <= ‘1’;
--Violation Configuration Hardware Security Rules, Clearance to
Configure Firewall denied-
  ELSE SECURITY_VIOLATION_DMA <= ‘0’;
    --Compliance w/ Configuration Hardware Security Rules-
      DMA_CHANNELi_ACCESS [ ]<= 1 --Clearance
      to Configure Firewall--
      DMA_CHANNELi[:]<= DMA_CHANNELi_INT[:];
            -New MreqInfo Config loaded into DMA_Channeli
            Register--
  ENDIF;
ENDIF;
--Loop Until DMA_CHANNELn Completion--
```

| | |
|---|---|
| DMA_CHANNELi_ACCESS[ ] <= (OTHERS =>’0’); | --Initialize-- |
| DMA_CHANNELi <= (OTHERS => ‘0’); | --Initialize-- |

TABLE 11 shows an example of permitted accesses to a DMA Firewall. The heading Current Mode refers to lowest level of permission established by configuration in the channel rights register DMA_CHANNELi of FIG. 20, which is required to access a target. That level of permission is expressed in terms of a selected plurality of Mreq qualifiers, which are MreqSecure, MreqSystem, and MreqPrivilege in this example. Security Hierarchy designates each Current Mode possibility by a letter V for Virtual and N for Non-virtual, and by a numeral wherein 3 is a low, more-accessible level and 0 is a high, less-accessible level. Allowed Access Modes identifies various Initiator modes that can successfully access Current Mode of the target, and those Initiator modes are identified by MreqInfo bits pertaining to the same plurality of Mreq qualifiers, e.g., MreqSecure, MreqSystem, and MreqPrivilege.

In FIG. 21, an example of a Security Hierarchy is visually depicted as two columns N and V. Any lower-numbered Non-virtual N mode Initiator can access any equal or higher-numbered N mode (Current Mode of Target), and any lower-numbered Virtual V mode Initiator can access any equal or higher-numbered V mode (Current Mode of Target). Any Virtual mode Initiator having a given number can access a Non-virtual N mode having the same number or higher (Current Mode of Target). For instance, an N0 Initiator can access N0, N1, N2, or N3 in the target. V2 Initiator can access V2 or V3, or N2 or N3 in the target. Any Initiator mode that attempts to access, but is not allowed to access, the Current Mode of TABLE 11 generates X*Secure_Error, Y*System_Error and Z*Supervisor_Error. Any other Initiator access modes on the MreqInfo lines of FIG. 20 besides the tabulated Allowed Initiator Access mode(s), are disallowed access to a target that has its firewall configured with a given Current Mode value in DMA_CHANNELi register.

TABLE 11
DMA FIREWALL ACCESS MODES PERMISSION TABLE EXAMPLE

| Current Mode | Current Mode | Allowed Initiator Access Modes |
|---|---|---|
| DMA_CHANNELi | Signifiers | (X = MreqSecure, Y = MreqSystem, Z = MreqPrivilege) |
| Public Non-Virtual | N3 | All modes can access N3. |
| User | (000) | |
| Public Non-Virtual | N2 | (0, 0, 1); (1, 0, 1); (1, 1, 1); (0, 1, 1) (1, 1, 0); (1, 0, 0) |
| Privilege | (001) | |
| Secure Non-Virtual | N1 | (1, 0, 1); (1, 0, 0); (1, 1, 1); (1, 1, 0) |
| User | (100) | |
| Secure Non-Virtual | N0 | (1, 0, 1); (1, 1, 1) |
| Privilege | (101) | |
| Public Virual User | V3 | (0, 1, 0); (0, 1, 1); (1, 1, 0); (1, 1, 1) |
| | (010) | |
| Public Virtual | V2 | (0, 1, 1); (1, 1, 0); (1, 1, 1) |
| Privilege | (011) | |
| Secure Virtual User | V1 | (1, 1, 1); (1, 1, 0) |
| | (110) | |
| Secure Virtual | V0 | (1, 1, 1) |
| Privilege | (111) | |

The various categories running on MPU 2610 act as Initiators. Other system components can be Initiators. For instance, Display Subsystem 3510.4 of FIG. 18 can act as another Initiator and handle even secure transactions with secure targets (such as on-chip RAM frame buffer or DDR SDRAM). The Display Subsystem 3510.4 and its embedded DMA registers 3515.4 are accessible through the Interconnect 3534 and therefore are protectable by the firewalls 3532.1 and 3512.4. The Display Subsystem 3510.4 and its embedded DMA 3518.4 has the capability to switch to full secure state. When configured, all transactions issued by the Display Subsystem DMA 3518.4 are Secure User (MreqSecure qualifier is active, MreqPrivilege is inactive).

The Display Subsystem registers 3515.4 are configured to be accessible only by Secure accesses using interconnect 3534 protection groups. The Display subsystem 3510.4 is used integrally inside the Secure mode for securing display events such as banking display when needed. When configured as Secure, the Display subsystem does not need the MPU 2610 to be in Secure mode to receive or transmit Secure transactions.

For Secure transaction configuration, the Display Subsystem DMA 3518.4 is configured to full Secure state by setting a DISP_Control Secure register bit field. This bit field is only accessible by the MPU 2610 in Secure mode of the MPU to access the DISP_Control register field to set/reset it. Once configured, all transactions issued by the Display subsystem 3510.4 are tagged as Secure (MreqSecure active). When the Secure bit has been set, the MPU 2610 software in Secure mode is responsible for checking the Display Subsystem configuration. The video layers are disabled by software operating on MPU 2610 in Secure mode of MPU 2610. A secure Camera DMA 3510.3 transaction is configured for Secure or Non-secure operation in a way analogous to that described for the Display subsystem 3510.4.

The system memory interface 3555 of FIG. 18 has a firewall 3552 and a Security Control Register of FIG. 14. Interface 3555 integrates in its Security Control Register of TABLE 14 bits for dedicated locking of individually-numbered rotating buffer contexts, and for arbitration policy and soft reset capability. In interface 3555, configuration registers are given default values or suitably programmed with product-line specific values and then locked at boot time when interface 3555 is set for general purpose (lower security, GP) device units and for Test or Emulation (T/E) device units. Alternatively, these configuration registers are given suitable high security configuration values and locked during run-time for purposes of high security (HS) device units. The configuration and locking of the rotating buffer contexts is suitably performed at Boot-time or otherwise as appropriate beforehand.

TABLE 14
INTERFACE 3555 SECURITY CONTROL REGISTER FIELDS

| Register Field Name | Function |
|---|---|
| RotCtxt<#>Lock | Inactive: Any transaction allowed to program the context |
| (# for each context) | Active: Only Secure transaction allowed to program the context |
| ArbitrationRegsLock | Inactive: Any transaction allowed to program the arbitration |
| | Active: Only Secure transaction allowed to program the arbitration |
| Region1RegsLock | When this bit is active, the region 1 is restricted to secure access only |
| | and do not depend anymore on the state of the FirewallLock field |
| SoftResetLock | When this bit is active, the interface 3555 component soft reset is |
| | triggered only by a secure access. |
| ErrorRegsLock | When this bit is active, ERR_TYPE and ERR_ADDR registers in |
| | interface 3555 are read and clear only by Secure access. |
| FirewallLock | Once set to active, the firewalls registers are programmable only with |
| | Secure accesses. |
| SecurityControlRegLock | When this field is set to active, only a Secure access is effective to |
| | change its state. |

FIG. 21 shows a Target Firewall protection structure and process for illustrating the screening or filtering process used to evaluate regular (non-configuration) attempted accesses. (FIG. 21 shows some aspects of the configuration process of TABLE 10 as well.) Protection address regions are designated within the address space of a given target 3510.i. The access to these address regions is granted only for authorized initiators ConnID with in-band attributes represented by and sent with the qualifiers MCMD and the MreqInfo qualifiers on bus 3538.

When an access is detected, the Target Firewall 3512.i has a comparator 3710 that first checks whether the address MADDR of the access on bus 3538 matches with a defined firewall permitted Start_Addr/End_Addr address range fields in channel rights register DMA_CHANNELi_ADDR. Also, multiple address ranges or regions with different qualifier permissions configured for them are suitably established at configuration time and used for the regular run-time process according to a permission register or permission table 3720 that comprises the channel rights registers DMA_CHANNELi.

Address inclusion into or exclusion from such a range is defined for a firewall FW by:

Addr=Function(MADDR, MAddrSpace), e.g., FW_Start_Addr≦MADDR≦FW_End_Addr. Address MADDR corresponds to the physical address of the access as it would be seen by the MPU 2610 with the MMU disabled. FW_Start_Addr=Base_Addr, FW_End_Addr=Base_Addr+Size. Base_Addr and Size are configured in an Addr_Match field of the register, or the End address field is configured directly with an end address value in FIG. 21.

In FIG. 21, if the address MADDR of the access is within the range configured for the Target Firewall 3512.i, then the access qualifiers asserted on the MreqInfo lines of bus 3538 are compared using another comparator 3730 with the Target Firewall permissions table 3720 configuration for them. Another qualifier MCMD has four states for example: Read only=Read access, Write only=Write access, No access=IDLE, All Access=Read/Write access. An Initiator identification ConnID includes a multi-bit reference code (ConnID) signifying the module (initiator) that has initiated the current access.

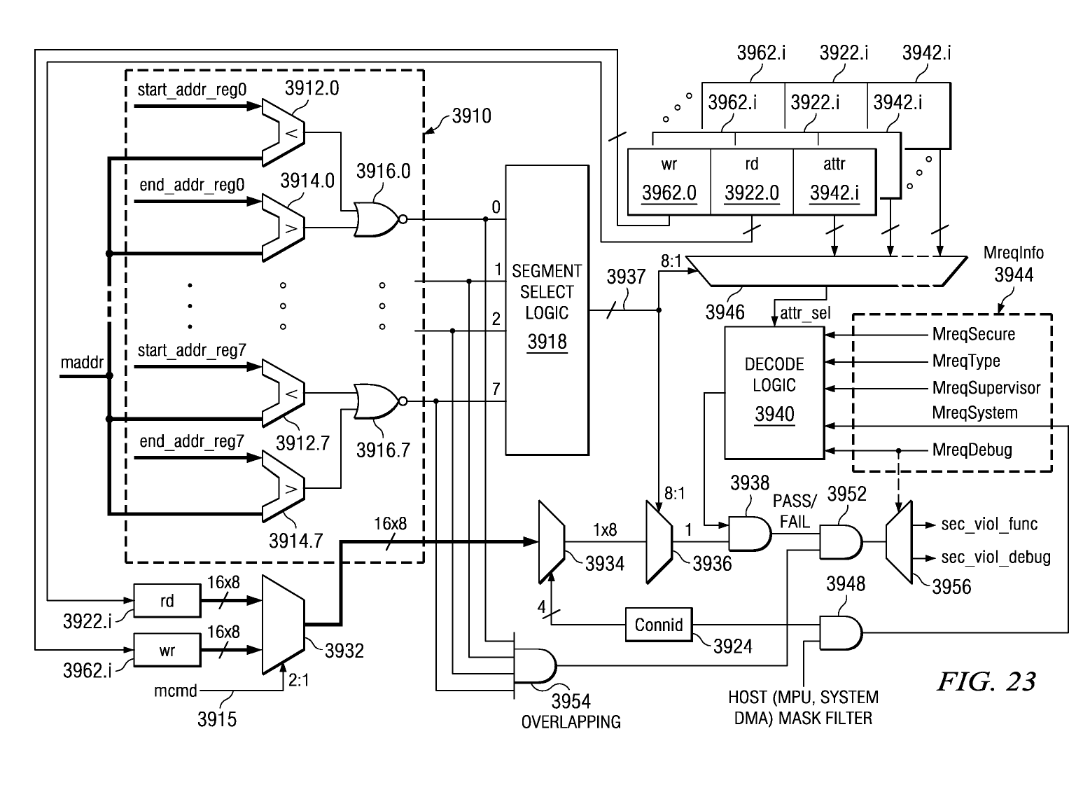

Read_Permission and Write_Permission register fields are provided in the DMA_CHANNELi registers. Each permission field has a subfield giving Read (rd) permission (or not) and a subfield giving Write (wr) permission (or not) on an initiator-by-initiator basis for every initiator in the system of FIG. 18. These permission register fields are configured as in TABLE 10 and TABLE 11 by a Secure data write of sufficiently high privilege level to accord with the configuration hardware security rules. In firewall operation, the permission register fields are used to evaluate a given initiator attempting access as in FIG. 22, using an associated decoder circuit of FIG. 23, for instance.

The associated decoder circuit is of such as type as would be used for address decoding but fed instead with the MreqInfo bits, MCMD, and ConnID bits. Each individual register bit from the Permission register is active/inactive to represent permission/no-permission for a particular combination of MreqInfo bits, MCMD read or write access, and particular Initiator represented by a particular combination of ConnID bits. When a particular combination of these bits is fed to the associated decoder circuit, the Permission register is muxed out and coupled to a Permission output line that delivers the appropriate particular permission bit in the Permission register representing whether the attempted access is permitted or not.

In FIGS. 21, 22, 23, notice that the MreqInfo bits represent what type of access is being attempted. The MreqInfo bits are decoded (along with MCMD and ConnID) to read-access a particular bit in the previously-configured Permission register. The particular bit thus read-accessed delivers the permission output Pass/Fail of FIG. 21. The Permission output tells whether the attempted access is permitted or not by the Firewall 3512.i. Each Firewall 3512.i or 3522.i has a respective Permission register(s) that is configured with the access permissions that pertain to that Firewall. If the access qualifiers and the firewall permissions compare successfully at comparator 3730, then the access is allowed to proceed through the Firewall 3512.i to the subsystem 3510.i that Firewall 3512.i protects. Otherwise, a Security_Violation_DMA signal is generated in case the subsystem 3510.i was addressed by the attempted access and a FAIL was generated by comparator 3730.

In FIG. 22, a process of operation is shown for a firewall such as 3512, 3522, 3532, or 3552 of FIG. 18. Operations commence with an Incoming Request 3805. In a step 3810, an asserted access address MADDR is decoded and compared with region-indexed Address Start and Address End registers 0-7, designated ADDR_Match registers 3812 in FIG. 22, to determine whether the access is within a permitted address range for a target in the protection region. A succeeding decision step 3815 determines whether MCMD indicates a read access or write access is attempted. If a read access (Yes), operations go to a decision step 3820 to determine an Initiator ID 3824 (ConnID) of the initiator has permission from a register RD_Permission 3822 (rd) for the region to indeed read from this region. If not, then operations branch from step 3820 to a step 3830 where Access is denied.

If Yes at step 3820, then operations proceed to a further decision step 3840 to determine by comparison with contents of a firewall register Req_Info_Permission 3842 (subfield attr, compare register DMA_CHANNELi of FIG. 20) whether the request itself (the attempted access) has the correct Mreq qualifiers, collectively called MreqInfo, to permit access to the region or target (compare to element 3730 of FIG. 21). If not at step 3840 (Fail), then operations branch to step 3830 where Access is denied. If Yes (Pass) at step 3840, then operations proceed to a step 3850 where Access is granted.

If a write access is indicated by MCMD at decision step 3815, operations go from step 3815 (No) to a decision step 3860 to determine the Initiator ID 3864 (or 3824) of the initiator has permission from a register WR_Permission 3862 (subfield wr) for the region to indeed write to this region. If No at step 3860, then operations branch to step 3830 where Access is denied. If Yes at step 3860, then operations proceed to the further decision step 3840 to determine whether the request has the correct Mreq qualifiers, collectively called MreqInfo, to permit write access to the region. If No at step 3840, then operations branch to step 3830 where Access is denied. If Yes at step 3840, then operations proceed to step 3850 where Access is granted.

Various combinations of bits values in the Req_Info_Permission register of FIG. 22 collectively indicate the constellation of permissions that the firewall provides. A given firewall associated with a target is programmable so that access requests are granted, for instance, for either Public or Secure accesses or both, for either Privileged or Non-Privileged (User mode) accesses or both, for either MPU 2610 accesses or system (e.g., DSP, modem) accesses or both, for functional or debug accesses or both, and for data accesses or opcode (instruction) accesses or both, and/or any combination of the foregoing. The logic of the MreqInfo decoder in some embodiments is hardwired to reflect the combination of permissions, and in other embodiments the permission register values themselves reflect the combination of permissions. Each firewall is configured to admit the accesses authorized for its respective target. In this way, configuration flexibility is provided to accommodate various kinds of system architectures and system-on-a-chip (SOC) architectures. Notice that the configuration of each firewall is a special case in a uniformly-applied general plan of configurable firewall hardware of FIGS. 20-23 for any particular system and product of FIG. 18, FIG. 2 and FIG. 1.

TABLE 12 shows various registers for use in an alternative embodiment of a firewall 3512.i or 3522.i, etc. Address-subsystem/segment-specific Permission registers are provided and called Protection Group registers PROT_GROUP(0), (1), . . . (N) in TABLE 12.

In FIG. 23, the MreqInfo decoder accesses all the Protection Groups together. A given access permission from each group is fed to mux circuitry 3936, 3946. The mux circuitry 3936, 3946 has a selector control fed with a signal corresponding to the subsystem or segment i (e.g., 3510.i) to which access is attempted. The output of the mux represents access permission or denial of access.

TABLE 12
FIREWALL REGISTERS

| Register | Field | Description |
|---|---|---|
| Segment(0 . . . , N − 1) | Base | Segment base address |
| | Size | Segment size |
| PROT_GROUP(0) | ConnID | Permitted Initiators |
| | MreqInfo, MCMD | |
| PROT_GROUP(1) | ConnID | Permitted Initiators |
| | MreqInfo, MCMD | |
| PROT_GROUP(2), | ConnID | ″ |
| . . . (N − 1) | MreqInfo, MCMD | ″ |
| Region | MADDRSPACE | Target Bus |
| | | MaddrSpace value |
| | SEGMENT_ID | Segment ID of the region |
| | PROT_GROUP_ID | Protection group ID |
| | BYTE_DATA_WIDTH_EXP | Target Bus data byte |
| | | width |
| | PHY_TARGET_ID | Physical target ID |
| | SIZE | Region size |
| | ENABLE | Enable of the region |
| | | register |
| | BASE | Region base address |

Security Violation handling for In-band errors. When an in-band error is sent back into a system-side bus (e.g., an Open Core Protocol OCP side of interface 2665) in response to an attempted bus transaction, this error is converted by the MPU2BUS as a xRESPx=ERROR flag. HRESPx is an error response regarding Host (MPU). SRESPx is an error response regarding System (e.g., Modem, DSP, Camera, etc.). The SRESPx flag from Firewallx is seen by the MPU 2610 as an External Prefetch Abort or Data Abort depending on whether the transaction type is an opcode fetch or a data transfer.

As used herein, “in-band errors” refer to errors that are embedded in a response transaction to an initiator. Initiator refers to a circuit that is initiating an information transfer. For example, a response transaction may include status information such as an “OK” indicator or a “FAIL” indicator that is returned to the initiator. As used herein, “out-band errors” refer to errors that are out of the initiator execution flow. For example, the firewalls may generate error signals that are outside the initiator execution flow. The out-band errors are used to update status registers and/or to cause an MPU 2610 interrupt to notify a user of the system, to disable one or more functions of the system, or to perform some other action in response to a security violation. An in-band error SRESP is provided to processor core 2610.

In FIG. 20, in case of occurrence of a firewall violation signal for out-band error interrupt, the out-band error interrupt can activate either Monitor Mode code and/or SSM 2460, and thereupon commence diagnostics, recovery of regular system operation, error reporting, and/or countermeasures as appropriate against the offending code. Separate lines for in-band and out-band errors are distinguished at the firewall and are provided in different embodiments wherein such errors use interconnect and interface 2665, Interrupt Handler 2720, and/or Security Violation Handler 2760. Or a single line for both in-band error codes and out-band error codes is provided in other embodiments.

When an External Prefetch Abort is seen by the MPU 2610 internal pipeline, the MPU flushes all its pipeline stages, flushes its prefetch unit and branches to the External Prefetch Abort exception vector whereupon Extend Prefetch Abort service software code linked to that exception vector is executed. When an External Data Abort occurs, the MPU stalls its pipeline and branches to the External Data Abort exception vector. External Data Abort software code linked to this exception vector is executed. The MPU responds to both types of in-band errors to kill the applicable process thread.

An in-band error due to a Security violation can come from any of the firewalls due to an MPU Read or Write transaction or an instruction transaction as applicable to the firewall. When a posted write fails, an Out-of-Band error is generated. Out-of-Band errors are suitably generated by various DMA firewalls and Interconnect firewalls and are flagged in the Control Module 2765 and reported in the Platform_Violation field of the SSM Platform_Status Register (PSR) in registers 2620 of FIG. 9B.

TABLE 13 describes various error-reporting registers.

TABLE 13
ERROR REPORTING REGISTERS

| Register | |
|---|---|
| Type | Register Description |
| Initiator | Out-Of-Band error reporting of debug errors |
| | Out-Of-Band error reporting of functional errors |
| | Error Status |
| | Value of Bus Memory-error signal |
| Interface | Out-of-Band error reporting of debug errors |
| | Out-Of-Band error reporting of functional errors |
| | Error Status |
| | Value of Bus Memory-error signal |
| Register | MReqInfo bits of the request that causes the error |
| | Multiple errors detected |
| | Indicates whether a security violation was a primary or a |
| | secondary error (Debug errors) |
| | Initiator Request Errors Codes: |
| | No Errors |
| | Address hole error |
| | Security violation |
| | ConnID of request causing the error |
| | Command that causes the error |

FIG. 23 shows an overview of another embodiment of circuitry in a firewall for address overlap detection and the use of the MreqInfo qualifiers to generate functional and debug Security Violation signals. The circuitry of FIG. 23 can be compared with the embodiments of FIG. 22 and FIG. 21 by some of the trailing digits of numerals in each of FIGS. 21-23. The circuitry in FIG. 23 can be used to implement and supplement parts of embodiments of FIGS. 20, 21, 22.

In FIG. 23, an address compare section 3910 compares the address MADDR of the attempted access with various Start/End addresses configured for the firewall. If address MADDR is lower/higher than the respective Start address start_addr_reg<i> for an address segment for target i=0, 1, . . . n (n=7 in this example), then each subtractor 3912.i goes high/low at a first input of its respective NOR-gate 3916.i. If address MADDR is higher/lower than the End address end_addr_reg<i> for address segment for context i, then each subtractor 3914.i goes high/low at a second input of its respective NOR-gate 3916.i. The output of each NOR-gate 3916.i goes high or low depending on whether the address MADDR is inside or outside the range defined by the Start address and End address for that segment i. The outputs, n in number, of the NOR-gates 3916 are fed to a Segment Selector Logic 3918 that produces selector signals indicative the segment i or subsystem i that the attempted access is addressing. In the meantime, the signal MCMD is fed on a line 3915 to act as a Read/Write selector signal representing a type of request by the Initiator attempting access.

In FIG. 23 and FIG. 20, the Permission register(s) (e.g., DMA_CHANNELi of FIG. 20, and 3720 of FIG. 21) for the firewall are configured by writing register-wide data to the Permission registers. The configuration process is compliant with configuration hardware security rules described hereinabove for FIG. 20 and TABLE 10. The Permission register fields in FIG. 23 (compare registers of FIG. 20) include read permissions rd 3922.i, attributes attr 3942.i, and write permissions wr 3962.i. In FIG. 23 drawing numerals, the trailing digits are selected to facilitate comparison with FIG. 22.

In FIG. 23, depending on whether signal MCMD on a line 3915 defines a Read or a Write, a 2:1 mux 3932 responsively delivers read permissions from eight 16-bit register fields rd 3922.i or from eight 16-bit register fields wr 3962.i. The 16×8 output of mux 3932 is 16:1 muxed by a Mux 3934 based on Initiator's four-bit ConnID 3924. The resulting 8-bit output of Mux 3934 gives permission bits for all of the illustrated eight subsystems i. The eight-bit output of Mux 3934 is then is 8:1 muxed by a Mux 3936 to find the addressed target i. Mux 3936 has selector controls driven by output lines 3937 from Segment Select Logic 3918 that is responsive to MADDR via block 3910. Mux 3936 supplies a one-bit output signal representing whether the initiator ConnID in fact has permission to access address segment i, or target i, using the Read or Write type of access defined by signal MCMD.

Permission Decode logic 3940 generates an intermediate clearance or permission signal to a first input of an AND-gate 3938. Mux 3936 has its output coupled to a second input of the AND-gate 3938.

Permission Decode logic 3940 has a number m (five here) MreqInfo inputs 3944 from FIG. 20. The MreqInfo inputs 3944 together have one out of 2-to-the-number-m (e.g., 32) possible binary logic states or permutations. A 32-bit signal attr-sel has respective permission bits for each of the 32 possible logic states of 5-wide MreqInfo in this example. The particular permutation or state of the five MreqInfo inputs is collectively used by the Permission Decode logic 3940 as a selector signal to 32:1 mux-select (in effect 3940 is a mux) a single bit selected from the 32-bit attr-sel from a Mux 3946. The resulting single permission bit provides the intermediate permission signal from logic 3940 signifying that the Initiator-asserted MreqInfo is acceptable or not. Mux 3946 has eight 32-bit inputs from the eight corresponding attribute fields attr 3942.i of the eight respective segment/target-specific Permission registers. Each attribute field (attr) represents or includes a Current Mode Signifier of TABLE 11 applicable to a particular firewall target, for example. Mux 3946 is an 8×32:1×32 mux that has its selector control lines coupled to the output lines 3937 of Segment Selector Logic 3918 that identifies the segment or target to which the Initiator access applies.

AND-gate 3938 supplies an output active-high when both the intermediate MreqInfo permission signal is active from Permission Decode logic 3940 and the Read permission/Write permission output from Mux 3936 is active. The output from Mux 3936 to indicates that the initiator identified by ConnID is permitted to make the type (Read or Write) of access being attempted. The output of AND-gate 3938 is like the Pass/Fail output from FIG. 22.

A logic circuit 3948 is fed with ConnID as a system input and with an MPU 2610 signal indicating an MPU access. Logic circuit 3948 in some embodiments acts as a mask filter or comparator to produce one or more MreqSystem signal(s) active when a particular ConnID indicative of a Modem DSP or System DMA, for instance, is making the access, and to produce the MreqSystem signal inactive when the MPU 2610 is making the access. SSM 2460 in another embodiment, as in FIG. 7, generates the MreqSystem signal for decode logic 3940 such as when a virtual processor (e.g., virtualized modem) is active (VP1_Active).

An AND-gate 3952 is fed at a first input with the permission output of the AND-gate 3938. AND-gate 3952 is fed at a second input with the output of an Overlap Logic circuit 3954 which represents whether undesirable overlapping of defined address segments is absent or not. Overlap Logic circuit 3954 has n-number of inputs coupled to the outputs of the NOR-gates 3916.i for the various address segments i. If two or more of the outputs of the NOR-gates 3916.i are active concurrently, then the output of the logic 3954 is made active. In this way, the hardware monitors the Start/End addresses of the segments so that the definitions of the separate address segments are non-overlapping and do not generate an ambiguous multiple hit in different segments i by a given attempted access.

If such overlapping is present, or if AND-gate 3938 has permission output inactive indicating that access permission is denied, then the AND-gate 3952 supplies an active security violation output to a 1:2 demux 3956. Classifier MreqDebug drives the selector control of demux 3956. Suppose the output of logic 3952 is active, indicating a security violation. If classifier MreqDebug is active for Debug access, then Demux 3956 supplies a debug-based Security Violation output signal Sec_Viol_Debug active. Otherwise, if classifier MreqDebug is inactive for Debug access, thus indicating Functional access, then Demux 3956 supplies another Security Violation output signal Sec_Viol_Func active instead.

Numerous circuitry embodiments can be prepared by reference to the examples and/or otherwise according to the teachings herein to accomplish the determination of permission Pass/Fail (Granted/Denied) for the attempted access. Among other things, some embodiments suitably use multi-bit permission fields, instead of a single bit permission field, and a particular multi-bit permission field is retrieved depending on a particular permutation or state of MreqInfo inputs. Degree of programmability of the firewall and amount of chip real estate are considered in preparing a particular embodiment.

In FIG. 24 and TABLE 17, Read and Write accesses occurring to each word in the Secure Privilege mode (SPM) Stack memory space are checked using a dedicated, dynamic firewall DFW 4010 having properties that change on the fly according to the access occurring. This dynamic hardware firewall 4010 detects a buffer overflow event attempting to overwrite stack buffers and/or overwrite a function return pointer before a stack pop or read by the MPU 2610. Firewall 4010 is activated when Secure Privilege Mode Stack Integrity Checker SPMSIC_EN field is set active in a SSM_Firewall_Controller register 4020 in Control Module 2765. The SPM Stack memory space protected by this mechanism is configured as Normal, Non-Shared, Non-Cacheable in the MMU associated with MPU 2610. Fields in an SSM_SPMSIC_Control Register operate as follows. When a field Reset_Matrix_SPMSIC is active, the dynamic firewall is reset. When a field Freeze_SPMSIC is active, the dynamic firewall is frozen.

In FIG. 24, an SPM Stack firewall 4010 embodiment uses a hardware matrix 4015 that has a matrix of bits to track each read and write to any given word in the SPM Stack. In one embodiment, DFW_Matrix (L_Lines, W_Words) has a number L of memory lines (each line having 256 bits) that are containable in the memory reserved stack area for the Secure Privilege mode. DFW_Matrix 4015 is used to flag a change to any of a number W of 32-bit words in each memory line of the memory reserved stack area.

Suppose a Stack of size 2ˆ (N+1)=L×256 bytes is to be protected. The letter “A” designates an Address_of_the_Incoming_Group_of_Access [MSB] and is a memory line address MSB selection out of L memory lines. The letter “B” designates the Word_Line_Used [LSB] and is the word selection LSB out of the W words inside a given memory line address. The DFW Matrix 4015 supports mixed-Endian, aligned and unaligned accesses for packed stacks, and bursts from store multiple instructions.

In one type of embodiment the DFW Matrix has a cell or bit corresponding to each coordinate pair (A,B). If DFW_Matrix (A, B)=0 a write access is allowed to word B of the memory line address A. When the write occurs, the corresponding cell is set, so DFW_Matrix (A, B)=1 (Set). When a read to the same word (A,B) occurs, that cell is cleared, so DFW_Matrix (A, B)=0 (cleared). If DFW_Matrix (A, B)=1 and a write access occurs consecutively to the “B” word of the memory line “A” without an intervening read, then a Security Violation is generated. The Security Violation is generated because an attempt to overwrite a word in the SPM Stack has occurred after an earlier write and before a pop or read has occurred.

If 4 Kbytes of stack are to be monitored by the dynamic firewall 4010, this means N=11. The memory reserved stack area is aligned on 2ˆ (N+1) address boundary for simplicity and to avoid matrix translations. If word width is 32 bits (4 bytes), and W is 8 words/line, then the number L of memory lines is 128 lines (=4K bytes/(4 bytes/word×8 words/line)).

In FIG. 24, and associated with the DFW Matrix 4015, is an MPU bus write access decoder 4016 of TABLE 15 also in firewall 4010. The MPU2BUS interface 2665 separates for write accesses the following: the address access request, the data transfers and transfers status. The MPU bus interface 2665 operates in the manner of an address posting. To further protect the SPM Stack, MPU bus write access decoder 4016 regenerates exactly what address would hit or access the Secure Privilege Stack before any data access physically happens by posting or initiation by the MPU 2610. Decoder 4016 decodes from the address sent and burst mode a corresponding word (B above) on an eight-word memory line designated Write_Matrix_Hit[:] in the DFW_Matrix 4015. In an example shown by TABLE 15 hardware design code, a write strobe is used on the Write channel, and an example of decoder 4016 operates on a per-data basis. This mechanism re-aligns all accesses on eight bytes and responds to a write strobe WSTRB.

TABLE 15
BUS WRITE ACCESS DECODER 4016

WRITE_MATRIX_HIT [7:0] <= (OTHERS => ‘0’);

| | |
|---|---|
| HIGH_WSTRB_VAR | <= WSTRB(7) OR WSTRB(6) OR WSTRB(5) OR WSTRB(4); |
| LOW_WSTRB_VAR | <= WSTRB(3) OR WSTRB(2) OR WSTRB(1) OR WSTRB(O); |
| WSTRB_VAR | <= HIGH_WSTRB_VAR & LOW_WSTRB_VAR; |

| | |
|---|---|
| CASE AWADDRW[4:3] IS | -- This mechanism re-aligns all accesses (Hits) on 8 Bytes 0-7 |

and uses the write strobe WSTRB --

| | | |
|---|---|---|
| WHEN “00” | => WRITE_MATRIX_HIT [1:0] | <= WSTRB_VAR; |
| WHEN “01” | => WRITE_MATRIX_HIT [3:2] | <= WSTRB_VAR; |
| WHEN “10” | => WRITE_MATRIX_HIT [5:4] | <= WSTRB_VAR; |
| WHEN “11” | => WRITE_MATRIX_HIT [7:6] | <= WSTRB_VAR; |
| WHEN OTHERS | => WRITE_MATRIX_HIT | <= (OTHERS => ‘0’); |

END CASE

TABLE 16
BUS READ ACCESS DECODER 4018

```
READ_MATRIX_HIT [7:0] <= (OTHERS = >‘0’);
IF ARSIZEW [1:0] = “11”
THEN READ_MATRIX_HIT
    [(2* (ARLENW[1:0] + ARADDRW[4:3] + 1) −1) :
    (2*ARADDRW [4:3])] <= (OTHERS = >‘1’);
ELSE READ_MATRIX_HIT
    [((ARLENW[1:0] + ARADDRW[4:2] + 1) −1): (ARADDRW[4:2])]
    <= (OTHERS = >‘1’);
ENDIF;
```

For bus Reads, a MPU bus read access decoder 4018 is provided in the SPM Stack firewall 4010, and complements the MPU bus write access decoder 4016 just described. The MPU bus read access decoder 4018, shown by example in hardware design code of TABLE 16, decodes from the address sent and burst mode a particular word (B) on the eight-word memory line (designated Read_Matrix_Hit) in the DFW_Matrix 4015.

A Secure Privilege Mode Stack Integrity Checker SPMSIC firewall 4010 and example hardware design code for it are shown in FIG. 24 and TABLE 17. References to WriteDecoder( ) and ReadDecoder( ) in the design code of TABLE 17 pertain as a whole to the Write Access Decoder 4016 of TABLE 15 and to the Read Access Decoder 4018 of TABLE 16 respectively. A Security Violation signal that is specific for SPM_Stack is output if an attempt to overwrite a given word in the SPM Stack has occurred after an earlier write to that word and before a pop or read of that word in SPM Stack has occurred.

TABLE 17
SECURE PRIVILEGE STACK FIREWALL SPMSIC 4010
HARDWARE DESIGN CODE EXAMPLE

```
STACK_BUFFER_OVERFLOW_VIOLATION <= ‘0’;
IF SPMSIC_EN = ‘1’
THEN
  READ_Matrix_HIT [7:0] <= (OTHERS = >‘0’);
  WRITE_Matrix_HIT [7:0] <= (OTHERS = >‘0’);
  IF (RESET_Matrix_SPMSIC =’1’)
  THEN DFW_Matrix<= (OTHERS => ‘0’);
  ENDIF;
  IF (FREEZE_SPMSIC = ‘0’)
  THEN
    IF (AWVALIDW = ‘1’ & ACLKEN = ‘1’ & AWPROTW [ ] = “001”
    & AWADDRW [MSB] = START_SPM_STACK)
    THEN
      WRITE_Matrix_HIT = WriteDecoder(AWADDRW, WSTRB)
      WRITE_Matrix_VIOLATION
        <= DFW_Matrix (AWADDRW [LSB]) & WRITE_Matrix_HIT;
      WRITE_Matrix_MASK
        <= DFW_Matrix(AWADDRW [LSB]) OR WRITE_Matrix_HIT;
      IF (WRITE_Matrix_VIOLATION = 0x0)
      THEN DFW_Matrix (AWADDRW [LSB]) <= WRITE_Matrix_MASK;
      ELSE STACK_BUFFER_OVERFLOW_VIOLATION <= ‘1’;
      ENDIF;
    ENDIF;
    IF (ARVALIDW = ‘1’ & ACLKEN = ‘1’ & ARPROTW [ ] = “001”
    & ARADDRW [MSB] = START_SPM_STACK)
    THEN
      READ_Matrix_HIT<= ReadDecoder(ARSIZEW,ARLENW,ARADDRW)
      READ_Matrix_MASK
        <= DFW_Matrix (ARADDRW [LSB]) & (NOT(READ_Matrix_HIT));
      DFW_Matrix (ARADDRW [LSB]) <= READ_Matrix_MASK;
    ENDIF;
  ENDIF;
ENDIF;
SECURITY_VIOLATION_SPM_STACK
            <= STACK_BUFFER_OVERFLOW_VIOLATION;
```

Further in FIG. 24 and in TABLE 18, a Monitor Stack Firewall 4030 checks that no write access physically happens to the Monitor Stack if the MPU 2610 is not in Monitor Mode (CPSR_Mode unequal to Monitor). The Monitor Stack is a reserved memory space situated in an upper portion of the SPM Stack when End_SPM_Stack is used for End address. Monitor Stack is otherwise situated in memory space when End_Monitor_Stack is used for End address for firewall 4030.

Monitor Stack Firewall 4030 protects the integrity of data in the Monitor Stack from write access) by any CPSR mode of MPU 2610 other than Monitor Mode. Enabling both firewalls 4010 and 4030 from Firewall_Controller register 4020 provides a dual enforcement configuration activated by register fields/bits SPMSIC_EN and MONITOR_STACK_EN. A Security Violation signal specific to occurrence of an attempted non-Monitor write access threatening the Monitor Stack is output by firewall 4030 to Security Violation Handler 2760. MMU page configurations for Monitor Stack and SPM Stack are set up as non-executable data page.

TABLE 18
MONITOR STACK FIREWALL 4030
HARDWARE DESIGN CODE EXAMPLE

```
MON_STACK_TRASH <= ‘0’;
IF (MONITOR_STACK_EN = ‘1’ & CPSR_MODE != MONITOR )
THEN
  IF (AWVALIDW = ‘1’ & ACLKEN = ‘1’)
  THEN
    IF (START_MONITOR_STACK [MSB] = AWADDRW [MSB]
      & START_MONITOR_STACK [LSB] ≦ AWADDRW [LSB]
                    ≦ END_SPM_STACK [LSB])
    THEN MON_STACK_TRASH <= ’1’;
    ELSE MON_STACK_TRASH <= ‘0’;
    ENDIF;
  ENDIF;
ENDIF;
SECURITY_VIOLATION_MONITOR_STACK <=
MON_STACK_TRASH;
VIOLATION_WRBUS_NEUTRALIZER
  <= (SECURITY_VIOLATION_MONITOR_STACK OR
  {other Neutzn});
```

In FIG. 24, FIGS. 25A/25B, and FIG. 26, the SSM_Firewall_Controller Register 4020 provides various fields or bits of information to selectively enable SSM protections as listed in TABLE 19. Description pertains when the field or bit is active.

TABLE 19
SSM FIREWALL CONTROL REGISTER FIELDS

| Field | Function |
|---|---|
| SSM_FC_REGISTER_LOCK | Lock all fields of Firewall Controller (FC) register |
| CPSR_ENFORCEMENT_EN | SSM locks the SSM_CPSR_Mode_Enforcement register and |
| | activates the checks of CPSR transition 2755 in FIGS. 9, 10A/10B according to |
| | SSM_CPSR_Mode_Enforcement register configuration. |
| DC_ENFORCEMENT_EN | SSM checks that L1/L2 Data cache (DC) is activated in the Secure |
| | World (Enforcement applies only when security zone locking SZ_LOCKING is ACTIVE.) |
| IC ENFORCEMENT_EN | SSM checks that L1/L2 Instruction cache (IC) is activated in the |
| | Secure World (Enforcement applies when SZ_LOCKING is Active.) |
| MMU_ENFORCEMENT_EN | SSM checks that MMU is activated in the Secure World |
| | (Enforcement applies when SZ_LOCKING is Active.) |
| SPMSIC_EN | SPM Stack Firewall 4010 in FIG. 24 checks the Secure Privilege Mode Stack |
| | against buffer overflow |
| MONITOR_DRW_EN | Monitor Mode Data Firewall 4150 in FIG. 25B checks that |
| | Monitor code only performs Data Write transfer in allowed memory range |
| MONITOR_STACK_EN | Monitor Stack Firewall 4030 in FIG. 24 checks that Monitor Mode |
| | Stacks are not trashed by write accesses from others CPSR_Mode. When Active, this register |
| | locks the Start_Monitor_Stack and End_Monitor_Stack registers. |
| MONITOR_DTRACE_EN | Trace Bus Firewall 4860 in FIG. 31A starts the data Trace |
| | checking of the Monitor code and locks the Start_Monitor_Stack_Trace, |
| | End_Monitor_Stack_Trace, Start_Monitor_Periph_Trace, and End_Monitor_Periph_Trace |
| MONITOR_ITRACE_EN | Trace Bus Firewall 4830 in FIG. 31B starts the instruction Trace |
| | checking of the Monitor code and locks the Start_Monitor_Code_Trace and |
| | End_Monitor_Code_Trace |
| SPM_STACK_EN | Instruction Firewall 4110 in FIG. 25A checks that instructions are not |
| | executed in the Secure Privilege Mode Stack and locks the Start_SPM_Stack and |
| | End_SPM_Stack registers |
| STACKEDRAM_EN | Instruction Firewall 4110 in FIG. 25A allows the Secure mode to fetch |
| | code in SDRAM allowed memory range and locks the Start_StackedRAM and |
| | End_StackedRAM registers |
| SECRAM_EN | Instruction Firewall 4110 in FIG. 25A allows the Secure mode to fetch |
| | code in on-chip RAM allowed memory range |
| MONITOR_EN | In FIGS. 25A/25B, Monitor Mode firewalls 4110 and 4150 check that the |
| | Monitor code only fetch instructions in allowed memory range and that Monitor code only read |
| | data from allowed memory space. Start_Monitor_Code and End_Monitor_Code registers are |
| | locked. |

In FIG. 25, an Instruction Bus Firewall 4110 is connected with the rest of the SSM 2460 of FIG. 9 in the system of FIGS. 9, 18, and 25. TABLE 20 shows example design code for the Instruction Bus Firewall 4110. The specific monitoring of Secure RAM addresses is enabled/disabled in the Control Module 2765 by writing in the SSM_Instruction_FW_Controller registers in a SPM_Stack_EN field.

In FIG. 25, Secure Privilege Mode Stack Protection (SPMSP) 4110 against instruction execution is separate and independent from a Secure Privilege Mode Stack Integrity Checker (SPMSIC) 4010 of FIG. 24. In some embodiments, both mechanisms 4010 and 4110 share the same start address Start_SPM_Stack 4122 and the SPMSIC 4010 has a fixed size in FIG. 24, and omits an input from End_SPM_Stack register 4124. In FIG. 25, the SPMSP 4110 suitably protects an equal or larger memory space relative to the space protected by SPMSIC 4010 of FIG. 24. Depending on whether the processor stacks are handled in decreasing or increasing addressing in the Secure Kernel in different embodiments, the Start_SPM_Stack register 4122 represents higher or lower addresses respectively compared to End_SPM_Stack 4124.

In FIG. 25A, Instruction Bus Firewall 4110 also establishes SDRAM component memory partitioning for secure access to secure stacked SDRAM 3550 of FIG. 18, such as off-chip memory for use by Secure Demand paging (SDP) 2745 of FIG. 9. The Start_Secure_Stacked_RAM 4126 and End_Secure_Stacked_RAM 4128 registers are configurable in the Control Module 2765 with predetermined granularity. The specific monitoring of this range of addresses for Stacked RAM 3550 is enabled/disabled in the Control Module 2765 of FIG. 25A by writing in the Firewall_Controller register 4020 in a StackedRAM_EN field. A secure area in Stacked SDRAM 3550 is also configured and protected using the firewalls 3552.i of FIG. 18. Instruction Bus Firewall 4110 of FIG. 25 physically, controllably and securely enables this capability.

Instruction Bus Firewall 4110 generates a Security Violation for instruction bus IBUS if Monitor Mode code attempts to get an opcode from anywhere besides a Start/End_Monitor_Code reserved space, or if any Secure mode attempt to access an instruction opcode goes outside Start/End address spaces in Secure ROM, Secure RAM or Stacked RAM permitted for opcode retrieval. If any Secure mode opcode access is specifically directed to the SPM Stack, the occurrence is flagged and a corresponding Security Violation is generated. If the IBUS bus lines indicative of protection ARPROTI are inconsistent with the CPSR_Mode and NS security bits on the Security Monitor bus SECMON 2635 of MPU 2610, then a Security violation is issued by firewall 4110. Also, a Secure mode access for an instruction opcode in the SPM Stack is not permitted, since SPM Stack is for data and not opcodes, and firewall 4110 triggers a Security Violation upon such an occurrence.

TABLE 20
INSTRUCTION BUS FIREWALL 4110 DESIGN CODE EXAMPLE
(MSB = more-significant bits; LSB = less-significant bits.)

```
OUT_OF_MONITOR <= ‘0’;
IN_SPM_STACK <= ‘0’;
OUT_OF_SECROM <= ‘0’;
OUT_OF_SECRAM <= ‘0’;
OUT_OF_STACKEDRAM <= ‘0’;
OUT_OF MMU_SECURE <= ‘0’;
IF (ARVALIDI = ‘1’ & ACLKEN = ‘1’ & ARPROTI [ ] = Opcode)
THEN
  IF (CPSR_MODE = MONITOR_MODE)
  THEN
    IF (ARPROTI [:] = User Mode or Public)
    THEN OUT_OF MMU_SECURE <= ‘1’;
    ELSE OUT_OF MMU_SECURE <= ‘0’;
    ENDIF;
    IF (Start_Monitor_Code[MSB] = ARADDRI [MSB] & Monitor_EN = ‘1’
  & Start_Monitor_Code[LSB] ≦ ARADDRI [LSB] ≦ End_Monitor_Code[LSB])
    THEN OUT_OF_MONITOR <= ‘0’;
    ELSE OUT_OF_MONITOR <= ‘1’;
    ENDIF;
ELSE
    IF (CP15S_NS= ‘0’)
    THEN
      IF ARPROTI [ ] =User Mode
      THEN OUT_OF MMU_SECURE <= ‘1’;
      ELSE OUT_OF MMU_SECURE <= ‘0’;
      ENDIF;
      IF (START_SecROM [MSB] = ARADDRI [MSB]
      & START_SecROM [LSB] ≦ ARADDRI [LSB] ≦ END_SecROM[LSB])
      THEN OUT_OF_SECROM <= ‘0’;
      ELSE OUT_OF_SECROM <= ‘1’;
      ENDIF;
      IF (START_SecRAM [MSB] = ARADDRI [MSB]
      & START_SecRAM [LSB] ≦ ARADDRI [LSB] ≦ END_SecRAM[LSB])
      & SECRAM_EN = ‘1’
      THEN OUT_OF_SecRAM <= ‘0’;
      ELSE OUT_OF_SECRAM <= ‘1’;
      ENDIF;
      IF (START_SPM_Stack[MSB]= ARADDRI [MSB] & SPM_Stack_EN =‘1’
    & END_SPM_Stack[LSB]≦ARADDRI [LSB]≦START_SPM_Stack[LSB]
    &”11”)
      THEN IN_SPM_STACK<=‘1’;
      ELSE IN_SPM_STACK<=‘0’;
      ENDIF;
      IF (START_StackedRAM [MSB] ≦ ARADDRI [MSB] ≦END_StackedRAM [MSB])
    &StackedRAM_EN = ’1’
    THEN OUT_OF_STACKEDRAM <= ‘0’;
    ELSE OUT_OF_STACKEDRAM <= ‘1’;
    ENDIF;
  ENDIF;
ENDIF;
Security_Violation_IBUS <= OUT_OF_MONITOR
          OR OUT_OF_MMU_SECURE
          OR IN_SPM_STACK
          OR (OUT_OF_SecROM
            & OUT_OF_SecRAM
              &  OUT_OF_STACKEDRAM);
Violation_IBUS_Neutralizer <= Security_Violation_IBUS OR {other Neutzn};
```

A Monitor Mode Data Firewall 4150 is depicted in FIG. 25B, and a hardware design code example is given in TABLE 21. During Secure mode execution, Monitor Mode data-related read/write operations are checked to determine whether the Monitor is reading from allowed locations and whether the Monitor writes are directed to allowed locations. Allowed Monitor read locations are specified, for instance, as Secure ROM Monitor Mode data address ranges Start/End_SEC_ROM, Monitor Stack ranges Start/End_Monitor_Stack, and various embodiments apply some or all of these and other ranges. A Security Violation is issued by firewall 4150 if Monitor code attempts a read outside the configured ranges.

In firewall 4150, a Security violation for Monitor Data is issued if an attempted Monitor data access would use an area prevented or forbidden to Monitor by firewall 4150. If Monitor Mode attempts write outside the Monitor Stack, then a Security Violation is issued. Furthermore, if the CPSR_Mode on SECMON bus indicates Monitor Mode, but the Data Read bus protection lines ARPROTW or Data Write bus protection lines AWPROTW indicate User or Public mode, then the inconsistency is detected by firewall 4150. Depending on the applicable bus, data read_DRBUS or data write_DWBUS, a respective Security_Violation_signal is issued from firewall 4150.

By way of operational comparison of firewalls 4030 and 4150, a Write is rejected by Monitor Stack Firewall 4030 of FIG. 24 if the Write is directed to Monitor Stack(s) by any process running in a Public or Secure mode that is not Monitor Mode. Firewall 4030 thus operates to separate and insulate the Monitor Mode acting as hypervisor from tampering by processes of FIGS. 3-6 that the hypervisor is supposed to control. Moreover, firewall 4150 ensures that the Monitor Mode itself operates in permitted spaces in a manner expected of hypervisor operation. A shared Data section in SPM Stack is suitably provided to mediate or provide a means of communication between the Monitor Mode and Secure Privilege mode. Further, the Secure Privilege Mode SPM Stacks are protected against buffer overflow by SPM Stack Firewall 4010 of FIG. 24.

In FIGS. 25A/25B, Monitor Mode Instruction Bus Firewall 4110 and Monitor Mode Data Firewall 4150 prevent Monitor Mode code itself from attempting access outside permitted spaces. In case Monitor Mode code were intruded upon by an attack, Monitor code is prevented from executing virus or other code involved in the attack. Monitor code can control a transition from Secure space into Public space because in Monitor Mode the Monitor code can context-switch MPU 2610 core parameters that do not need to enter the mode concerned. Also, the Monitor Mode has a dedicated memory stack called the Monitor Stack. Moreover, Monitor Mode can access both Secure and Public MMU and SSM 2460 of FIG. 9.

Monitor Mode code is constrained by the circuitry of FIG. 25B and TABLE 21 to only transition to Secure or Public Privilege mode, such as through a Secure SWI Handler. Thus, the Monitor code is forbidden by the hardware of FIG. 25B to directly to do a transition from itself to a non-privileged mode such as User mode. Conversely, a non-privileged mode such as User mode or even a Secure non-privilege mode cannot transition directly to Monitor code but only through a Public Privilege mode SWI Handler by a SMI (software monitor interrupt) or Secure Privilege mode SWI Handler respectively. The transition occurs from each SWI Handler by a software monitor interrupt (e.g., SMI). In an example, the SMI occurs instead of trapping some FIQ.

In FIG. 9 and FIG. 18, the SSM 2460 has registers 2620 and Control Module 2765 has registers. These configurable registers are suitably either coupled to the Peripheral Bus to MPU2BUS interface 2728 of FIG. 9 or provided in Control Module 2765 and coupled to the Interconnect 3534 of FIG. 18, or handled in any appropriate alternative manner. Allocation of registers to SSM registers 2620 or to the Control Module 2765, for instance, is based on considerations that some registers are used to configure statically the Security Zone architecture and configure and activate the SSM 2460, the firewalls and other security circuitry to ensure the security robustness of the platform. Such registers are readily situated in the Control Module 2765. Some other registers are used dynamically by the Monitor Mode hypervisor for critical, fast operation each time an SMI and/or FIQ happens or are used by operations in Secure Privilege mode. The more dynamically used registers are well-accommodated in the SSM registers 2620.

In FIGS. 25A/25B, the Monitor Mode is itself regulated and protected by protective circuitry 4110, 4150 and prevented from accessing outside of predefined memory space and elsewhere in the rest of the platform. Having the Monitor Mode code running on MPU 2610 and accessing SSM Registers 2620 via Peripheral Port 2625 is safer and easier to control while ensuring a fast execution. In one circuit example, accessing the Peripheral Port 2625 of FIG. 9 is also considerably faster than accessing the Interconnect 3534 of FIG. 18. Accordingly, the registers that are used dynamically by the Monitor Mode hypervisor are allocated to the Registers 2620 in such a circuit example. In other embodiments, different allocations of registers, definitions of fields and access mechanism may also be employed, especially where the speed and security considerations may be significantly different than just described.

In some embodiments, Monitor Mode Data Firewall 4150 includes a hardware section to initialize a SMI (Software Monitor Interrupt) flag SMI_Code if the mode is not Monitor Mode. If operations are in Monitor Mode and Monitor Mode is enabled, a permissible SMI service retrieve might occur but trigger a Security_Violation_DRBUS under the rules regulating Data Reads in firewall 4150. In that permitted case a Violation_DRBUS_Neutralizer output line is kept inactive, but otherwise an active state of Security_Violation_DRBUS as noted above also activates the Violation_DRBUS_Neutralizer output line from firewall 4150.

In some embodiments, a security zone mechanism in MPU 2610 can evict a data write cache line as dirty in Monitor Mode. In FIG. 25B and TABLE 21, a Monitor data write access protection Monitor_DRW_EN in SSM_Firewall_Controller register 4020 is suitably enabled to reject writes to Monitor Mode stacks by any process running in Secure Privilege or User modes. This access protection is preceded by Monitor code executing a Data Memory/Synchronization/Write Barrier (DMB_DSB/DWB) just before a Monitor Mode call or exit (SMI, FIQ, IRQ, EA when trapped into Monitor Mode). Compare with TABLE 42.

External Aborts EA include an Abort generated by the interconnect 3521 and/or 3534 of FIG. 18 mainly by firewall (FW) security violation, or address not mapped or access timeout from interconnect. External Aborts are precise or imprecise, meaning that MPU 2610 knows which transaction address failed (precise) or not (imprecise). Posted write is imprecise, instruction fetch is precise, and MMU faults are internal aborts in an example.

TABLE 21
MONITOR MODE DATA FIREWALL 4150
HARDWARE DESIGN CODE EXAMPLE

```
OUT_OF_STACK_R <= ‘0’;
OUT_OF MMU_SECURE_R <= ‘0’;
OUT_OF_PERIPH_R <= ‘0’;
OUT_OF_ROM_R <= ‘0’;
OUT_OF_STACK_W <= ‘0’;
OUT_OF MMU_SECURE_W <= ‘0’;
OUT_OF_PERIPH_W <= ‘0’;
IF (CPSR_MODE = MONITOR AND MONITOR_EN = ‘1’)
THEN
IF (ARVALIDW = ‘1’ & ACLKEN = ‘1’ & ARPROTW [ ] = Data)
THEN - DATA READ transfers
  IF (START_MONITOR_CODE [MSB] = ARADDRW [MSB]
    & START_MONITOR_CODE [LSB] ≦ ARADDRW [LSB]
      ≦END_MONITOR_CODE [LSB])
    THEN OUT_OF_ROM_R <= ‘0’;
    ELSE OUT_OF_ROM_R <= ‘1’;
    ENDIF;
    IF (START_MONITOR_STACK [MSB] = ARADDRW [MSB]
    & START_MONITOR_STACK [LSB] ≦ ARADDRW [LSB]
      ≦ END_MONITOR_STACK [LSB])
    THEN OUT_OF_STACK_R <= ‘0’;
    ELSE OUT_OF_STACK_R <= ‘1’;
    ENDIF;
    IF (ARPROTW [:] = User Mode or Public )
    THEN OUT_OF MMU_SECURE_R <= ‘1’;
    ELSE OUT_OF MMU_SECURE_R <= ‘0’;
    ENDIF;
ENDIF;
SECURITY_VIOLATION_DRBUS
  <= (OUT_OF_ROM_R & OUT_OF_STACK_R)
              OR OUT_OF_MMU_SECURE_R;
IF (SMI_CODE = ‘0’ & Security_Violation_DRBUS =’1’)
  -- Failing access corresponding to SMI service retrieve--
THEN SMI_CODE <= ARREADY;
      Violation_DRBUS_Neutralizer <= ‘0’;
ELSE Violation_DRBUS_Neutralizer <= Security_Violation_DRBUS;
  ENDIF;
ELSE SMI_CODE <= ‘0’;
ENDIF;
IF (AWVALIDW = ‘1’ AND ACLKEN = ‘1’
              AND AWPROTW[ ]=DATA WRITE transfers)
THEN
  IF (CPSR_MODE = MONITOR & MONITOR_DRW_EN = ‘1’)
  THEN
    IF (START_Monitor_STACK [MSB] = AWADDRW [MSB]
      & START_Monitor_STACK [LSB] ≦ AWADDRW [LSB]
        ≦ END_Monitor_STACK [LSB])
      THEN OUT_OF_STACK_W<= ‘0’;
      ELSE OUT_OF_STACK_W<= ‘1’;
      ENDIF;
      IF (AWPROTW [:] = User Mode or Public)
      THEN OUT_OF MMU_SECURE_W<= ‘1’;
      ELSE OUT_OF MMU_SECURE_W<= ‘0’;
      ENDIF;
    ENDIF;
ENDIF;
Security_Violation_DWBUS <= OUT_OF_STACK_W
                OR OUT_OF_MMU_SECURE_W;
Violation_WRBUS_Neutralizer <= Security_Violation_DWBUS);
```

In FIG. 26, an example of security zone static configuration enforcement block 2750 and related fields in a Firewall Controller register 4020 are shown. Some architectures have an associated security zone mechanism (e.g., TrustZone) that operates on its own axioms or principles. The hardware-protected hypervisor and firewalls described herein enhance and compatibly accommodate such security zone mechanisms where they exist.

To provide some hardware-supported hypervisor embodiments herein with an MPU 2610 having a security zone architecture, the features of the security zone architecture are analyzed. The skilled worker identifies a suitable security zone configuration as desirable for use with the hardware-supported hypervisor. Then the identified configuration is established on boot. For example, in the case of TrustZone, the identified configuration is one that provides the maximum security that the security zone mechanism establishes. For other security zone architectures, some intermediate level, or even a low level of security, may be identified for use, and then the SSM 2460 is provided with appropriate security zone circuits in block 2740 and the firewalls are configured to establish the security features for supporting hypervisor operation, all according to the teachings herein.

If MPU 2610 has a security zone mechanism, the security zone mechanism is configured at boot in a highly security-robust way that prevents Current Program Status Register CPSR transitions between some less-sensitive modes and some more-sensitive modes. Certain mode transitions (e.g. in CPSR register) that are permitted between modes by the security zone mechanism are further hardware-controlled, regulated or restricted by hardware in SSM 2460 and firewalls as described herein. A design strategy herein considers the modes of the processor and picks one of the secure privileged modes (e.g., MPU Monitor Mode) to be the vessel for control code added herein. The hardware of SSM 2460 and the firewalls regulate and restrict the permitted operations of MPU 2610 and the system so that the control code operates as a hypervisor which in turn has the categories of FIGS. 3-6 operating under its control. Note that various embodiments of enhancing circuitry are suitably introduced into the security zone mechanism, or provided outside the security zone mechanism, or arranged to straddle inside and outside the security zone mechanism. In this way, various embodiments are prepared using any of a wide variety of commercial or custom microprocessors or microprocessor cores in different kind of systems that industrial enterprises and the consuming public demand now and in the future.

In a MPU core example in FIG. 26, the SECMON bus carries bit codes to identify modes for User, FIQ, IRQ, Supervisor, Abort, Undefined, System, and Monitor.

In FIG. 26, the following provisions in some embodiments further enhance the security robustness and efficiency of a security zone core (e.g., TrustZone core) for some of the embodiments involving hypervisor-controlled dual HLOS/RTOS or multiple operating systems. Some enhancements for the security zone are already described in connection with CPSR Mode Checker and NS Bit Enforcement 2755 of FIG. 9 and FIGS. 10A/10B, FIG. 26, and Preemptive Masking Handler 2715 of FIG. 19, Security Violation Handler 2760 of FIGS. 28A/28B and other enhancements elsewhere herein.

FIG. 26 and TABLE 22 show Static Configuration Enforcement 4210 to restrict, disable, prevent, regulate and/or govern a security zone mechanism of MPU 2610 from changing or permitting change to its own static configuration and thereby enhance the security zone for purposes of at least some embodiments herein. A security zone (SZ) core allows disabling configuration instructions depending on the signal state of a hardware pin or lead CP15Disable. This capability allows Boot routine to define the Secure mode structure and options of the SZ mechanism. The Boot routine also configures CPSR/NS Enforcement 2755 and other parts of SSM 2460 and Control Module 2765 to variously activate some or all enforcement options to enhance security robustness according to the strategy for a given type of system product. The Secure modes are entered with the MMU enabled (after first boot). The CP15Disable hardware lead of the security zone is protectively controlled by the circuitry of Static Configuration Enforcement 4210.

The instructions to configure the SZ mechanism are executable by MPU 2610 when CP15Disable has a predetermined first state in secure (NS=0) Monitor or Privilege mode, but become Undefined in MPU 2610 when CP15SDisable is put in a second state that effectively prevents the SZ mechanism from being re-configured. If an Undefined error happens in Monitor Mode, a Security Violation is generated in this embodiment. One source of an Undefined error is from an attempted unauthorized re-configuration. The hardware also generates a Security Violation in response to an occurrence of External Prefetch Abort and Data Abort when both the MPU is in Monitor Mode and the translation table base TTB0 Control Register configuration is set to execute a page table walk and not set to generate a page fault.

The CP15Disable mechanism of MPU 2610 relates to configuring areas in MPU 2610 such as or related to: Secure Control Register CP15S, Secure Translation Table, Secure Domain Access Control, controls for Data or Instruction low-latency tightly-coupled memory (TCM) and various remap registers, vector base addresses (e.g., in FIG. 29) for Secure and Monitor modes, Secure fast context switch, and master valid registers for caches.

In Secure Boot, higher security HS and lower security GP integrated circuit devices boot from on-chip Secure ROM so that the boot image running on the platform is authenticated before it is executed. A valid boot image is checked for the proper size, format and signatures. For Test or Emulator device units used in development, an External Boot mode swaps or remaps addressing from the Secure ROM target to Flash memory target memory space. Firewalls of FIGS. 18 and 20-23 are configured. The Control Module 2765 and SSM Registers 2620 of FIG. 9 and other Figures are configured.

A security zone locking SZ_Locking register in SSM Registers 2620 has a field CP15Disable_REG for configuring CP15Disable. This SZ_Locking register is coupled to Peripheral Port 2625 in order for CP15Disable hardware pin to be reset so that Boot or re-boot can configure the system as soon as the MPU 2610 and SSM 2460 CP15Disable_REG are reset.

Boot software running in Secure Supervisor mode sets a configuration for L1/L2 caches in Secure world, and to enable Secure MMU 2520 of FIG. 7 upon completion of Boot. The Secure world is configured in low exception vector mode, MMU extended page table and protection mechanisms for MMU/Data cache/Instruction cache are selectively enabled via respective bits M,D,I of CP15S register, and the Secure world is configured in FIQ mode in FIG. 6. Then in FIG. 26, the Boot software puts a CP15Disable_Reg field of an SZ Locking Register into a state that activates and commands Static Configuration Enforcement 2755 to lock the SZ configuration.

In FIG. 26, the M, D, I Bits of the MPU 2610 security zone register CP15S, as observed by Static Configuration Enforcement 4210 on SECMON bus, are enforced by that Enforcement block 4210 as soon as the CP15Disable_REG is activated to lock the SZ configuration. This enforcement block 4210 is configurable respectively for MMU, Data cache (DC), and Instruction cache (IC) enforcement through corresponding fields in the SSM_Firewall_Controller register in the Control Module 2765. This enforcement applies in Monitor Mode or in Secure mode (NS=0). In FIG. 26, if any of the M,D,I bits are inactive on SECMON bus when Enforcement 4210 is configured by Firewall_Controller register to expect the respective M,D,I bit(s) to be active, then a respective Security Violation is issued to Security Violation Handler 2720.

Among other features, the CP15S register SZ configuration for the Secure world suitably has selections such as from one, some or all the following: Setting of CPSR exception bit when exception occurs, Enable of vectored interrupt (VIC) interface, Enable extended page table configuration, Fast interrupt configuration, Enable Instruction/Data TCMs, Load instruction to program counter PC to activate an alternative MPU instruction-set, Enables for MMU protection, Enables for Instruction cache(s) and Data cache(s) and establish their replacement policies, Establish exception vectors and their locations, Branch prediction disable/enable, ROM protection, Enable/establish Mixed-Endian configuration, Enable Write Buffer, Enable unaligned access and/or strict alignment fault checking. Various embodiments of Security Zone Static Configuration Enforcement 4210 are prepared to appropriately act to protect the integrity of the SZ configuration.

TABLE 22
SECURE ZONE STATIC CONFIGURATION ENFORCEMENT 4210
HARDWARE DESIGN CODE EXAMPLE

```
IF (CP15Disable_REG = {Lock SZ configuration}
          & (CPSR_Mode = Monitor OR CP15S_NS = ‘0’)
THEN
  IF CP15S_M = ‘0’ & MMU_Enforcement_EN = ‘1’
  THEN MMU_VIOLATION <= ‘1’;
  ELSE MMU_VIOLATION <= ‘0’;
  ENDIF;
  IF CP15S_D = ‘0’ & DC_Enforcement_EN = ‘1’
  THEN DC_VIOLATION <= ‘1’;
  ELSE DC_VIOLATION <= ‘0’;
  ENDIF;
  IF CP15S_I = ‘0’ & IC_Enforcement_EN = ‘1’
  THEN IC_VIOLATION <= ‘1’;
  ELSE IC_VIOLATION <= ‘0’;
  ENDIF;
ELSE MMU_VIOLATION <= ‘0’;
  DC_VIOLATION <= ‘0’;
  IC_VIOLATION <= ‘0’;
ENDIF;
CP15Disable <= CP15Disable_REG;
SECURITY_VIOLATION_SZONE_CONF
  <= MMU_VIOLATION OR DC_VIOLATION OR IC_VIOLATION;
```

In FIG. 27 and TABLE 23, a Platform Events and Configuration Handler 2775 in SSM 2460 hardware is provided for application processor architecture platform events and configuration handling.

In order to deliver product engineering coherency across different product platforms for ever more efficient business operations, the security zone core of MPU 2610 is desirably made compatible with lower security product units called General Purpose (GP) devices (see incorporated patent application TI-38206), and provided with a Strict Public Debug mode platform capability and also protected against unauthorized manipulations of a Test Mode and of External Boot from Flash memory. When one of these modes or lower-security levels is activated, the MPU 2610 is provided with appropriate controls.

In order to establish, configure or re-create these software-compatible functionalities across devices, consider an example wherein the security zone mechanism of MPU 2610 boots in Secure Supervisor mode, and wherein an SMI instruction cannot be disabled and thus Monitor Mode can always be called. A Boot routine is coded and executed in Secure Supervisor mode.

Monitor code of FIGS. 5 and 29 has code that monitors the subset of SSM Registers 2620 shown in FIG. 27. Control Module 2765 updates SSM registers 2620 with any power reset events and/or platform violations such as Security Violations. Platform Events and Configuration Handler 2775 updates SSM Registers 2620 if Strict Public debug is established or if the integrated circuit device is configured (e.g., e-fused) to be a GP (lower-security) device.

Platform Events and Configuration Handler 2775 activates Monitor Mode code, and the Monitor code determines that one of these lower-security modes is entered. This suitably occurs by Boot code configuring internal fields and/or detecting e-fuses in MPU 2610 and correspondingly configuring Platform Status Register in SSM Registers 2620. Monitor code polls the internal fields and the Platform Security Register fields of FIG. 27 in SSM registers 2620. Entering Monitor Mode does not modify the state of the NS Bit. SSM 2460 restricts, inhibits or prevents switching the NS bit in a manner that would compromise security when in Strict Public Debug Mode, and in GP devices, and when non-allowed External Boot and Test Modes are configured. In this way, more security robustness is achieved.

For the present purposes higher-security (HS) configured devices activate various bits in the SCR of Interrupt Handler 2720 of FIG. 19. An example of a GP device can set internal register bits (e.g., in CPSR and CP15S) so that IRQ and FIQ are both handled in the Public mode (PIRQ, PFIQ), External Prefetch/Data Abort are both handled and maskable in the Public mode, FIQ are maskable in Public mode, and NS bit cannot be re-asserted to a Secure state after first exit of the Secure Supervisor mode Boot routine.

In FIG. 27, platform error handling is provided for SSM security rules enforcement with an MPU core 2610 that provides security NS bit, such from a security zone circuit associated with the MPU 2610.

Platform hardware firewalls in FIG. 20 generate in-band and out-of-band errors when Security Violations are detected. The in-band errors are seen by the MPU 2610 as External Prefetch/Data Abort and out-band errors are captured by a Security Error Status register CONTROL_SEC_ERROR_STATUS (FIGS. 27 and 28A) in the Control Module 2765 and are converted to interrupts.

Suppose in some embodiments that in-band errors are not generated in case of a Security Violation by particular component in FIG. 18 such as System DMA, Display DMA, Camera DMA or when the platform hardware firewalls are working with posted write operations. Moreover, the platform or architecture of FIGS. 9 and 18 encompasses power domains. Power management operations might happen without notifying the MPU 2610 by in-band errors or out-band errors.

In FIG. 26, in order to enhance and maintain robustness of the Secure mode, the Control Module 2765 updates SSM Registers 2620 and thereby informs the Monitor code of any Security Violations and Power Events that have happened without triggering an in-band or out-band error. The Monitor code is able to detect with little additional Monitor code these Security Violations (Platform Violations) and Power Events rapidly through the SSM registers 2620 via interface MPU2BUS 2728 on the Peripheral Port 2625.

Another example of device-type handling with Security Zone core and SSM security rules enforcement is given next.

The SSM 2460 allows different debug and trace configurations depending on the device type set in an E-fuse farm CPU component. Compare FIG. 30 and TABLE 23. The default configuration (reset values) of the debug and trace capabilities are defined according to the device type GP/HS/Emulator. For Emulator and Secure (HS) devices, the Secure Supervisor Debug and Trace configurations are set through Secure mode operations. For Emulator devices, an ActLikeSecure signal from an emulation-selection circuit (e.g., ICE-PICK circuit) is given through an emulation interface such as a JTAG TAP (test access port). SSM 2460 responds to the ActLikeSecure signal to have the same behavior as a Secure device. This capability facilitates porting of Emulator device platforms to Secure devices.

Test Modes handling with Security Zone core and security rules enforcement in FIG. 27 includes several test modes. Test modes are exercised to ensure that the device is working as expected at the time of manufacture. Platform Events and Configuration Handler 2775 enforces a rule that the Secure mode is entered only in Functional (non-debug) or pseudo-functional modes that are non-invasive debug or non-invasive test. When Test modes other than Test_At_Speed are configured, they are presumed to be invasive and risky to security, so the Platform Events and Configuration Handler 2775 in FIGS. 27 and TABLE 23 sends the Public_Stuck signal active to the MPU2BUS interface 2665. The Public_Stuck signal ties the qualifier MreqSecure to non-secure state as seen by the firewalls regardless of any CPU 2610 core transaction. Switching from any Functional mode to Test mode, or from any Test mode to any Functional mode, triggers PRCM 2790 to generate a Cold Reset at top level (FIG. 9B). Compare TABLE 23, TABLE 28, and TABLE 31, and FIGS. 27, 28A/28B, and 30. When Cold Reset is generated due to Test_Mode or Functional Mode switch, the secure software clears any memories that are not affected by the Cold Reset when re-booting.

Platform Events and Configuration Handler 2775 in TABLE 23 monitors a Test_En signal which signifies status on the current mode of operation, and a Test_At_Speed_En signal which signifies status on at speed test status. This Test Mode restriction is relaxed for Test device (device with non-programmed or undebugged E-fuses) for comprehensive test in a secure factory environment. The Test device type facilitates comprehensive debugging of first prototypes on an emulator. The E-fuses are suitably programmed before leaving the factory.

External Boot handling with security zone mechanism in MPU 2610 and security rules enforcement is described next for Platform Events and Configuration Handler 2775 example in TABLE 23. In some embodiments, the External Boot mode is activated by a hardwire line Sys.Boot of the MPU 2610 and a signal CPU_Boot_Mode is coupled from MPU 2610 to Platform Events and Configuration Handler 2775. External Boot Mode allows swapping the on-chip ROM address space to off-chip Flash ROM memory space. This mode remaps a starting address for the ROM to the starting address of the external Flash memory, e.g., 1025 or 1435 in FIG. 2. For security reasons, booting from external memory is prevented for GP and HS devices and a signal Security_Violation_GP_SPD is supplied from Platform Events and Configuration Handler 2775 to Security Violation Handler 2760 of FIGS. 28A/28B. Devices that are configured as Emulator or Test devices do allow the External Boot Mode to aid software development.

In FIG. 27, MPU 2610 has security field or bit NS (e.g., CP15S_NS) and non-volatile bits/fields such as e-fuses for indicating a Device Type as general purpose (GP, lower security), higher security (HS), useful for specialized testing purposes (Test), or not-fully-functional (Bad). MPU 2610 also provides signals indicating whether it is in Boot mode (CPU_Boot_Mode), has a test feature enabled (Test_En) or test-at-speed enabled (Test_At_Speed_En), or particular debug mode(s) enabled (GenDBGEnable).

Platform Events and Configuration Handler 2775 in SSM 2460 responds to these bits/fields to establish various configuration signals in the system at boot and during run-time. For example, the Platform Status Register PSR in SSM Registers 2620 has bits/fields for signifying Power_Reset_Events, Platform_Violations, and general purpose device GP_Device and Strict_Public_Debug.

On a SMI exception (software monitor interrupt), see FIGS. 5 and 29, Monitor Mode code checks whether or not all these bits/fields signify inactive conditions. If all the bits/fields have their state inactive, then operations proceed to handle the SMI exception, and otherwise operations proceed in a manner responsive to the particular active state of one or more of these bits/fields that have been activated.

In FIG. 27, Power_Reset_Events is activated in the PSR register by an OR-circuit in Control Module 2765 if any of various bits in a security status register Control_Sec_Status indicates a PowerOnReset initiated, requested, or required by any security violation active or other condition active in some part of the system, or by any of various bits in a secure memory (SECMEM) status register Control_SECMEM_Status being active indicating, for instance, that the MPU L1 cache is unusable.

In FIG. 27, Power domain information in Control Module 2765 is used for security handling in Platform Status Register of registers 2620. In order to ensure that power manipulation does not create security holes, different status signals are established in order for the Monitor Mode and the Secure Kernel to know what happens in the Public mode and if the memories are affected or erased. A Control_SECMEM_Status register in the Control Module 2765 latches signals pertaining to each memory bank when it has been powered off or put in Low IDDQ or Retention Mode.

In FIG. 27, the Control_SEC_Status register in Control Module 2765 also latches bits to represent different platform resets that occur and pertain to different system blocks such as: WCDMA Domain reset, HSDPA Domain reset, DSP Domain reset, Display Domain reset, Camera Domain reset, Peripheral Domain reset, Emulation Domain reset, Core domain reset, MPU domain reset, SSM Violation Warm CPU reset, Secure Watchdog Timer Warm CPU reset, Global Warm CPU reset from any source hardware or software, and Platform Power on Reset or Power Reset to the Control Module 2765. A Power_Reset_Events signal is OR-generated if any of the foregoing events occur, and that signal is forwarded into the SSM Platform_Status register in registers 2620. Monitor Mode reads this signal from Platform_Status register as soon as the Monitor Mode is entered. If this signal is active, then the Secure Kernel is called to react accordingly to protect the system.

Some of the use cases that involve sophisticated use of the power mechanisms do not wake up the MPU 2610 when processing from retention to active states (e.g., MPU 2610 and Display subsystem 3510.4 for refresh). Depending on the chosen application scenarios, the values from the interconnect firewalls 3522.i registers are exported into the Control Module 2765 to allow a public path through a given interconnect firewall without need of MPU 2610 wake-up.

When the Core Power Domain logic itself, e.g., including Control Module 2765 and any memories in that domain, is powered on and off, the interconnect firewall configuration integrity may depend on the power state in the Core Power Domain. Interconnect firewall Permission register default configurations are properly chosen that at power-on or re-activation, the security of a given firewall is very high. On-chip Secure ROM code saves each firewall configuration in response to an imminent power domain power-down operation and restores each saved firewall configuration on a power-up operation.

In some embodiments, data retention modes are activated by the PRCM 2790 (power reset control manager) using either Secure or Public accesses or operations by MPU 2610 or by a data retention unit. Retention modes are part of a power saving strategy and are not necessarily a mechanism to do security. Accordingly, the hardware-supported Hypervisor running as Monitor code on MPU 2610 secures the usage and operations of the PRCM 2790. The Hypervisor software selectively activates the retention modes according to the processor load and status of the different HLOS and/or RTOS running on the virtual processors or categories or multiple CPU cores of alternative embodiments. The power architecture in various alternative system embodiments is arranged to identify and avoid or handle any feedback loops in operations and to build run-time analysis statistics.

In FIG. 27 and FIGS. 28A/28B, a Security Violation is generated when the Monitor Mode detects through Platform_Status register in the registers 2620 that a power event has occurred. A Security Violation is also generated when the Secure ROM code detects through the Control_SECMEM_Status register in the Control Module 2765 that the on-chip RAM went to an unexpected low-leakage mode and that a RAM saving operation was not performed before previous exit of Secure Mode.

Retention Flip-flops are introduced into the random number generator RNG in security block 1450 and/or 1140 of FIG. 2. The retention flip-flops retain the values of accumulated entropy plus state and control registers when the Peripheral Power Domain is off such that once re-awakened, the RNG can generate true random values without need of time-consuming entropy accumulation.

Security-related peripheral(s) are suitably provided, such as hardware acceleration for encryption/decryption/hash in security blocks 1450 or 1140 of FIG. 2 and 3540 in FIG. 18. A timer peripheral is also suitably included and security-protected. Suppose that such peripheral(s) are enabled and there is an ongoing Secure operation. The peripheral is arranged to respond with an Idle Acknowledge signal to an incoming Idle Request signal after completion of the ongoing Secure operation. Until the Idle_Acknowledge signal is in fact generated by the security-related peripheral, the security-related peripheral is not shut down by the Power, Resets, and Control Module (PRCM). Thus, power state transitions are prevented in the middle of operations in the security peripheral domain(s). The security peripherals are clocked independently of, and do not share interface clock with, non-secure modules. Accordingly, non-secure modules are rendered incapable of prematurely or undesirably shutting down a security-related peripheral.

In FIG. 27 in the Control Module 2765, the register Control_SECMEM_Status also records power-managed states of power domains and records reset manipulation. In an example embodiment, the hardware accurately detects power and reset events generated in Public mode. In this way, states which should be reconstituted later are saved. This save operation provides a countermeasure against applicable kinds of security attack as well. For example, an operation on a power domain or a reset operation may manipulate a particular memory to power-off or low IDDQ (current level) state wherein memory points are discharging and data may be lost, destroyed, or corrupted. In that case, the memory content would be unusable and is invalidated. Depending on embodiment, Security Violation Handler 2760 and/or the hypervisor running on MPU 2610 is arranged to at least temporarily activate a retention mode that makes the memory inaccessible to Public modes. Resets are locked out to ensure that vital Secure mode operations are not stopped and that the secure configuration is maintained and not lost.

In FIG. 27, the Platform_Violations bit/field in the PSR register of SSM registers 2620 is activated by an OR-circuit in Control Module 2765 if any of various bits in a security error status register Control_Sec_Err_Status indicates that a security violation (FIG. 28) or an on-chip ROM memory error is detected, or by any of various bits in a debug security error status register Control_Sec_Err_Status_Debug being active indicating that an on-chip ROM memory error or other security-related error is detected in a debug mode.

In FIG. 27, when a Strict Public Debug mode is active in MPU 2610, a bit/field Strict_Public_Debug is set active in the PSR register in SSM registers 2620. When the MPU 2610 Device Type e-fuse state signifies general purpose (GP), then a GP_Device bit/field is set in SSM registers 2620 by the hardware of TABLE 23.

The Platform Events and Configuration Handler 2775 delivers a security violation signal designated Security_Violation_GP_SPD if there is a NS bit violation or a Boot violation. NS_Bit_Violation signal is set active when an inconsistency arises between the MPU 2610 NS security bit signifying a secure state when a non-secure state is expected and indicated by an active NS_Lock signal in the hardware. NS_Lock is set active when the Platform Events and Configuration Handler 2775 circuit detects a GP device or a Strict Public debug (SPD_EN, non-secure debug) condition of signal GenDBGEnable. The corresponding GP_Device and/or Strict_Public_Debug bit/fields in the PSR register are also set. A second violation aspect of signal Security_Violation_GP_SPD is a Boot violation. If the MPU 2610 External Boot mode signal is active at run-time for either a GP or HS device, then a Boot violation is generated.

MPU2BUS interface 2665 has a circuit that responds to a signal Public_Stuck to force the qualifier MreqSecure to non-secure state and maintain that state regardless of any CPU 2610 core transaction. When Test modes others then Test_At_Speed are configured the Platform Events and Configuration Handler 2775 hardware supplies the Public_Stuck signal active to the MPU2BUS interface 2665. FIG. 27 and TABLE 23 show an application processor architecture platform events and configuration handler hardware example.

TABLE 23
APPLICATION PROCESSOR ARCHITECTURE PLATFORM
EVENTS AND CONFIGURATION HANDLER 2775 HARDWARE
DESIGN CODE EXAMPLE

```
IF DEVICE_TYPE = GP
THEN GP_DEVICE_INT <= ‘1’;
ELSE GP_DEVICE_INT <= ‘0’;
ENDIF;
IF CPU_BOOT_MODE = ‘1’ & (DEVICE_TYPE=GP OR
DEVICE_TYPE=HS)
THEN BOOT_INT <= ‘1’;
ELSE
  IF DEVICE_TYPE = BAD
  THEN BOOT_INT <= ‘1’
  ELSE BOOT_INT <= ‘0’
  ENDIF;
ENDIF:
IF DEVICE_TYPE = TEST
THEN TEST_INT <= ‘0’;
ELSE TEST_INT <= TEST_EN & NOT (TEST_AT_SPEED_EN);
ENDIF;
IF GenDBGEnable = {“001” OR “010”}
THEN SPD_EN_INT <= ‘1’;
ELSE SPD_EN_INT <= ’0’;
ENDIF;
IF (GP_DEVICE_INT = ‘1’ OR SPD_EN_INT = ‘1’)
THEN
  IF CP15S_NS = ‘1’
  THEN NS_LOCK <= ‘1’;
  ENDIF;
ELSE NS_LOCK <= ‘0’
ENDIF;
IF (NS_LOCK = ‘1’ & CP15S_NS = ‘0’)
THEN NS_BIT_VIOLATION <= ‘1’;
ELSE NS_BIT_VIOLATION <= ‘0’;
ENDIF;
GP_DEVICE <= GP_DEVICE_INT ;
SPD_EN <= SPD_EN_INT;
PUBLIC_STUCK <= TEST_INT;
SECURITY_VIOLATION_GP_SPD <= NS_BIT_VIOLATION OR
BOOT_INT;
```

TABLE 24 shows an example of hardware design code for a firewall 2742 for a variable length codec (VLCD) 2744, e.g., a Huffman codec for telecom. iVLCD Firewall 2742 restricts the access to the iVLCD 2744 depending on CPSR mode of operation {User; Privilege}, {Public; Secure}, system state of operation {Debug; Functional}, and MMU page-type {Data; Instruction}. The iVLCD Firewall 2742 of TABLE 24 can be compared with and supplemented by the firewall illustration and description of FIG. 20 and description elsewhere herein.

When an attempted but unpermitted access is detected by iVLCD firewall 2742, an iVLCD Security Violation is generated. This violation is then handled by the Security Violation Handler 2760 of FIGS. 28A/28B depending on the current debug mode configured, if any, and the security violation strategy. The iVLCD firewall 2742 is embedded hardware and allows restricting the iVLCD 2744 for data Read/Write accesses and bus protection lines HPROT attribute combinations as follows. A set of bits {Privilege, Security, Debug, Type} form a four-bit combination that for particular bit values represents one of sixteen bit positions in a register HPROT_Perm. When access is allowed for a particular combination, a bit ReqBIT is set in the corresponding one of the sixteen bit positions, analogous to the attribute attr field of Permissions register in FIG. 23.

The iVLCD firewall 2742 is configured through a SSM_IVLCD_Firewall register that includes HPROT_Perm. Other bits are VP1_Access where 0/1 means only Non-virtual or Virtual can access, WR_Perm 0/1 means Write not-allowed or allowed, and RD_Perm 0/1 means Write not-allowed or allowed, respectively. Register access rights are provided to the modes in Class 0: All; Class 1: Public Privilege; Secure User; Secure Privilege; Class 2: Secure User; Secure Privilege; Class 3: Secure Privilege.

TABLE 24
VARIABLE LENGTH CODEC FIREWALL HARDWARE DESIGN
CODE EXAMPLE

```
iVLCD_ADDR_SPACE = {defined address range}
IF (ARVALIDW = ‘1’ & ACLKEN = ‘1’
  & iVLCD_ADDR_SPACE [MSB] = ARADDRW [MSB]
THEN  --Look for a Read violation--
    IF (RD_PERM = ‘1’
      & HPROT_PERM (ARPROTW [0] & ARPROTW [1] &
      DBGACK & ‘0’) = ‘1’)
      & (VP1_ACCESS = VP1_ACTIVE)
    THEN RDBUS_VIOLATION<= ‘0’;
    ELSE RDBUS_VIOLATION<= ‘1’;
    ENDIF;
ELSE RDBUS_VIOLATION<= ‘0’;
ENDIF;
IF (AWVALIDW = ‘1’ & ACLKEN = ‘1’
  & iVLCD_ADDR_SPACE [MSB] = AWADDRW [MSB]
THEN  -Look for a Write violation--
    IF (WR_PERM = ‘1’
      & HPROT_PERM (AWPROTW [0] & AWPROTW [1] &
      DBGACK & ‘0’) = ‘1’)
      & (VP1_ACCESS = VP1_ACTIVE)
    THEN WRBUS_VIOLATION<= ‘0’;
    ELSE WRBUS_VIOLATION<= ‘1’;
    ENDIF;
ELSE WRBUS_VIOLATION<= ‘0’;
ENDIF;
VIOLATION_RDBUS_NEUTRALIZER
          <= (RDBUS_VIOLATION OR {other Neutzn});
VIOLATION_WRBUS_NEUTRALIZER
          <= (WRBUS_VIOLATION OR {other Neutzn});
SECURITY_VIOLATION_iVLCD_IBUS <= ‘0’;
SECURITY_VIOLATION_iVLCD_RWBUS
          <= RDBUS_VIOLATION OR WRBUS_VIOLATION;
SECURITY_VIOLATION_iVLCD
    <= IBUS_VIOLATION OR RDBUS_VIOLATION OR
    WRBUS_VIOLATION;
```

FIG. 28 and TABLE 28 show a Security Violation Handler example for Security Violations handling and attacks neutralization.

The following Security Violation fields have designations prefixed with SECURITY_VIOLATION and are generated by the different components of the SSM: _IBUS, _DRBUS, _DWBUS, _ITRACEBUS, _DTRACEBUS, _MONITOR_STACK, _SPM_STACK, _CPSR, _GP_SPD, _SZ_CONF, _DEBUG, _iVLCD, _IBUS_PHY_VP1, _RDBUS_PHY_VP1, _IBUS_VIR_VP1, _DBUS_VIR_VP1.

The SSM 2460, by its construction and configuration, monitors the different buses and system components in a specific way. Depending on the configuration and security blocks provided for the SSM component as taught herein, the Security Violation signaling strategy varies depending on whether the attack that initiates the security violation response creates damage or not and whether any particular damage scenario is recoverable or not. Damage scenarios might include trashing of a particular memory section, leakage of secure assets, fetching of non-allowed instructions, processor state hijacking, and other potential security compromises.

Some CPU cores can post Read and Write addresses before any accesses physically happen. Some embodiments of SSM respond to this posting capability, when present, to send back an External Prefetch Abort and/or Data Abort (In_Band) signal before any physical Data Read or Data Write takes place. The MPU2BUS interface, either directly or via Monitor code, responds to that In-Band signal to neutralize an attack by intercepting the actual Read or Write transaction. A damage scenario is prevented because memory is not corrupted or one or more attacker instructions are not executed.

In the Posted Read or Posted Write architecture, a security violation signaling strategy example is given as follows. If a particular type of Security Violation upon hypothetical occurrence would not damage memory contents nor corrupt the MPU processor state, then External Data/Prefetch Abort generation is a sufficient response. If a particular type of Security Violation upon hypothetical occurrence would cause damage to memory contents or corrupt the MPU processor state, but they are recoverable by activating an appropriate exception handler, then External Data/Prefetch Abort generation is sufficient. If a particular type of Security Violation upon hypothetical occurrence would cause unrecoverable damage to memory contents or corrupt the MPU processor state, then the security response should reset the MPU 2610, or reset or re-initialize the virtual processor responsible for the category of FIGS. 4 and 6 in which the Security Violation arises, or reset the core CPU of FIGS. 32-33 responsible for the Security Violation. A Security_Violation_CONF register of TABLE 26 is configured with the strategy appropriate for a given architectural embodiment.

An External Data Abort (EA bit) is maskable in some MPU cores. If External Data Abort is maskable, then an External Prefetch Abort is used instead to respond to a Security Violation and generate a pipeline flush to destroy the context of the application responsible for the Security Violation. Thus, some flexibility is suitably established through the SSM registers to configure whether to generate an External Prefetch Abort on next instruction when a Read/Write Data Security Violation is detected currently, see Aborts of FIG. 28B.

FIGS. 28A and 28B and TABLE 27 show security violations in functional modes. The different SSM Security Violations are grouped by severity level with appropriate security neutralization strike-back responses of TABLES 25-26. In a Group 1 of Instruction Read Channel Violations, the response supplied by Security Violation Handler 2760 includes External Prefetch Abort and Reset of the MPU 2610.

Security Violation Handler 2760 responds to either FIG. 25 signal Security_Violation_IBUS or FIG. 11 signal Security_Violation_IBUS_PHY_VP1 and generates the response. These violation signals are generated when the MPU 2610 tries to execute in non-allowed memory when in Monitor Mode or Secure mode. These security violations are recoverable by generating the External Prefetch Abort and performing a pipeline flush before the instruction is executed. Because of the added security thus provided, read channel violations are neutralized, and unwanted instructions are not executed.

In a Group 2 of Data Read Channel Violations of TABLE 28, the response supplied by Security Violation Handler 2760 includes External Data Abort, External Prefetch Abort and Reset of the MPU 2610. Security Violation Handler 2760 responds to either FIG. 25 signal Security_Violation_DRBUS or FIG. 11 signal Security_Violation_RDBUS_PHY_VP1 and generates the response. These security violations are generated when the MPU 2610 tries to perform a Read Data transfer in non-allowed memory when in Monitor Mode, Secure mode or Secure Privilege mode. In TABLE 26, IRDBUS_Violation_Strategy provides a response code for Group 2 Security Violations. WRBUS_Violation_Strategy provides response code for handling Group 3 Security Violations. Group 2 and and Group 3 Security Violations are respectively recoverable by generating an External Data Abort and handling the abort before the Read Data is read or Write Data is written. Because of the added security thus provided, read and write channel violations are neutralized, and unwanted data reads and writes are not completed.

An External Prefetch Abort request is also sent back to the MPU 2610 in response to a Next_Instr_Abort signal to MPU2BUS interface 2665 in order to destroy the context of the application by pipeline flush on occurrence of a Group 2 Security Violation or a Group 3 Security Violation. External Prefetch Abort is coupled with exception handler circuitry to terminate the application process that caused the Security Violation.

In a Group 3 of Data Write Channel Violations, the response supplied by Security Violation Handler 2760 includes External Data Abort, External Prefetch Abort and Reset of the MPU 2610. Security Violation Handler 2760 responds to either FIG. 25 signal Security_Violation_DWBUS or FIG. 24 signal Security_Violation_MONITOR_STACK and generates the response according to the response code for WRBUS_Violation_Strategy in TABLE 26. These violations are generated when the MPU 2610 performs a Write Data transfer in non-allowed memory when in Monitor Mode, Secure mode or Secure Privilege mode.

In a Group 4 of Data Write Channel Violations of TABLE 28, the response supplied by Security Violation Handler 2760 accords with the particular response code configured into DFW_Violation_Strategy of TABLE 26. For example, the response suitably includes External Data Abort, External Prefetch Abort and Reset of the MPU 2610. Security Violation Handler 2760 responds to FIG. 24 signal Security_Violation_SPM_STACK and generates the response. This type of security violation is generated if the MPU 2610 performs a Write Data transfer in non-allowed memory when in Secure Privilege mode consecutively to a buffer overflow attack. This type of security violation may not be recoverable if the Write physically completes. However, recovery is possible by using an appropriate exception handler to terminate the thread responsible for the security violation and repair or erase the damaged memory area.

To perform such a recovery, Security Violation Handler 2760 generates a signal Next_Instr_Abort to MPU2BUS interface 2665 which in turn sends back an External Prefetch Abort signal to MPU 2610. MPU 2610 responds by vectoring to an appropriate exception handler that triggers a pipeline flush and thereby destroys the context of the offending application in response to the security violation. The exception handler further executes instructions to repair the damaged SPM Stack area using a precautionary saved-copy of the stack contents. Notice that Security Violation Handler in this example is structured to apply separate, different or independent security response strategies to Group 3 and Group 4 Security Violations.

Regarding a Group 5 of Security Violations in TABLE 28, the Group 5 Security Violations are believed not recoverable (or at least more difficult to recover) because they attempt to hijack the processor state and the secure mode architecture. The response SECURITY_VIOLATION in FIG. 28B is supplied by Security Violation Handler 2760 to PRCM 2790. The response initiates Reset of the MPU 2610 or at least re-initialization of the virtual processor category which is responsible for any of these suffixed Security_Violation signals: _ITRACEBUS, _DTRACEBUS, _CPSR, _GP_SPD, _SZ_CONF, _DEBUG, _IBUS_VIR_VP1, _DBUS_VIR_VP1.

The SSM Registers 2620 include a Configuration register and an Error Log register to facilitate flexible handling of the different Security Violations of Groups 1-5 and to respond efficiently when any of them happen. These registers are accessible for Read and Clear operations by Secure Privilege modes. In Control Module 2765, in its separate power domain, a register Control_SEC_Error_Status is provided to protectively store a copy of security violations on Platform Status Register from Security Violation Handler 2760. Stored firewall-violation information examples are tabulated in TABLE 12. The information accumulates errors or security violation statistics and diagnostics from the system. A register Control_Sec_EMU in Control Module 2765 configures security enables for debug, emulation, and trace of FIGS. 27, 28A/28B, 30, and 31 and TABLES 30-34. The register partitioning is established in a suitable manner into specifically named register(s) of different embodiments.

In a Group 6 of iVLCD firewall violations of TABLE 28, the response supplied by Security Violation Handler 2760 accords with TABLE 26 iVLCD_Violation_Strategy and includes External Data Abort, External Prefetch Abort and Reset of the MPU 2610. Security Violation Handler 2760 of FIG. 28B and TABLE 25 responds to TABLE 24 signal Security_Violation_iVLCD and generates the response. This Security_Violation_iVLCD is generated when a non-allowed access to iVLCD is performed and is recoverable if an External Data Abort is generated before data has been read or written. Because of the added security, write channel violations are neutralized, and thus unwanted data writes are not completed and unwanted data is not written. Note that this Group 6 approach is applicable to various firewalls in the system.

In response to the Group 6 Security Violation, the Security Violation Handler 2760 generates a signal Next_Instr_Abort to MPU2BUS interface 2665 which in turn sends back an External Prefetch Abort signal to MPU 2610. MPU 2610 responds by vectoring to the appropriate exception handler that triggers a pipeline flush and thereby destroys the context of the offending application that caused the Group 6 Security Violation.

In FIG. 28, Read channel security violation neutralization by MPU2BUS interface 2665 is described next. The Neutralization circuitry sends back to the MPU 2610 an External Prefetch/Data Abort request signal in response to an input IBUS_Abort active or RDBUS_Abort active or WRBUS_Abort active from Security Violation Handler 2760. These Abort signals from Security Violation Handler 2760 are provided to MPU2BUS interface 2665 in the same MPU bus clock cycle when Security Violation Handler 2760 detects the security violation.

The MPU2BUS interface 2665 in some embodiments is itself also provided with circuitry that detects a non-allowed Address transaction request on the MPU bus. The MPU2BUS interface 2665 is constructed to embed an additional External Prefetch Abort/Data Abort In-Band qualifier in a response channel representing occurrence of a non-allowed transaction. The circuitry concurrently sends back to the MPU 2610 an External Prefetch/Data Abort request signal. MPU2BUS interface 2665 also asserts the In-Band error qualifier (sets it active) in response to and in conjunction with all attempted Data transfers associated with the aborted address transaction if they propagate into the system of FIG. 18.

In FIG. 28B and TABLE 25, Write channel security violation neutralization by MPU2BUS interface 2665 is described. The Security Violation Handler 2760 requests a Data Abort by sending an active signal WRBUS Abort to MPU2BUS 2665 in the same MPU bus clock cycle when SSM 2460 detects a non-allowed Address transaction request on the MPU bus. The MPU2BUS 2665 replaces the write state of signal MCMD (MCMD=WR state) of the non-allowed Write transaction by an Idle state of signal MCMD=IDLE. MPU2BUS 2665 concurrently sends back on the transaction response channel mentioned hereinabove the Data Abort In-Band qualifier to the MPU 2610. The MPU2BUS 2665 asserts the In-Band error qualifier and replaces MCMD=WR by MCMD=IDLE to all the Data transfers associated with the aborted Address transaction.

TABLE 25
MPU2BUS 2665 NEUTRALIZATION HARDWARE DESIGN CODE EXAMPLE

IF GenDbgEN = {110 or 111}
THEN HaltOnSecurityViolation_int <= NOT(HaltOnSecurityViolation);
ELSE HaltOnSecurityViolation_int <= ‘1’;
ENDIF;
-- Insert in the INSTRUCTION bus analyzer
FUNCTION_IBUS_NEUTRALIZATION (INSTRUCTION_VIOLATIONS)
{IBUS_ABORT <= INSTRUCTION_VIOLATIONS & HaltOnSecurityViolation_int;}
-- Insert in the DATA READ bus analyzer
FUNCTION_DRBUS_NEUTRALIZATION (DATA_READ_VIOLATIONS)
{RDBUS_ABORT <= DATA_READ_VIOLATIONS & HaltOnSecurityViolation_int;}
-- Insert in the DATA WRITE bus analyzer
FUNCTION_WRBUS_NEUTRALIZATION (DATA_WRITE_VIOLATIONS)
{WRBUS_ABORT<= DATA_WRITE_VIOLATIONS & HaltOnSecurityViolation_int;}
In one example, IBUS_ABORT, DRBUS_ABORT and WRBUS_ABORT are Active only in
and during each same clock cycle as the failing access is on the bus.

In FIG. 28 and TABLE 26, the security violation strategy configuration is defined by bit-fields in the SSM Security_Violation_CONF register of FIG. 9 and FIG. 28. Depending on the response code configured into the register of TABLE 26, the existence of any security violation in a particular Group in TABLE 28 triggers a specified response of TABLE 26 into the circuitry of FIG. 28B.

TABLE 26
FIELDS IN SSM SECURITY_VIOLATION_CONF REGISTER

| Field Name | Function, Strategy, or Response |
|---|---|
| Violation_Strategy_Lock | When field value is active, this register is locked |
| Debug_Mode_Masking | When field value is active, and when the Secure Debug is |
| | configured, Debug Request are replaced with normal violation |
| | strategy |
| Intercon_Attack_Neutralizer | When field value is active, the MPU2BUS interface 2665 |
| | duplicates External Data Abort into External Prefetch Abort in |
| | next transaction |
| iVLCD_Violation_Strategy | 2-bit field for response codes |
| | {RD/WR}BUS_Abort + Next_Instr_Abort + Reset |
| | {RD/WR}BUS_Abort + Next_Instr_Abort |
| | {RD/WR}BUS_Abort |
| | Next_Instr_Abort is generated for data transfer. |
| DFW_Violation_Strategy | 2-bit field for response codes |
| | Next_Instr_Abort + Reset |
| | Next_Instr_Abort |
| WRBUS_Violation_Strategy | 2-bit field for response codes |
| | WRBUS_Abort + Next_Instr_Abort + Reset |
| | WRBUS_Abort + Next_Instr_Abort |
| | WRBUS_Abort |
| IRDBUS_Violation_Strategy | 2-bit field for response codes |
| | {I/RD}BUS_Abort + Next_Instr_Abort + Reset |
| | {I/RD}_Abort + Next_Instr_Abort |
| | {I/RD }_Abort |
| | Next_Instr_Abort is generated for Data Read. |
| HaltOnSecurityViolation_EN | |

The added Intercon_Attack_Neutralizer security field is configurable in the Security_Violation_CONF register which activates a security mechanism in MPU2BUS interface 2665. This Intercon_Attack_Neutralizer security mechanism creates an External Prefetch Abort each time an External Data Abort is seen on the Read or Write channel. The External Prefetch Abort is generated by the interface MPU2BUS 2665 in the next instruction transaction that occurs on the instruction bus IBUS. In different embodiments, the strategy fields of TABLE 26 are merged, subdivided, augmented, or removed as suitable to provide desired security responses. In debug modes, The security violation reporting is replaced by Debug_Request generation to the In-circuit Emulator depending on the Debug_Mode and Invasive Debug configuration.

The security violation reporting is described in TABLE 13. SSM 2460 and Debug Section 2770, 2772 of FIGS. 9B and 30 and TABLES 28 and 31 checks the GenDbgEN, ICESecPrivDebugEn, and DBGEN, SPIDEN signals of TABLE 30 to modify the violation reporting of TABLE 13 and Security Violation to PRCM 2790 in TABLE 28 and FIG. 28B. The Debug Section checks that the Secure Privilege Debug mode has not been tampered with. The Debug Section 2770 monitors the DBGACK in order to acknowledge the Debug Request of FIG. 30 sent to the in-circuit emulator 2785. When HaltOnSecurityViolation is configured in the In-circuit Emulator 2785 and the Secure User or Secure Virtual & Privilege Debug is configured in GenDbgEn, then the in-band errors (External Prefetch/Data Aborts) are not generated by Security Violation Handler 2760 to MPU2BUS interface 2665, see TABLE 25.

In FIG. 28, the security violations handling architecture is flexible by flagging different Security Violations in the Control Module 2765 and the Platform_Status Register of FIGS. 27, 28A/28B and as listed in TABLE 27, and clearing them when no longer needed. The Security Violation Handler 2760 establishes logic values for numbered Groups based on various entries in the Platform_Status Register of FIG. 28 in registers 2620 of FIG. 9. Active states of Security_Violation_<suffix> signals provide useful security diagnostics and are described in TABLE 27, where the suffix name is tabulated by itself for brevity.

TABLE 27
PLATFORM STATUS REGISTER FIELDS

| | |
|---|---|
| _DBUS_VIR_VP1 | Non-allowed access occurred in virtual memory space |
| _IBUS_VIR_VP1 | Non-allowed access occurred in virtual memory space |
| _RDBUS_PHY_VP1 | Non-allowed access occurred in physical memory space |
| _IBUS_PHY_VP1 | Non-allowed access occurred in physical memory space |
| _iVLCD_DRWBUS | Non-allowed access occurred on iVLCD |
| _DEBUG | Secure Privilege Debug mode is unexpectedly configured |
| _SZ_CONF | Defective security zone configuration: |
| | Secure MMU should be active |
| | Secure Icache should be active (if configured) |
| | Secure Dcache should be active (if configured) |
| _GP_SPD | NS bit changed after Secure Boot |
| | while in Strict Public Debug mode or GP Device |
| _CPSR | Non-allowed CPSR mode switch or non-allowed change of NS bit |
| _DTRACEBUS | Trace (e.g. ETM) data bus firewall has been violated: |
| | Monitor Mode read/writes data in not-allowed virtual memory |
| | Monitor Mode data transfer are not valid/expected |
| _ITRACEBUS | Trace instruction bus firewall has been violated: |
| | Monitor Mode fetches in not-allowed virtual memory |
| | Monitor Mode instructions are not valid/expected |
| _SPM_STACK | Buffer Overflow attack in Privilege Mode Stacks |
| _MONITOR_STACK | Attempt to trash the Monitor Mode Stacks |
| _DWBUS | SSM firewall for Write Data bus has been violated: |
| | Monitor Mode writes data in not-allowed physical memory |
| | Monitor Mode MMU configuration is trashed |
| _RDBUS | SSM firewall for Read Data bus has been violated: |
| | Monitor Mode read data in not-allowed physical memory |
| | Monitor Mode MMU configuration is trashed |
| _IBUS | SSM firewall for Instruction bus has been violated: |
| | monitor mode fetches in not-allowed physical memory |
| | Monitor/Secure Mode MMU configuration is trashed |
| | Secure mode fetches in not allowed physical memory |
| | Secure mode fetches in Privilege Mode Stacks |

The Platform Status Register PSR also provides fields for the circuitry of FIG. 27 and TABLE 23:

Power_Reset_Events Power/reset state has changed.

Platform_Violations Security violation has occurred in the system

Strict_Public_Debug Device is in Strict Public Debug mode

GP_Device Device is a General Purpose device

Notice that the hardware of TABLE 28 for Security Violation Handler 2760 has a close relationship and includes FIG. 30 hardware 2772 relating to Debug and depending on a decision step determining whether GenDbgEnable=“111” or not. This Debug-related portion of Security Violation Handler 2760 is associated with the Debug configuration block 2770 of FIG. 9 and FIG. 30 and with the SSM Debug section hardware of TABLE 31 and TABLE 32. The symbolism_INT refers to an internal, interim, or temporary field, bit, signal or its line(s).

TABLE 28
SECURITY VIOLATION HANDLER 2760 HARDWARE DESIGN CODE EXAMPLE

```
GROUP1<= Security_Violation_IBUS OR Security_Violation_IBUS_PHY_VP1;
GROUP2<= Security_Violation_DRBUS OR Security_Violation_RDBUS_PHY_VP1;
GROUP3<= Security_Violation_DWBUS OR Security_Violation_MONITOR_STACK;
GROUP4<= Security_Violation_SPM_STACK;
GROUP5<= Security_Violation_GP_SPD OR Security_Violation_CPSR
        OR Security_Violation_SZ_CONF OR Security_Violation_ITRACEBUS
        OR Security_Violation_DTRACEBUS OR Security_Violation_DEBUG
    OR Security_Violation_IBUS_VIR_VP1 OR Security_Violation_DBUS_VIR_VP1;
GROUP6<= Security_Violation_iVLCD_DRWBUS;
Platform_Status_Register[:] --Load the Platform Status Register--
  <= Security_Violation_DBUS_VIR_VP1 , Security_Violation_IBUS_VIR_VP1
  , Security_Violation_RDBUS_PHY_VP1 , Security_Violation_IBUS_PHY_VP1
  , Security_Violation_IVLCD_DRWBUS , ‘0’ , Security_Violation_DEBUG
  , Security_Violation_SZ_CONF , Security_Violation_GP_SPD
  , Security_Violation_CPSR , Security_Violation_DTRACEBUS
  , Security_Violation_ITRACEBUS , Security_Violation_SPM_STACK
  , Security_Violation_MONITOR_STACK , Security_Violation_DWBUS
  , Security_Violation_DRBUS , Security_Violation_IBUS;
SECMODFWERR <= (GROUP1 OR GROUP2 OR GROUP3 OR GROUP4 OR GROUP5 OR
GROUP6); -- Stay high during enough clock cycles for Control Module resynchronization--
CASE IRDBUS_VIOLATION_STRATEGY [:] IS -GROUP2 is Data transfer--
  WHEN “00” => Security_Violation_G12_INT <= ‘0’;
                Next_Instr_Abort_G12_INT <= ‘0’;
  WHEN “01” => Security_Violation_G12_INT <= ‘0’;
                Next_Instr_Abort_G12_INT <= GROUP2;
  WHEN “10” => Security_Violation_G12_INT <= (GROUP1 OR GROUP2);
                Next_Instr_Abort_G12_INT <= GROUP2;
  WHEN “11” => Security_Violation_G12_INT <= (GROUP1 OR GROUP2);
                Next_Instr_Abort_G12_INT <= GROUP2;
END CASE;
CASE WRBUS_VIOLATION_STRATEGY [:] IS -Write transfer--
  WHEN “00” => Security_Violation_G3_INT <= ‘0’;
                Next_Instr_Abort_G3_INT <= ‘0’;
  WHEN “01” => Security_Violation_G3_INT <= ‘0’;
                Next_Instr_Abort_G3_INT <= GROUP3;
  WHEN “10” => Security_Violation_G3_INT <= GROUP3;
                Next_Instr_Abort_G3_INT <= GROUP3;
  WHEN “11” => Security_Violation_G3_INT <= GROUP3;
                Next_Instr_Abort_G3_INT <= GROUP3;
END CASE;
CASE DFW_VIOLATION_STRATEGY [:] IS
  WHEN “00” => Security_Violation_G4_INT <= ‘0’;
                Next_Instr_Abort_G4_INT <= GROUP4;
  WHEN “01” => Security_Violation_G4_INT <= GROUP4;
                Next_Instr_Abort_G4_INT <= GROUP4;
  WHEN “10” => Security_Violation_G4_INT <= GROUP4;
                Next_Instr_Abort_G4_INT <= GROUP4;
  WHEN “11” => Security_Violation_G4_INT <= GROUP4;
                Next_Instr_Abort_G4_INT <= GROUP4;
END CASE;
CASE iVLCD_VIOLATION_STRATEGY [:] IS
  WHEN “00” => Security_Violation_G6_INT <= ‘0’;
                Next_Instr_Abort_G6_INT <= ‘0’;
  WHEN “01” => Security_Violation_G6_INT <= GROUP6;
                Next_Instr_Abort_G6_INT <= GROUP6;
  WHEN “10” => Security_Violation_G6_INT <= GROUP6;
                Next_Instr_Abort_G6_INT <= GROUP6;
  WHEN “11” => Security_Violation_G6_INT <= GROUP6;
                Next_Instr_Abort_G6_INT <= GROUP6;
END CASE;
NEXT_INSTR_ABORT
      <= Next_Instr_Abort_G12_INT OR Next_Instr_Abort_G3_INT
        OR Next_Instr_Abort_G4_INT OR Next_Instr_Abort_G6_INT;
SECURITY_ATTACK_NEUTRALIZED
    <= (GROUP1 OR GROUP2 OR GROUP3 OR GROUP4 OR GROUP6);
INTERCON_ATTACK_NEUTRALIZER --Forwarding--
    <= Intercon_Attack_Neutralizer_reg & NOT (DBGACK);
IF GenDbgEnable = “111”
THEN  -- Secure User Debug--
    IF ICESecPrivDebugEn = ‘0’
    THEN Security_Violation _INT <= GROUP5 OR Security_Violation_G4_INT;
          Debug_Request_INT
                <= Security_Violation_G12_INT
                  OR Security_Violation_G3_INT
                  OR Security_Violation_G6_INT;
    ELSE Security_Violation _INT <= ‘0’; --Secure Privilege Debug--
          Debug_Request_INT
                <= Security_Violation_G12_INT
                  OR Security_Violation_G3_INT
                  OR Security_Violation_G4_INT
                  OR GROUP5
                  OR Security_Violation_G6_INT;
    ENDIF
ELSE Security_Violation _INT <= Security_Violation_G12_INT
                        OR Security_Violation_G3_INT
                        OR Security_Violation_G4_INT
                        OR GROUP5
                        OR Security_Violation_G6_INT;
      Debug_Request_INT <= ‘0’;
ENDIF;
IF DEBUG_MODE_MASKING = ‘1’
THEN SECURITY_VIOLATION <= Security_Violation _INT
                            OR Debug_Request_INT;
ELSE SECURITY_VIOLATION <= Security_Violation _INT
ENDIF;
IF DBGACK = ‘0’
THEN DEBUG_REQUEST <= Debug_Request_INT;
ELSE DEBUG_REQUEST <= ‘0’;
ENDIF;
```

FIG. 29 and TABLE 29 show a process flow embodiment for the Monitor Mode hypervisor 4410 with SWI handlers 4420 and 4430 and an example of vectors and their addresses in an associated memory infrastructure for the Monitor Mode hypervisor. FIG. 29 is divided into a left half for depicting a Public space 4440 and a right half for Secure space 4450. Other process and structure embodiments such as those of FIG. 5 and TABLE 29 and TABLE 42 and description elsewhere herein can be compared with and supplement FIG. 29 and each other.

In the Public space 4440, Public HLOS of FIGS. 4-6 calls a Public SWI (software interrupt) handler 4420 to request activation of another category such as modem in public virtual category 2430 or a protected application (under security kernel) in secure non-virtual category 2450 or other software in some other category. A Public SWI handler 4420 operates in Public Privilege mode and has an associated entry SWI vector 4425 offset from a base address Public_BA. Software Monitor Interrupt (SMI) in the Public SWI handler accesses a Monitor Mode vector 4455 to enter Monitor code. Compare to protection wall 2140 of FIG. 3. Monitor code can also transition to the Public SWI handler 4420 by using the entry SWI vector 4425.

In an MPU 2610 example in FIG. 26, the SECMON bus carries bit codes to identify modes for User, FIQ, IRQ, Supervisor, Abort, Undefined, System, and Monitor.

Each of the modes has an associated vector address including a base address and an offset address. Vector base address registers are provided as in FIG. 29, for example. A software monitor interrupt SMI instruction thereafter is used to make a transition from a given mode to the Monitor Mode under conditions as discussed for FIG. 19.

In FIG. 29, Monitor code, Monitor Stack, and Monitor Mode vectors reside in the Secure space. At respective offsets from a Monitor Mode base address Monitor_BA, several Monitor Mode vectors are provided for SMI vector, External Prefetch Abort vector, External Data Abort vector, IRQ mode vector, FIQ mode vector. Monitor code is further offset from the base address Monitor_BA. On-chip Secure RAM has still further offset addresses and space for the Monitor Stack.

In the Secure space 4450, Secure SWI (software interrupt) handler 4430 operates in Secure Privilege mode and has an associated entry SWI vector 4435 offset from a base address Secure_BA. Monitor code transitions to the Secure SWI handler 4430 by using the entry SWI vector 4435. Compare to protection wall 2150 of FIG. 3. To transition from the Secure SWI handler 4430, Software Monitor Interrupt (SMI) accesses Monitor Mode vector 4455 and enters Monitor code.

In TABLE 29, fast context (CTX) switch is provided in the Monitor code of FIG. 29 for uncomplicated and inexpensive implementation. With fast context switch, a context switching MMU is unnecessary, and a moderate sized address space (e.g., 32M) is used to support Modem, Camera, and Linux operating system. In another example embodiment, full MMU context switching is provided and a very large 4 GB address space is provided to support relatively sophisticated, large-scale sharing of resources.

TABLE 29
MONITOR CODE TRANSITIONS

```
IF PUBLIC SMI -4420 use entry vector 4455; call to enter Secure space:
  PUSH CTX --Context to Monitor Code Stack
  SCR [ ] = 0 - Reset NS bit to establish Secure mode
  SCR [ ] = 1 - Set IRQ trap in Monitor Mode
  ENABLE I, F, A bits -- Enable MPU CPSR IRQ mask, FIQ mask
  ...
  <Hypervisor Body Software Operations here>
  ...
  POP CTX --Context from Monitor Code Stack
  IMB (Flush prefetch buffer for Instruction Memory Barrier)
  Emulated SWI -- Enter Secure SWI using Secure SWI entry vector 4435
ENDIF
IF SECURE SMI --4430 use entry vector to Monitor code; call to enter
Public space:
  PUSH CTX --Context to Monitor Code Stack
  ENABLE I, F, A bits -- Enable MPU CPSR IRQ mask, FIQ mask
  ...
  <Hypervisor Body Software Operations here>
  ...
  SCR [ ] = 1 - Set NS bit to establish Public mode
  DISABLE I bit -- Disable IRQ mask
  SCR [ ] = 0 - Set IRQ trap in Public mode
  POP CTX --Context from Monitor Code Stack
  IMB (Flush prefetch buffer for Instruction Memory Barrier)
  Emulated SWI --Enter Public SWI using Public SWI entry vector 4425
ENDIF
```

Before exiting the Monitor Mode an IMB (Instruction memory barrier, flush prefetch buffer) is established by executing assembly code to enter and propagate the altered NS bit value in the pipeline of MPU 2610.

FIG. 30 shows an SSM Debug Section 2770, 2772 of FIG. 9 and structured in one example by debug hardware design code of TABLE 28, TABLE 31, and TABLE 32. The SSM Debug Section is coupled to the MPU 2610 via debug port 2780 and to an in-circuit emulation block 2785. The Core Power Domain includes the Control Module 2765 coupled to the SSM Debug Section. The Control Module 2765 has a secure control over a TAP (e.g., JTAG 1149.1 Test Access Port for serial scan) via a TAP enable field designated SystemMpuTapEn in a Control_SEC_TAP register.

In-circuit Emulator 2785 is coupled to the TAP controller which in turn controls and selects serial scan chains that are built into MPU 2610 in predetermined core areas. These serial scan chains, and other emulation and testability features, obtain bits from MPU 2610 that represent a selected portion of the processor state (also called the image) of MPU 2610. Some background information on this type of technology is provided in U.S. Pat. No. 5,329,471, “Emulation Devices, Systems And Methods Utilizing State Machines,” which patent is hereby incorporated herein by reference. The processor state is selectively coupled to an emulation and testability host computer provided for the purpose, such as PC 1070 of FIG. 1.

Emulation security and privilege modes are established by configurable entries in a register Control_SEC_EMU. These entries are tabulated in TABLE 30 and are identified by various suffixes to a prefix ForceDAP (Force Debug Access Port).

Different trace/debug modes are configurable by a combination of Control Module 2765 registers, SSM registers 2620 and MPU registers (e.g., CP15S_, DSCR) configuration fields or bits establishing the different debug modes. For example, an invasive debug mode is activated by setting DBGEN active. Invasive debug mode couples the SSM Debug Section 2770, 2772 with the in-circuit emulator 2785 and/or a Trace component 4820 of FIG. 31A. Invasive debug is used for debug of a halted system or running system, using watch points and break points. A Real Monitor Mode and a Halt Mode are software configurable when DBGEN is active.

In FIG. 30 and TABLE 31, a Non-Invasive Debug (NID) observational mode is established by setting a trace enable signal NIDEN active. The SSM Debug Section is coupled with the Trace block 4820. A trace export from MPU 2610 to the Trace block 4820 occurs when NIDEN is activated. Non-invasive debug mode permits data observation of a running system through trace, performance monitoring, and program counter (PC) sampling from MPU 2610.

In FIG. 30 and TABLE 31, in order to configure invasive debug mode, the DBGEN signal is set active. The configurable signal System MPU_TAP_En sets enable DBGEN_EN active to activate DBGEN from Emulator 2785. The type of debug mode is set in a MPU 2610 Debug Status and Control Register (DSCR) using debug mode bits. Hardware halting of MPU 2610 in debug mode operates when an external debug request (e.g. EDBGRQ) is received from Emulator 2785. MPU 2610 responds with the DBGACK debug acknowledge signal active, and MPU 2610 is halted. Software halting in debug mode forces DBGACK signal active using an applicable bit in of the DSCR that halts the MPU. DBGACK is coupled to both Emulator 2785 and to SSM Debug Section 2770. Breakpoints are suitably set and used to halt the MPU core on specific addresses, events or instructions.

Different debug mode properties of the MPU 2610 are suitably established by applicable bits of the DSCR coded for No Debug, Halt Debug and Real-time Debugging. When neither Halt mode or Real-time debugging mode are selected and enabled, all debug events are ignored, although a breakpoint instruction generates Prefetch Abort, which is equivalent to a security In-Band error.

In TABLE 32, various debug modes are provided and have names to correspond with various Boolean combinations of two or more of the MreqInfo qualifiers. Some of the Boolean combinations corresponding to debug modes involve the qualifier MreqSystem. The ForceDAP< > entries in register Control_SEC_EMU are used to establish and control the MreqInfo qualifiers for debug purposes.

Some of the debugging process and structure embodiments include lines for the following signals tabulated in TABLE 30, and the descriptions apply to the active state.

TABLE 30
DEBUG-RELATED SIGNALS

| | |
|---|---|
| DBGACK: | MPU asserts this signal active when MPU 2610 is halted |
| | in Halt mode. |
| DBGEN: | MPU 2610 can enter a debug mode |
| | (Halt or Real-Time Debugging mode) |
| SPIDEN: | MPU 2610 can debug in Secure Supervisor Mode |
| NIDEN: | MPU 2610 can supply a trace output to a |
| | Trace component 4820 |
| SPNIDEN: | MPU 2610 can supply a trace output in |
| | Secure Supervisor mode |
| SUNIDEN: | MPU 2610 can supply a trace output in |
| | Secure User mode |
| EDBGRQ: | External debug request input used to halt the MPU 2610 |
| | when in Halt mode |

Signals designated SUIDEN and SUNIDEN signals are controlled by software (MPU secure debug enable register).

A Strict Public Debug Mode is enforced by software during the Monitor Mode execution by not allowing NS bit to be toggled to the Secure state and preventing Secure Privilege modes from being entered. The Monitor Mode is coded to configure the fields SSM_DBGEN_Disable and SSM_NIDEN_Disable when switching in or out of the Virtual Public Mode. MPU-Trace-related Monitor code is suitably coded to perform the following steps when disabling or enabling DBGEN and NIDEN:
1) Store DSCR [:] value.
2) Perform a Data Memory/Synchronization/Write Barrier (DMB_DWB/DSB).
3) Write the required value in SSM_DBGEN_Disable and SSM_NIDEN_Disable.
4) Perform a Data Memory/Synchronization/Write Barrier (DMB_DWB/DSB).
5) Restore DSCR [:] until the DSCR [:] read value is equal to the write value as determined by polling.

To facilitate control by GenDbgEn[:] from DSCR over the states of DBGEN and NIDEN, a VP1_DEBUG_DIS status is included. This status indicates a Debug action to perform when switching to/from the Virtual Public Mode. When the VP1_DEBUG_DIS is active, then the Monitor code operates to activate SSM register 2620 fields SSM_DBGEN_Disable and SSM_NIDEN_Disable.

Halt mode debugging halts MPU 2610 to collect information and invasively allows changing processor and coprocessor state. Real-time debugging is established by suitable values in DSCR and is used to collect information in situations in which MPU 2610 is not halted. MPU 2610 is caused to take a Debug Exception instead of halting. A special piece of software, a monitor target, can then take control to examine or alter the processor state.

SSM Security Violation Handler 2760 suitably has hardware of TABLE 28 that is responsive to invasive debug modes that have been configured for higher security and/or higher privilege to disable debug access to MPU 2610. For example, In TABLE 28 among the higher-level debug modes, a Secure Privilege Debug mode activation operates the Emulator 2785 using a Debug Request signal (FIG. 30) and encompasses events in Groups 4 and 5, as well as Groups 1, 2, 3, 6. But the non-privilege Secure User Debug mode is regulated and restricted so that Debug Section 2772 issues the Debug Request signal in response to events in Group 1, 2, 3, or 6 to operate Emulator 2785. Occurrence of a Group 4 or 5 violation in Secure User Debug mode does not operate Emulator 2785 and instead triggers protective hardware by the signal SECURITY VIOLATION to PRCM 2790.

The Security Violation Handler 2760 in TABLE 28 thus uses the signals GenDbgEnable and ICESecPrivDebugEn to establish the Security Violation reporting of TABLE 13 and strategy for issuing the SECURITY VIOLATION signal to PRCM 2790 from TABLE 28 and FIG. 28B. Debug Section hardware 2770 of TABLE 31 checks that the Secure Privilege Debug Mode has not been tampered with and, if tampered, then issues a signal Security_Violation_DEBUG to Security Violation Handler 2760. The FIG. 30 Debug Section 2770 also receives DBGACK as shown in TABLE 28 from MPU 2610, which acknowledges the Debug Request sent to Emulator 2785. The sequence is that Debug Section 2772 sends a Debug Request to Emulator 2785. In-circuit Emulator 2785 sends external debug request EDBGRQ by to MPU 2610 to halt the MPU 2610 for Halt mode debug. MPU 2610 also activates acknowledge DBGACK, and then Debug Section 2772 of TABLE 28 turns off the Debug Request. The Trace input is masked when the MPU 2610 halts. As soon as the Debug Acknowledge signal DBGACK is issued by MPU 2610, the hardware of TABLE 32 tags the subsequent FIG. 18 Interconnect transactions with the MReqDebug qualifier and the MreqInfo qualifiers specified for debug use by register Control_SEC_EMU.

In real-time debug mode, (non-invasive) debugging, emulation commands are transmitted to the MPU 2610 using either debug software in the Monitor Mode code or using commands issued from a JTAG TAP controller that couples the Emulator 2785 to the MPU 2610. External debug request EDBGRQ is ignored in real-time debug. Debug Acknowledge signal DBGACK is not activated and the MreqDebug qualifier is disabled on the interconnect of FIG. 18.

In this way, SSM Debug Section 2770, 2772 of FIG. 30 is enabled, to the extent permitted by security and privilege configuration, to steer, guide, or activate Emulator 2785 precisely to or at the lines and commands in the software that are producing Security Violations in the various Groups. The Debug Section cooperating with Emulator 2785 in the system of FIGS. 18 and 30 facilitates and speeds software code development in the software development process, and enhances the accuracy and speed of security analysis of existing software and the accuracy and speed of field service debug and field testing of the system by authorized personnel either locally to the device or remotely from the device of FIG. 1.

TABLE 31 describes an embodiment of circuitry for the SSM Debug section 2770, 2772, which accompanies the circuitry 2772 of TABLE 28 of the Security Violation Handler 2760 of FIG. 9.

TABLE 31
SSM DEBUG SECTION 2770, 2772
HARDWARE DESIGN CODE EXAMPLE

NSBIT_IC <= CP15S_NS;
IF GenDbgEnable = {‘001’, ‘010’, ‘011’, ‘100’} -From Platform Handler 2775--
THEN VP1_DEBUG_DIS <= ‘1’
ELSE VP1_DEBUG_DIS <= ‘0’
ENDIF;
IF (SystemMpuTapEn = ‘1’ & GenDbgEnable != “000”)
-from Control Module 2765 & Platform Handler 2775--

| | |
|---|---|
| THEN DBGEN_EN | <= NOT (SSM_DBGEN_DISABLE); --Invasive Debug-- |
| NIDEN | <= NOT (SSM_NIDEN_DISABLE); --Non-Invasive, Trace-- |

```
ELSE DBGEN_EN<= ‘0’;
    NIDEN<= ‘0’;
ENDIF;
IF (ICESecPrivDebugEn = ’1’ OR TRACESecPrivDebugEn = ’1’)
THEN
    IF GenDbgEnable = “111” --‘111’ is expected--
    THEN SPIDEN <= ICESecPrivDebugEn;
        SPNIDEN<= TRACESecPrivDebugEn;
        Security_Violation_DEBUG <= ‘0’;
```

| | |
|---|---|
| ELSE SPIDEN <= ‘0’; | --Turn off Debug-- |
| SPNIDEN <= ‘0’; | --Turn off Trace-- |

```
        Security_Violation_DEBUG <= ‘1’; --Inconsistency, not ‘111’--
    ENDIF;
ELSE SPIDEN <= ‘0’;
    SPNIDEN <= ‘0’;
    Security_Violation_DEBUG <= ‘0’;
ENDIF;
```

Emulation components are grouped in an Emulation Power Domain in order to decrease the power consumption for production devices. A Debug Access Port DAP is provided as an initiator on the L3 Interconnect in some embodiments and has firewall-regulated access to various parts of the system of FIG. 18 using scan chain methodology. In order to have a coherent security framework, the DAP is regulated by appropriate configuration of the various firewalls such as L3 Interconnect firewalls 3522, L4 Interconnect firewalls 3532, and System Memory firewall 3552 to work efficiently according to the security policy established for the various parts of the system of FIG. 18. In this way, the qualifier MreqDebug is used by the firewall hardware as described in connection with FIG. 20 to contribute to regulating access to various parts of the system according to the security policy.

In TABLE 32, a Debug Security block sets MreqDebug high and fills three MreqInfo bits Mreq[ ]—MreqSecure, MreqPrivilege, MreqSystem, for example. Concurrently loaded plural fields or bits in the design pseudocode are separated by commas. Various inputs are prefixed by ForceDAP and suffixed with Debug mode options. These inputs are responsive to states of Debug configuration fields or bits in a protected register such as Control_SEC_EMU. This Debug Security block facilitates emulation of the processor and improves system development, testing, and field service both locally and remotely to the system by authorized personnel.

TABLE 32
DEBUG SECURITY DESIGN CODE EXAMPLE

```
CASE GenDbgEnable IS
  WHEN 000 => Mreq[ ] <= ‘000’;
  WHEN 001 => Mreq[ ] <= ‘000’;
  WHEN 010 => Mreq[ ] <= ‘0’ , NOT(ForceDAPPubUserDebugEn), ‘0’;
  WHEN 011 => Mreq[ ] <= ‘000’;
  WHEN 100 => Mreq[ ] <= ‘0’ , NOT(ForceDAPPubUserDebugEn), ‘0’;
  WHEN 101 => Mreq[ ] <= ‘0’ , NOT(ForceDAPPubUserDebugEn)
                            , NOT(ForceDAPPubSystemDebugEn);
  WHEN 110 =>
      IF ForceDAPSecPublicDebugEn = ‘1’
      THEN Mreq[ ] <= ‘0’, NOT(ForceDAPPubUserDebugEn)
                            , NOT(ForceDAPPubSystemDebugEn);
      ELSE Mreq[ ] <= ‘100’;
      ENDIF;
  WHEN 111 =>
      IF (ForceDAPSecPublicDebugEn = ‘1’)
      THEN Mreq[ ] <= ‘0’, NOT(ForceDAPPubUserDebugEn)
                          , NOT(ForceDAPPubSystemDebugEn);
      ELSE Mreq[ ] <= ‘1’, NOT(ForceDAPSecUserDebugEn)
                          , NOT(ForceDAPSecSystemDebugEn;
      ENDIF;
END CASE;
MreqSecure, MreqPrivilege, MreqSystem <= Mreq[ ];
MreqDebug =’1’
```

In FIG. 31A, a trace instruction bus 4810 at port 2635 couples the MPU 2610 to a Trace component 4820. In FIG. 31B, a Trace bus firewall 4830 with hardware as in TABLE 33 is coupled to the trace instruction bus 4810 to hardware-protect the Monitor Mode from security compromise. This firewall 4830 is coupled to receive and check trace information from MPU 2610 via the trace instruction bus 4810 (e.g., in an external trace monitoring bus or ETM bus).

In FIG. 31B, Control Module registers are coupled to this hardware 4830, which re-creates or specifies Monitor code virtual address ranges or spaces for instruction fetch and data transfer relating to Monitor Stack(s), Monitor code ROM location and via Peripheral Port 2625 as addressable spaces) and checks that the instructions fetched from L1/L2 Caches and ROM locations correspond to what is expected.

A Trace data bus 4850 in FIG. 31A conveys the results of actual execution in MPU 2610, such as from a writeback execution stage of the processor pipeline. A Trace Bus Firewall 4860 is coupled to more Control Module 2765 registers that specify an address range for Monitor code in Monitor code ROM, an address range for Monitor stack, and an address range for Monitor to use to address SSM Registers 2620 and Interrupt Handler Registers 2725 via Peripheral port 2625. Trace Bus Firewall 4860 has hardware as in TABLE 34 to ensure that any Data fetched from L1/L2 Caches and ROM locations corresponds to what is expected, and that the Data transfer activity happens only in the expected spaces or locations.

Virtual addresses output by a Trace instruction address bus in bus 4810 are checked by firewall 4830 of FIG. 31B when the MPU 2610 is executing in Monitor Mode (CPSR_Mode=Monitor).

Monitor Mode is differentiated in this example for purposes of L1/L2 caches and MMU from the User mode and from Privilege modes other than Monitor Mode. The virtual mapping of the Start/End addresses of Monitor Stack(s) and Monitor code ROM space are set in the MMU using a TTB0 register and the entries are locked down in MMU TLB (translation lookaside buffer) by setting a CP15Disable field or bit. This lock-down prevents any page table walk that might compromise system security.

Dedicated registers in the Control Module 2765 duplicate or mirror the TTB0/TLB programming in order to re-create the Monitor code virtual address range mapping when Monitor code is executed from the ROM location and L1/L2 Caches. Trace signals are output by the MPU 2610 when a signal Trace (ETM) power up PWRUP is active.

Trace Instruction Address bus addresses on bus 4810 are compared with stored Start and End addresses defining the ROM virtual address range occupied by the Monitor code. The Trace Instruction Address bus outputs the virtual addresses that have been executed or generated by MPU 2610 at writeback execute stage in the MPU pipeline. The Trace Instruction Address bus 4810 is qualified in FIGS. 31A/31B by Trace instruction address control IACTL information available on the SECMON Bus. The SECMON Bus also outputs the CPSR modes from the writeback execute stage in the pipeline. All the information is taken from the writeback execute stage itself, thereby checking and promoting the coherency of the information and the reliability of the information used for the checking. A set of lines in the Trace Instruction Address bus description are qualified by an instruction address-valid signal and deliver the address for the MPU-executed instruction for MMU Paging monitoring of each address region with appropriate granularity to make the comparison.

Also some Monitor code attacks could involve aborting or corrupting some instruction at different stages in the MPU 2610 pipeline. Certain Trace bus control signals for Trace instruction address control IACTL, Trace data address control TRACEDACTL and Trace data data control DDCTL are used to ascertain and control that the instruction execution and data transfer are valid. In this way, the instructions fetched from L1/L2 Caches and ROM locations are properly executed.

In FIG. 31B and TABLE 33, execution status and error flags of the executed instruction are checked by firewall 4830 by checking the Trace IACTL signal corresponding to each address output on the Trace Instruction Address bus 4810. The checks make sure, first, that the Monitor code instructions executed are in fact a predetermined instruction width (e.g., 32-bit) used for the Monitor Mode, by checking that TRACEIACTL bus lines for other instruction widths (e.g., 16-bit half-word aligned and variable-length byte-aligned) are inactive for each instruction executed in Monitor Mode. The particulars that characterize Monitor code for checking purposes vary from embodiment to embodiment. The firewalls 4810 and 4860 are established in each embodiment to accommodate and check such particulars of Monitor code.

In FIG. 31B and TABLE 33, the Data associated with the Monitor code instructions are also validity-checked in firewall 4830 so that when a respective Trace IACTL line indicates presence of data, another line is inactive for data from a coprocessor, in some embodiments, or other data not associated with Monitor Mode. Further, the exceptions occurring in Monitor Mode are validity-checked in firewall 4830 to determine that they are expected exceptions. Respective Trace IACTL lines are monitored so that when one line indicates presence of an Exception, then further lines are checked to make sure that they are not Java nor a so-called precise data/instruction abort nor a so-called Undefined exception. Precise data aborts are not expected when TTB0 is configured not to generate page fault.

TABLE 33
TRACE INSTRUCTION BUS FIREWALL 4830 DESIGN CODE EXAMPLE

```
IF SECMONBUS [ ] = Monitor & Monitor_ITRACE_EN OR Monitor_DTRACE_EN)
THEN TracePWRUP <= ‘1’;
ELSE TracePWRUP <= ‘0’;
ENDIF;
IF SECMONBUS[ ] = ‘1’& (SECMONBUS [ ] = Monitor & Monitor_ITRACE_EN = ‘1’) THEN
    IF (TraceIACTL [ ] = ‘00’ )
    THEN CPU_Instruction_Set_NOT_USED <= ‘0’;
    ELSE CPU_Instruction_Set_NOT_USED <= ‘1’;
    ENDIF;
    IF (SECMON [23] = ‘1’)
    THEN
        IF TRACEIACTL [10] = ‘0’
        THEN Data_Instruction_NOT_VALID <= ‘0’;
        ELSE Data_Instruction _NOT_VALID <= ‘1’;
        ENDIF;
    ELSE DATA_INSTRUCTION _NOT_VALID <= ‘0’;
    ENDIF
    IF ( TRACEIA [ ] is within Start/End Addresses of Monitor Code trace function)
    THEN OUT_OF_IMONITOR<=‘0’;
    ELSE OUT_OF_IMONITOR <=‘1’;
    ENDIF;
ELSE
    OUT_OF_IMONITOR <= ‘0’;
    EXCEPTION_NOT_VALID<= ‘0’;
    Cpu_Instruction_Set_NOT_USED <= ‘0’;
    Data_Instruction_NOT_VALID <= ‘0’;
ENDIF;
IF(SECMON [24] = ‘1’& SECMONBUS [8:5]=Monitor & Monitor_ITRACE_EN = ‘1’)
THEN
    IF (TRACEIACTL[14:12] = ‘100’ OR ‘000’)
    THEN EXCEPTION_NOT_VALID <= ‘1’;
    ELSE EXCEPTION_NOT_VALID <= ‘0’;
    ENDIF;
ELSE EXCEPTION_NOT_VALID <= ‘0’;
ENDIF
SECURITY_VIOLATION_ITRACEBUS <= OUT_OF_IMONITOR
                                    OR EXCEPTION_NOT_VALID
                                    OR CPU_Instruction_Set_NOT_USED
                                    OR Data_Instruction_NOT_VALID;
```

Further in FIG. 31A, a Trace Data bus 4850 has firewall 4860 to hardware-protect the Monitor Mode from security compromise. TABLE 34 shows an example of this firewall 4860 hardware in the SSM 2460 to monitor Trace Data bus 4850.

Data transfers occur only from predetermined areas in the system, e.g., on-chip ROM space, a Monitor Stack space reserved for Monitor code in on-chip Secure RAM (Read/Write), or via the FIG. 9 Peripheral Port 2625 in SSM Registers 2620 and in Registers 2725 for Interrupt Handler 2720. In FIG. 31A and TABLE 34, these Data transfers are monitored for proper execution. Virtual addresses output by a Trace data address bus DA are checked when the MPU 2610 is executing in Monitor Mode. The virtual addresses compared with the Trace DA bus are Start and End addresses of the ROM virtual address space, Stack virtual address space, and Peripheral Port virtual address space, all for the Monitor code.

The virtual mapping of the Monitor Mode stacks and Monitor code ROM space are set in the MMU (memory management unit) using the TTB0 register and entries locked-down in TLB (translation lookaside buffer). Dedicated registers in the Control Module 2765 are used by the SSM 2460 in order to duplicate exactly the TTB0/TLB programming to 1) re-create the Monitor code virtual address mapping when the Monitor code is executed from the ROM location and L1/L2 caches, 2) re-create the Monitor Stack virtual address mapping when data transfer took place, and 3) re-create the Monitor code data accesses (R/W) to the Peripheral Port 2625 including SSM registers 2620 and Interrupt Handler registers 2725.

The Trace DA bus in bus 4850 outputs the virtual addresses of the Data that has been manipulated by the MPU 2610 at an Add execute pipeline stage and those virtual addresses are checked. The TRACEDA bus is qualified by two Trace DACTL lines available in FIG. 31A on SECMON Bus at Add stage in the pipeline so that the checking occurs when a line indicates that a data item is present and another line indicates that the data is not a coprocessor access. The SECMON bus has lines to output the CPSR modes from the writeback execute stage in the pipeline and firewall 4860 captures the CPSR_Mode information signifying that Monitor Mode is entered.

In FIG. 31A and TABLE 34, a Trace DDCTL bus is checked for the Data transfer execution and associated errors corresponding to each address output on the Trace DA bus. Validity of data transfer in Monitor Mode is determined by checking respective SECMON bus lines corresponding to Trace DDCTL to make sure they indicate that when a data item is present, then other bus lines indicate that no data write failed and no imprecise data abort occurred.

Note that in various embodiments, the skilled worker identifies any accesses or characteristics that are not associated with the Monitor code or hypervisor mode and then uses hardware monitoring for such accesses or characteristics to signal a Security Violation, e.g., Security_Violation_DETMBUS (data) and Security_Violation_IETMBUS (instruction). The particulars of some examples are described herein, and the various embodiments contemplate monitoring other particulars which may or may not include the ones mentioned.

TABLE 34
TRACE DATA BUS FIREWALL 4860 DESIGN CODE EXAMPLE

```
IF (SECMONBUS [8:5] = Monitor & Monitor_DTrace_EN = ‘1’)
THEN
    IF SECMONBUS [4:3] = ‘00’
    THEN DATA_SLOT_ABORT<= ‘0’;
    ELSE
        IF TraceDDCTL [3:2] = ‘00’
        THEN DATA_SLOT_ABORT<= ‘0’;
        ELSE DATA_SLOT_ABORT <= ‘1’;
        ENDIF;
    ENDIF;
    IF(SECMONBUS [2:1]=‘00’OR (SECMONBUS [2:1] != ‘00’
      & TraceDACTL[15]=‘1’))
    THEN OUT_OF_ROM <= ‘0’;
          OUT_OF_STACK <= ‘0’;
          OUT_OF_{—} PERIPH <= ‘0’;
    ELSE OUT_OF_ROM <= ‘1’;
          OUT_OF_STACK <= ‘1’;
          OUT_OF_{—} PERIPH <=‘1’;
    ENDIF;
    IF (TRACEDA [ ] is in the Start/End Monitor Code space for trace)
    THEN OUT_OF_ROM <= ‘0’;
    ENDIF;
    IF (TRACEDA [ ] is in the Start/End Monitor Stack space for
    trace)
    THEN OUT_OF_STACK <= ‘0’;
    ENDIF;
    IF (TRACEDA [ ] is in the Start/End Monitor Peripheral space
    for trace)
    THEN OUT_OF_PERIPH <=‘0’;
    ENDIF;
    Security_Violation_DTRACEBUS_int
            <= (OUT_OF_ROM OR OUT_OF_STACK
            OR OUT_OF_PERIPH);
    IF (SMI_CODE_TRACE = ‘0’ &
    Security_Violation_DTRACEBUS_int = ’1’)
    THEN SMI_CODE_TRACE <= ‘1’;
        -- Failing access corresponding to SMI service retrieve
    Security_Violation_DTRACEBUS_int<= ‘0’;
    ENDIF;
ELSE
    OUT_OF_ROM <= ‘0’;
    OUT_OF_STACK <= ‘0’;
    OUT_OF_{—} PERIPH <= ‘0’;
    DATA_SLOT_ABORT <= ‘0’;
    Security_Violation_DTRACEBUS_int<= ‘0’;
    SMI_CODE_TRACE <= ‘0’;
ENDIF;
SECURITY_VIOLATION_DTRACEBUS
          <= DATA_SLOT_ABORT OR
          Security_Violation_DTRACEBUS_int;
```

Secure Demand Paging SDP 2745 of FIG. 9 corresponds to SDP 1040 of FIGS. 1 and 2 and has a pool of pages in a Secure RAM 1034 that are physically loaded with data and instructions taken from a storage memory that is suitably encrypted (or not) external to the secure mode. See incorporated patent applications TI-38213 and TI-39617 for further background. SDP 2745 creates virtual memory in secure mode and thus confers the advantages of execution of Protected Application (PA) software that far exceeds (e.g., up to 4 Megabytes or more in one example) the storage space in on-chip Secure RAM. The pool of pages in Secure RAM 1034 is updated by the SDP according to Memory Management Unit (MMU) page faults resulting from execution of secure software currently running on the system.

In operation, the PA (Protected Application) and an MMU Mapping Table for Virtual mapping to Physical mapping are maintained secure on-chip. A Physical-Address-to-Virtual-Address table PA2VA provided for SDP 2745 with page table entries (PTE) pertaining specifically to pages stored in Secure RAM. One of the bits in a PTE is a Valid/Invalid bit, also called an Active bit ACT[N] for Page N herein. This page activity register ACT allows disabling of usage level monitoring for any page of the page pool.

An invalid state in ACT[N] or in the MMU Mapping Table for a given page causes an MMU page fault or interrupt when a virtual address in secure VAS (virtual address space), for a particular one of several contexts VMC of SDP within a category of FIGS. 4 and 6, is accessed corresponding to a physical address in that page which is absent from Secure RAM.

SDP hardware provides secure page swapping, and the virtual address mapping process is securely provided under Secure Mode. Secure RAM pages are positioned at the virtual address positions where they are needed, dynamically and transparently in the background to PAs.Code and Data for SDP Manager software are situated in Secure RAM in a fixed PPA (primary protected application) memory address space from which swapping is not performed.

SDP software coherency with the hardware is maintained by the MMU so that part of the software application is virtually mapped in a Secure OS (Operating System) virtual machine context VMC according to Virtual Mapping. If a context switch is performed, then the VMC entries in PA2VA are changed to a new VMC identification number.

When loading a new page into Page Slot N in Secure RAM, the previous Virtual to Physical mapping is no longer coherent. The new page corresponds to another part of the source application. The Virtual Mapping regarding the Swapped Out previous page N is obsolete regarding Page N. Entries in the MMU internal buffers representing the previous Virtual to Physical Mapping correspondence are now invalidated. An access to that Swapped Out page generates a Page Fault signal.

Also, entries in an instruction cache hierarchy at all levels (e.g. L1 and L2) and in a data cache hierarchy at all levels are invalidated to the extent they pertain to the previous Virtual to Physical Mapping correspondence. Accordingly, a Swapped Out code page is handled for coherency purposes by an instruction cache range invalidation relative to the address range of the Code page. A Data page is analogously handled by a data cache range invalidation operation relative to the address range of the Data page. Additionally, for loading Code pages, a BTAC (Branch Target Address Cache or Branch Target Buffer BTB) flush is executed at least in respect of the address tags in the page range of a wiped Code page, in order to avoid taking a predicted branch to an invalidated address.

When wiping out a page from Secure RAM, some embodiments have Code pages that are always read-only. Various of these embodiments distinguish between Data (Read/Write) pages and Code (Read Only) pages. If the page to wipe out is a Data page, then to maintain coherency, two precautions are executed. First, the Data cache range is made clean (dirty bit reset) in the range of addresses of the Data Page. Second, the Write Buffer is drained so that any data retained in the data caches (L1/L2) are written and posted writes are completed.

The SDP paging process desirably executes as fast as possible when wiping pages. Intelligent page choice mechanism built into the SDP 2745 hardware reduces or minimizes the frequency of unnecessary page wipes or Swaps since an intelligent page choice procedure as disclosed herein leaves pages in Secure RAM that are likely to be soon used again. Put another way, if a page were wiped from Secure RAM that software is soon going to use again, then SDP would consume valuable time and power to import the same page again, especially with cryptographic protection procedures.

An additional consideration in the SDP paging process is that the time consumption for wiping pages varies with Type of page as Code Page or Data Page. For example, suppose a Code Page is not required to be written back to the external memory because the Code Page is read-only and thus has not been modified. Also, a Data Page that has not been modified does not need to be written back to the external memory. By contrast, a Data Page that has been modified is encrypted and hashed and written back to the external memory 3550 of FIG. 18. Since Code Pages take less time to wipe in systems wherein Code Pages are read-only and unmodified by definition, the Code Pages are assigned somewhat higher priority to wipe in such systems than pages of similar Usage Level that are modified, for example.

In SDP 2745, statistics on frequency of use of each page N are kept as 2-bit values designated in a register STAT. Register STAT identifies which pages are used more frequently than others so that paging is less likely to wipe out a more frequently used page. SDP access counting operations help avoid prematurely swapping out a newly swapped-in page. Swap is executed when a page fault occurs, which means an attempted access is made to a missing page. SDP software uses Page Wiping Advisor in the SDP 2745 hardware, to identify a page slot for wiping and/or swap out and swap in when the space in Secure RAM for physical pages is full.

SDP has registers ACT for page active, TYPE for code or data page, WR for write page, STAT for statistics, and ADV for advice on which page to wipe. When any of these registers are reset, such as on power up, Warm CPU reset, or new Virtual Machine Context (VMC), all the bits in those five registers are suitably reset to zero. Those five registers are suitably provided as secure registers protected by SSM 2460. Software operating in a secure, privilege mode such as Secure Supervisor mode, is used to access and reset those registers ACT, TYPE, WR, STAT and ADV in Secure mode.

Next, various signal designators are used in connection with the coupling to busses. The signal designators are composites build up from abbreviations and interpreted according to the following Glossary TABLE 35.

TABLE 35

| GLOSSARY | REMARKS |
|---|---|
| ABBREVIATION | (also subject to explanation in text) |
| A | Address |
| ADDR | Address |
| CLK | Clock |
| EN | Enable |
| I | Instruction (bus) |
| LEN | Length of a burst access |
| N | Page Number |
| PROT | Protection, Protected, Secure |
| R | Read |
| READY | Ready |
| RW | Read/Write |
| SEC | Secure |
| VALID | Valid |
| W | Write |
| WR | Write |

TABLE 36 lists various further glossary items.

TABLE 36

| Abbreviation/Term | Meaning |
|---|---|
| Violation_IBus_Neutralizer | Neutralizer for violation on Instruction bus by Prefetch Abort |
| | triggered by violation on either instruction bus or data bus. |
| Branch Phantom | A branch instruction with dead bit set that is not executed but still |
| | propagating in the pipeline. Happens when pipeline is flushed |
| | (or assimilated) due to BTAC, Branch folding mis-prediction. |
| DContainer | Data container (Physical and virtual bound checking) on the |
| | virtual processor (data side) from SSM checker standpoint. |
| | Permitted address range is configurable through SSM registers. |
| IContainer | Instruction container (Physical and virtual bound checking) on the |
| | virtual processor (instruction side) from SSM checker standpoint. |
| | Permitted address range is configurable through SSM registers. |
| Data_Slot_Abort | When an instruction attempts data transfers (data pipeline), |
| | it associates a slot to each data item. These slots are aborted |
| | on an MMU fault, or SSM or Bus returns a Data Abort exception. |
| Supervisor Mode | Processor non-user mode for interrupts, exception, |
| | operating system, etc. |
| CPSR_Mode | User or Exception Mode bit in MPU core CPSR register. |
| | Processor hardware signals to indicate in which mode the |
| | processor core is evolving in, taken from Execute stage of |
| | processor pipeline. |
| SECMON | Security monitor bus coupled to processor core |
| | and SSM 2460 hardware-support for hypervisor. |
| MPU2BUS | MPU bus bridge to a bus protocol for a bus outside of |
| | MPU processor core. |
| TRACE | Embedded trace macrocell allows tracing code |
| | executed and data transferred, example is ETM. |
| TRACEPWRUP | TRACE Power Up activates a TRACE interface to MPU. Trace is |
| | enabled only when emulation is needed. For security purposes, TRACE in |
| | from MPU is output on SECMON bus to SSM Debug Section of FIG. 30. |
| TRACEIA[ ] | TRACE instruction address. Virtual address of the instruction |
| | executed by the processor at writeback WB stage plus one in |
| | the MPU pipeline. |
| TRACEIACTL[ ] | Execution status of the instruction executed by MPU at |
| | writeback WB stage plus one in the pipeline. |
| TRACEDDCTL[ : ] | Trace data data control |
| TRACEDACTL[] | Trace data address control |
| TRACEDA[ : ] | Trace data address |
| PRCM | Power, resets, and clocks manager |
| NSBIT_IC | CP15S_NS transferred to In-Circuit emulation block. |
| DBGACK | Asserted when the MPU is Halted subsequently to a debug request |
| | taken when DSCR = HALT mode. |
| EDBGRQ | Enable debug request (handshake reply is DBGACK). |
| DBGEN | Debug enable |
| NIDEN | Non-Intrusive Debug NID enable |
| SMI | MPU instruction to switch to Monitor Mode, a secure mode. |
| SPIDEN | In-circuit emulation secure privileged intrusive debug enable, |
| | see debug RTL. |
| SPNIDEN | TRACE secure privileged non-intrusive debug enable. |
| SystemMpuTapEn | Enable from System microprocessor MPU 2610 or PC 1070 |
| | to JTAG debug TAP (test access port) controller |

In FIG. 9, processor Instruction bus and Data buses have signals Read_Channel (data and instruction fetch load), and Write_Channel (data write) signals. These signals listed in TABLE 37 are used, for instance, by SSM firewalls 4010, 4030 in FIG. 24 and 4110, and 4150 in FIG. 25. SDP 2745 of FIG. 9 can use bus signals to determine that a Data page is written (dirty) and change the SDP priority for swapping.

TABLE 37
READ CHANNEL and WRITE CHANNEL GLOSSARY

| | |
|---|---|
| ACLK | Main Clock |
| ACLKEN | Used to divide the Main clock to create half-rate clock |
| | for bus |

READ_CHANNEL:

| | |
|---|---|
| ARVALID: | When High the address on the bus is valid |
| ARPROT: | Indicates if this transaction is Secure/Public; |
| | User/Supervisor; |

Data/Opcode

| | |
|---|---|
| ARADDR: | Address requested |

WRITE CHANNEL:

| | |
|---|---|
| AWVALID: | When High the address and data in the bus are valid |
| AWPROT: | Indicates if this transaction is Secure/public; |
| | User/Supervisor; |

Data/Opcode

| | |
|---|---|
| AWADDR: | Address requested |

Multi-Processor Architecture with Hardware-Supported Hypervisor

FIGS. 32-38B show some hardware security embodiments for symmetric multiprocessing (SMP) core(s). One of the cores is called the SMP core and designated CPU0. A hardware (HW) supported secure hypervisor runs at least on the SMP core. Linux SMP HLOS is symmetric across all cores and is chosen as the master HLOS in some embodiments. A secure environment is provided by use of SSM 2460 described in detail in connection with FIGS. 9A/9B and in connection with SSM 5030 of FIG. 34B. By contrast with the symmetric HLOS, one core CPU0 acts as a control core and is provided with security zone circuitry so that the security zone is not asymmetric in the multi-core embodiment. The HW hypervisor mechanism provides standalone CPU virtualization in order to run a single processor based OS such as WinCE or Nucleus.

The hypervisor code runs in Monitor Mode, and virtual worlds are switched from Monitor Mode. The hypervisor-mediated categories of FIG. 6, are scheduled by timers in synchronous time sharing fashion. The HW secure hypervisor mechanism in this embodiment is asymmetric relative to the processor cores.

In some other embodiments, a pseudo-symmetric architecture has virtual processors wherein any of the virtual processors can do SMP (symmetric multi-processing) while using a control core plus a further number n−1 (one less than n) CPU cores, also called processor cores herein. In other words, if a complete cluster has four (4) cores or processors, then the pseudo-symmetric virtual core mechanism uses an SMP cluster of 3 CPUs as processor cores with some operations conducted by the additional control core CPU0.

The hardware hypervisor provides real time interrupt firing capability for virtual worlds to ensure RTOS capability. Any OS running in a virtual world is able to call Secure services even if the secure environment is on CPU0 and the virtual world is running on another CPU. Any security mechanism and any hypervisor mechanism are invisible to the SMP HLOS. A minor FIQ (Fast interrupt request) latency introduction has negligible effect on the SMP HLOS performance.

Each interrupt line from the 96 possible interrupt line is tagged to the Public Normal, Public Virtual, Secure Normal or Secure Virtual mode. The Security zone mechanism (SZ) traps any FIQ in Monitor Mode. The Monitor code is written to identify to which category (Public Non-virtual, Public Virtual, Secure Non-virtual or Secure Virtual) the FIQ belongs. To do this, the Monitor code reads the Interrupt Handler 2720 qualifier MreqSecure (Secure or Public FIQ) and then reads the SSM 2460 (5030) qualifier MreqSystem (Non-virtual or Virtual). Using the identified mode information, the Monitor code switches operations to a specific processor.

In some embodiments, the security zone mechanism is implemented on all CPUs of the cluster. The Secure Kernel and its secure services run specifically on CPU0, which operates as a master CPU. CPU0 is the first CPU core to boot and to setup or configure the hypervisor structure. CPU cores other than CPU0 have a small secure kernel that includes a Monitor Mode implementation to forward SMI/WFI (Software Monitor Interrupt SMI or Wait for Interrupt WFI). SMI/WFI are generated by a virtual OS kernel (WinCE, RTOS) as Secure fast interrupt SFIQ. SFIQ is coupled to the secure hypervisor in Monitor Mode operating on the master CPU0 core, which executes or drives hypervisor scheduling. The hypervisor scheduling on master CPU0 core is unnecessary on the other CPU cores, which simplifies this embodiment. The Security Monitor bus SECMON interface is accessible by the SSM 2460 (5030) for all the CPU cores. Wait for Interrupt WFI instruction is trapped into Monitor Mode as a SWI software interrupt exception, if and as-configured on a CPU-specific basis.

All WDtimers and Timers operate in a synchronous mode, and are either synchronous at the same clock rate or clock frequency or run at clock rates that are exact multiples of each other and have coinciding clock edges at the lower or lowest clock rate. All WDtimers and Timers are programmable by CPU0 to support the hypervisor scheduling. (WD is watchdog.)

FIG. 32 shows a dual-core embodiment that has the same one SMP HLOS running on all CPU cores. Each CPU has SSM hardware and Monitor code to constitute a hardware-supported hypervisor. The hypervisor shares its bandwidth between the SMP HLOS and another world in the following way. CPU0 is shared between SMP HLOS and Secure Environment using the security zone mechanism. CPU1 is shared between SMP HLOS and Modem RTOS and a Public HLOS (e.g., WinCE operating system, non-real-time or other operating system) using the security zone mechanism plus SSM hardware hypervisor structuring.

In each world there is a small secure service routine for transmitting a secure service request to CPU0 wherein the Monitor Mode is located in the Secure environment of CPU0 and provides hypervisor operation.

FIG. 33 shows an overview of a four-CPU embodiment having the same one SMP HLOS running on all four CPU cores indexed by index i. Each CPUi has hardware-supported hypervisor to share its bandwidth between the SMP HLOS and another world in the following manner. CPU0 is shared between SMP HLOS and Secure Environment using a security zone mechanism. CPU1 is shared between SMP HLOS and Modem RTOS using a security zone mechanism plus SSM hardware hypervisor structuring. CPU2 is shared between SMP HLOS and Public HLOS using security zone mechanism plus SSM hardware hypervisor structuring. CPU3 is shared between SMP HLOS and drivers such as non-GPL drivers using security zone mechanism plus SSM hardware hypervisor structuring.

Expanding on FIG. 32, each CPU of FIG. 33 has a small amount of secure code for transmitting a secure service request SFIQ to CPU0 where the Monitor Mode is located in the Secure environment of CPU0 and provides hypervisor operation. The hypervisor operation and hardware support by SSM ensure the security robustness of the virtual modes. Each of the cores CPU0-3 has a respective Security Monitor bus (SECMON), a pipeline, and circuitry for establishing various privilege modes such as some or all of Monitor, Supervisor, System, FIQ mode, IRQ mode, Abort mode, Undefined mode, and a non-privilege mode such as a User mode.

In FIGS. 34A and 34B, a four-CPU hardware-supported hypervisor embodiment 5000 of FIG. 33 is shown in more detail. FIGS. 34A/34B can be compared with and supplemented by the embodiments shown in FIGS. 38A/38B and FIGS. 6, 8, 9, 19, and 20 and other description elsewhere herein. Non-virtual Public HLOS and Non-Virtual Secure Kernel run in the system as coherent and shared devices with MMUi (Memory Management Unit) for each of the CPUi (CPU0-3), L1$i (Level 1 Cache) for each of the CPUi (CPU0-3), and a shared Snoop Control Unit SCU 5010. Public Virtual OS or RTOS (WinCE, Nucleus, etc.) runs non-coherently and as a not-shared device with an MMU.

The Interrupt architecture, for example, optionally has dedicated SFIQ input. IRQ are reserved for SMP HLOS in some embodiments. Public FIQ can be used with SMP HLOS of Public Non-virtual mode. Other modes (Public Virtual, Secure Non-virtual and Secure Virtual) use exclusively Secure FIQ to preempt the SMP HLOS.

In FIG. 34A, a block called a Generalized Interrupt Handler GIC 5020 (compare Interrupt Handler 2720 of FIGS. 9A and 19) is provided to handle interrupts that can be selectively masked and routed to respective GIC Bus 0-3 ports corresponding to each of the CPU cores CPU0-3. Some embodiment do not differentiate interrupt lines activated by and assigned to Virtual modes from interrupt lines activated by and assigned by Non-virtual modes at GIC level.

Further in FIG. 34B, SSM hardware hypervisor-support circuitry 5030 includes registers 5035 and logic for a Virtual Checker 5045, a Physical Checker 5055, and a Virtual Modes Creator 5075. See FIGS. 9A/9B for SSM circuitry that is suitably used for each CPUi and replicated per-CPU as appropriate for the system of FIGS. 34A/34B. Registers 5035 include virtual processor-related registers for each virtual processor x to be used. These are respectively designated VPx_Debug_Dis for debug disable, VPx_NS for virtual processor-specific secure state or non-secure state, VPx_Active for active or inactive status, and VPx_Boundaries for begin/end addresses to define address space(s) assigned to the virtual processor indexed x. These registers are used to activate and define each virtual processor.

In FIG. 34B Virtual Checker 5045 checks that the currently-active virtual modes execute properly in their own virtual address spaces. Virtual Checker 5045 includes a CPSR_Mode switch checker and a Per-CPU Preemptive Masking circuit for each CPU0-3. Virtual Checker 5045 has inputs from CPU0-3 (index i=0, 1, 2, 3) for CPUi_Trace_Virtual_Address, CPUi_CPSR_Mode, and CPU_CPSR_< > fields or bits CPSR_I for masking interrupts IRQ, CPSR_F for masking fast interrupts FIQ, and for External Abort EA. Virtual Checker 5045 has four outputs coupled to GIC 5020 of FIG. 34A. The outputs signify fast interrupt mask enables CPUi_FIQMASK and pertain respectively to the several CPU i.

Also in FIG. 34B, an Error Generator 5050 receives an Abort request SRESP from the Physical Checker 5055 in the same clock cycle in which a physical check violation occurs. Physical Checker 5055 checks that the virtual processors execute properly in their own physical address space and that other running cores are not injecting data or code into address spaces reserved for other virtual processors that are running or not. Error Generator 5050 is coupled to a Read channel and a Write channel of one or more functional buses emanating from SCU 5010 of FIG. 34B.

In the embodiment of FIG. 34B, the Read channel and Write channel are coupled via Error Generator 5050 to a level-two cache L2$ 5060. Physical checker 5055 checks the address and other signals on the Read channel and Write channel on the L2$ side of the Error Generator 5050. L2$ 5060 is further coupled to a bus interface MPU2BUS 5065.

Virtual Modes Creator 5075 protects and generates respective CPU-specific MreqSystemX qualifiers for each CPU indexed X. For example, if three (3) worlds are identified (HLOS, RTOS), then two (2) MreqSystemX qualifiers are provided to interface MPU2BUS 5065 on the same clock cycle in which the debug status arises. For virtual modes that have debug activated in registers 5035, the Virtual Modes Creator 5075 generates an MreqDebug qualifier and conveys it to interface MPU2BUS 5065 on the same clock cycle in which the debug status arises.

In FIG. 34B, the MreqSystemX qualifiers together with qualifiers MreqType, MreqPrivilege, MreqDebug, MreqSecure are relayed or generated by interface MPU2BUS 5065 and sent onto interconnects 5070 for each virtual processor or OS along with bus addresses and data and other bus control lines. Interconnects 5070 are coupled to various Firewalls 5080A, B, . . . Z and are further coupled to respective Timers CPUiTimer 5085.0, .1, .n respective to the various CPUs indexed i from CPU0 to CPUn. The timers 5085.i are responsive to a common clock or counter 5088.

A Security Violation Handler 5090 (compare 2760 of FIG. 9B) is responsive to any security violation(s) detected in Virtual Checker 5045, Physical Checker 5055, and Virtual Modes Creator 5075. The Security Violation Handler 5090 provides appropriate security violation response output(s) such as aborts and neutralization and delivering reset control to a PRCM 5095. In this way SSM HW Hypervisor structures the multi-CPU system to that Monitor Mode of CPU0 operates as a hypervisor.

The SSM 5030 implements all the registers and logic for providing exclusive or cooperating debug between CPUs and virtual OS (WinCE, Nucleus). The SSM 5030 differentiates for each interrupt the mode or world (Public Non-virtual, Public Virtual, Secure Non-virtual or Secure Virtual) to which the interrupt belongs.

In the GIC (Generalized Interrupt Handler) 5020 of FIG. 34A, IRQ are dedicated to SMP HLOS in an example. Public Fast Interrupt Requests PFIQ can be used by the SMP HLOS. Secure Fast Interrupt Requests SFIQ are dedicated to Secure Environment and virtual worlds. The GIC 5020 differentiates the Public or Secure nature of each interrupt via a dedicated register (compare FIG. 19) having retention flip flops identifying the Public or Secure assignment of the corresponding interrupt line. Each interrupt line that is identified or configured as Secure is also made fast interrupt FIQ. Configuration of the register is accessible only by Secure Privilege data accesses such as at Boot time.

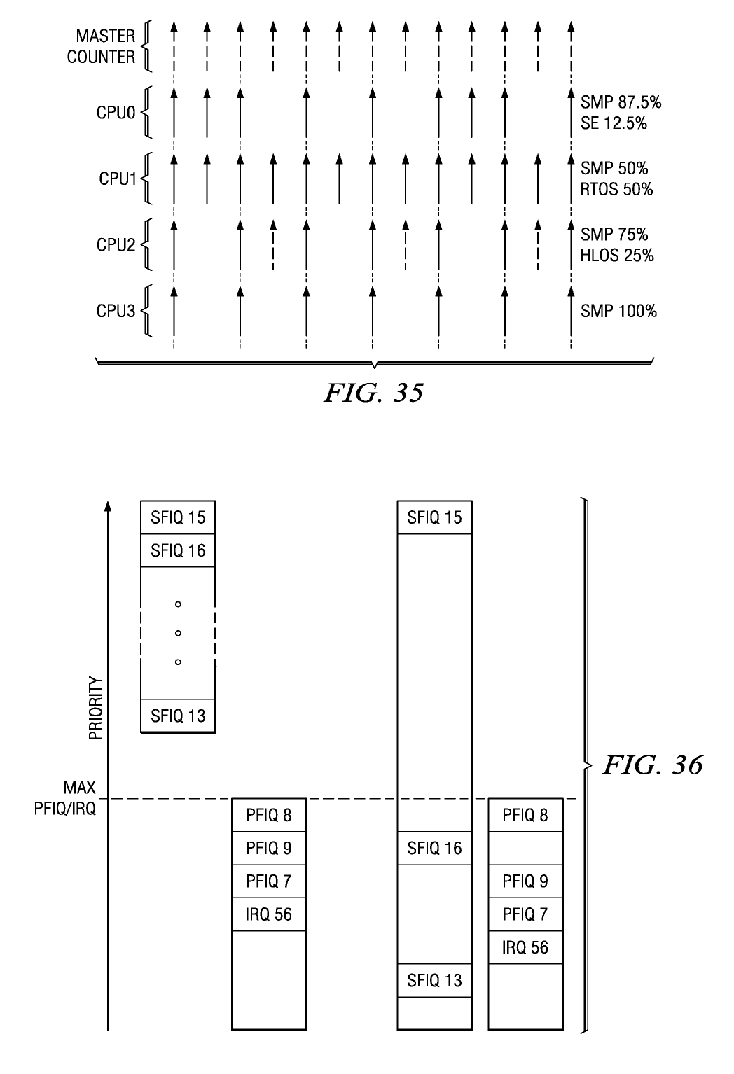

In FIGS. 34B and 35, synchronous timer scheduling makes all CPU timers synchronous relative to each other in order to facilitate scheduling and to efficiently schedule the different worlds. Also, the timers are made configurable through an interface that is responsive to qualifier MreqSystemx, where index x on the qualifier identifies the CPUx that is attempting an access. This protects the virtual world setting from tampering.

The timers 5085.i output two interrupts per CPUi, a first interrupt for the SMP HLOS and a second interrupt for the virtual world running on the CPUi or secure mode. On a dual core or multi-core embodiment where multiple virtual worlds are evolving on a single CPUi, software is made to have only the Secure mode own the timers 5085.i (for virtual worlds). In this way, the secure hypervisor dispatches or allocates CPU bandwidth correctly between worlds.

The timers 5085.i are banked so that SMP HLOS programs its own setting. Then each virtual processor VPx or secure mode programs its respective setting into a timer bank register. The timer bank register is protected by a firewall.

In FIG. 35, the outputs of all timers 5085.i of FIG. 34B are made synchronous (aligned) relative to each other. The second interrupt for and programmed by the virtual worlds or secure mode SE is in synchronism with the SMP HLOS. The second interrupt is synchronized to occur in the middle of two SMP HLOS timer ticks. Plural full periods are also suitably left to SMP HLOS. For instance, FIG. 35 illustrates one tick every 3 ticks, but with that second interrupt occurring on the middle of two SMP HLOS ticks.

In FIG. 35, the timers for FIG. 33 are shown in an example with Master Counter 5088 ticks being twice the rate of SMP HLOS timer ticks. CPU0 receives SMP HLOS ticks 87.5% and Secure Kernel SE 12.5% in the illustration. CPU1 receives SMP HLOS ticks 50% and RTOS ticks 50%. CPU2 receives SMP HLOS ticks 75% and Public HLOS ticks 25%. CPU3 receives SMP HLOS ticks 100% in this example.

In FIG. 35 the arrows (ticks) represent fast interrupt requests FIQ in the rows of FIG. 35 below the top row. Some multi-processor system embodiments work as follows. FIQ are trapped in Monitor Mode by interrupt hardware and vectoring in MPU 2610. Each FIQ is tagged to belong to a category or world such as SMP HLOS, SE, RTOS, Public HLOS in or by the hardware of GIC 5020 and SSM registers 2620. Each FIQ occurs on the particular CPUi that governs execution of, or is assigned to execute, the category or world to which the FIQ belongs. When the FIQ is initiated (fires), that FIQ is trapped in the Monitor Mode of this particular CPUi. The Monitor Mode of the particular CPUi has code to initiate a context switch between the different categories or worlds. The category or world of execution of the particular CPUi can usually mask only the FIQ belonging to that category or world, with some possible exception as described elsewhere herein, refer to TABLE 42. Consequently, the Monitor code of control core CPU0 can allocate accurate bandwidth (e.g., MIPS of each processor core CPUi) for each category or world.

In the banked-timers section, the Master Counter is the principal counter. The other counters service the CPUs respectively and are derived from the Master Counter. The multi-CPU system establishes the arrow percentages (SMP 50%, RTOS 50%, etc.) as follows. The Hypervisor code running in the Monitor Mode of the first core CPU0 accesses the timer of every core CPU0-CPUn and defines or establishes by configuration of the timer percentage values according to the different bandwidths required. Secure privilege access is suitably used to establish the timers configuration. This bandwidth requirement depends on power consumption estimation and power constraints and bandwidth (e.g., MIPS millions of instructions per second) required per software application.

The timer configuration of percentages is static or dynamic, or both static and dynamic. In some embodiments, a hardware feedback loop is provided to establish optimization and bandwidth allocation.

FIG. 36 shows an example of interrupt priority settings. GIC 5020 has a register called an SFIQ Prioritization register to prioritize each secure FIQ relative to other secure FIQ. Another GIC 5020 register called an Interrupt Prioritization register prioritizes each secure FIQ against public FIQ/IRQ. These GIC 5020 prioritization registers are accessible only in secure privilege mode, such as at boot time, in this example.

A default configuration suitably makes all SFIQ higher priority than PFIQ/IRQ as shown in the left two columns of FIG. 36. Notice that the lowest interrupt priority level of a secure FIQ (e.g., that of SFIQ 13) exceeds the highest interrupt priority level MAX PFIQ/IRQ configured for any Public FIQ (e.g., PFIQ 8, 9, 7) or other interrupt IRQ (e.g., IRQ 56).

SFIQ priority is downgraded as shown in the right two columns of FIG. 36 as appropriate. To downgrade the SFIQ priority, configure the GIC Interrupt Prioritization register to equal or less than a priority of some PFIQ and IRQ. In the illustration, SFIQ 15, SFIQ 16 and SFIQ 13 retain the same priority relationship to each other but now SFIQ 16 is between PFIQ 8 and PFIQ 9 in priority, and SFIQ 13 has a lower priority than that of IRQ 56.

In FIG. 37, SSM provides Public FIQ pre-emptive masking for hypervisor control over SMP HLOS and virtual worlds. Automatic handling for SMP HLOS is completely hardware driven when an Automatic option bit is activated. Otherwise, Manual handling is provided for virtual worlds in the sense that the handling is software-driven in Monitor Mode because the number of virtual worlds that can be running concurrently is subject to variation and is not predetermined. The embodiment of FIG. 37 can also be compared to that of FIG. 19 and each may be used to supplement the other. Compare Manual handling of FIG. 37 with Monitor Mode method of FIG. 19.

In FIG. 37, the SSM has an Entry Condition hardware block 5110, Manual/Auto hardware block 5120, Flag/Mask hardware block 5130, and a Flag hardware block 5140 structured to do operations specified as follows in TABLE 38, for an example.

TABLE 38
SSM HARDWARE TO SUPPORT GIC 5020

```
IF (SECMON CPSR F Mask_Tentative = 1 & CP15NS_BIT= 1
      & SSM_FIQ_Preemptive_Masking = 1) -Block 5110--
THEN
    IF Automatic -determine whether Manual or Automatic in block
    5120-
    THEN --in Block 5130--
        CPUx_FIQ_MASK_status = 1 (SSM HW flag)
        CPUx_GIC_PFIQ_MASK = 1 (HW signal Masks all
        PFIQ automatically at GIC):
    ELSE -in Block 5140-
        CPUx_FIQ_MASK_status = 1 (SSM HW flag) -> System
        waits for FIQ
ENDIF
```

Upon an SFIQ event from Flag block 5140, operations go a Monitor software Mask/Unmask block 5150. Otherwise, if no SFIQ event, operations go to an Entry Condition hardware block 5170. Blocks 5150 and 5160 are performed in the Monitor Mode software in this example. Mask/Unmask Process block 5150 operates as in TABLE 39 on FIQ trapped into Monitor Code:

TABLE 39
MONITOR SOFTWARE MASK/UNMASK BLOCK

```
IF (CPUx_FIQ_Mask_status = 1 ) THEN
    MASK all FIQ belonging to this world (GIC access)
    CPUx_FIQ_MASKED = 1  (SSM access)
ENDIF;
IF (SSM_FIQ_Unmask_REQ_Interrupt) THEN
    UNMASK all FIQ belonging to applicable world  (GIC access)
    Acknowledge SSM_FIQ_Unmask_REQ_Interrupt (SSM access)
ENDIF;
```

In Flag/Mask block 5130 if there is an occurrence called a PFIQ event corner case introduced by GIC sorting time, then operations go to a Corner Process monitor software block 5160 and use NEWFIQAGR, otherwise to the Entry Condition hardware block 5170. In such corner case, the PFIQ in the GIC sorting process cannot be masked and consequently trapped. Corner Process block 5160 in the Monitor Mode software code operates as follows upon such occurrence of a PFIQ Corner case:

TABLE 40
MONITOR SOFTWARE CORNER PROCESS BLOCK 5160

```
IF (CPUx_FIQ_Mask_status = 1) THEN
  Perform NewFIQAgr
  Wait PFIQ mask OK_feedback
ENDIF;
RETURN --Return without servicing--
```

The SSM 5030 has hardware blocks for Entry Condition 5170, Manual/Automatic 5175, Mask Status/Unmask 5180, and Mask Status/Unmask 5190. Entry Condition block 5170 has a structure defined as follows:

TABLE 41
SSM HARDWARE ENTRY CONDITION BLOCK 5170

```
IF (SECMON CPSR F_Unmask_Tentative = 1 & CP15NS_BIT= 1
  & SSM_FIQ_Preempive_Masking = 1)
THEN
    IF AUTOMATIC --Block 5175-
    THEN  --Block 5180 Automatic-
      CPUx_FIQ_MASK_status = 0
      CPUx_GIC_PFIQ_MASK = 0
      (Unmasks all PFIQ automatically by generating a HW signal to
      GIC)
    ELSE --MANUAL--
      CPUx_FIQ_MASK_status = 0
      IF (CPUx_FIQ_MASKED = 1)
      THEN Generate SSM_FIQ_Unmask_REQ_Interrupt --Block
      5190 Manual--
      ENDIF;
    ENDIF;
ENDIF;
```

Further, in addition to the SSM PFIQ pre-emptive masking above, GIC 5020 also supports SSM Public (NS=1) FIQ pre-emptive masking capability. An input hardware bit or field GIC_PFIQ_MASK is provided. When this bit or field is set active, GIC 5020 masks all Public FIQ that can occur on this specific CPU core (enforcement analogous to PFIQ CPSR F enable). GIC 5020 provides an OK_Feedback readable by Secure Privilege software, SFIQ are still active. When the GIC_PFIQ_MASK is inactive, GIC 5020 unmasks all public FIQ that can occur on this specific core (analogous to PFIQ CPSR F disable). GIC 5020 clears the OK_Feedback, which is readable by secure privilege SW, and both PFIQ and SFIQ are active. Signals CPUx_GIC_PFIQ_MASK for each CPUi in a multi-processing embodiment are established and are configured and reset by Secure Privilege software.

Implementing PFIQ and SFIQ input at each CPUi core boundary, for example, provides an uncomplicated architectural approach. This provides interrupt virtualization wherein CPSR F Disable/Enable applies only on PFIQ input when operations are in Public mode. The GIC 5020 routes all FIQ marked as Public to PFIQ and all FIQ marked as Secure to SFIQ.

TABLE 42
MONITOR CODE, SWITCH HANDLER

Save context of current world
PUSH r0 -> r14 of each mode {User, Supervisor, System, IRQ, FIQ, Aborts, Undef}
Restore context of world that has to be switched to
POP r0 -> r14 of each mode {User, Supervisor, System, IRQ, FIQ, Aborts, Undef}
Data Coherency
Execute: Data Memory Barrier
Execute: Data Synchronisation Barrier
Switching
Go to SMP HLOS

| | |
|---|---|
| CP15_NS_Bit = 1; | #Public world |
| Virtual_Processorx_Active = 0; | #Non-virtual world (SMP HLOS) |
| Virtual_Processorx_Dbg = Debug_Conf | #Depends of current system debug settings |
| IRQ trapped in SMP HLOS | #Direct servicing of SMP HLOS IRQ |
| | in IRQ mode |
| FIQ trapped in Monitor Mode | #DISPATCH when in Monitor Mode |
| | (SMP HLOS, SE, Virtual worlds) |
| External aborts (EA) trapped in HLOS | #DMB/DSB ensures no EA pending after switch |
| IRQ maskable in HLOS | #- |
| FIQ not maskable in HLOS | #SMP HLOS FIQ is preempted |
| | (automatic mode) |
| SSM FIQ pre-emptive masking= 1; | #Mechanism activated |
| SSM automatic/manual FIQ mode = 1; | #Automatic mode 100% hardware |

| | |
|---|---|
| Go to Public Virtual NON-REAL-TIME OS x | # (Public HLOS, e.g., WinCE) |
| | x <= {0; n} possible worlds |
| CP15_NS_Bit = 1; | #Public world |
| Virtual_Processorx_Active = 1; | #Virtual world |
| Virtual_Processorx_Dbg = Debug_Conf | #Depends on current system |
| | debug settings |
| IRQ trapped in Monitor Mode | #Direct switch to SMP HLOS IRQ mode |
| FIQ trapped in Monitor Mode | #DISPATCH when in Monitor Mode |
| | (SMP HLOS, SE, Virtual worlds) |
| EA trapped in Public Virtual OS | #DMB/DSB ensures no EA pending |
| | after switch |
| IRQ maskable in Public Virtual OS | #SMP HLOS is maskable |
| | (rising condition of SMP) |
| FIQ not maskable in Public Virtual OS | #Virtual world is preempted |
| | (manual mode) |
| SSM FIQ pre-emptive masking = 1; | #mechanism activated |
| SSM automatic/manual FIQ mode = 0; | #Manual mode (SW driven) |
| Go to Public Virtual REAL-TIME OS x | # (e.g., Nucleus OS) |
| | x <= {0; n} possible real-time worlds |
| CP15_NS_Bit = 1; | #Public world |
| Virtual_Processorx_Active= 1; | #Virtual world |
| Virtual_Processorx_Dbg = Debug_Conf | #Depends on current system debug |
| | settings |
| IRQ trapped in Monitor Mode | #Direct switch to SMP HLOS IRQ mode |
| FIQ trapped in Monitor Mode | #Dispatch when in Monitor Mode |
| | (SMP HLOS, SE, Virtual worlds) |
| EA trapped in Public Virtual OS | #DMB/DSB ensures no EA pending |
| | after switch |
| IRQ maskable in Public Virtual OS | #SMP HLOS is maskable |
| | (rising condition of SMP) |
| FIQ maskable in Public Virtual OS | #True Real-Time capable |
| | (SE not running on this core, |
| | DOS attacks are resisted) |
| SSM FIQ pre-emptive masking= 0; | #SSMFIQ_EN disabled |
| SSM automatic/manual PFIQ mode = 0; | #Don't care |
| Go to SECURE OS | |
| CP15_NS_Bit = 0; | #Secure world |
| Virtual_Processorx_Active= 0; | #Non-virtual world |
| Virtual_Processorx_Dbg = Debug_Conf | #Depends on current system debug settings |
| IRQ trapped in Monitor Mode | #Direct switch to SMP HLOS IRQ mode |
| FIQ trapped in Monitor Mode | #Dispatch when in Monitor Mode |
| | (SMP HLOS, SE, VWs) |
| EA trapped in Secure OS | #- |
| IRQ maskable in Secure OS | #SMP HLOS is maskable |
| | (rising condition of SMP) |
| FIQ maskable in Secure OS | #True Real-Time capable |
| SSM FIQ pre-emptive masking= 0; | #SSMFIQ_EN disabled |
| SSM automatic/manual PFIQ mode = 0; | #Don't care |
| Note: DOS attack is denial of service attack. | |

CPU core for hypervisor worlds debug does run time activation of DBGEN and NIDEN in a less time-consuming way with automated coherency micro-code execution.

CPU core for SSM hardware-support for hypervisor implements hypervisor world security by adding CPSR F bit tentative masking that is then sent out on the SECMON bus. The Snoop Control Unit SCU 5010 distinguishes which CPUi has issued the current access. SCU 5010 propagates coherent shared data into the caches associated with the other CPUs. SCU 5010 ensures data coherency between all level-one caches L1$i of the cores CPUi as a cluster by moving/updating any updated instruction cache line and any updated data cache line from the cache area associated with any one CPUi to the caches of all the CPUs, i.e., all the cores in the cluster.

SCU 5010 is coupled to and cooperates with the multi-core hypervisor using an enable/disable circuit in SCU 5010 that operates as an asymmetric mode switch configurable by core CPU0 at run-time in an auxiliary control register. In that way, the core CPU0 that runs the hypervisor operates or disables the SCU 5010 so as to exclude accesses of the core CPU0 pertaining to the hypervisor process from being used to update cache lines for all the other CPUi. In other words, certain hypervisor-related accesses are selectively prevented from being taken into account by the SCU 5010 by turning off the snooping and cache line updating by SCU 5010 when hypervisor needs to disable those operations. This facilitates isolation of the hypervisor in CPU0 from the rest of the multi-core system. In this way SCU 5010 acts as an example of a cache control circuit for updating coherency between the caches. The protective circuitry of SSM 5030 is responsive to a line from CPU0 indicating that Monitor Mode is activated in CPU0 to temporarily disable the cache control circuit from updating coherency between the caches.

Enable and disable of the symmetric coherent or asymmetric not-coherent configuration per CPUi is established, for example, by configuring an auxiliary control register asymmetric field on each CPUi of the cluster. When the asymmetric field is configured active on each core CPUi, then each transaction issued by the MMU stage of the respective core CPUi to its L1$i cache and then to SCU 5010 is tagged with in-band qualifier MreqNCoherence that commands or controls the SCU 5010 to not maintain coherency on these accesses. In some embodiments, the SCU 5010 outputs information pertaining to each access that tells which CPU0-3 has generated the access. In response to the information identifying which CPUi generated the access, the SSM 5030 generates the corresponding MreqSystemX qualifiers and provides the address boundary checking and configuration checking that pertain to that CPUx category or world.

The SSM 5030 implements the following added registers to support the CPU0 SMP core hypervisor. A register for CPU0 inter-CPU SFIQ generation is configurable in Secure Privilege mode. This register enables each SFIQ to occur on a configuration-specified one or more CPUs. Each SFIQ is maskable individually by Secure Privilege software configuring a dedicated Mask register.

Per-CPU virtual worlds activation and debug control is provided. Per-CPU SMI call forward to CPU0 is provided. Per-CPU Wait for Interrupt WFI call forward to the same CPU is provided. CPUi can replace this by trapping WFI into Monitor Mode analogously to trapping SMI with a dedicated exception vector.

A Flag is provided for each interrupt line to identify which virtual world the interrupt line belongs to. A Secure/Public interrupt designation is made at GIC 5020 level. SSM 5030 adds 2 bits encoding to differentiate the virtual worlds:
00=Non-virtual
01=Virtual world 1
10=Virtual world 2
11=Virtual world 3

Hypervisor control over different worlds is established using bits of TABLE 43.

TABLE 43
CONTROL FIELDS FOR EACH CPU FOR MULTI-PROCESSING

| | |
|---|---|
| CPUn_SSM_NIDEN_Disable | When field is active, NIDEN is low at CPUn boundary |
| CPUn_SSM_DBGEN_Disable | When field is active, DBGEN is low at CPUn boundary |
| CPUn_Virtualworld_DEBUG_DIS | When field is active, SSM_DBGEN_Disable and |
| | SSM_NIDEN_Disable are set active before entering |
| | the Virtual world and reset to previous value before |
| | exiting. |
| CPUn_Virtualworld_Active | When field is active, CPUn is virtual |

Hypervisor control over the different categories and CPU cores is implemented, for example, as follows: When each particular low-active field is cleared (active), an interrupt is generated. When the interrupt is acknowledged, the particular field is automatically set inactive. Default value is inactive high. The _DEBUG_DIS fields are read-only, while the other TABLE 43 fields are Read or Write accessible. All the following are Read or Clear accessible: CPU<1/2/3>_inter-CPU_SFIQ, and CPU<1/2/3>_SMI_SFIQ.

In FIGS. 38A/38B, a multi-processor core virtualization architecture embodiment is shown. Switching from the different worlds or categories on CPU cores is done only through the Monitor Mode, which acts as a hardware-supported hypervisor.

In FIG. 38A, Timers 5805.i for each CPUi are suitably provided as dual synchronous output banked timers responsive to Master Counter 5088. GIC 5020 routes interrupts, as indicated by an example arrow therein. GIC 5020 provides visibility into the routing process such as which interrupts are being routed, from which context and CPU each interrupt comes, and to which context and CPU each interrupt goes.

Further in FIG. 38A, the SSM 5030 provides CPUi {0, n} inter-CPU and CPU0 WFI SFIQ generation (Wait for Interrupt, Secure Fast Interrupt reQuest) via respective lines from the SSM 5030 to GIC 5020. For each CPUi {0, n}, SSM 5030 provides NS=1 FIQ preemptive masking by a PFIQ masking command line to GIC 5020 and a PFIQ masking feedback status line for each CPU{0,n} from GIC 5020 to SSM 5030.

For each respective CPUi other than CPU0, SSM 5030 performs CPUi SMI forward to CPU0 along a line for SMI CPU0 request to the interrupt handler via GIC 5020. For each respective CPUi other than CPU0, SSM 5030 performs CPUi WFI SFIQ generation along a line for WFI request via GIC 5020 to the interrupt handler for CPU0.

In FIG. 38A, Monitor Mode code is provided for every CPU0-CPU3. From each CPUi and via GIC 5020 to Monitor Mode for each CPU0-CPU3 in this example, each fast interrupt FIQ is always trapped into the Monitor Mode, and each interrupt IRQ for Virtual and Secure worlds is always trapped into Monitor Mode. External Abort EA is not trapped in Monitor Mode. In other respects, the cores CPU1, CPU2, CPU3 suitably are provided with Monitor Mode code analogous to each other. The core CPU0 has somewhat different Monitor Mode code compared to the Monitor Mode code of the other cores CPU1, CPU2, CPU3.

For core CPU0, the Monitor Mode code controls the CP15_NS_Bit (SCR bit/field [ ]) by setting it active or inactive for transitions from Secure to Public or Public to Secure worlds respectively. CPU0 Monitor Mode code inactivates another bit/field CPU0_VirtualWorld_Active to establish Non-virtual mode. CPU0 Monitor Mode code generates CPU1_SFIQ inter-CPU FIQ for extra scheduling to the other cores CPU1, CPU2, CPU3.

For cores CPUi other than CPU0, the Monitor Mode code i in the respective CPUi controls the CP15S_NS_Bit (SCR bit/field [ ]) in CPUi by setting it active or inactive to establish Public world or Secure world in that CPUi depending on the Public or Secure operations configured or commanded for that CPUi by CPU0 and the SSM 5030. In CPUi, another bit/field CPUi_VirtualWorld_Active is inactivated or activated to establish Non-virtual mode or Virtual mode depending on the Non-virtual or Virtual operations configured or commanded for that CPUi by CPU0 and the SSM 5030.

In FIGS. 38A/38B, SSM 5030 (and Control Module analogous to 2765 associated with SSM 5030) is bi-directionally coupled to each CPU0-CPU3 of FIG. 38B by Virtual Activation blocks 5310 of SSM 5030. In an example configuration of CPU0, Public or Secure mode is defined by NS=1 or 0 and CPU0_VirtualWorld_Active is inactivated in both the Public and Secure modes. In an example configuration of the cores CPUi other than CPU0, Public or Secure mode is defined by NS=1 or 0 and CPU0_VirtualWorld_Active is inactivated or activated depending on the desired category of operation of FIGS. 4, 33 and 38B.

In FIGS. 38C/38D, the categories of operation of each CPUi in the multi-processing system are shown. In CPU0, the SMP HLOS Kernel and its Kernel Drivers and APIs operate in Public Supervisor mode. A SE API for interface to Secure Environment, and a real-time operating system RTOS API, and Public high-level operating system Public HLOS API are all provided for operation in the Public Supervisor mode of CPU0. In the Secure Supervisor mode of CPU0, a Secure Kernel operates and has associated Secure Drivers and interfaces to the SMP HLOS, the RTOS, and the Public HLOS through SMP API, RTOS API, and Public_HLOS_API respectively.

Further in FIG. 38C, for example in CPU1, the SMP HLOS Kernel and its Kernel Drivers and APIs operate in Public Supervisor mode in Public Non-virtual category of FIG. 4. A SE API for interface to Secure Environment, a real-time operating system RTOS API, and Public high-level operating system Public HLOS API are each provided for operation in the Public Supervisor, Non-virtual mode in CPU1. In the Public Supervisor mode of CPU1, but with CPU1_VP_Active activated for Virtual mode operation of CPU1, the RTOS Kernel and Modem Protocol Stack PS operates and have associated Kernel Drivers and interfaces to the SMP HLOS, to the Secure Environment, and to the Public HLOS through SMP API, SE API, and Public_HLOS_API respectively. Secure Supervisor Non-virtual category in CPU1 is used for hypervisor extensions in some further embodiments. Secure Supervisor Virtual category in CPU1 is used for a Secure Virtual Kernel SVK in some further embodiments.

Further in FIG. 38D, for example in CPU3, the SMP HLOS Kernel and its Kernel Drivers and APIs operate in Public Supervisor mode in Public Non-virtual category of FIG. 4. A SE API for interface to Secure Environment, and a GSP API are each provided for operation in the Public Supervisor, Non-virtual mode in CPU3. Modem Protocol stack (PS) layers include OS tasks that communicate using messages via queues. The GSP API is used to support and provide the messaging services to the PS and a modem AT Command Interface (ACI) and to abstract from different operating systems the PS can run on.

In the Public Supervisor mode of CPU3, but with CPU3_VP_Active activated for Virtual mode operation of CPU3, the Public HLOS Kernel operates and has associated Kernel Drivers and interfaces to the SMP HLOS, to the Secure Environment, and to the RTOS through SMP API, SE API, and RTOS API respectively. Secure Supervisor Non-virtual category in CPU3 is used for Hypervisor extensions in some further embodiments. Secure Supervisor Virtual category in CPU3 is used for a Secure Virtual Kernel SVK in some further embodiments.

In FIG. 38E/38F, each of the cores CPU0-CPU3 in each of the categories of operation thereof is coupled to the Snoop Control Unit SCU 5010. SCU 5010 is coupled to L2 Cache monitoring 5050. The current categories of operation of each CPUi are communicated along with attempted accesses asserted by SSM 5030 and interface MPU2BUS 5065 output to interconnect and firewalls of the system (see FIGS. 18 and 34B). The qualifier MreqSecure is 0 or 1 for Non-secure or Secure mode from the accessing CPUi.={0; 1} The x-indexed qualifier for Virtual world or context MreqSystemVPx is 0 or 1 for Non-virtual or Virtual mode from the accessing CPUi.

Design, Verification and Fabrication

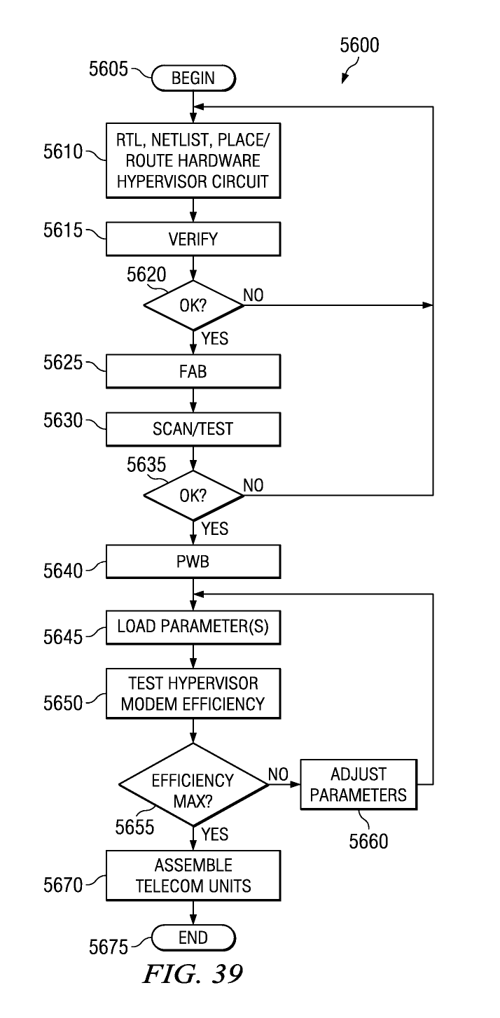

In FIG. 39, various embodiments of an integrated circuit improved as described herein are manufactured according to a suitable process of manufacturing 5600 as illustrated in the flow of FIG. 39. The process begins at step 5605 and a step 5610 preparing RTL (register transfer language) and netlist for a particular design of one or more integrated circuits or a system as shown in one or more of the Figures of drawing herein as some examples and alternatives, and/or as described in the detailed description herein.

In a step 5615, the design of the hardware-supported hypervisor circuitry, for instance, is verified in simulation electronically on the RTL and netlist. In this way, the contents and timing of the registers, operation of the circuits in various configurations and using the registers, are verified and the firewalls and interrupt operation are verified. The operations are verified pertaining to real-time and non-real-time operations and interrupts, and transitions through handlers, Monitor Mode, Secure Privilege modes, User mode, Debug modes, power management, and various attack scenarios. Then a verification evaluation step 5620 determines whether the verification results are currently satisfactory. If not, operations loop back to step 5610.

If verification evaluation 5620 is satisfactory, the verified design is fabricated in a wafer fab and packaged to produce a resulting integrated circuit at step 5625 according to the verified design. Then a step 5630 verifies the operations directly on first-silicon and production samples by using scan chain methodology on the page processing circuit. An evaluation decision step 5635 determines whether the chips are satisfactory, and if not satisfactory, the operations loop back as early in the process such as step 5610 as needed to get satisfactory integrated circuits.

Given satisfactory integrated circuits in step 5635, a telecommunications unit based on teachings herein is manufactured. This part of the process first prepares in a step 5640 a particular design and printed wiring board (PWB) of the telecommunication unit having a telecommunications modem, a microprocessor coupled to the telecommunications modem, a secure hardware support for a hypervisor coupled to the microprocessor and peripherals and firewalls for the peripherals, and a user interface coupled to the microprocessor. Storage, such as SDRAM and Flash memory and on-chip secure memory, is coupled to the system and is provided with RTOS, Public HLOS, protected applications (PPAs and PAs), and Monitor Mode software.

The particular design of the hardware-supported hypervisor is tested in a step 5650 by electronic simulation and prototyped and tested in actual application. Operation of the circuits and using the registers in various configurations selectively activating fields of TABLE 19 in Firewall_Controller register, for instance, are verified and the firewalls and interrupt operation are verified to confirm operations of the integrated circuit(s) and system and to perform verification and test operations that go beyond those operations earlier in the process. The verification and test operations pertaining to real-time and non-real-time operations and interrupts, and transitions through handlers, Monitor Mode, Secure Privilege modes, User mode, Debug modes, power management, various real-time scenarios such as modem operational scenarios. Further testing evaluates and confirms system stability and satisfactory operation of display, phone, e-mails/data service, web browsing, voice over packet, content player, camera/imaging, video, microcontroller, and other such operation that is apparent to the human user and can be evaluated by system use. Also, various attack scenarios are applied in the test operations, such as by using real viruses, DoS attacks and other attacks.

Parameters of the circuitry, software and system are adjusted for in faster application execution, lower power dissipation, evaluation of system use, attack resistance, and other pertinent metrics. Examples of parameters include enable/disable fields in configuration registers of SSM Registers 2620 and Control Module 2765, interrupt priorities in FIGS. 19 and 36, and mode hierarchy in FIG. 21. If further increased efficiency is called for in step 5655, then adjustment or reconfiguration of the parameter(s) is performed in a step 5660, and operations loop back to reload the parameter(s) at step 5645 and do further testing. When the testing is satisfactory at step 5655, operations proceed to step 5670.

In manufacturing step 5670, the adjusted parameter(s) are loaded into the Flash memory or otherwise established in the integrated circuit(s) of the system. The components are assembled on a printed wiring board or otherwise as the form factor of the design is arranged to produce resulting telecommunications units according to the tested and adjusted design, whereupon operations are completed at END 5675.

Various embodiments are used with one or more microprocessors, each microprocessor having a pipeline is selected from the group consisting of 1) reduced instruction set computing (RISC), 2) digital signal processing (DSP), 3) complex instruction set computing (CISC), 4) superscalar, 5) skewed pipelines, 6) in-order, 7) out-of-order, 8) very long instruction word (VLIW), 9) single instruction multiple data (SIMD), 10) multiple instruction multiple data (MIMD), 11) multiple-core using any one or more of the foregoing, and 12) microcontroller pipelines, control peripherals, and other micro-control blocks using any one or more of the foregoing.

Various embodiments are implemented in any integrated circuit manufacturing process such as different types of CMOS (complementary metal oxide semiconductor), SOI (silicon on insulator), SiGe (silicon germanium), organic transistors, and with various types of transistors such as single-gate and multiple-gate (MUGFET) field effect transistors, and with single-electron transistors and other structures. Photonic integrated circuit blocks, components, and interconnects are also suitably applied in various embodiments.

Aspects (See Explanatory Notes at End of This Section)

1A. The electronic device claimed in claim 1 wherein first and second qualifiers have combinations of states that represent a non-virtual public category, a virtual public category, and a non-virtual secure category.

1B. The electronic device claimed in claim 1 wherein said processor is further operable to generate an attempted access on said bus and said device further comprising a firewall coupled to said bus to receive the attempted access and the first and second qualifiers.

1C. The electronic device claimed in claim 1B wherein said firewall is responsive to the attempted access and to the first and second qualifiers to permit an access by said processor pertaining to at least one of the categories and prevent an access pertaining to at least another one of the categories.

1D. The electronic device claimed in claim 1 wherein said processor is operable to transition between said categories and said protective circuitry is operable to generate at least one security violation signal unless said protective circuitry detects the monitor mode line active during the transition.

1E. The electronic device claimed in claim 1 wherein said real-time category includes a modem engine.

1F. The electronic device claimed in claim 1 wherein said processor has a public mode that is less secure and less privileged than the monitor mode of said processor.

1G. The electronic device claimed in claim 1 wherein said processor further includes a digital signal processor core coupled to said bus and operable to make an access, and said protective circuitry is also responsive to said processor to set the register field active when a given access pertains to said digital signal processor core.

2A. The integrated circuit claimed in claim 2 wherein said processor has a secure mode and said storage has a secure kernel, and said security circuit is further operable to generate the at least one security violation signal unless the transition includes a transition between the secure kernel and said software monitor.

2B. The integrated circuit claimed in claim 2 wherein said security circuit is operable to divide said processor into categories including a non-virtual public category, a virtual public category, and a non-virtual secure category.

2C. The integrated circuit claimed in claim 2B wherein said real time operating system is assigned to the virtual public category.

2D. The integrated circuit claimed in claim 2B wherein the categories further include a virtual secure category.

2E. The integrated circuit claimed in claim 2B said security circuit has a path for a plurality of signals collectively representing a current category of the processor.

2F. The integrated circuit claimed in claim 2E said security circuit has at least one firewall coupled to said bus to said path for the plurality of signals collectively representing a current category of the processor.

2G. The integrated circuit claimed in claim 2F wherein at least one said firewall is interposed between at least part of said storage and said bus.

2H. The integrated circuit claimed in claim 2F wherein at least one said firewall establishes predetermined address spaces for a category.

2J. The integrated circuit claimed in claim 2F wherein at least one said firewall establishes predetermined address spaces for the software monitor.

2K. The integrated circuit claimed in claim 2F further comprising a peripheral circuitry and wherein at least one said firewall is interposed between at least part of said peripheral circuitry and said bus.

3A. The electronic system claimed in claim 3 wherein the combinations of states represent a non-virtual public category, a virtual public category, and a non-virtual secure category.

3B. The electronic system claimed in claim 3 wherein the processor has first and second modes and said protective circuitry is further operable to permit alteration of a particular combination of the states by said processor when the processor is in said first mode and to prevent such alteration if said processor is in said second mode.

3C. The electronic system claimed in claim 3 wherein the first mode of said processor is a more secure and more privileged mode relative to said second mode.

3D. The electronic system claimed in claim 3 further comprising a first peripheral coupled by a first firewall to said processor and said first firewall is also coupled to said protective circuitry and responsive to the first and second signals to permit an access by said processor pertaining to at least one of the categories and prevent an access pertaining to at least another one of the categories.

3E. The electronic system claimed in claim 3 wherein said processor is operable to transition between said categories and said protective circuitry is operable to generate at least one security violation signal unless a transition between the categories includes the software monitor.

3F. The electronic system claimed in claim 3 wherein said real-time application includes a modem application.

4A. The security circuit claimed in claim 4 wherein said first checker circuit and said second checker circuit are jointly operable to structure a particular one of the modes to make that particular one a hypervisor mode.

4B. The security circuit claimed in claim 4 wherein said security violation handler has an output for a next-instruction abort signal.

4C. The security circuit claimed in claim 4 wherein said security violation handler has an output for an interconnect transaction neutralizer signal.

4D. The security circuit claimed in claim 4 wherein said security violation handler has an output for a reset signal.

4E. The security circuit claimed in claim 4 further comprising a bus interface circuit for establishing a path for a plurality of signals collectively representing a current category of operation of the processor based on the modes.

4F. The security circuit claimed in claim 4E further comprising a plurality of firewall circuits coupled to said bus interface circuit and to said path for a plurality of signals collectively representing a current category of operation of the processor.

4G. The security circuit claimed in claim 4F wherein said firewall circuits have respective logic circuitries independently responsive to the mode signals and to said address signals to identify attempted access transactions involving addresses in different modes and, upon detection of an attempted transaction contrary to a respective transaction policy for the respective firewall, to activate a transaction blocking signal for the respective firewall.

4H. The security circuit claimed in claim 4 wherein said second checker circuit have respective logic circuitries independently responsive to the mode signals and to said address signals to identify attempted access transactions representative of accesses of respective virtual processors and, upon detection of an attempted access transaction contrary to a respective transaction policy for the respective virtual processor, to activate an output to said security violation handler.

4J. The security circuit claimed in claim 4 further comprising a control module having a register circuit coupled to configure said first checker circuit and to configure said second checker circuit.

4K. The security circuit claimed in claim 4 for use with security configuration signals of the processor having a security policy, the first checker circuit including a logic circuit having input lines for the modes and security configuration signals, said logic circuit based on a second security policy followed by said logic circuit that is more restrictive than the security policy of said processor, said logic circuit operable to detect and generate a security violation upon an occurrence of a security configuration of the processor inconsistent with the second security policy followed by said logic circuit.

4L. The security circuit claimed in claim 4 for use with platform configuration signals of the processor having a platform policy, the first checker circuit including a logic circuit having input lines for the modes and platform configuration signals, said logic circuit based on a second platform policy followed by said logic circuit that is more restrictive than the platform policy of said processor, said logic circuit operable to detect and generate a platform violation upon an occurrence of a platform configuration of the processor inconsistent with the second platform policy followed by said logic circuit.

5A. The processor claimed in claim 5 wherein said processor has at least first and second other privilege modes besides said monitor mode, and said security circuit is further operable to generate a security flag if a transition is attempted from the first other privilege mode to said monitor mode and to not-generate a security flag upon a transition from the second other privilege mode to said monitor mode.

5B. The processor claimed in claim 5 wherein said processor has at least first and second other privilege modes besides said monitor mode, and said security circuit is further operable to generate a security flag if a transition is attempted from said monitor mode to the first other privilege mode and to not-generate a security flag upon a transition from said monitor mode to the second other privilege mode.

5C. The processor claimed in claim 5 wherein said processor is operable in said monitor mode and in said second privilege mode to change the state of said security storage and said security circuit is operable to generate said security flag if said second privilege mode is used to change the state of said security storage.

6A. The processor claimed in claim 6 wherein said security violation handler is operable, when said second storage is in the first state that does permit exception trap into monitor mode, to activate a non-violation security flag if a transition pertaining to monitor mode occurs in said first storage.

6B. The processor claimed in claim 6 wherein said processor has a third storage having a first state wherein said processor is enabled in a non-secure mode and a second state wherein said processor is enabled in a secure mode, and said monitor mode is a type of secure mode and said processor has another type of secure mode, and said security circuit is further operable to generate a security violation signal if an attempt occurs outside said monitor mode to change a state of said third storage.

6C. The processor claimed in claim 6 wherein said security circuit is further operable to generate a security flag if a transition is attempted from the first other privilege mode to said monitor mode and to not-generate a security flag upon a transition from the second other privilege mode to said monitor mode.

6D. The processor claimed in claim 6 wherein said security circuit is further operable to generate a security flag if a transition is attempted from said monitor mode to the first other privilege mode and to not-generate a security flag upon a transition from said monitor mode to the second other privilege mode.

6E. The processor claimed in claim 6 wherein said security circuit further includes a security storage with a plurality of security flags, including a first security flag indicative when activated of a relaxed-rule transition, and a second security flag indicative when activated of a security violation, and said security violation handler is operable when said second storage is in the second state that does not permit exception trap into monitor mode to activate the second security flag indicative of a security violation if a transition pertaining to monitor mode occurs in said first storage, and said security violation handler is operable when said second storage is in the first state that does permit exception trap into monitor mode to activate the first security flag indicative of a relaxed-rule transition if a transition pertaining to monitor mode occurs in said first storage.

7A. The integrated circuit claimed in claim 7 wherein said security circuit is operable to activate the qualifier signal indicative of modem operation provided the physical address lies within an address range reserved for modem operation and to inactivate the qualifier signal if the physical address lies within a shared address range for modem operation and for non-modem operation.

7B. The integrated circuit claimed in claim 7 wherein said processor is operable to assert an access type representing an instruction access together with the asserted physical address, and said security circuit is operable to determine whether the asserted access type is permitted to accompany the asserted physical address and, if not, to activate a security violation signal.

7C. The integrated circuit claimed in claim 7B wherein said security circuit includes a firewall circuit for holding a field to indicate whether or not an instruction access type is permitted in a predetermined address range.

7D. The integrated circuit claimed in claim 7 wherein said security circuit includes a firewall circuit for holding plural permissions concurrently, each of said plural permissions indicating whether permission to access said modem peripheral is granted or denied.

7E. The integrated circuit claimed in claim 7D wherein said security circuit includes a decoder circuit for selecting a particular selection from the permissions in response to inputs to said decoder circuit including at least one input responsive to the qualifier signal indicative of modem operation.

7F. The integrated circuit claimed in claim 7D wherein said security circuit includes a permissions register that has fields for read permissions, write permissions, and permissions corresponding to different permutations of states of plural qualifier signals as active and inactive and including states of the qualifier pertaining to modem operation.

8A. The electronic system claimed in claim 8 wherein said firewall circuit is operable for holding plural permissions concurrently, each of said plural permissions indicating whether permission to access said system peripheral is granted or denied.

8B. The electronic system claimed in claim 8A wherein said firewall circuit includes a selector circuit responsive to a current state of each of the qualifier signals to select a particular one of said plural permissions, whereby to determine that an access to the system peripheral is granted or denied.

8C. The electronic system claimed in claim 8 wherein said firewall circuit includes a permissions register that has fields for read permissions, write permissions, and permissions corresponding to different states of qualifier signals.

8D. The electronic system claimed in claim 8 wherein the qualifiers include an endian-related qualifier.

8E. The electronic system claimed in claim 8 wherein the qualifiers include an instruction access type qualifier.

8F. The electronic system claimed in claim 8 wherein the qualifiers include a privilege mode qualifier.

8G. The electronic system claimed in claim 8 wherein the qualifiers include a cacheability qualifier.

8H. The electronic system claimed in claim 8 wherein the qualifiers include a debug qualifier.

8J. The electronic system claimed in claim 8 wherein the qualifiers include an element-size qualifier.

8K. The electronic system claimed in claim 8 wherein the qualifiers include a security qualifier.

8L. The electronic system claimed in claim 8 wherein said firewall circuit has a first policy for the granting and denying access to said system peripheral in response to different states of the qualifier signals, and said firewall circuit has a firewall configuration register and has a second policy for granting and denying access to said firewall configuration register in response to different states of the qualifier signals.

9A. The processor claimed in claim 9 wherein said processor has a second storage having a first state wherein said processor is enabled in a privilege mode and a second state wherein said processor is enabled in a non-privilege mode, and said monitor mode is a type of privilege mode and said processor has another type of privilege mode, and said security circuit is further operable to generate a security violation signal upon an attempt to transition the second state of the second storage to the first state of the second storage element.

9B. The processor claimed in claim 9 wherein said processor has a second storage having a first state wherein said processor is enabled in a non-secure mode and a second state wherein said processor is enabled in a secure mode, and said monitor mode is a type of secure mode and said processor has another type of secure mode, and said security circuit is further operable to generate a security violation signal if an attempt occurs outside said monitor mode to change a state of said second storage element.

9C. The processor claimed in claim 9 wherein said processor has at least first and second other modes besides monitor, and said security circuit is further operable to generate a security violation signal if a transition is attempted from the first other mode to said monitor mode and to not-generate the security violation upon a transition from the second other mode to said monitor mode.

9D. The processor claimed in claim 9 wherein said processor has at least first and second other modes besides said monitor mode, and said security circuit is further operable to generate a security violation signal if a transition is attempted from said monitor mode to the first other mode and to not-generate the security violation upon a transition from said monitor mode to the second other mode.

9E. The processor claimed in claim 9 wherein said security circuit independently performs a detection of an attempt by the software monitor to access an instruction outside a first predetermined address space for instructions and a detection of an attempt by the software monitor in monitor mode to access data outside a second predetermined address space for data and generates the security violation signal in a manner depending on which independent detection occurs.

10A. The processor claimed in claim 10 wherein said security zone mechanism has a configuration and said security circuit is operable generate a security violation in response to a change in the configuration of said security zone mechanism.

10B. The processor claimed in claim 10 wherein the processor has different particular modes for processing software programs in privilege and non-privilege modes and for processing monitor software in a monitor mode, and said security zone mechanism is operable to permit either a privilege mode or the monitor mode to control a mode change, and said security circuit is operable to further restrict control of the mode change to monitor mode only.

10C. The processor claimed in claim 10 wherein the security zone mechanism has a security storage having a first state wherein said processor is in a non-secure mode and a second state wherein said processor is in a secure mode, and said monitor mode is a type of secure mode, and said security circuit is operable to generate a security violation signal if an attempt occurs in a privilege mode other than monitor mode to change a state of said security storage element.

10D. The processor claimed in claim 10 wherein the processor has control code and said security circuit is operable to govern said security zone mechanism and the processor so that the control code is established as a hypervisor.

10E. The processor claimed in claim 10 wherein the processor has boot code for configuring the security zone mechanism.

10F. The processor claimed in claim 10 wherein the processor has a memory management unit (MMU) and at least one cache memory, and said security zone mechanism has a configuration to enable or disable protection mechanisms for the MMU and the cache memory.

10G. The processor claimed in claim 10F wherein said security circuit is operable to lock the configuration of said security zone mechanism pertaining to the MMU and the cache memory.

10H. The processor claimed in claim 10 wherein said security circuit has a locking register and said processor has boot code to activate the locking register so that said security circuit protects the security zone mechanism from a change in the configuration of the security zone mechanism.

10J. The processor claimed in claim 10 wherein said processor has a secure mode and has a functional bus port coupled to said pipeline and said functional bus port also has a first path indicative of the secure mode, and said security zone mechanism has a security monitor port for a second path indicative of the secure mode, and said security circuit is coupled to said functional bus port and to said security monitor port to detect any inconsistency between the first path and the second path pertaining to secure mode status.

11A. The electronic circuit claimed in claim 11 wherein said processor has a secure mode and said security circuit enforces the processor so that the secure mode is entered only in functional processor operation and at least one non-invasive mode.

11B. The electronic circuit claimed in claim 11 wherein said processor has a secure mode and the processor is coupled by a bus to said peripherals and said bus has a path for a qualifier indicative of the secure mode active, and said security circuit is operable to force the qualifier to non-secure state as seen by the peripherals even when the processor is in the secure mode.

11C. The electronic circuit claimed in claim 11B wherein said processor also has test modes that are invasive or non-invasive, and said security circuit is responsive to at least one test mode that is invasive to force the qualifier to non-secure state as seen by the peripherals even when the processor is in the secure mode.

11D. The electronic circuit claimed in claim 11 wherein said electronic circuit further comprises a plurality of memories, and said security circuit has a register coupled to store respective power-event signals pertaining to at least two of said plurality of memories.

11E. The electronic circuit claimed in claim 11D wherein at least one of said memories has a mode of power-on and a retention mode.

11F. The electronic circuit claimed in claim 11 wherein the power domains include system blocks and said security circuit has a register coupled to store information pertaining to respective resets of at least two system blocks.

11G. The electronic circuit claimed in claim 11F wherein said processor is coupled to said security circuit so that if said register pertaining to resets shows activity, said processor is operable to protect the system.

11H. The electronic circuit claimed in claim 11 wherein said processor has a sleep state and at least one of said peripherals is operable to export information to said security circuit without need of processor wake-up.

11J. The electronic circuit claimed in claim 11 wherein at least one said peripheral has a firewall with a firewall configuration register, and said processor is operable in response to power events affecting said firewall to save and restore configuration for the firewall configuration register.

11K. The electronic circuit claimed in claim 11 wherein said security circuitry includes a random number generator and retention circuits coupled to said random number generator and operable in response to power events affecting said random number generator to save and restore information pertaining to the random number generator.

11L. The electronic circuit claimed in claim 11 wherein at least one of said peripherals includes a security peripheral, and said security circuitry is operable to prevent power state transitions in the middle of operation in said security peripheral.

11M. The electronic circuit claimed in claim 11 wherein at least one of said peripherals includes a resettable security peripheral, and said security circuitry is operable to lock out reset of said security peripheral.

11N. The electronic circuit claimed in claim 11 wherein said power management circuitry provides a cold reset and a warm processor reset, and said platform status register is coupled to said cold reset, and said processor is coupled to said warm processor reset, whereby security protection by said security circuit is enhanced.

12A. The processor claimed in claim 12 wherein said processor has a second storage having a first state wherein said processor is in a privilege mode and a second state wherein said processor is in a non-privilege mode, and said monitor mode is a type of privilege mode and said security circuit is configurable to specify a reserved address space for privilege mode, and said security circuit is further operable to generate another security violation signal in response to an attempted access on said bus by said pipeline inside the reserved address space for privilege mode when said storage has said first state.

12B. The processor claimed in claim 12 wherein said storage also has states for privilege mode and non-privilege mode and said security violation signal is further conditional on attempted access in non-privilege mode.

12C. The processor claimed in claim 12 wherein said storage also has states for instruction access or data access and said security violation signal is further conditional on attempted instruction access.

13A. The electronic circuit claimed in claim 13 further comprising a first peripheral pertaining to real-time and having an interrupt request line coupled to said interrupt handler circuit and a second peripheral pertaining to non-real-time and having another interrupt request line coupled to said interrupt handler circuit.

13B. The electronic circuit claimed in claim 13A wherein said interrupt handler is operable to establish interrupt priority higher for said interrupt request line from said first peripheral than for said another interrupt request line from said second peripheral.

13C. The electronic circuit claimed in claim 13A wherein said processor is differently responsive to secure interrupts than to public interrupts and said interrupt handler is operable to couple a secure interrupt to said processor for real-time thereby to establish an interrupt priority for real-time.

13D. The electronic circuit claimed in claim 13 further comprising a register for enabling or disabling said pre-emptive masking handler circuit.

13E. The electronic circuit claimed in claim 13 further comprising a register coupled to said preemptive masking handler to inhibit public interrupts or not.

13F. The electronic circuit claimed in claim 13 wherein first and second type of interrupt request includes slow (IRQ) and fast (FIQ) interrupt request respectively.

13G. The electronic circuit claimed in claim 13F wherein said processor register circuit also has a public FIQ mask disable to prevent masking of the FIQ, and said preemptive masking handler is operable to activate public FIQ masking regardless.

13H. The electronic circuit claimed in claim 13 wherein said preemptive masking handler is operable to mask at least one interrupt for non-real-time whereby to prevent interference of non-real-time with real-time.

13J. The electronic circuit claimed in claim 13 further comprising a qualifier circuit to generate a qualifier indicating that a virtual processor is active in said processor and said preemptive masking handler circuit is responsive to said qualifier circuit to make at least one interrupt non-maskable when said qualifier is active.

13K. The electronic circuit claimed in claim 13 further comprising a register coupled to said preemptive masking handler for automatically inhibiting at least one interrupt or not.

13L. The electronic circuit claimed in claim 13K wherein said pre-emptive masking handler circuit is responsive to said automatic inhibiting register to directly mask at least one interrupt from said interrupt handler transparent to the monitor mode.

13M. The electronic circuit claimed in claim 13 further comprising a register for enabling a public mask feedback from said interrupt handler to said pre-emptive masking handler circuit.

13N. The electronic circuit claimed in claim 13 wherein said pre-emptive masking handler circuit itself has an output line to supply an interrupt request to said interrupt handler circuit to interrupt said processor.

13P. The electronic circuit claimed in claim 13N further comprising an additional register circuit coupled to said interrupt request output line of said pre-emptive masking handler circuit, said additional register circuit operable to provide an acknowledge to said preemptive masking handler circuit.

13Q. The electronic circuit claimed in claim 13P wherein said pre-emptive masking handler circuit is responsive to the acknowledge to de-assert said interrupt request to said interrupt handler circuit for said processor.

13R. The electronic circuit claimed in claim 13Q further comprising a security violation handler circuit coupled to said additional register circuit to not reset said interrupt request output line of said pre-emptive masking handler circuit when a security violation occurs.

13S. The electronic circuit claimed in claim 13 wherein said processor register circuit also has a secure mode and said pre-emptive masking handler circuit has inputs coupled to said processor register circuit indicative of the monitor mode and secure mode.

13T. The electronic circuit claimed in claim 13 wherein said processor register circuit has an interrupt mask enable and said pre-emptive masking handler circuit has an input coupled to monitor the interrupt mask enable from said processor register circuit.

13U. The electronic circuit claimed in claim 13 further comprising a register coupled to said interrupt handler and operable to flag if an interrupt pertains to a virtual processor or not.

13V. The electronic circuit claimed in claim 13 wherein said processor is operable in categories depending on secure mode or not, and virtual processor or not, and said processor is operable in monitor mode as a hypervisor mode to switch between said categories and to service interrupts respective to each category.

13W. The electronic circuit claimed in claim 13 wherein said processor has respective first and second interrupt masking for said first and second type of interrupt request, and said processor has at least one privileged mode in a secure or public state, and when said processor is in the at least one privileged mode in the public state and the first interrupt masking is enabled, then said preemptive masking handler circuit is responsive so that said interrupt handler masks the second type of interrupt request as well.

13X. The electronic circuit claimed in claim 13 wherein said processor register circuit has a secure mode, and when said processor is in the monitor mode or secure mode, then said preemptive masking handler is maintained activated to prevent at least one non-real-time interrupt request of the second type from interfering with the monitor mode and secure mode.

13Y. The electronic circuit claimed in claim 13 wherein said processor register circuit has a secure mode and public mode and said electronic circuit further comprises a register with a trap field to activate a trap into monitor mode for the first type of interrupt request, and the processor monitor mode is coded to inactivate the trap field when the non-real-time operating system switches within public modes in response to the first type of interrupt request, and to activate the trap field when the processor register circuit is in the secure mode.

14A. The electronic system claimed in claim 14 further comprising caches corresponding to the processor cores and the system further comprising a cache control circuit for updating coherency between the caches, said protective circuitry responsive to the monitor mode line for temporarily disabling the cache control circuit from updating coherency between the caches.

14B. The electronic system claimed in claim 14 wherein said processor is further operable to generate an attempted access on said bus and said system further comprising a firewall coupled to said bus to receive the attempted access and the first and second qualifiers.

14C. The electronic system claimed in claim 14B wherein said firewall is responsive to the attempted access and to the first and second qualifiers to permit an access by at least one of said processor cores and prevent an access pertaining to at least another one of said processor cores.

14D. The electronic system claimed in claim 14 wherein said processor is operable to transition between cores active for access on said bus and said protective circuitry is operable to generate at least one security violation signal unless protective circuitry detects the monitor mode line active from said control core during the transition.

14E. The electronic system claimed in claim 14 further comprising an interrupt routing circuit for routing interrupts to the control core from the other processor cores.

14F. The electronic system claimed in claim 14 further comprising a clock circuit operable to couple clock signals to the processor cores.

14G. The electronic system claimed in claim 14F wherein said clock circuit is configurable by control core.

14H. The electronic system claimed in claim 14G wherein said protective circuitry is further operable to detect a security violation if said clock circuit is configured outside a predetermined mode of said control core.

15A. The process of manufacturing claimed in claim 15 wherein the testing of the processor includes testing of at least one operational transition selected from the group consisting of transition through real-time modem operation, interrupt handling, monitor software, debug, and power management.

15B. The process of manufacturing claimed in claim 15 further comprising providing and assembling a telecommunications unit printed wiring board having said integrated circuit and a user interface coupled to said integrated circuit.

15C. The process of manufacturing claimed in claim 15B wherein said printed wiring board further has a storage provided with a real-time operating system (RTOS), a high-level non-real time operating system (HLOS), and a security-protected application.

15D. The process of manufacturing claimed in claim 15 wherein the testing successively adjusts at least one parameter for a more favorable level of at least one metric, the at least one parameter selected from the group consisting of enable/disable fields in the configuration registers of the protective circuitry, interrupt priorities, and a firewall mode hierarchy.

15E. The process of manufacturing claimed in claim 15D wherein the metric is selected from at least one of the group consisting of faster application execution, lower power dissipation, communication quality of service, system stability, attack resistance, and evaluation of system user experience.

15F. The process of manufacturing claimed in claim 15D wherein the process further comprises loading at least the adjusted parameter into the telecommunications unit.

16A. The electronic device claimed in claim 16 wherein the second processor includes another application processor.

16B. The electronic device claimed in claim 16 wherein the second processor includes a graphics processor.

16C. The electronic device claimed in claim 16 wherein the second processor includes a modem processor.

17A. The telecommunications unit claimed in claim 17 wherein the modem circuit includes a wireless modem circuit and said user interface includes a voice interface for a wireless handset.

17B. The telecommunications unit claimed in claim 17 wherein the software monitor is operable as a hypervisor.

17C. The telecommunications unit claimed in claim 17 wherein said user interface includes a video display.

17D. The telecommunications unit claimed in claim 17 wherein said user interface is adapted for television signal coupling.

17E. The telecommunications unit claimed in claim 17 wherein said storage also includes a storage unit for media content.

17F. The telecommunications unit claimed in claim 17 wherein said processor is operable as a microcontroller and said user interface is adapted for microcontroller signal coupling.

17G. The telecommunications unit claimed in claim 17 wherein the modem circuit includes a wireline modem circuit.

18. An integrated circuit comprising

a processor including a pipeline;

a debug circuit coupled to said processor; and

a security circuit coupled to said processor and operable to generate a security violation signal upon occurrence of a security violation by said processor, said security circuit also operable to respond to the security violation to couple a debug request signal to said debug circuit, whereby the debug circuit is steered to the security violation.

19. An integrated circuit comprising

a processor including a pipeline;

a first bus coupled to said processor;

a first storage coupled to said bus;

a trace bus coupled to said pipeline separately from said first bus; and

a security circuit including a security storage coupled to said second bus, said security circuit operable to generate at least one security violation signal indicative of a non-permitted access by said processor to said security storage of the security circuit itself.

Notes: Aspects are paragraphs which might be offered as claims in patent prosecution. The above dependently-written Aspects have leading digits and internal dependency designations to indicate the claims or aspects to which they pertain. Aspects having no internal dependency designations have leading digits and alphanumerics to indicate the position in the ordering of claims at which they might be situated if offered as claims in prosecution.

References to “monitor mode” refer to a high-level control mode of a processor and should be understood in a broad and substantial sense whether or not a particular processor that substantially has a monitor mode lacks the explicit name monitor mode, for instance.

It is emphasized here that while some embodiments may have an entire feature totally absent or totally present, other embodiments, such as those performing the blocks and steps of the Figures of drawing, have more or less complex arrangements that execute some process portions, selectively bypass others, and have some operations running concurrently sequentially regardless. Accordingly, words such as “enable,” disable,” “operative,” “inoperative” are to be interpreted relative to the code and circuitry they describe. For instance, disabling (or making inoperative) a second function by bypassing a first function can establish the first function and modify the second function. Conversely, making a first function inoperative includes embodiments where a portion of the first function is bypassed or modified as well as embodiments where the second function is removed entirely. Bypassing or modifying code increases function in some embodiments and decreases function in other embodiments.

A few preferred embodiments have been described in detail hereinabove. It is to be understood that the scope of the invention comprehends embodiments different from those described yet within the inventive scope. Microprocessor and microcomputer are synonymous herein. Processing circuitry comprehends digital, analog and mixed signal (digital/analog) integrated circuits, ASIC circuits, PALs, PLAs, decoders, memories, non-software based processors, microcontrollers and other circuitry, and digital computers including microprocessors and microcomputers of any architecture, or combinations thereof. Internal and external couplings and connections can be ohmic, capacitive, inductive, photonic, and direct or indirect via intervening circuits or otherwise as desirable. Implementation is contemplated in discrete components or fully integrated circuits in any materials family and combinations thereof. Various embodiments of the invention employ hardware, software or firmware. Process diagrams herein are representative of flow diagrams for operations of any embodiments whether of hardware, software, or firmware, and processes of manufacture thereof.

While this invention has been described with reference to illustrative embodiments, this description is not to be construed in a limiting sense. Various modifications and combinations of the illustrative embodiments, as well as other embodiments of the invention may be made. The terms “including”, “includes”, “having”, “has”, “with”, or variants thereof are used in the detailed description and/or the claims to denote non-exhaustive inclusion in a manner similar to the term “comprising”. It is therefore contemplated that the appended claims and their equivalents cover any such embodiments, modifications, and embodiments as fall within the true scope of the invention.

What is claimed is:

1. An electronic device comprising
a processor including a pipeline operable to execute instructions in a real-time category or a non-real-time category, the processor operable in a secure or non-secure mode and in a monitor or a non-monitor mode and further operable to generate mode signals on a secure mode line and a monitor mode line;
a bus coupled to said pipeline for accesses; and
protective circuitry coupled to said processor, said protective circuitry having a register field operable to couple first and second qualifiers to said bus wherein the first qualifier is responsive to said secure mode line and the second qualifier represents whether the processor is in the real-time category or not for a given access, and said protective circuitry further responsive to the monitor mode line to permit alteration of said register field by said processor when the processor is in the monitor mode and to prevent alteration of at least part of said register field when said processor is in a non-monitor mode.

2. An integrated circuit comprising
a processor including a pipeline;
a bus coupled to said pipeline;
a storage coupled to said bus, said storage having a real time operating system, a non-real-time operating system, and a software monitor; and
a security circuit coupled to said bus and operable to generate at least one security violation signal unless a transition between the real time operating system and the non-real-time operating system includes the software monitor.

3. An electronic system comprising
a processor including a pipeline;
a bus coupled to said pipeline;
a storage coupled to said bus, said storage having a real time operating system and a real-time application, a non-real-time operating system, a secure environment kernel, and a software monitor; and
protective circuitry coupled to said processor and operable to establish a first signal and a second signal each having states and together having combinations of the states representing a first category for the real-time operating system and the real-time application, a second category for the non-real-time operating system, and a third category for the secure environment kernel.

4. A security circuit for use with a processor having modes and address signals, the security circuit comprising:
a security violation handler;
a first checker circuit having a first checker output coupled to said security violation handler and said first checker circuit having input lines for receiving mode signals indicative of at least some of the modes and said first checker circuit having logic circuitry coupled to the input lines to detect mode transitions between the modes and activate the first checker output upon detection of a mode transition contrary to a permitted transition policy for said logic circuitry; and
a second checker circuit having a second checker output coupled to said security violation handler, said second checker circuit having second input lines for receiving mode signals indicative of at least some of the modes, said second checker circuit further having third input lines for receiving the address signals, and said second checker circuit having second logic circuitry responsive to the mode signals and to said address signals to identify attempted transactions of different modes and activate the second checker output upon detection of an attempted transaction including an address and a mode contrary to a permitted transaction policy for said second logic circuitry.

5. A processor having modes for processing in privilege and non-privilege modes and for processing in a monitor mode, the processor comprising
a pipeline;
a storage having a field for representing privilege mode and monitor mode, and said monitor mode is a first privilege mode and said processor has a second privilege mode; and
a security circuit having a security storage having a first state wherein said processor is enabled in a non-secure mode and a second state wherein said processor is enabled in a secure mode, and said monitor mode is a type of secure mode, and said security circuit is further operable to generate a security violation signal if an attempt occurs in a mode other than the monitor mode to change a state of said security storage.

6. An integrated circuit comprising
a processor having modes for processing in privilege and non-privilege modes and for processing in a monitor mode, the processor including
a pipeline; and
a first storage for representing that said process is in the monitor mode or not and for representing at least first and second other privilege modes besides the monitor mode;
and
the integrated circuit further comprising a security circuit coupled to said processor and including
a second storage having a first state wherein an exception trap by said processor into monitor mode is permitted and a second state wherein the exception trap into monitor mode is not permitted; and
a security violation handler operable when said second storage is in the second state that does not permit exception trap into monitor mode to generate a security violation signal if a transition pertaining to monitor mode occurs in said first storage.

7. An integrated circuit comprising:
a processor operable to assert a physical address and to establish secure and public modes and privileged modes including a particular privileged mode;
a bus for communicating the asserted physical address;
a modem peripheral coupled to said bus to receive the asserted physical address; and
a security circuit coupled to said bus and operable to activate a qualifier signal indicative of modem operation by determining whether the asserted physical address lies within a predetermined address range for modem operation and has occurred in a public mode and in the particular privileged mode.

8. An electronic system comprising:
a processor operable to assert a physical address and to establish modes including modes that are privileged or non-privileged, and secure or public;
a bus for communicating the asserted physical address;
a system peripheral coupled to said bus to receive the asserted physical address;
a security circuit coupled to said bus and operable to activate qualifier signals including a system qualifier indicative of a category of processor operation representing a virtual processor in response to the physical address and modes; and
a firewall circuit for granting and denying access to said system peripheral in response to different states of the qualifier signals including the states of the system qualifier.

9. A processor for processing a software program and a software monitor, the processor comprising
a pipeline;
a storage having a first state wherein the pipeline is enabled to process the software program and said storage having a second state establishing a monitor mode wherein the pipeline is enabled to process the software monitor;
a bus coupled to said pipeline;
security circuit coupled to said bus and to said storage and operable to generate a security violation signal in response to an attempted access on said bus by said pipeline outside a predetermined address space when said storage has said second state establishing the monitor mode.

10. A processor having modes, the processor comprising
a pipeline;
a security zone mechanism operable according to its own axioms for permissible and impermissible operations pertaining to the various modes; and
a security circuit coupled with said security zone mechanism to further restrict at least one of the permissible operations to be impermissible.

11. An electronic circuit comprising:
a processor having modes including a high-level control mode;
peripherals coupled to said processor;
power management circuitry dividing and controlling the electronic circuit in power domains with power events of power-up and power-down to the power domains; and
a security circuit having a platform status register coupled with said power domains to detect a power event and to interrupt said processor to said high-level control mode to protect information security of the electronic circuit.

12. A processor for processing a software program and a software monitor and a predetermined address space reserved for said software monitor, the processor comprising
a pipeline;
a storage having a first state wherein the pipeline is enabled to process the software program and said storage having a second state establishing a monitor mode wherein the pipeline is enabled to process the software monitor;
a bus coupled to said pipeline;
a security circuit coupled to said bus and to said storage and operable to generate a security violation signal in response to an attempted access on said bus by said pipeline inside the predetermined address space reserved for said software monitor when said storage has said first state.

13. An electronic circuit comprising
a processor including a pipeline and a register circuit for modes including a monitor mode;
a bus coupled to said pipeline;
a storage coupled to said bus, said storage having a real time operating system and a non-real-time operating system;
an interrupt handler circuit coupled to said processor and operable to provide a first type of interrupt request and a second type of interrupt request, said processor responsive to said second type of interrupt request to activate the monitor mode; and
a pre-emptive masking handler circuit coupled to said processor and to said interrupt handler circuit so that said interrupt handler circuit is responsive to mask at least one non-real-time interrupt request and responsive to provide at least one real-time interrupt request of the second type to said processor.

14. An electronic system comprising
a processor including a plurality of processor cores each including a pipeline operable to execute instructions, at least one of said processor cores operable as a control core in a secure or non-secure mode and in a monitor or a non-monitor mode and further operable to generate mode signals on a secure mode line and a monitor mode line;
a bus coupled to said pipeline for accesses; and
protective circuitry coupled to said processor, said protective circuitry operable to couple a first qualifier to said bus wherein the first qualifier is responsive to said secure mode line, the protective circuitry further having a register field coupled to said bus, the register field acting as a second qualifier for representing which of said processor cores is active for a given access, and said protective circuitry further responsive to the monitor mode line to permit alteration of said register field by said processor when said control core is in the monitor mode and to prevent such alteration when said control core is in a non-monitor mode.

15. A process of manufacturing an electronic product, the process comprising:
fabricating in a wafer fabrication facility an integrated circuit having a processor operable for executing a hypervisor responsive to at least one interrupt, and having a secure hardware-supported hypervisor protective circuitry having configuration registers and firewalls; and
testing the integrated circuit by operating the processor and secure hardware-supported hypervisor protective circuitry while using the registers in at least two different configurations and verifying the hardware supported hypervisor, firewalls and interrupt operation pertaining to real-time and non-real-time operations.

16. An electronic assembly comprising:
a first integrated circuit including an application processor operable to execute a hypervisor and at least one operating system selected from the group consisting of a real-time operating system, a non-real-time operating system, and a secure environment kernel, and the first integrated circuit including a protective circuitry coupled to said processor and operable to establish a first signal and a second signal each having states and together having combinations of the states representing a first category for the real-time operating system, a second category for the non-real-time operating system, and a third category for the secure environment kernel; and
a second integrated circuit physically affixed and communicatively coupled to said application processor and to said protective circuitry of said first integrated circuit, said second integrated circuit including a second processor operable to execute at least one additional operating system selected from the group consisting of a real-time operating system, a non-real-time operating system, and a secure environment kernel.

17. A telecommunications unit comprising:
a processor including a pipeline;
a bus coupled to said pipeline;
a storage coupled to said bus, said storage having a real time operating system and a real-time modem application, a non-real-time operating system, a secure environment kernel, and a software monitor;
protective circuitry coupled to said processor and operable to establish a first signal and a second signal each having states and together having combinations of the states representing a first category for the real-time operating system and the real-time application, a second category for the non-real-time operating system, and a third category for the secure environment kernel;
a telecommunications modem circuit coupled to said processor; and
a user interface coupled to said processor.
